(19) United States
(12) Patent Application Publication
(10) Pub. No.: US 2014/0164290 A1
(43) Pub. Date: Jun. 12, 2014

(54) DATABASE FOR RISK DATA PROCESSING

(71) Applicant: TRANSCON SECURITIES PTY LTD, Melbourne (AU)

(72) Inventor: Geoff Salter, South Yarra (AU)

(73) Assignee: TRANSCON SECURITIES PTY LTD, Melbourne (AU)

(21) Appl. No.: 14/092,714

(22) Filed: Nov. 27, 2013

Related U.S. Application Data
(63) Continuation of application No. PCT/AU2012/000474, filed on May 3, 2012.

(30) Foreign Application Priority Data
May 30, 2011 (AU) 2011902097

(51) Int. Cl. G06Q 40/06

(52) U.S. Cl. CPC G06Q 40/06
USPC 705/36 R

(57) ABSTRACT

A database for risk data processing is described. A database system includes a database storage comprising one or more data items, each data item associated with a selection criteria and a risk tolerance. The system further includes an electronic processing device in data communication with the database storage. The electronic processing device is configured to interface between a user terminal and the database storage to process risk data and provide displayable representations thereof.

### CROSS-REFERENCE TO RELATED APPLICATIONS

Any and all applications for which a foreign or domestic priority claim is identified in the Application Data Sheet as filed with the present application are hereby incorporated by reference under 37 C.F.R. §1.57. This application is a continuation of PCT Application No. PCT/AU2012/000474, filed May 3, 2012, which claims priority to Australian Patent Application No 2011902097, filed May 30, 2011. Each of the above applications is incorporated herein by reference in its entirety.

### BACKGROUND

1. Technological Field

The present invention relates to a database for risk data processing which may be included in, for example, a financial management system.

2. Description of the Related Technology

Harry Max Markowitz was a recipient of the John von Neumann Theory Prize and the Nobel Memorial Prize in Economic Sciences. He is best known for his pioneering work in Modern Portfolio Theory, studying the effects of asset risk, return, correlation and diversification on probable investment portfolio returns.

Markowitz chose to apply mathematics to the analysis of the stock market. While researching the then current understanding of stock prices Markowitz realized that the theory lacks an analysis of the impact of risk. This insight led to the development of his seminal theory of portfolio allocation under uncertainty, published in 1952 by the Journal of finance (Markowitz, H. M. (March 1952), “Portfolio Selection”, The Journal of Finance 7 (1): 77-91). Markowitz continued to research optimization techniques, further developing the critical line algorithm for the identification of the optimal mean-variance portfolios, lying on what was later named the Markowitz frontier. He published the critical line algorithm in a 1956 paper and a book on portfolio allocation which was published in 1959 (Markowitz, H. M. (1959) Portfolio Selection: Efficient Diversification of Investments).

Markowitz's theory included a coefficient correlation technique that used quadratic equations which lead to a broader macro review of investment portfolios. Markowitz's technique relied on mean and variance. However, he didn't look at other characteristics such as symmetry of distribution (Absolute Risk Adjusted Return Relative to Benchmark) and optionality (The Optimum Gap Analysis Alignment between the Client's Risk Tolerance and the Selection of the Investments). To address this, financial management systems have previously employed the following tools, for example, to find the right mix of investments for an investment portfolio:
1. Create a risk profile for an investor;
2. Select investments for the investment portfolio;
3. Allocate the investor's assets over the investments of the investment portfolio; and
4. Manage the risk associated with the investment portfolio in accordance with the investor's risk profile.

Advantageously, asset allocation represents over 90% of the accuracy response of a portfolio volatility return and a 70% response chance regarding the value add return of a portfolio. The purity of improved predictability expectations to leads towards:
1. comfortably forecasted usage;
2. a highly concentrated approach; and
3. a better absolute Alpha.

At the end of the day, the above-mentioned techniques provide insight and understanding of the dynamics of the problems associated with constructing an investment portfolio. However, the financial planner can't get away from exercising judgment when evaluating and selecting investments for an investment portfolio. To this end, financial planners are perennially faced with the difficulty of accessing, understanding and assessing the myriad of information that is used to select investments for inclusion in an investment portfolio. This information, hereafter referred to as “Universal Comparison Information”, for example, comes in the form of:
1. investment comparison information such as Alpha, Beta, Standard Deviation, etc.
2. other indicators used by professionals to gauge the markets like business sentiments;
3. investment and employment levels; and
4. major commodity prices.

Financial planners, for example, typically trawl through the Universal Comparison Information to determine when to buy, sell, or hold investments with a view to identifying promising investments. However, these decisions are based on the financial planners ability compare and assess investments based on these metrics. As such, the decisions made by financial planners are prone to human error and human bias.

Some financial management systems have previously employed tools for drill mining the Universal Comparison Information in order to automate investment selection processes. However, these systems typically lack realization and practicability of solving the complete solution required by financial planners that, in turn, satisfies the desire of the client's mandate. That is, the client doesn't want to lose money, yet as the same time, the client expects to get constant performance.

It is generally desirable to overcome or ameliorate one or more of the above mentioned difficulties, or at least provide a useful alternative.

### SUMMARY OF CERTAIN INVENTIVE ASPECTS

In accordance with the invention, there is provided a system for constructing an investment portfolio for an investor, said system comprising:
(a) a computer system;
(b) computer readable data storage, in communication with the computer system, including computer readable instructions stored thereon which, when executed, cause the computer system to perform the steps of:
   (i) receiving risk tolerance data representing the risk tolerance level of the investor;
   (ii) receiving data representing selection criteria from the user terminal,
   (iv) generating, for display on the user interface of the user terminal, a list of investments for inclusion in the portfolio, where the investments are ranked in accordance with the selection criteria;
   (vi) receiving, from the user terminal, data representing a selection of investments from said list of investments for inclusion in the portfolio; and
   (vii) generating, for display on the user interface of the user terminal, a table showing each investment of said selection of investments; a distribution of investor assets over one or more asset classes of each investment; a distribution of assets over one or more asset classes of a benchmark risk category representing a risk tolerance level of the investor; and a distribution of assets over said one or more asset classes for the entire investment portfolio.

Preferably, the selection criteria includes efficiency ratio factor metrics.

Preferably, the selection criteria includes top quartile factor metrics.

Preferably, the selection criteria includes classic portfolio optimisation factor metrics.

In accordance with the invention there is also provided a computer program executable on one or more processors, for constructing an investment portfolio for an investor, said program for performing the steps of:
(a) receiving risk tolerance data representing the risk tolerance level of the investor;
(b) receiving data representing selection criteria from the user terminal;
(c) generating, for display on the user interface of the user terminal, a list of investments for inclusion in the portfolio, where the investments are ranked in accordance with the selection criteria;
(d) receiving, from the user terminal, data representing a selection of investments from said list of investments for inclusion in the portfolio; and
(e) generating, for display on the user interface of the user terminal, a table showing each investment of said selection of investments; a distribution of investor assets over one or more asset classes of each investment; a distribution of assets over one or more asset classes of a benchmark risk category representing a risk tolerance level of the investor; and a distribution of assets over said one or more asset classes for the entire investment portfolio.

Preferably, the selection criteria includes efficiency ratio factor metrics.

Preferably, the selection criteria includes top quartile factor metrics.

Preferably, the selection criteria includes classic portfolio optimisation factor metrics.

In accordance with the invention there is also provided a computer readable medium comprising instructions which, when executed causes the computer to analyse risk associated with an investment portfolio of an investor by performing a method comprising:
(a) generating a user interface for display on a user terminal, said user interface including a questionnaire for completion by the investor;
(b) receiving risk tolerance data representing answers to the questionnaire from said user terminal;
(c) generating data representing a risk tolerance level of the investor based on said risk tolerance data;
(d) associating the investor with benchmark risk category that represents the investor's risk tolerance level;
(e) generating, for display on the user interface of the user terminal, a list of investments for inclusion in the portfolio, where the investments are ranked based on risk and return, the return corresponding with the investor's risk tolerance level;
(f) receiving, from the user terminal, data representing a selection of investments from said list of investments for inclusion in the portfolio; and
(g) generating, for display on the user interface of the user terminal, a table showing each investment of said selection of investments; a distribution of investor assets over one or more asset classes of each investment; a distribution of assets over one or more asset classes of a benchmark risk category representing a risk tolerance level of the investor; and a distribution of assets over said one or more asset classes for the entire investment portfolio.

In accordance with the invention there is also provided a method of managing an investment portfolio of an investor, the method comprising:
(a) with a user terminal, categorizing the investor as being represented by one of a plurality of benchmark risk categories;
(b) generating, for display on the user interface of the user terminal, a list of investments for inclusion in the portfolio, where the investments are ranked based on risk and return, the return corresponding with the investor's risk tolerance level;
(c) receiving, from the user terminal, data representing a selection of investments from said list of investments for inclusion in the portfolio; and
(d) generating, by the processor of the user terminal, an additional user interface on the user terminal, the additional user interface including a table showing:
   i. each investment of the investment portfolio;
   ii. a distribution of assets of each investment of the investment portfolio over one or more asset classes;
   iii. another distribution of assets over the one or more asset classes of the benchmark risk category; and
   iv. a distribution of assets over said one or more asset classes for the entire investment portfolio,
   wherein the additional user interface further includes means for adding or removing an investment to or from the investment portfolio;
(e) with the user terminal, to adding or removing one or more of the investments from the investment portfolio so that the distribution of assets over said one or more asset classes for the entire investment portfolio corresponds with the distribution of assets over said one or more asset classes of the benchmark risk category of the investor.

Preferably, the table further shows a distribution of assets over one or more asset classes of another benchmark risk category, said another benchmark risk category representing a previous or a next benchmark in a series of benchmarks

In accordance with the invention there is also provided a method of managing an investment portfolio of an investor, the method comprising:
(a) with a user terminal, categorising the investor as being represented by one of a plurality of benchmark risk categories;
(b) generating, for display on the user interface of the user terminal, a list of investments for inclusion in the portfolio, where the investments are ranked based on risk and return, the return corresponding with the investor's risk tolerance level;
(c) receiving, from the user terminal, data representing a selection of investments from said list of investments for inclusion in the portfolio; and
(d) generating, by a processor of the user terminal, an additional user interface on the user terminal, said additional user interface including a table showing:
   i. each investment of the investment portfolio;
   ii. a distribution of assets of each investment of the investment portfolio over one or more asset classes;
   iii. another distribution of assets over the one or more asset classes of said benchmark risk category; and
   iv. a distribution of assets over said one or more asset classes for the entire investment portfolio,
   wherein the additional user interface includes means for allocating a proportion of the investor's assets to each investment of the investment portfolio; and
(d) with the user terminal, changing the proportion of the investor's assets allocated to each investment of the investment portfolio so that the distribution of assets over said one or more asset classes for the entire investment portfolio corresponds with the distribution of assets over said one or more assets of the benchmark risk category of the investor.

Advantageously, the system provides a complete solution required by financial planners that in turn satisfies the desired of the client's mandate. That is, the client does not want to loose money, yet at the same time it expects to get constant out (performance).

### BRIEF DESCRIPTION OF THE DRAWINGS

Preferred embodiments of the present invention are hereafter described, by way of non-limiting example only, with reference to the accompanying drawing in which:

FIG. 1 is a diagrammatic illustration of a preferred embodiment of the financial management system connected to a network;

FIG. 2 is a diagrammatic illustration of the financial management system shown in FIG. 1;

FIG. 3 is a diagrammatic illustration of the director and file structure of the web application of the financial management system shown in FIG. 1;

FIG. 4 is a dataflow diagram of the financial management system shown in FIG. 1;

FIG. 5 is a screen shot of a log in page generated by the system shown in FIG. 1;

FIGS. 6 & 7 are screen shots of a user profile generated by the system shown in FIG. 1;

FIGS. 8 to 18 are screen shots of a risk profile generated by the system shown in FIG. 1;

FIG. 19 is a flow diagram of showing steps performed by the system shown in FIG. 1 for the risk profile interface;

FIG. 20 is screen shot of a user profile generated by the system shown in FIG. 1;

FIGS. 21 to 26 are screen shots generated by the system shown in FIG. 1;

FIGS. 27 to 31 are schematic diagrams of methods performed using the system shown in FIG. 1;

FIG. 32 is a table showing core spectrum symmetry of distribution factor metrics building blocks for fund managers (1000+) used by the system shown in FIG. 1;

FIG. 33 is a table showing core spectrum symmetry of distribution factor metrics building blocks for direct share opportunities (1000+) used by the system shown in FIG. 1;

FIGS. 34a to 34d are tables showing efficiency ratio factor pricing metrics used by the system shown in FIG. 1;

FIGS. 35a to 35d are tables showing top quartile factor pricing metrics used by the system shown in FIG. 1;

FIGS. 36a to 36d are tables showing classic portfolio optimisation factor pricing metrics used by the system shown in FIG. 1;

FIGS. 37a to 37d are tables showing misprising direct shares opportunities re factor framework analysis for the system shown in FIG. 1;

FIGS. 38 to 58 are screen shots generated by the system shown in FIG. 1;

FIG. 59 not included; and

FIGS. 60 to 247 are screen shots generated by the system shown in FIG. 1.

### DETAILED DESCRIPTION OF CERTAIN ILLUSTRATIVE EMBODIMENTS

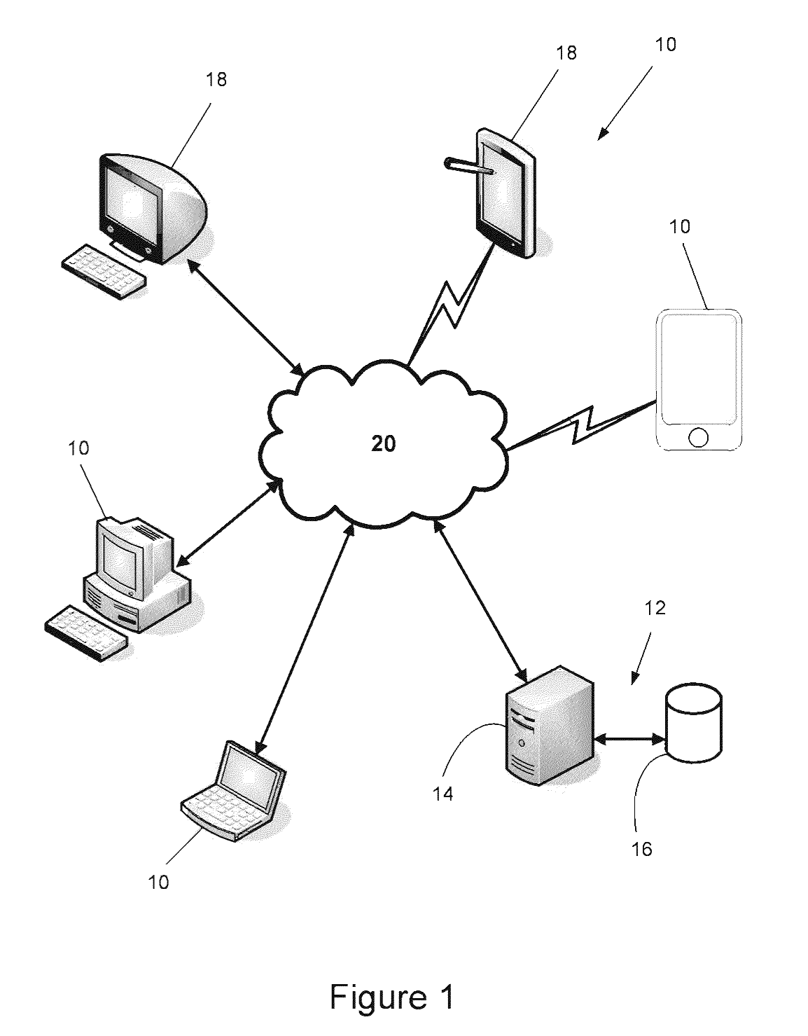

The system 10 shown in FIG. 1 provides a financial planner, for example, with the tools to:
1. Create a profile for an investor;
2. Create a risk profile for an investor that reflects the investor's risk tolerance level;
3. Assess investments in different economic sectors;
4. Select investments for an investment portfolio for an investor;
5. Allocate the investor's assets over the investments of the investment portfolio; and
6. Manage the risk associated with the investment portfolio in accordance with the investor's risk profile.

Importantly, the system 10 provides the financial planner with the tools to mine the myriad of information which financial planners use to compare investments (hereafter “Universal Comparison Information”) in a systematical way. Specifically, system 10 uses Core Spectrum Factor Metrics mine the data so that the financial planner can avoid making decisions based on human judgment which may be prone to error and bias. The Core Spectrum Factor Metrics consists of:
1. hardware:—Core Spectrum Symmetry of Distribution Factor Metrics; and
2. software:—Capital Asset Pricing Models Factor Metrics.

In doing so, the system 10 provides a tool for making sound economic financial decisions based on a reward for risk equilibrium. That is, efficient market hypothesis as opposed to making decisions based on human judgment which may be prone to error and bias. This is the underlying investment strategy rationality provided by the system 10 because it represents “The Goal for Successful Investing” and a “Broad Investment Risk Management Optimality System Targeted To an Efficient Frontier”.

The system 10 also provides the means for verification. The system 10 provides absolute concentrated risk adjusted return relative benchmark which contains this efficient investment outcomes due to it's self adjusting mechanism or equilibrium approach, meaning the only risk that should be rewarded is the market risk. Exposure to market risk is captured by beta, which measures the sensitivity of returns statistical and all the mean variances and fundamentals on the particular security and the portfolio to market. Therefore, this systematic building block approach by the system 10 through its flexible technique Alpha Metrics forms into a true superior value accordingly based on an in-built technique of efficient self adjusting structural hardware and software mechanism approach combined with utilising multiple strategies processed through systematic building blocks, that builds solutions for their clients in much the same way so as to continuously select the pedigree investments that asset allocate across the relative strength asset classes according to the consistency of the changing times and unpredictable markets which can mean long term assumptions about portfolio risk management and portfolio construction may need to be challenged and new methodologies explored.

### The System

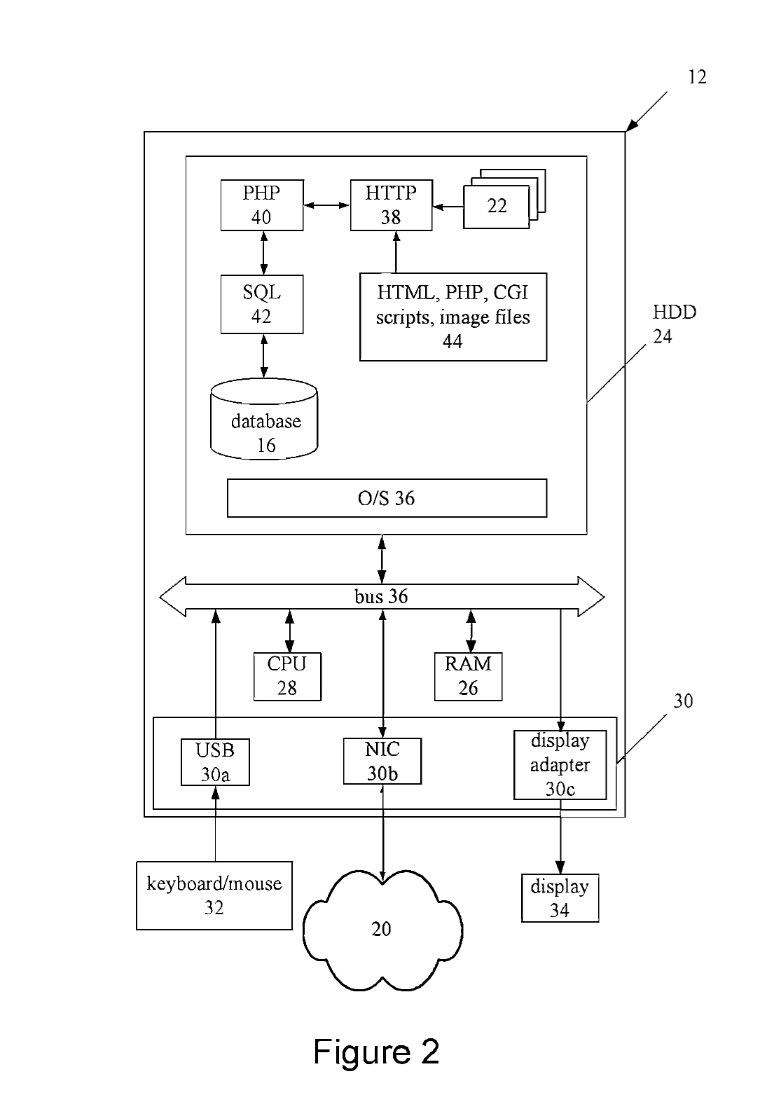

The system 10 is provided by the computer system 12 shown in FIG. 2 that includes a server 14 in communication with a database 16. The computer system 12 is able to communicate with equipment 18 of members, or users, of the system 10 over a communications network 20 using standard communication protocols. The equipment 18 of the members can be a variety of communications devices such as personal computers; interactive televisions; hand held computers etc. The communications network 20 may include the Internet, telecommunications networks and/or local area networks.

The components of the computer system 12 can be configured in a variety of ways. The components can be implemented entirely by software to be executed on standard computer server hardware, which may comprise one hardware unit or different computer hardware units distributed over various locations, some of which may require the communications network 20 for communication. A number of the components or parts thereof may also be implemented by application specific integrated circuits (ASICs).

In the example shown in FIG. 2, the computer system 12 is a commercially available server computer system based on a 32 bit or a 64 bit Intel architecture, and the processes and/or methods executed or performed by the computer system 12 are implemented in the form of programming instructions of one or more software components or modules 22 stored on non-volatile (e.g., hard disk) computer-readable storage 24 associated with the computer system 12. At least parts of the software modules 22 could alternatively be implemented as one or more dedicated hardware components, such as application-specific integrated circuits (ASICs) and/or field programmable gate arrays (FPGAs).

The computer system 12 includes at least one or more of the following standard, commercially available, computer components, all interconnected by a bus 24:
1. random access memory (RAM) 26;
2. at least one computer processor 28, and
3. external computer interfaces 30:
   a. universal serial bus (USB) interfaces 30a (at least one of which is connected to one or more user-interface devices, such as a keyboard, a pointing device (e.g., a mouse 32 or touchpad),
   b. a network interface connector (NIC) 30b which connects the computer system 12 to a data communications network such as the Internet 20; and
   c. a display adapter 30c, which is connected to a display device 34 such as a liquid-crystal display (LCD) panel device.

The computer system 12 includes a plurality of standard software modules, including:
1. an operating system (OS) 36 (e.g., Linux or Microsoft Windows);
2. web server software 38 (e.g., Apache, available at http://www.apache.org);
3. scripting language modules (e.g., personal home page or PHP, available at http://www.php.net, or Microsoft ASP); and
4. structured query language (SQL) modules 42 (e.g., MySQL, available from http://www.mysql.com), which allow data to be stored in and retrieved/accessed from an SQL database 16.

Together, the web server 38, scripting language 40, and SQL modules 42 provide the computer system 12 with the general ability to allow users of the Internet 20 with standard computing devices 18 equipped with standard web browser software to access the computer system 12 and in particular to provide data to and receive data from the database 16. It will be understood by those skilled in the art that the specific functionality provided by the system 12 to such users is provided by scripts accessible by the web server 38, including the one or more software modules 22 implementing the processes performed by the computer system 12, and also any other scripts and supporting data 44, including mark-up language (e.g., HTML, XML) scripts, PHP (or ASP), and/or CGI scripts, image files, style sheets, and the like.

The boundaries between the modules and components in the software modules 22 are exemplary, and alternative embodiments may merge modules or impose an alternative decomposition of functionality of modules. For example, the modules discussed herein may be decomposed into sub modules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the computer system 12 may be executed by a module (of software modules 22) or a portion of a module. The processes may be embodied in a machine-readable and/or computer-readable medium for configuring a computer system to execute the method. The software modules may be stored within and/or transmitted to a computer system memory to configure the computer system to perform the functions of the module.

The computer system 12 normally processes information according to a program (a list of internally stored instructions such as a particular application program and/or an operating system) and produces resultant output information via input/output (I/O) devices 30. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

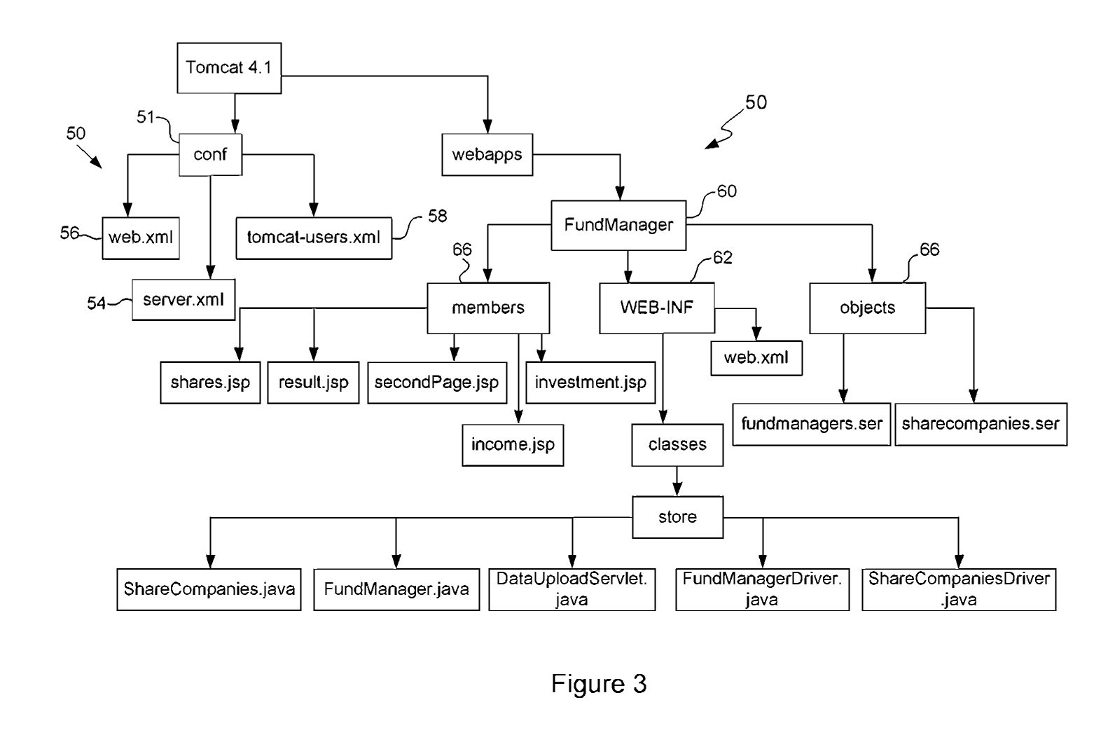

The computer system 12 uses Tomcat 4.1 as the servlet web container for the web application. An exemplary directory and file structure 50 for the web application is shown in FIG. 3. The conf directory 51 includes three XML configuration files 52 that are used to configure the servlet web container of the web application. The serve.xml file 54 configures the web application path and sets the address of the host web server. The web.xml file 56 is used to configure servlets and other resources that make up the web application. The tomcat-users.xml file 58 includes authentic user names and corresponding passwords.

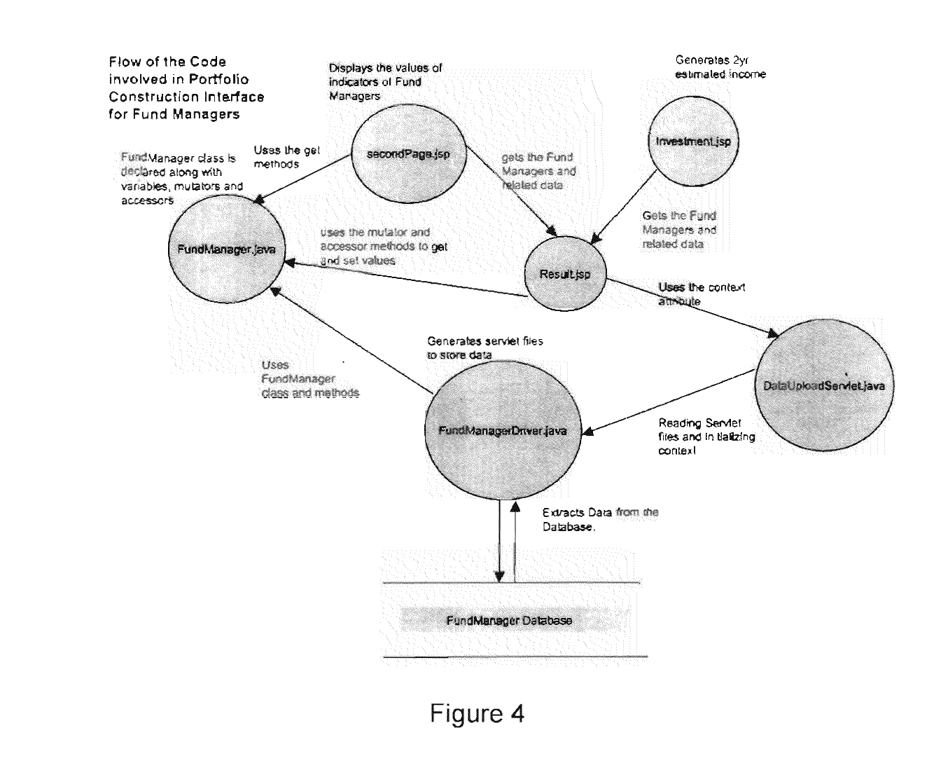

The FundManager directory 60 includes three main directories. The Web-inf directory 62 includes the Java files required to implement the web application. The objects directory 64 includes all of the servlet files. The members directory 66 includes the JSP files required for the display of interfaces of the web application. The dataflow between these interfaces of the system 12 is shown in FIG. 4.

### Using the System

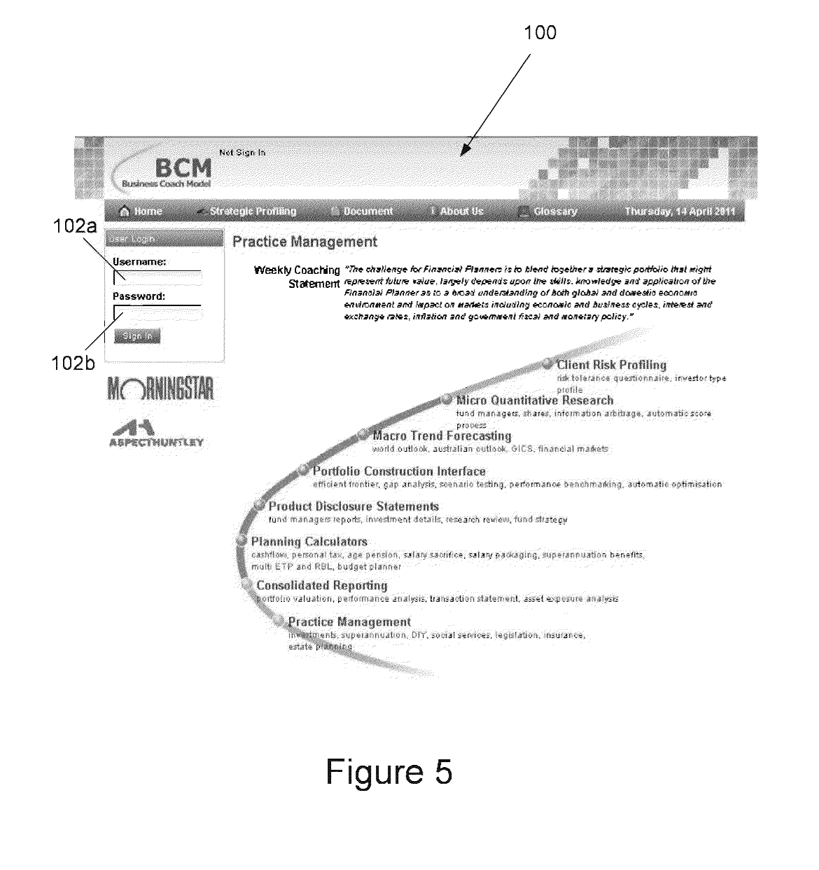

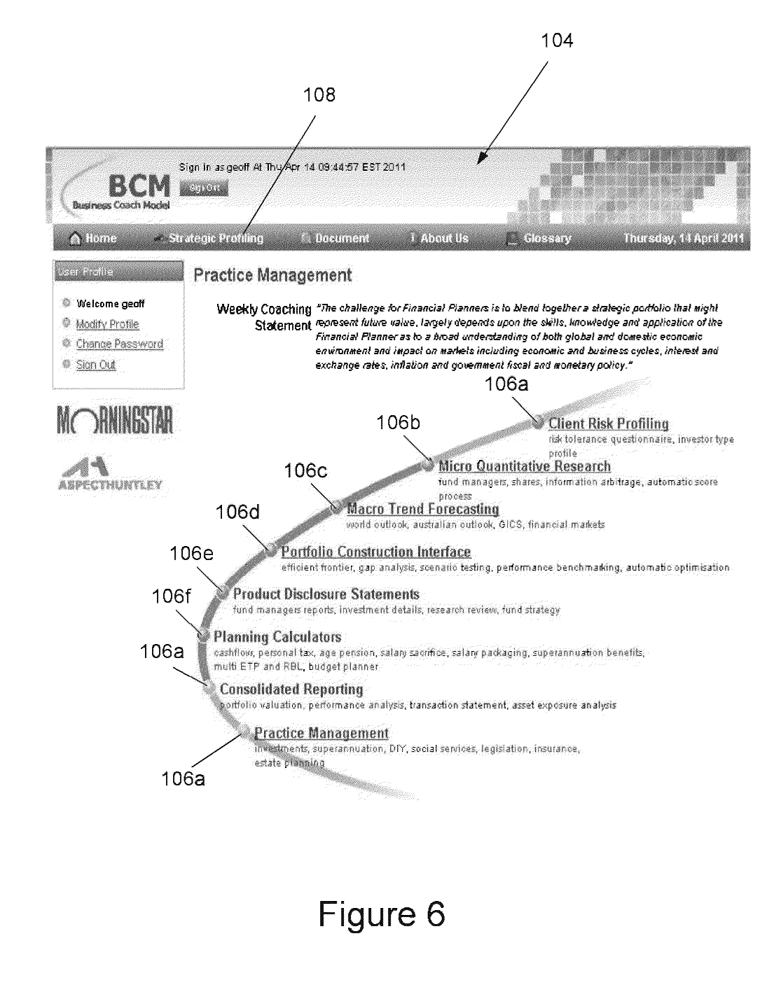

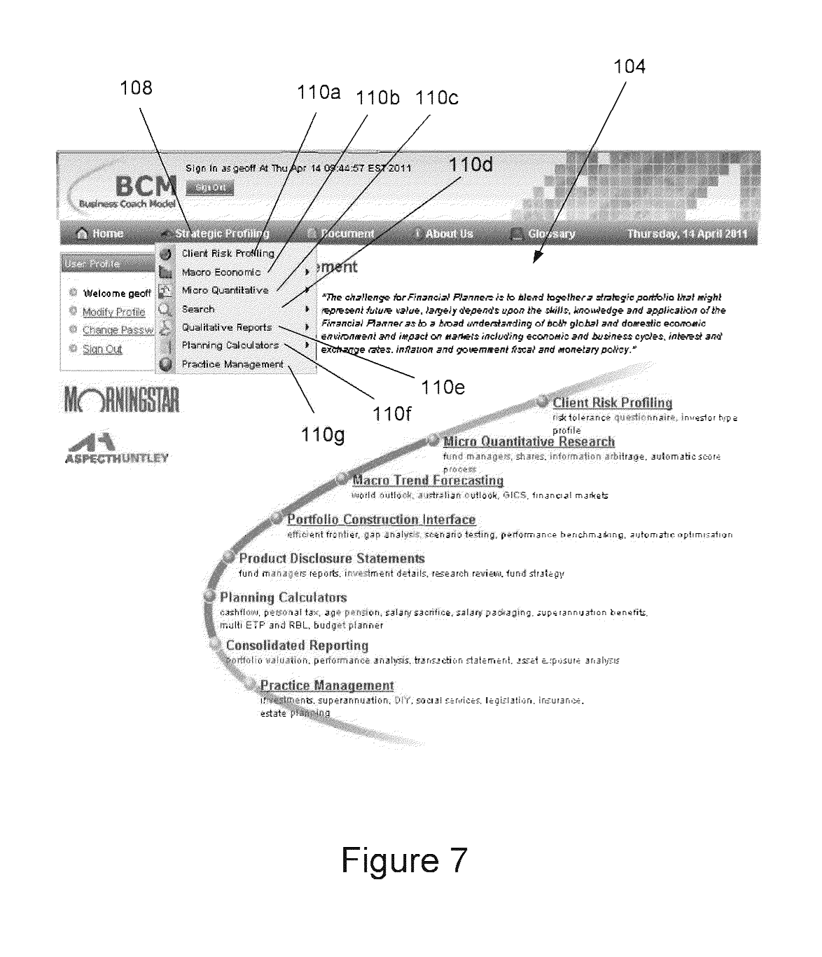

A member, such as a financial planner, can use his or her computer 18 to access the login page 100 shown in FIG. 5 generated by the system 12 over the Internet 20, for example. On receipt of a correct user name and password in the text boxes 102a, 102b, the system 12 generates a member profile graphical user interface (GUI) 104 shown in FIG. 7 for the member. The member profile 104 includes function buttons 106a to 106h that provide access to the following information:
1. Client Risk profiling 106a;
2. Micro Quantitative Research 106b;
3. Macro Trend Forecasting 106c;
4. Portfolio Construction Interface 106d;
5. Product Disclosure Statements 106e;
6. Planning Calculators 106f;
7. Consolidated Reporting 106g; and
8. Practice Management 106h.

When executed, the system 12 generates information relevant to the corresponding function button 106a to 106h selected by the member.

The member profile GUI 104 also includes a “Strategic Profiling” dropdown menu 108 which, as shown in FIG. 7, provides the following user function buttons:
1. Client Risk Profiling 110a;
2. Macro Economic 110b;
3. Micro Quantitative 110c;
4. Search 110d;
5. Qualitative Reports 110e;
6. Planning Calculators 110f; and
7. Practice management 110g.

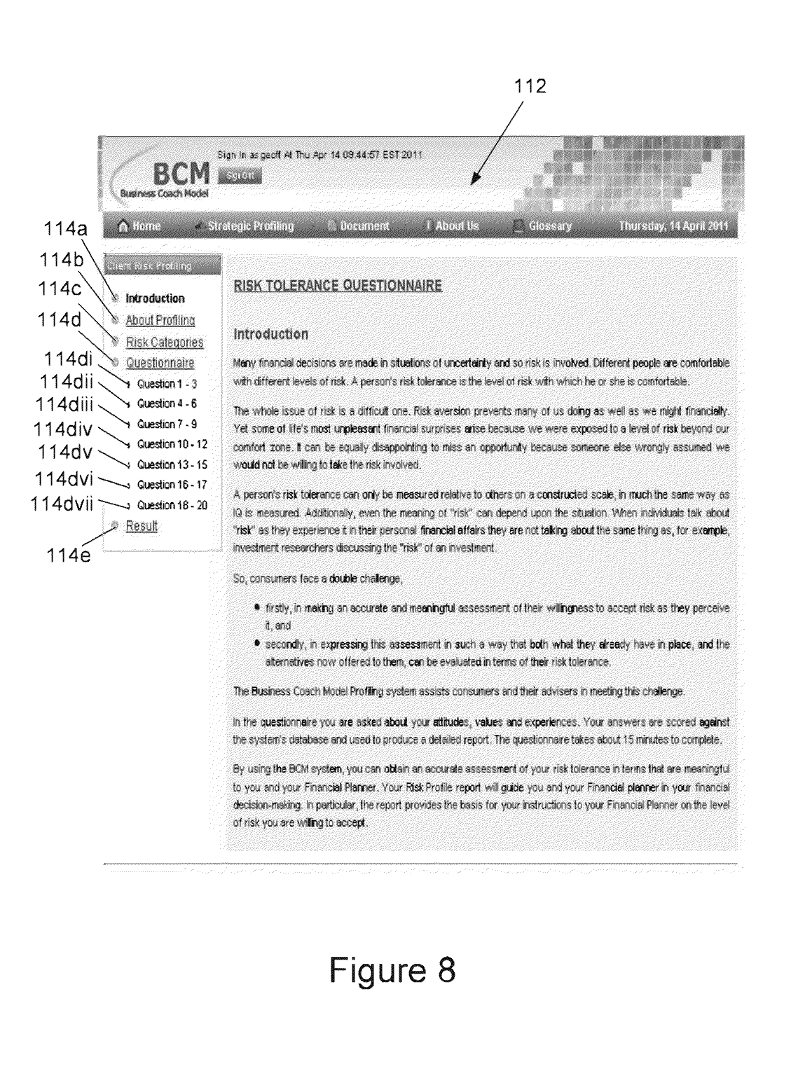

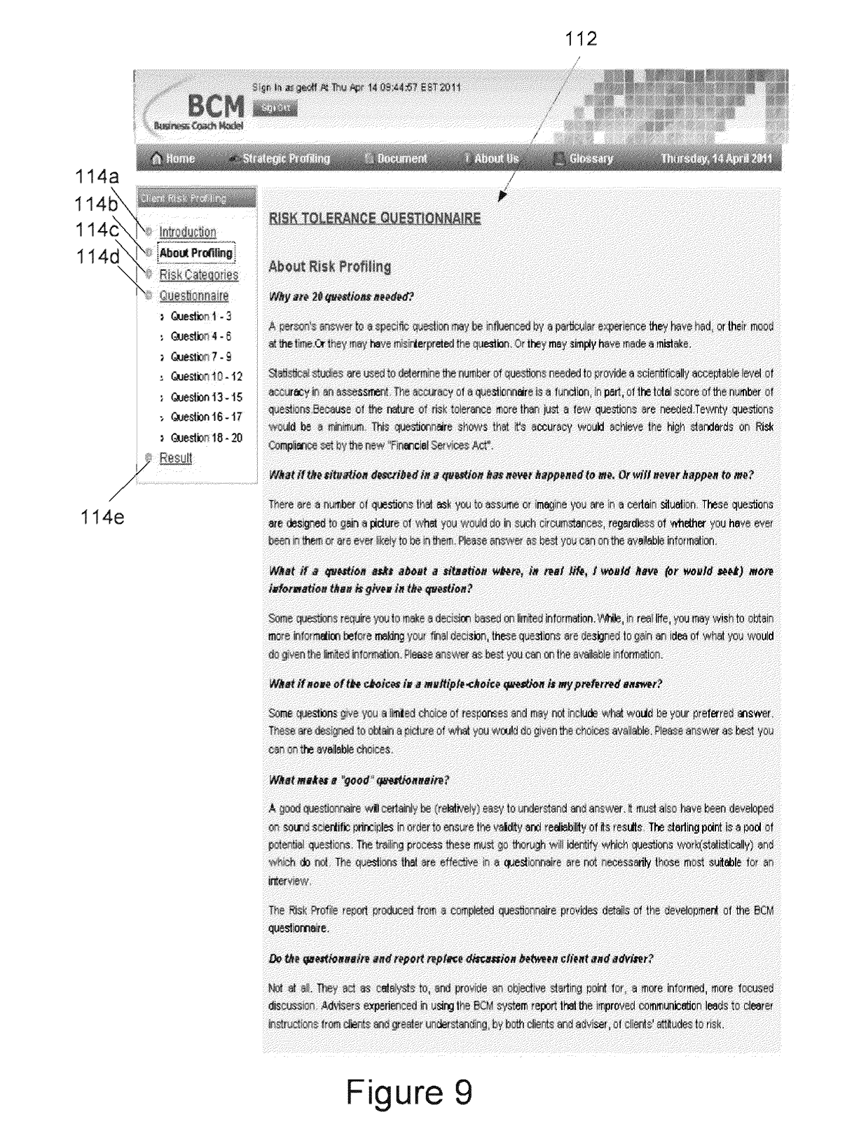

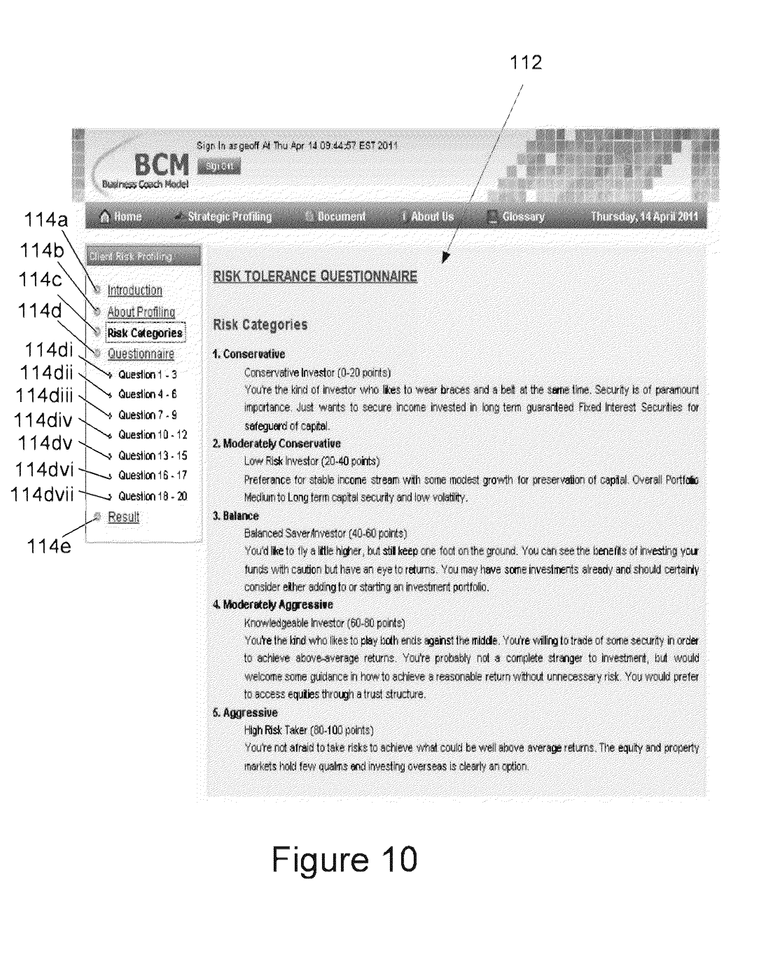

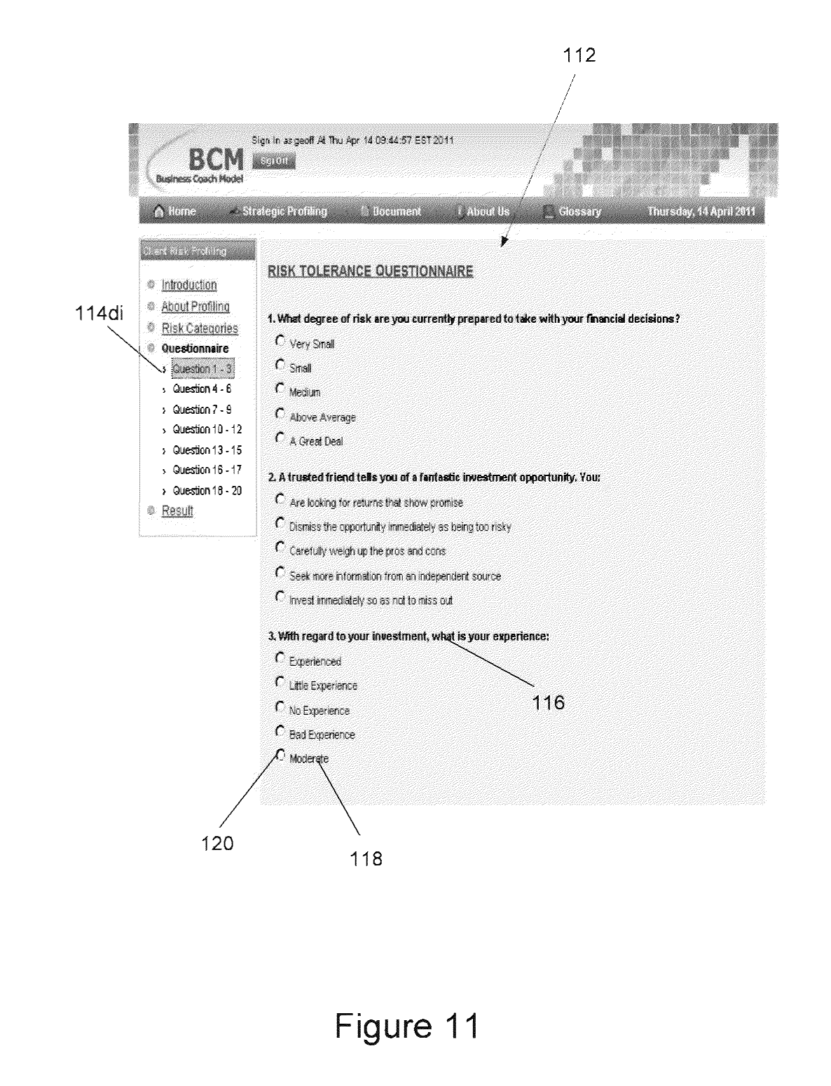

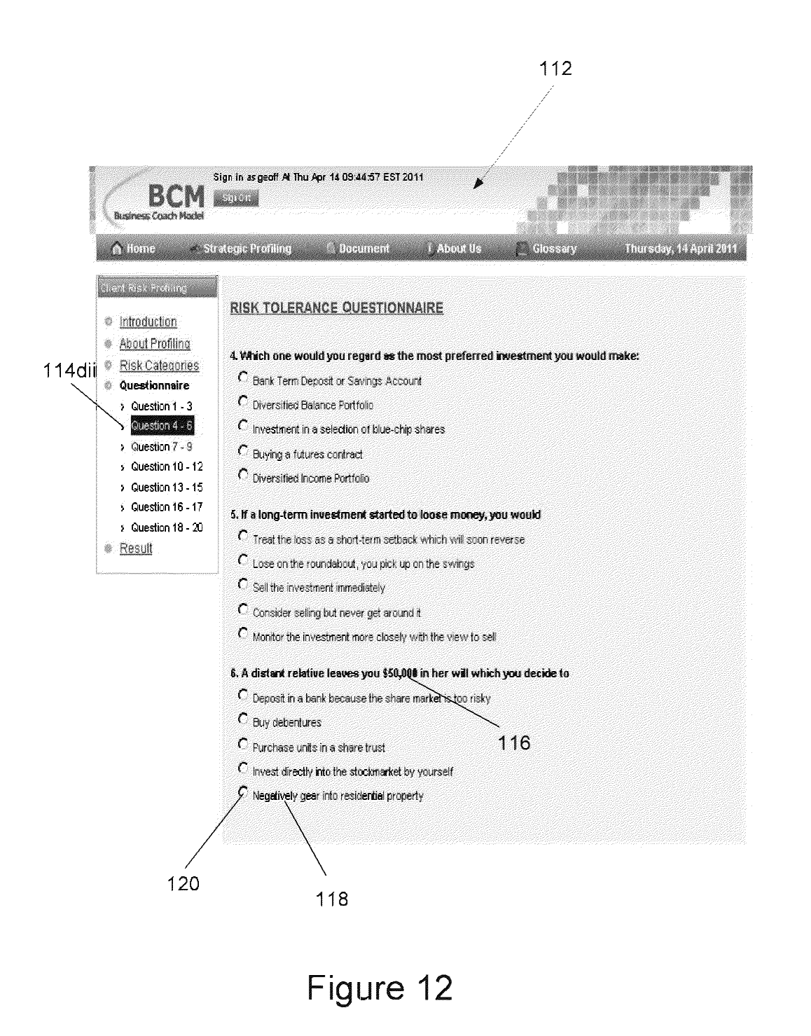

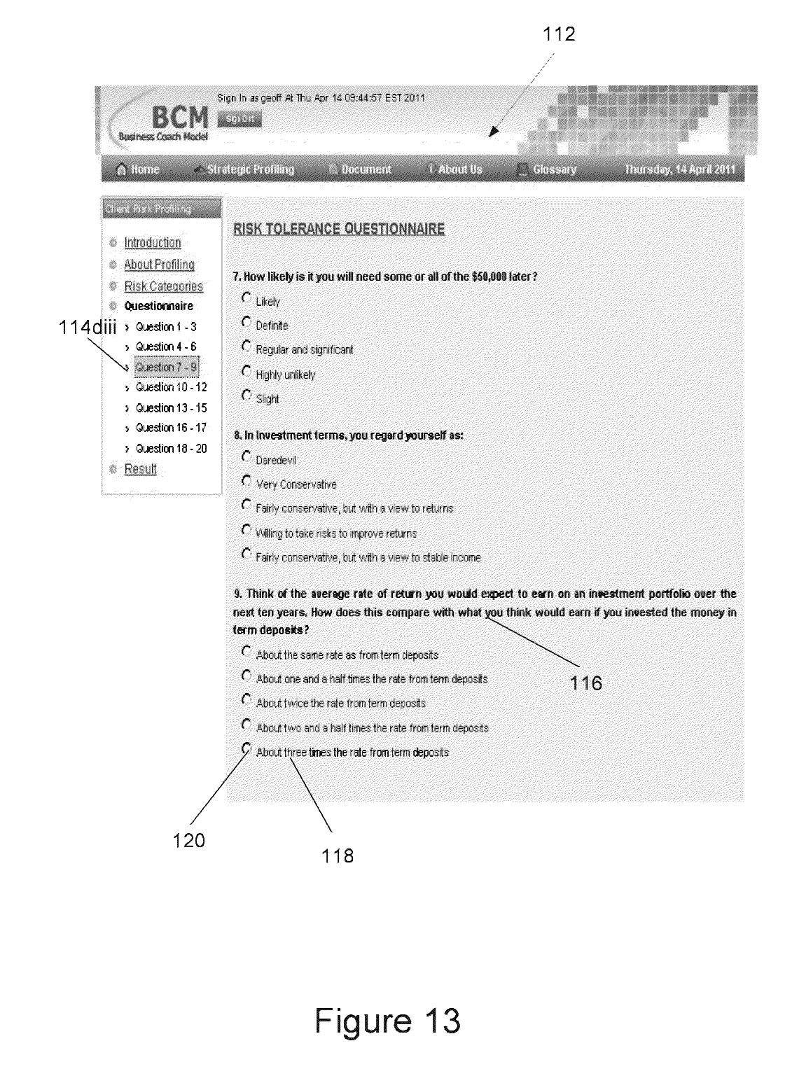

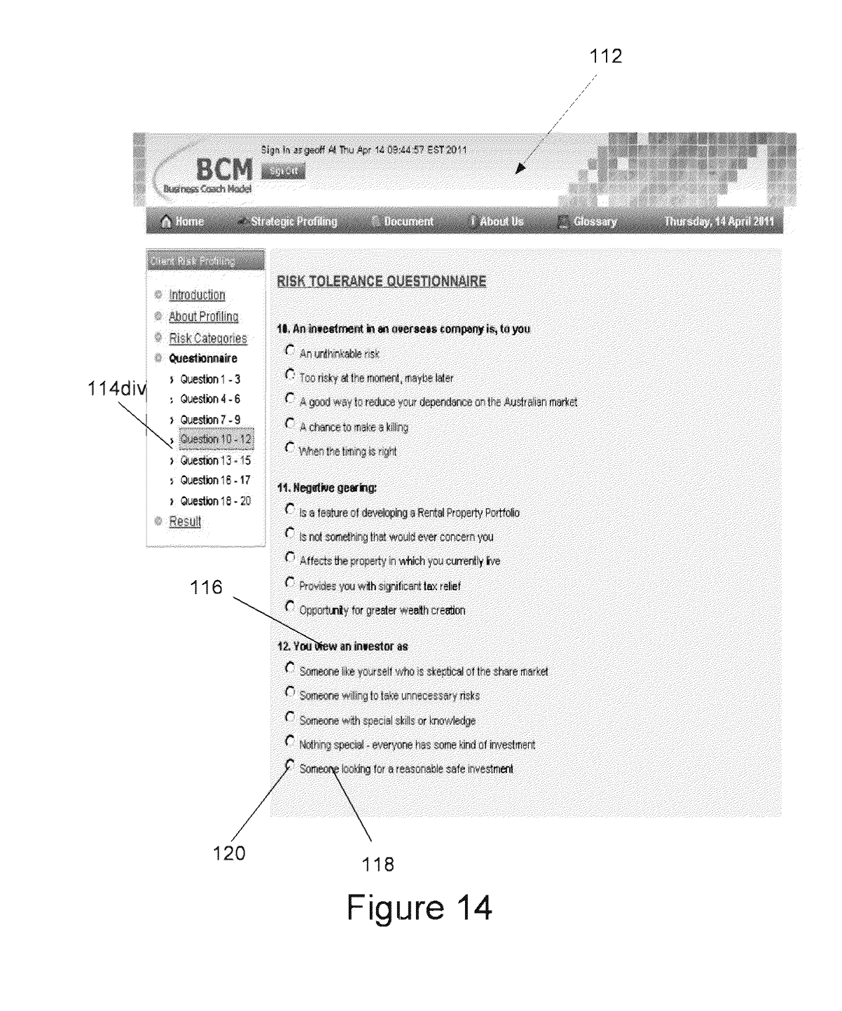

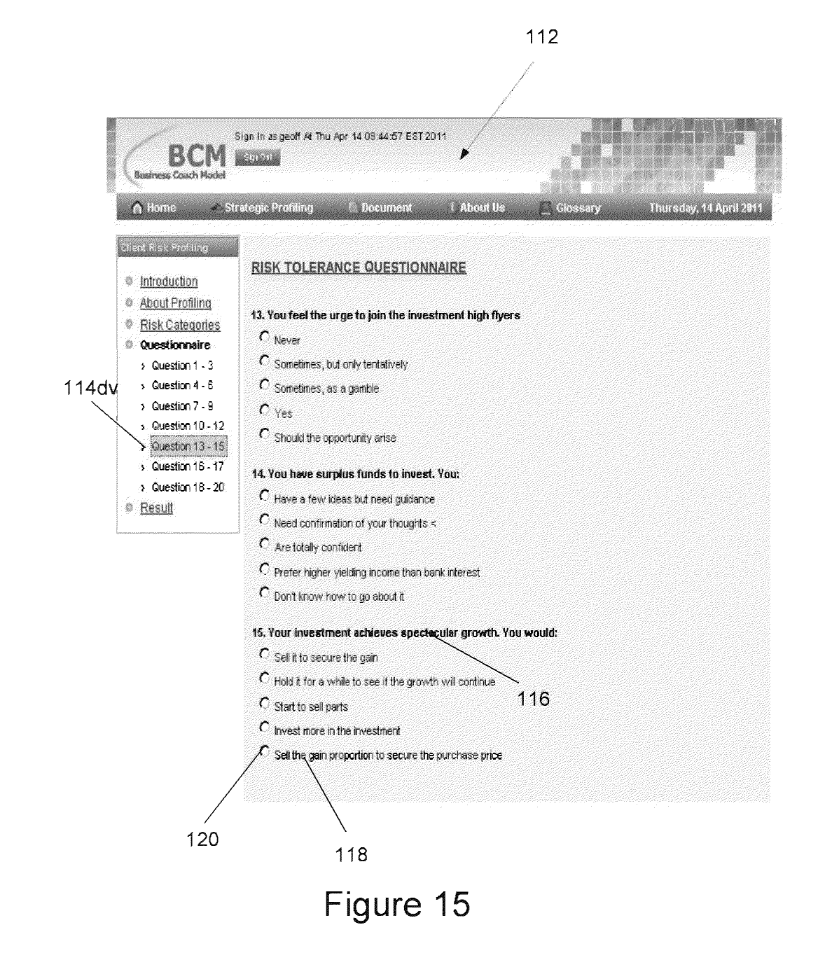

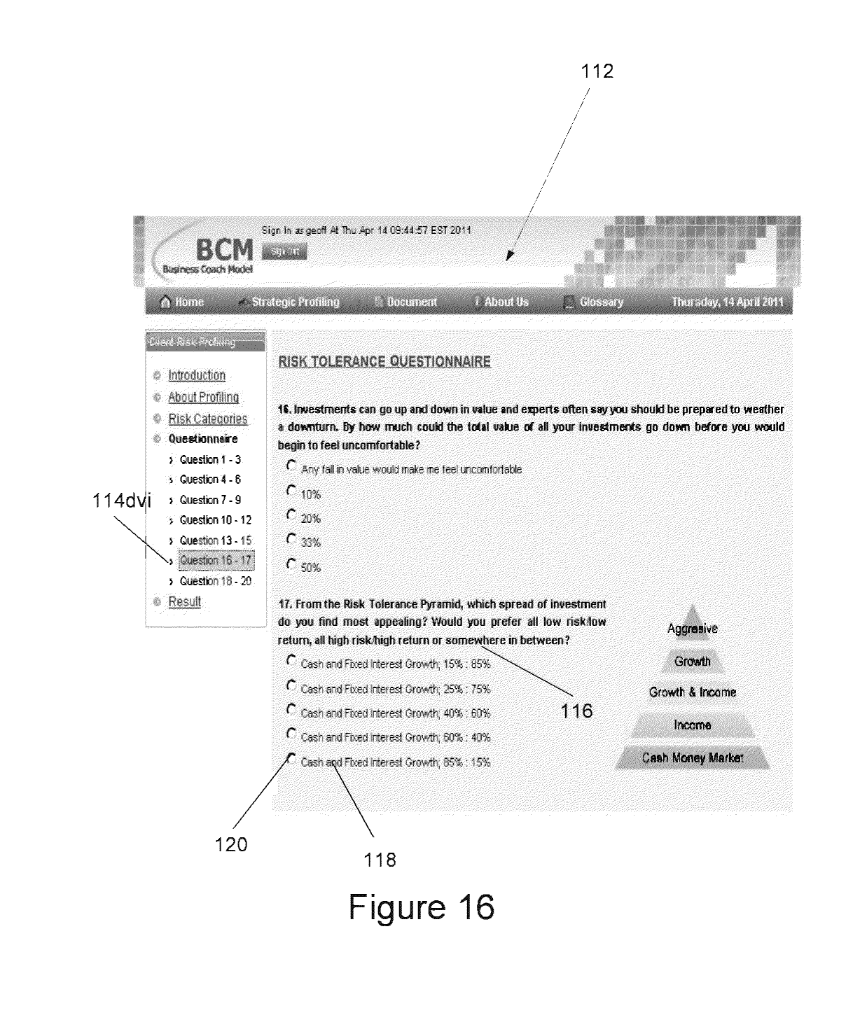

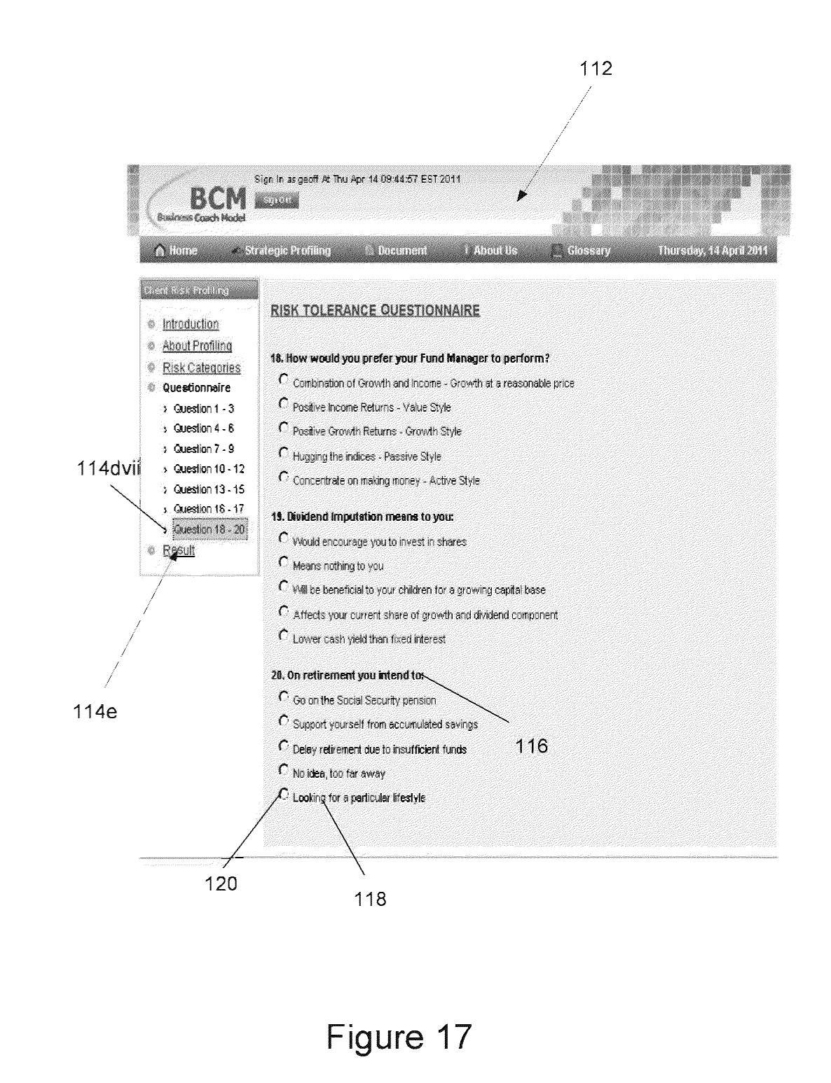

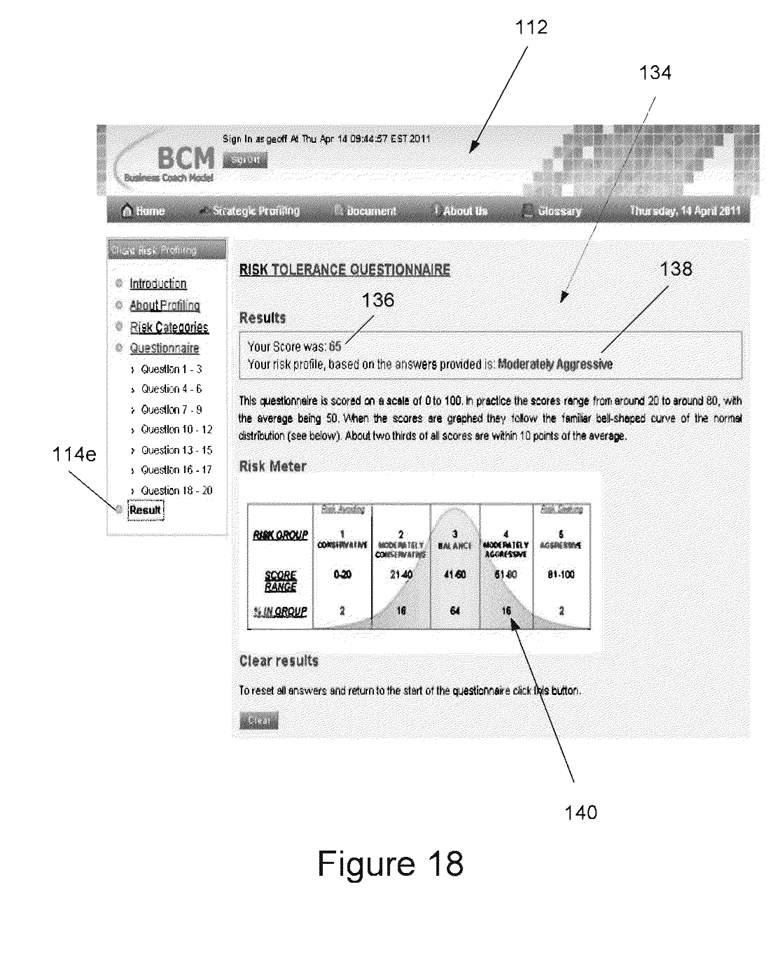

When the “Client Risk Profiling” function button 110a is selected by the user, the system 12 generates the Risk Profile GUI 112 shown in FIG. 8. The Risk Profile GUI 112 is used by the financial planner to determine the risk tolerance level of an investor and to assign a benchmark risk category to the investor. The Risk Profile GUI 112 includes the following function buttons:
a. “Introduction” 114a which, when executed, generates the display shown in FIG. 8 including introductory information about the Risk Tolerance Questionnaire;
b. “About Profiling” 114b which, when executed, generates the display shown in FIG. 9 including information about risk profiling;
c. “Risk Categories” 114c which, when executed, generates the display shown in FIG. 10 that includes information explaining the types of risk categories;
d. “Questionnaire” 114d which, when executed, displays a list of the following function buttons:
   i. “Questions 1 to 3” 114di which, when executed, generates the display shown in FIG. 11 which includes questions 116 one to 3;
   ii. “Questions 4 to 6” 114dii which, when executed, generates the display shown in FIG. 12 which includes questions 116 four to six;
   iii. “Questions 7 to 9” 114diii which, when executed, generates the display shown in FIG. 13 which includes questions 116 five to nine;
   iv. “Questions 10 to 12” 114div which, when executed, generates the display shown in FIG. 14 which includes questions 116 ten to twelve;
   v. “Questions 13 to 15” 114dv which, when executed, generates the display shown in FIG. 15 which includes questions 116 thirteen to fifteen;
   vi. “Questions 16 to 17” 114dvi which, when executed, generates the display shown in FIG. 16 which includes questions 116 sixteen to seventeen; and
   vii. “Questions 18 to 20” 114dvii which, when executed, generates the display shown in FIG. 17 which includes questions eighteen to twenty; and
d. “Results” 114e which, when executed, generates the display shown in FIG. 18.

Each of the questions 116 listed includes multiple choice answers 118 and associated selection boxes 120 that can be checked by the financial planner. The series of questions 116 are designed identify the risk tolerance level of the investor. The questions 116 are directed towards the investor's attitudes, values and experiences in investing. The “Introduction” and “About Risk Profiling” GUIs 114a, 114b include, amongst other things, a discussion on risk tolerance and information about the double challenge of:
a. making an accurate and meaningful assessment of their willingness to accept risk as they perceive it; and
b. expressing this assessment in such a way that what they already have in place, and the alternatives now offered to them, can be evaluated in terms of their risk tolerance.

These GUIs 114a, 114b also include information about risk profiling in general and a description of the five risk categories. Risk Profiles and Investor Profiles are used by Financial Planners in the process of selecting Asset Allocation where the Financial Planners triple challenge is:
a. To determine an asset allocation that will achieve the client's financial goals;
b. To determine whether the asset allocation is consistent with the client's risk tolerance; and
c. If there is no asset allocation, which meets these first two challenges, to have the process of resolving the mismatch.

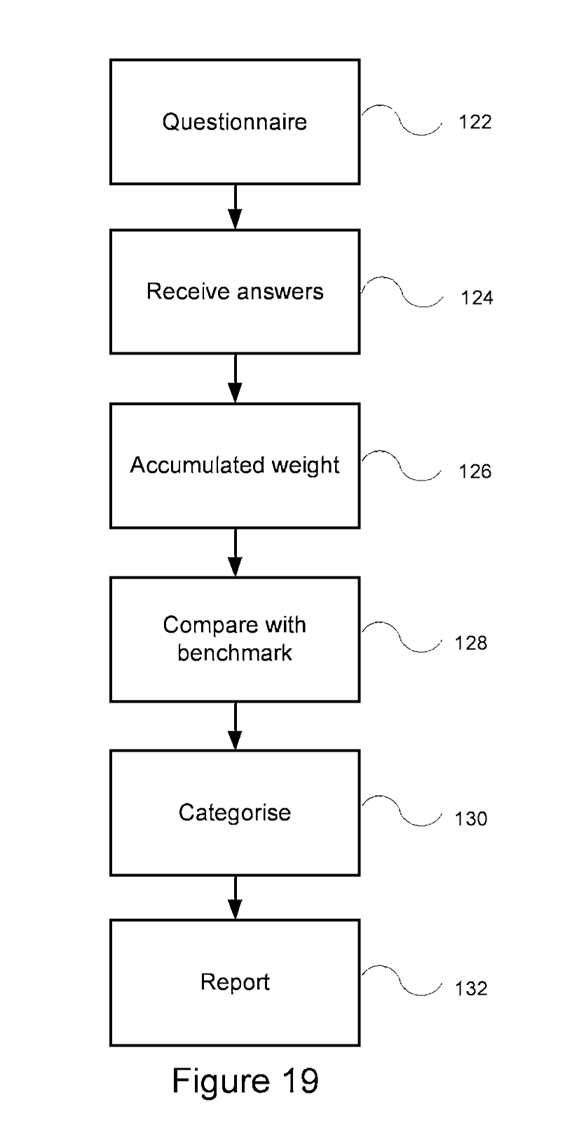

With reference to FIG. 19, the system 12 generates, at step 122, the Risk Profile GUI 112 when the “Client Risk Profiling” function button 110a is executed. The system 12 receives, at step 124, the answers 120 to each question 118. The answers 120 to each question are weighted and the system 12 determines, at step 126, the accumulated weight of the investor's answers. The risk profile GUI 112 compares, at step 128, the investor's accumulated weight to the accumulated weight ranges of predetermined benchmark risk categories. The risk portfolio GUI 112 categorises, at step 130, the investor as being a certain benchmark risk category if his or her accumulated weight falls within the range of that benchmark risk category. Set out below are exemplary benchmark risk categories, together with the associated ranges of scores to which they apply:
1. Conservative (0 to 20 points)
   Conservative investor. The kind of investor who likes to wear braces and a belt at the same time. Security is of paramount importance. Wants to secure income invested in long term guaranteed Fixed Interest Securities for safeguard of capital.
2. Moderately Conservative (20 to 40 points)
   Low risk investor. Performance for stable income stream with some modest growth for preservation of capital. Overall portfolio medium to long term capital security and low volatility.
3. Balance (40 to 60 points)
   Flies a little higher, but still keeps one foot on the ground. Can see the benefits of investing funds with caution but has an eye to good returns. May already have investments and is considering either starting, or adding to, an investment portfolio.
4. Moderately Aggressive (60 to 80)
   Play both ends against the middle. Willing to trade off some security in order to achieve above average returns. Not a complete stranger to investing. However, would welcome some guidance as to how to achieve a reasonable return without unnecessary risk. May prefer, for example, to access equities through a trust structure.
5. Aggressive (80 to 100)
   Not afraid to take risks to achieve what could be well above average returns. The equity and property markets hold few qualms and investing overseas is clearly an option.

On completion of the last question 116, the investor can execute the “Results” function button 114e to generate, at step 132, the Results GUI 134 shown in FIG. 18. The Results GUI 134 displays:
a. the client's score 136;
b. the clients associated risk profile 138; and
b. a risk meter 140 showing a Bell curve of the distribution of risk tolerances of investors' over the different risk groups.

### Systems and Processes for Selecting Investments for Inclusion in an Investment Portfolio

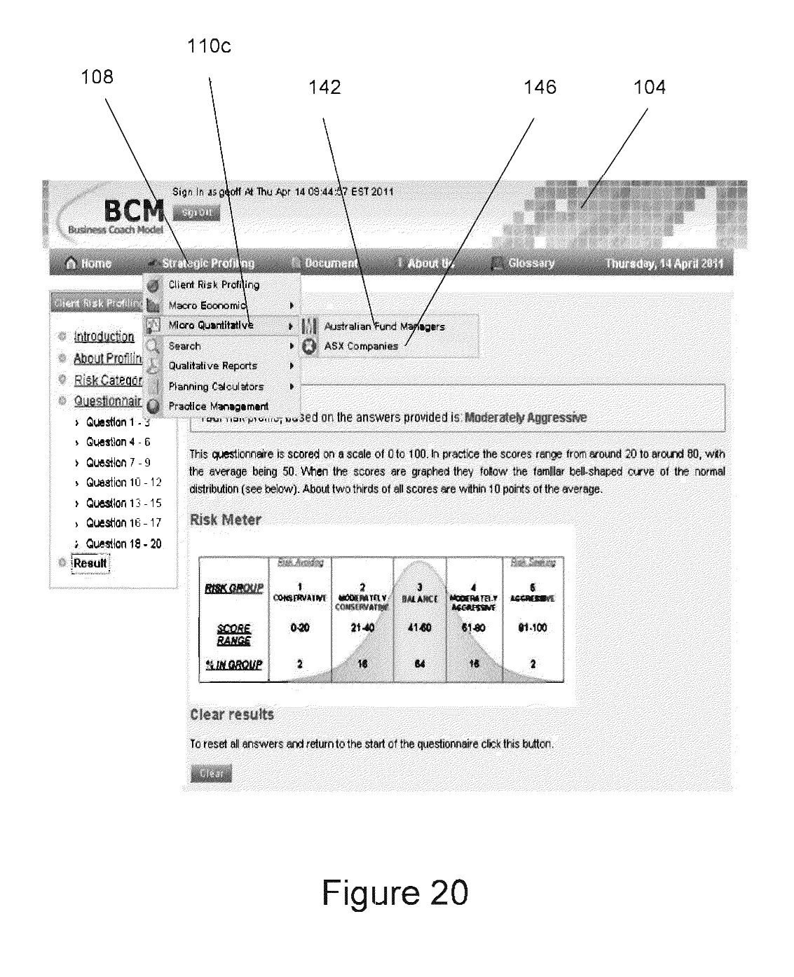

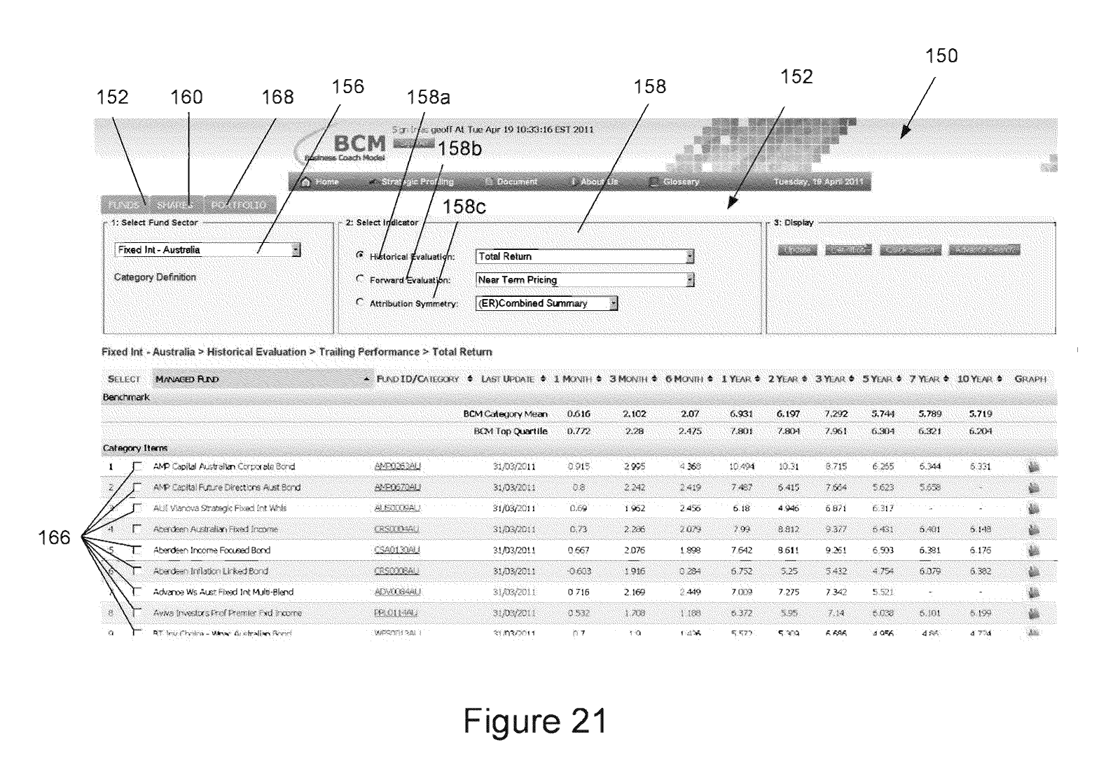

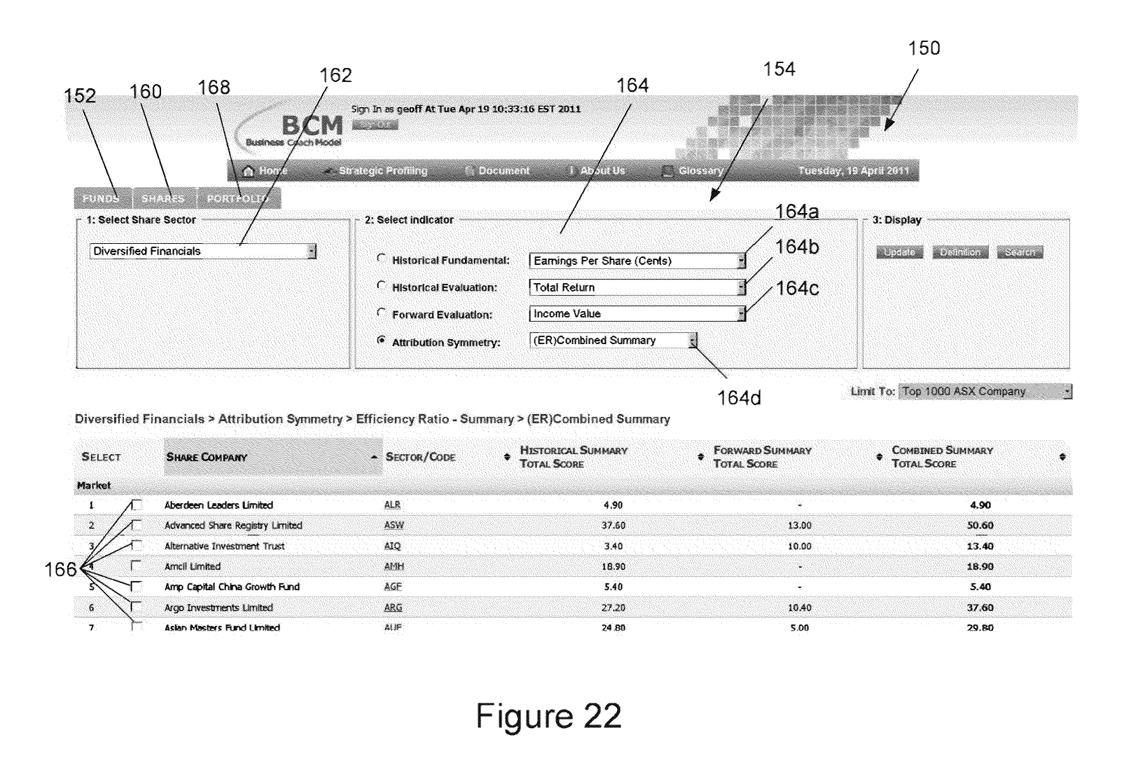

The financial planner can construct a new investment portfolio, or review an existing investment portfolio, by selecting the “Micro Quantitative” menu item 110c from the “Strategic Profiling” drop down menu 108 of the member profile GUI 104 and then either selecting the “Australian Fun Managers” menu item 142 or the “ASX Companies” 146 menu item, as shown in FIG. 20. If the “Australian Fund Managers” menu item 142 is selected, the system 12 generates the Portfolio Construction GUI 150 with the “FUNDS” tab page 152 displayed, as shown in FIG. 21. Alternatively, if the financial planner selects the “ASX Companies” menu item 146, then the system 12 generates the Portfolio Construction GUI 150 with the “SHARES” tab page 154 displayed, as shown in FIG. 22.

The Portfolio Construction GUI 150 is used by the financial planner to compare and review different investments, such as managed funds and direct share, by displaying the investments in selected sectors with selected indicators. For example, if the financial planner selects the “FUNDS” tab 155 in the Portfolio Construction GUI 150, the system 12 generates the Funds tab page 152 shown in FIG. 21 which includes a “Select Fund Sector” drop down menu 156 including the following sectors:
1. Cash:
   a. Cash; and
   b. Enhanced cash;
2. Fixed interest:
   a. Australia;
   b. Global;
   c. Mortgages (Aust.);
   d. Mortgages aggressive;
   e. Diversified;
   f. Hybrid; and
   g. High yield credit;
3. Property:
   a. Australian real estate;
   b. Global real estate; and
   c. Unlisted and direct property;
4. Australian Equities:
   a. Large blend;
   b. Large growth;
   c. Large value;
   d. Large geared;
   e. Mid/small blend;
   f. Mid/small growth;
   g. Mid/small value;
   h. Miscellaneous; and
   i. Other;
5. Global equities:
   a. Large blend;
   b. Large growth;
   c. Large value;
   d. Mid/small;
   e. World/Australia;
   f. Emerging markets;
   g. Asia Pacific w/o Japan;
   h. Europe;
   i. Japan;
   j. North America;
   k. Infrastructure;
   l. Technology; and
   m. Others;
6. Hedge Funds:
   a. Australia; and
   b. Global; and
7. Multi-sector funds:
   a. Conservative;
   b. Moderate conservative;
   c. Balanced;
   d. Moderate aggressive; and
   e. Aggressive.

The Funds tab page 152 shown in FIG. 21 also includes a “Select Indicator” section 158 including the following drop down menus:
1. Historical evaluation 158a:
   a. Trailing performance;
   b. Year end performance;
   c. Risk measures;
   d. Relative risk measures;
   e. Efficiency ratio trailing performance;
   f. Efficiency ratio year end performance;
   g. Efficiency ratio risk measures; and
   h. Efficiency ratio relative risk measures;
2. Forward evaluation 158b:
   a. Buy/Sell;
   b. Portfolio breakdown; and
   c. Efficiency ration Buy/Sell; and
3. Attribution symmetry 158c:
   a. Efficiency ratio strike rate;
   b. Top quartile strike rate;
   c. Ranking summary;
   d. Market price watch; and
   e. Reporting & PDS.

As such, the financial planner can use the system 12 to display managed funds by selected sector and to compare managed funds within the selected sector using data associated with the selected indicator.

Alternatively, the financial planner can use the Portfolio Construction GUI 150 to review and compare shares by selecting the “SHARES” tab 160. When selected, the system 12 generates the Share tab page 154 shown in FIG. 22 which includes a “Select Share Sector” drop down menu 162 including the following sectors:
1. Consumer discretionary:
   a. Automobiles & components;
   b. Consumer durables & apparel;
   c. Consumer services;
   d. Media; and
   e. Retailing;
2. Consumer staples;
   a. Food & staples retailing; and
   b. Food, beverage & tobacco;
3. Energy:
   a. Energy;
4. Financials:
   a. Bank;
   b. Diversified financials;
   c. Insurance;
   d. Real estate—investment trusts; and
   e. Real estate—management & development;
5. Health services:
   a. Health care equipment & services; and
   b. Pharmaceuticals & biotechnology;
6. Industrials:
   a. Capital goods;
   b. Commercial goods & services; and
   c. Transportation;
7. Information technology;
   a. Software & services
   b. Technology hardware & equipment; and
   c. Semiconductors & equipment;
8. Materials:
   a. Chemicals;
   b. Construction materials;
   c. Containers & packaging;
   d. Metals & mining; and
   e. Paper & forest products;
9. Telecommunications:
   a. Telecommunications services;
10. Utilities:
   a. Utilities; and
11. Sector relative strength trends:
   a. Market/Sector/Relative strength/trends.

The Share tab page 154 shown in FIG. 22 also includes a “Select Indicator” section 164 including the following drop down menus:
1. Historical Fundamental 164a:
   a. Earnings sustainability;
   b. Dividend sustainability;
   c. Financial strength; and
   d. Cash flow;
2. Historical evaluation 164b:
   a. Trailing performance;
   b. Risk measures;
   c. Relative risk measures;
   d. Efficiency ratio trailing performance;
   e. Efficiency ratio risk measures;
   f. Efficiency ratio relative risk measures;
3. Forward evaluation 164c:
   a. Fundamentals;
   b. Efficiency ratio fundamentals; and
   c. Mispricing fundamentals; and
4. Attribution symmetry 164d:
   a. Efficiency ratio summary;
   b. Top quartile strike rate;
   c. Mispricing fundamentals;
   d. Ranking summary; and
   e. Market price watch.

As such, the financial planner can use the system 12 to display direct shares by selected sector and to compare direct shares within the selected sector using data associated with the selected indicator.

The system 12 provides the financial planner with the tools to mine the myriad of information which financial planners use to compare investments (hereafter “Universal Comparison Information”) in a systematical way.

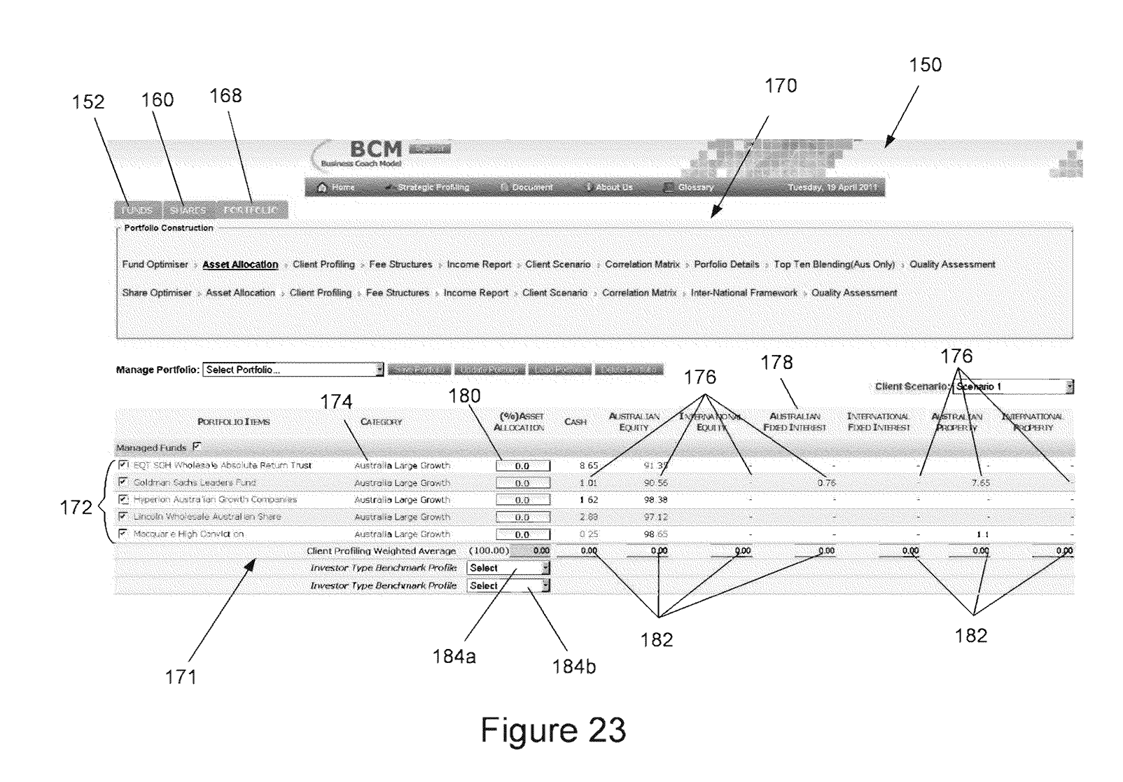

Once the financial planner has properly reviewed the investments, he or she can select the most desirable investments for inclusion in the investment portfolio by checking the selection boxes 166 next to the corresponding desired investments. The financial planner can then review the investments selected for the portfolio by selecting the “PORTFOLIO” tab 168. In response to selecting the “PORTFOLIO” tab 168, the system 12 generates the Portfolio tab page 170 shown in FIG. 23.

### Portfolio Construction

When the “PORTFOLIO” tab 168 is selected by the financial planner, the system 12 generates the Portfolio tab page 170 shown in FIG. 23. The Portfolio tab page 170 includes a table 171 including:
1. a column including the investments 172 selected by the financial planner;
2. a column including the sector 174 of each selected investment 172;
3. a row for each investment showing its distribution 176 of assets as a percentage over each one of the following asset classes 178:
   a. Cash;
   b. Australian equity;
   c. International equity;
   d. Australian fixed interest;
   e. International fixed interest;
   f. Australian property; and
   g. International property;
4. a column including asset allocation data entry boxes 180 for each investment of the investment portfolio so that the financial planner can allocate a percentage of the investor's assets to each investment of the investment portfolio; and
5. a row showing the sum 182 of the assets in each asset class of the entire investment portfolio, the assets in each class being weighted in accordance with the percentage of the investor's assets allocated to each investment of the investment portfolio; and
6. drop down “Investor Type Benchmark Profile” boxes 184a, 184b for selecting a benchmark risk category applicable for the investor.

Alternatively, the table 171 can be reconfigured so that the position of the rows and columns are swapped.

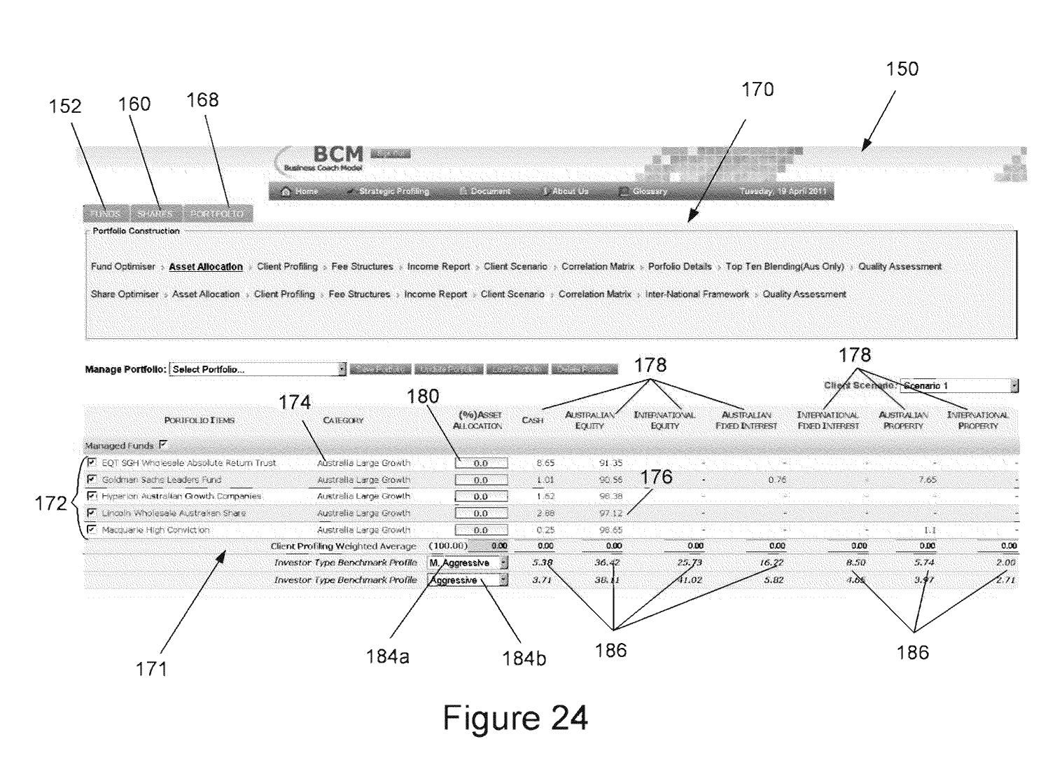

The financial planner can select the benchmark risk category of the investor determined using the Risk Profiling GUI 112 by choosing a corresponding category from the drop down menu 184a. For example, the financial planner might select “M. Aggressive”. In doing so, the system 12 generates and displays a row in the table 171 that shows the asset mix 186 of the selected benchmark risk category across the asset classes 178 in the manner shown in FIG. 24. The financial planner can thereby use system 12 to compare how closely the asset mix 182 of the investments 172 of the entire portfolio corresponds with the asset mix 186 of the benchmark risk category selected. That selected benchmark risk category representing the risk tolerance level of the investor.

In some cases, the risk tolerance level of the investor may not precisely match one of the benchmark risk categories. For example, the investor may be somewhere in between moderate aggressive and aggressive. In this situation, the financial planner can choose the next ascending category, for example, from the dropdown menu 184b. In doing so, the system 12 displays a set of train tracks within which the asset mix of the investor's portfolio should fall so that the portfolio matches the risk tolerance level of the investor.

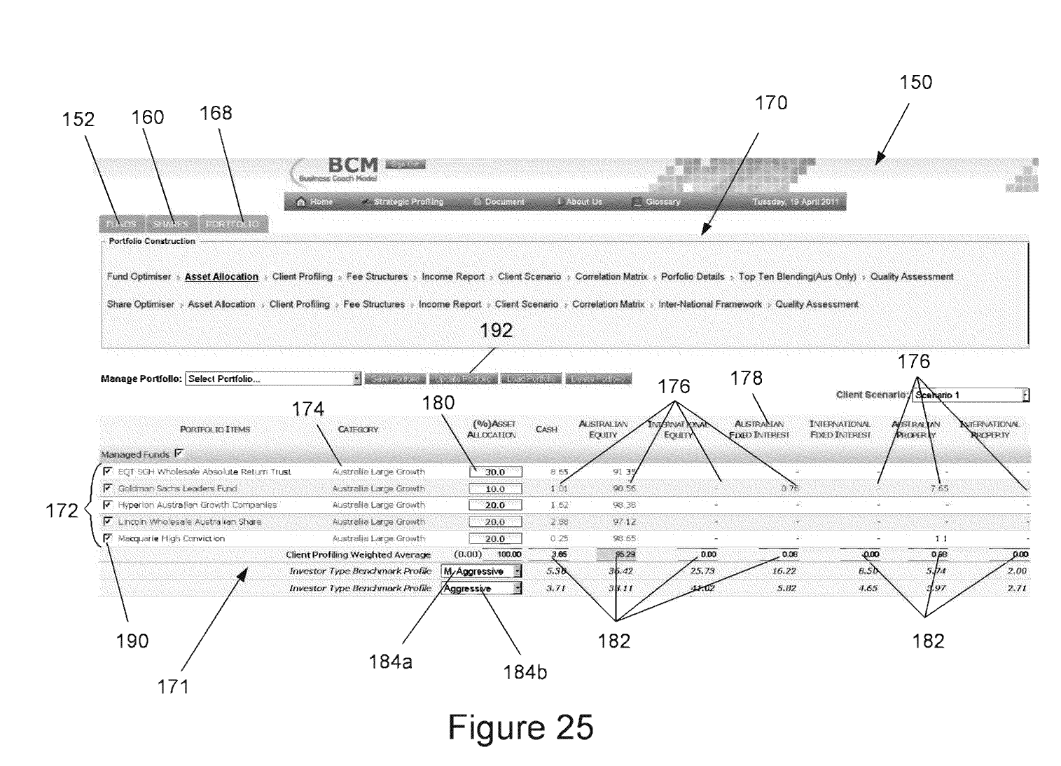

The financial planner can use the system 12 to asset allocate by entering numbers into the data boxes 180 for each investment 172 in the manner shown in FIG. 25. Each number represents a percentage of the investor's assets allocated to a corresponding investment. The sum 182 of the assets in each asset class of the investment portfolio weighted in accordance with the investor's assets allocated to the investments of the investment portfolio is displayed by the Portfolio tab page 170. The financial planner can thereby compare the weighted asset mix 182 of the entire portfolio with the asset mix of the selected bench mark risk category that represents the risk tolerance level of the investor. The financial planner can also change the percentage of the investor's assets allocated to each investment so that the asset mix 182 more closely, or less closely as the case may be, corresponds to the asset mix 186 of the selected benchmark risk category of the investor. To this end, the asset allocation process can represent over 90% as to the accuracy of portfolio volatility return and a 70% response chance regarding the value add return. The purity of improved predictability expectations to leads towards:
1. comfortably forecasted usage;
2. a highly concentrated approach; and
3. a better absolute Alpha.

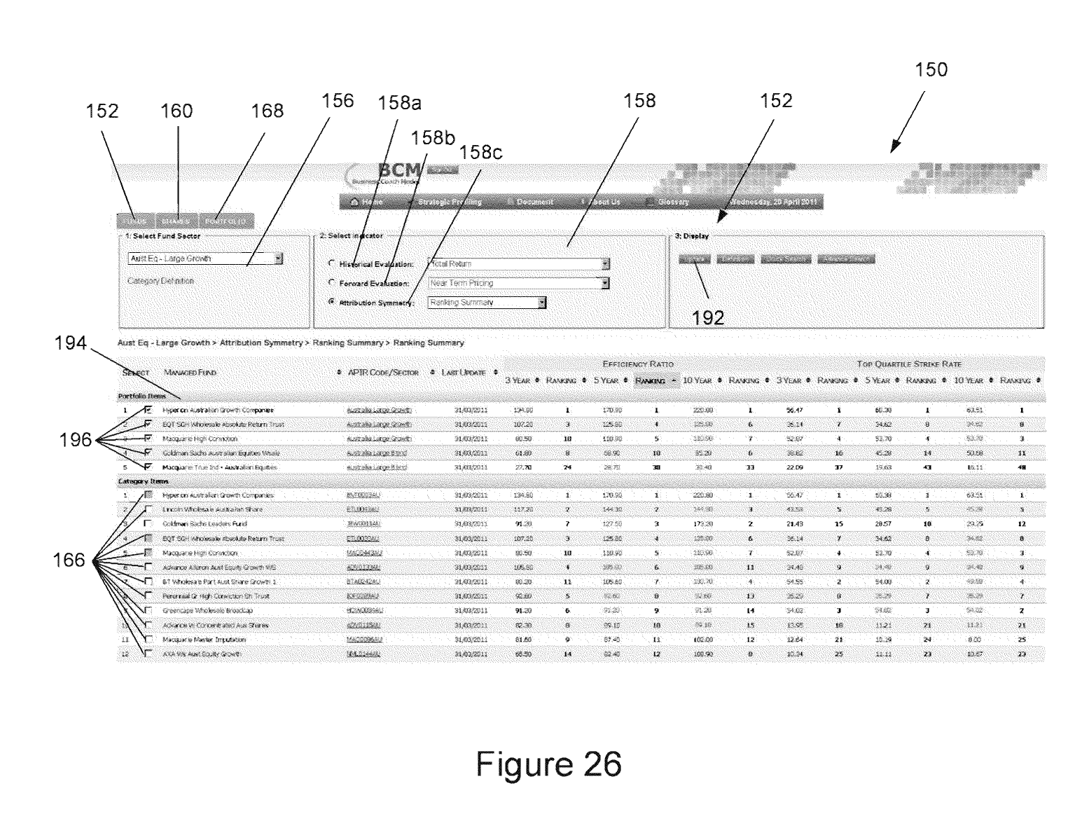

On review of the selected investments 172 in the table 171, the financial planner may decide to amend the investment selection by adding or removing an investment 172. To remove an investment from the portfolio, the financial planner need only uncheck the selection box 190 that corresponds to undesired investment and to execute the “Update Portfolio” function button 192. The system will then generate a new table 171 without the undesired investment shown. To add an investment to the existing portfolio, the financial planner need only select either the “FUNDS” tabs 152 or the “SHARES” tab 160. On receipt of selection of the “FUNDS” tab 152, for example, the system 12 generates the Funds tab page 152 shown in FIG. 26. The Funds tab page 152 includes the selected portfolio investments 194 shown with data about the selected indicator 158. The Funds tab page 152 also includes the managed funds for the selected sector and data for the selected indicator 158. The financial planner can remove an investment 172 from the portfolio by unchecking the selection box 196 that corresponds to the undesired investment and to execute the “Update Portfolio” function button 192. Alternatively, the financial planner can add an investment to the investment portfolio by checking the selection box 166 that corresponds to the desired investment and to execute the “Update Portfolio” function button 192.

Creating a Portfolio with Absolute Concentrated Risk Adjusted Return Relative to Benchmark Specifically Targeted Correlated Efficient Frontier (ACRARRBSCTEF)

The following description is made with reference to users/members of the system 12 being financial planners. However, users/members of the system 12 could alternatively be fund managers, stock brokers, or any other person involved in buying and selling of investments. Further, the terms “Fund Manager” and “Fund Managers” are used through out the specification. These terms are intended to respectively refer to a managed fund or managed funds.

A financial planner can use the system 12 to multitask the following strategies to continuously select the pedigree investments that systematically asset allocate in accordance with the client's risk profile:
1. Fund Managers;
2. Direct Share Opportunities;
3. Market;
4. Sector;
5. Relative Strength;
6. Trends; and
7. Selection process analysis. (FM/DSO/M/S/RS/T/SPA)

The system 12 improves upon the utilisation of the Modern Portfolio Theory Risk Management (MPTRM) invented by Markwitz by looking at FM/DSO/M/S/RS/T/SPA in terms of mean and variance fundamentals and other characteristics such as:
1. Attribution Symmetry (Absolute Risk Adjusted Return Relative Benchmark); and
2. Symmetry of Distribution (The Optimality Gap Analysis Alignment between the Client's Risk Tolerance and the Selection of Investments).

The system 12 has the following major drivers of a FM/DSO/M/S/RS/T/SPA to find the right mix of investments for an investment portfolio:
1. Selection;
2. Asset Allocation over the Asset Class (or sector); and
3. Risk Management in accordance with the Client Risk Profile,

The asset allocation phenomenon represented over 90% as to the accuracy response of a portfolio volatility return and a 70% response chance regarding the value add return. Hence the importance of asset mix cannot be overlooked. The system 12 gives the purity of improved predictability expectations to all points towards comfortable forecasted usage a high concentrated approach for a better absolute Alpha.

At the end of the day, the above mentioned tools can be used to provide insight and understanding of the dynamics of the problem of comparing and selecting investments for inclusion in an investment portfolio. However, the perennial problem faced by financial planners lies with the difficulty of accessing and understanding this myriad of information that comes in the form of statistics and data for indicators used by professionals to gauge the markets (hereafter referred to as Universal Comparison Information). Such indicators include business sentiments, investment and employment levels and major commodity prices associated with the problem of knowing when to buy, sell or hold.

To address this problem, the system 12 uses Core Spectrum Factor Metrics mine the Universal Comparison Data so that the financial planner can avoid making decisions based on human judgment which is prone to error and bias. The Core Spectrum Factor Metrics consists of:
1. Core Spectrum Symmetry of Distribution Factor Metrics (Hardware); and
2. Capital Asset Pricing Models Factor Metrics (Software).

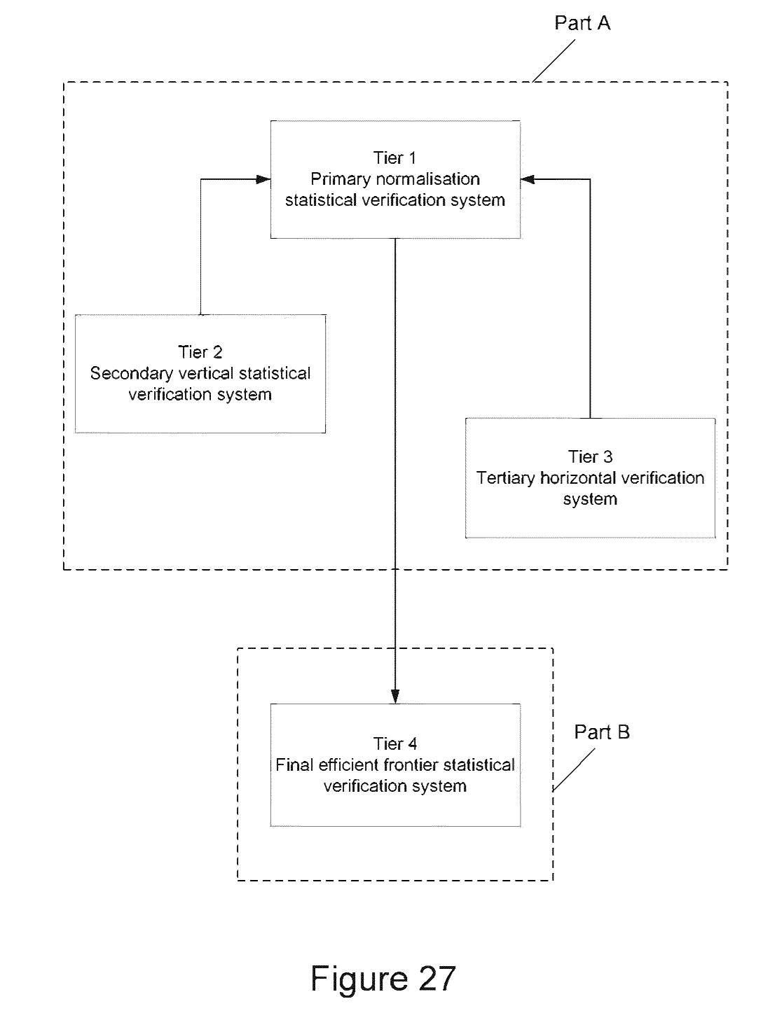

The system 12 gathers and evaluates Historical Evaluation, Forward Evaluation, and Attribution Symmetry data. The system 12 also explores how these key Statistical Verification Systems are used in analyzing the universal comparison information to identify skill driven traditional Managed Funds and Direct Share Opportunities. As particularly shown in FIG. 27, the system 12 uses a process consisting of the following Core Spectrum Capital Asset Pricing Model Factor Metrics:
a. Tier 1 (Primary);
b. Tier 2 (Secondary);
c. Tier 3 (Tertiary); and
d. Tier 4 (Final).

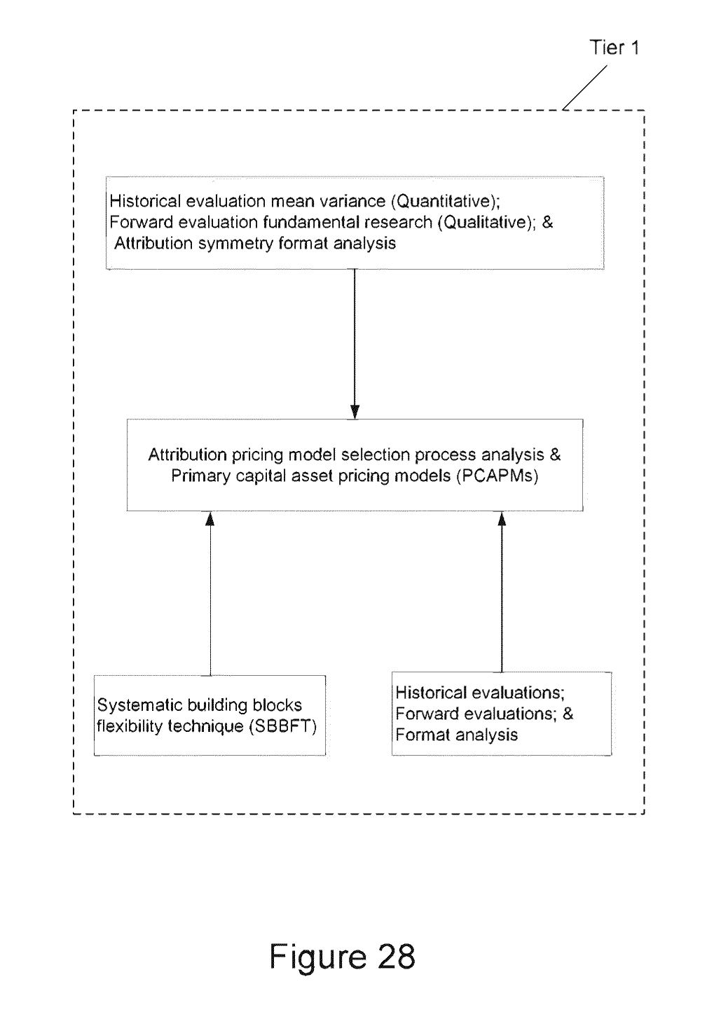

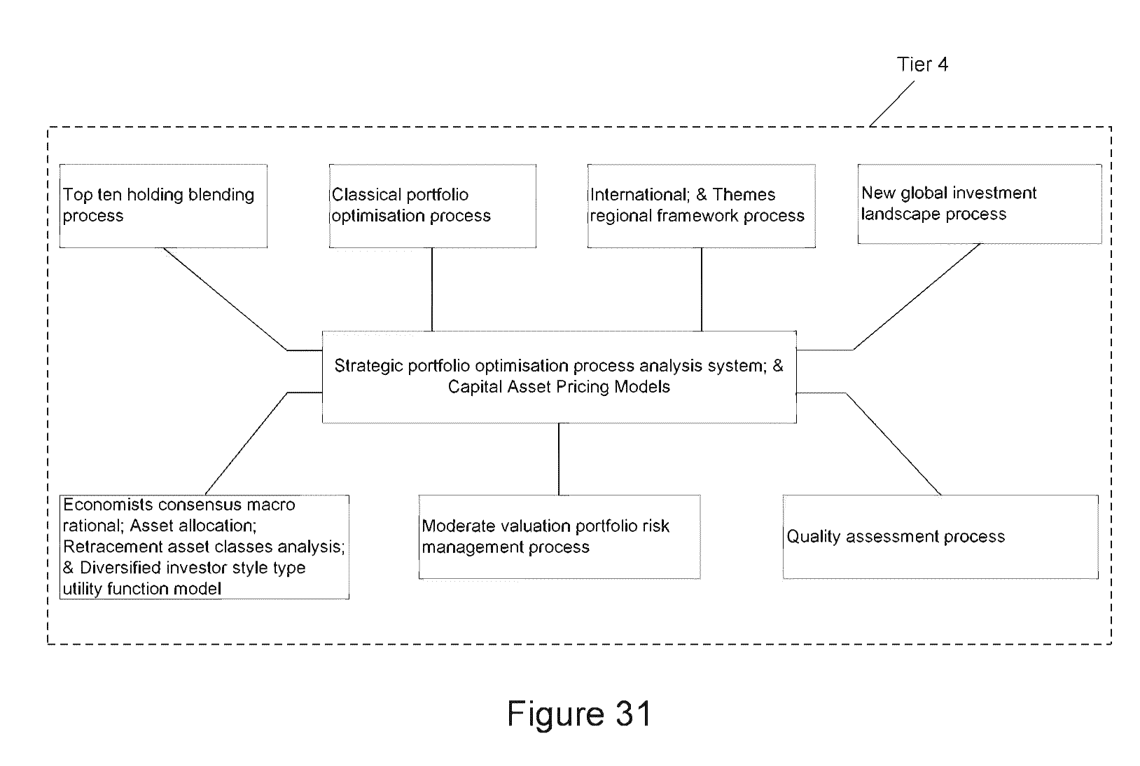

As shown in FIGS. 28 to 30, Tiers 1 to 3, collectively referred to as “Part A”, include an Attribution Pricing Model Selection Process Analysis System and Capital Asset Pricing Models (APMSPAS & CAPM's). As shown in FIG. 31, Tier 4, referred to as “Part B”, includes Strategic Portfolio Optimization Process Analysis System and Capital Asset Pricing Models (SPOPAS & CAPM's).

The four tier process results in a true Best of a Breed Portfolio. They are flexible processes which use factor metrics to determine whether discrepancies in the market are real or a mirage produced by a lack of understanding of the forces that drive the prices compared to their purity of valuation. This has the effect on the predictability and sustainability on the purity and relative strength of forecasted segments with the idea of minimising the market movement of the portfolio by hedging away from risk in accordance with the client's risk tolerance.

The system 12 works off the theory that you simply can't make it do what you want without performance in all markets. However, when shares get volatile, it can provide constant returns, no matter what's happening around you, by trading off volatility against the main market. The Core Spectrum Factor Metrics satisfy the desire of a client's mandate. That is, the client does not want to loose money, yet at the same time it expects to get constant out (performance). The system 10 provides a unique way of dealing with systematic risk and non-systematic risk.

### Customary Academic and Empirical Measures Relevant to Investment Portfolio for Out-Performance

### Introductory Background to the Academic Literature

The first question in any academic and empirical evidence for discussion is when measuring a fund's performance is more complicated than merely computing the realized or expected return. Since returns and risks are positively correlated, a manager can improve a portfolio's return simply by aggressively investing in more risky assets. Given that investors prefer less risk (other things being equal), investment performance measures should incorporate both these indicators: portfolio risks and returns. However, unlike returns, there are a variety of measures of risk which can be used and we have already reviewed these most common methods above.

Therefore it becomes a question of negative correlated risk/returns that's the key driver of performance when considering “can Fund Managers add value in the sense of ‘beating the market’.” Evidence of early studies of managed fund performance focused on this issue. These studies were done to test the Efficient Markets Theory. They also assist investors to decide whether it is better to invest in an actively managed fund or an index fund. The subject is complicated, as different results are obtained depending on what benchmark is used. Can consumers successfully use measures of past performance as a decision tool for fund selection?

As a result of extensive reviews undertaken of the academic and empirical literature on the “Performance Persistence” as to whether managed fund's past performance is related to their future performance evidence by a 100 or so relevant empirical studies written over the past 50 years.

Firstly came the most significant and central development of the Capital Asset Pricing Model (CAPM) by Markowitz (1952) Modern Portfolio Theory (MPT) and Jensen (1968) for his contribution to Strategic Asset Allocation being the macro Alpha Reward by the Market (Systematic Risk) and via selection process by the Capital Asset Pricing Model (CAPM), it was immediately obvious that the analysis provided a theoretical framework that could be applied to meet the challenges of performance measurement. Treynor (1965), Sharpe (1966), Jensen (1968) whereby, the issue is made even more complex by the fact that varied results have emerged from studies using similar methodologies or similar benchmarks.

Secondly recent studies co-inside with the more robust methodology discovery for separating Alpha from the Beta. The majority of studies have examined United States funds while a significant number examined United Kingdom funds, with also considered some studies of the performance of Australian funds. A majority of studies look at equity funds. The studies cover different time periods, use different benchmarks and reach different conclusions. The Australian studies are broadly consistent with the pattern of overseas research. These funds studies examines the see references context i.e. US (Khan and Rudd (1995) Elton, Gruber Blake (1996) Carhart (1997) Daniel, Grinblatt, Titman and Wermers (1997) Christopherson Person and Glassman (1998), UK (Allen and Tan(1999), Wood Mackenzie (2002) Aus (Hallahan (1999) Soucik (2002) reviewed their major findings vis-à-vis on “Performance Persistence” similarities to ACRARRB STCEF Building Blocks mechanism whose performance technique devoted such multi data point detail as to mean variance and forward fundamentals spreadsheet analysis Risk/Return/Time horizons that provides a more broad based overview analysis of the markets/sectors/relative strength/trend that the portfolio is more negative correlated to risk.

However due to the major development by the ACRARRBSTCEF applications and building blocks framework that provides a unique inside into implementation of how these numbers arise in different ways of measuring risk from various asset-pricing model only looks at market related risk (or beta), not total risk, hence the relevancy of their composite potential help contribute to an Investment Portfolio Out-Performance.

Therefore given this range of views in the academic literature about the best asset-pricing model; e.g. candidates vary from the CAPM, to arbitrage pricing based models, through to various ad-hoc factor-based models which have resulted from statistical exercises. In addition to studies using different pricing models, they also use a variety of benchmarks to represent the neutral market performance. There is an extensive academic literature on both asset-pricing models and performance benchmarks. The issue is made even more complex by the fact that varied results have emerged from studies using similar methodologies or similar benchmarks. However, ACRARRBSTCEF uses a underlying multi composite Alpha methodology variances, is the form of strongest aggregate score that by their meritorious accumulative outcomes represent the various performance persistence in these studies i.e. Alpha Extraction/Factor Evaluation Model/Core Spectrum/Concentration Approach (AE/FEM/CS/CA(T2) see Page 74, Scoring/Sorting/Factor Evaluation Model/Core Spectrum/Symmetry of Distribution Approach S/S/FEM/CS/SODA(T2) see Page 76, Strongest Aggregate Score/Factor Evaluation Model/Core Spectrum/Risk/Return Opportunities Approach (SAS/FEM/CS/R/ROA (T2).

Nevertheless central to the issue is “how useful is past performance information when consumers (or their advisers) are selecting an Investment Portfolio Construction Out—Performance.” Also in this paper we undertake an extensive review of the academic literature on the “persistence” of managed fund performance.

The academic studies look at whether funds' past performance is related to their future performance. If a fund's performance is consistently above (or below) the average performance for a group of similar funds, this is called “persistence”. Evidence of relative persistence has important implications for investor choices between funds. Of the 100 or so relevant studies written over the past 50 years, we have focused on the more recent studies and those studies with the more robust methodology. The majority of these studies look at US funds whilst a number have examined UK funds and Australian funds. We review their major findings vis-a-vis performance persistence.

We have kept in mind the situation facing retail investors and focused on the studies which are most relevant to real world situations:
a. Returns need to be adjusted for fees;
b. Most consumers have an investment horizon of at least several years and frequent switching between funds would incur costs and inconvenience.
c. The risk level of different funds is a significant factor.

### Factors to be Considered in Out-Performance Measurement

The use of past performance information is clearly linked to two related issues:
a. What is an acceptable performance risk measure?
b. A suitable measure needs to incorporate risk as well as return, given that performance figures are inextricably linked with the riskiness of investments.
c. Given a performance measure, can past performance be used as a guide to likely future performance?

### (i) Risk and Abnormal Returns

The main objective of a managed fund is to maximize returns while controlling the level of risk. Much of the performance reporting and advertising focuses entirely on returns achieved. However, all portfolios of investments are subject to risk and an indication of a funds' riskiness is required before any statement about historical returns can be meaningful, because they are the most accessible to consumers and their fluctuating performance can be examined from their unit prices.

Academic studies concentrate on whether a fund's returns out-perform some appropriate benchmark (which typically might be a composite market index). Performance is not superior if it cannot match that of a comparably risky diversified benchmark portfolio. One potential strategy is passive diversification which should produce a performance which has the same return and risk characteristics as the market average (e.g. a composite market index). If the fund manager takes on more risk by trying to choose winning stocks then the investor needs a measure of whether or not the policy produced returns commensurate with the extra risk level adopted i.e. Top Ten Holdings Blending Mandate Process Analysis (TTHBMPA) (T4) see Page 113, The Classic Portfolio Optimizer Process Analysis (CPOPA) (T4) see Page 115, Economists Consensus Macro Rotational Asset Class/Retracement Asset Allocation Process Analysis (ECMRAARACPA) (T4)/Diversified Investor Style Type Utility Function Models (DISTUFM) (T4) see Page 126, Moderate Valuation Portfolio Risk Management Process Analysis (MVPRMPA) (T4) see Page 130.

### (ii) Investment Risk

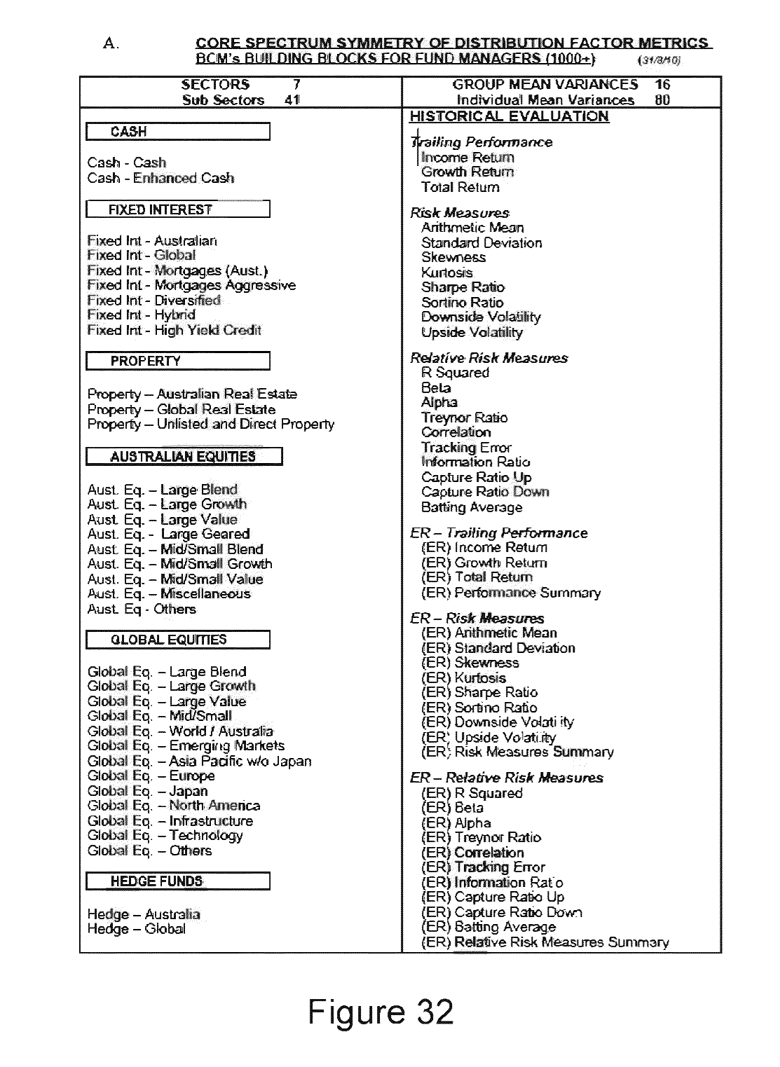

Since returns and risks are positively correlated, a manager can improve a portfolio's return simply by aggressively investing in more risky assets. Given that investors prefer less risk (other things being equal), investment performance measures should incorporate both these indicators: portfolio risks and returns. However, unlike returns, there are a variety of measures of risk which can be used. Therefore by reviewing some of these most common methods of mean variance/forward risk/return measures not with-standing various other risk and relative risk components featured in this paper i.e. see Building Blocks FIG. 32 Systematic Building Blocks Flexibility Technique (SBBFT (T1) see Page 61, i.e. ACRARRB—(Attribution Pricing Models Selection Process Analysis System/Capital Asset Pricing Models (APMSPAS/PCAPM)(T1)(T2)(T3) see Page 57-109, STCEF—(Strategic Portfolio Optimization Process Analysis System/Capital Asset Pricing Models (SPOPAS/CAPMs)(T4) see Page 109-146 i.e. Historical Evaluation Mean Variance (Quantitative)/Forward Evaluation Fundamental Research (Qualitative) Attribution Symmetry/Format Analysis (HEMV(Q)/FEFR(Q)/AS(FA) (T1) see Page 64. Standard Deviation

Markowitz (1952) suggested the use of standard deviation as a measure of risk. This metric measures the dispersion of returns from a central average value. The metric has distributional properties that allow inferences to be drawn. For instance, if the returns produced by a fund follow a bell-shaped normal distribution, then 95 times out of a hundred the return should be within plus or minus two standard deviations of the long term average. The greater the standard deviation, the greater the fund's volatility, plus all the multi variances amalgamated into this major algorithms

### Beta Index

Beta is a measure of a fund's sensitivity to market movements. It measures the relationship between a fund's excess return over a risk free investment (such as Treasury bills) and the excess return of the benchmark index. A fund with a 1.10 beta has performed 10% better than its benchmark index—after deducting the T-bill rate—than the index in up markets and 10% worse in down markets, assuming all other factors remain constant. Conversely, a beta of 0.85 indicates that the fund has performed 15% worse than the index in up markets and 15% better in down markets

### Sharpe Index (1966)

The Sharpe ratio is a risk-adjusted measure developed by the Nobel Laureate William Sharpe. Markowitz (1952), the founder of Modern Portfolio Theory (MPT), suggested that investors choose optimum portfolios on the basis of their expected return and risk characteristics. As noted above, the overall risk of a portfolio is measured by the standard deviation of its returns. Sharpe used this concept to build a “reward to variability” ratio which has become known as the Sharpe Index. The metric is calculated using standard deviation and excess return (i.e. return above a risk free investment) to determine reward per unit of risk. The higher the Sharpe ratio, the better the fund's historical risk-adjusted performance. In theory, any portfolio with a Sharpe index greater than one is performing better than the market benchmark

### Treynor Index (1965)

A third performance measure is the Treynor index. This is calculated in the same manner as the Sharpe index, using excess returns on the fund, but the excess return on the fund is scaled by the beta of the fund, as opposed to the funds' standard deviation of returns.

One advantage is that because investors are likely to spread their wealth into a number of funds, it is more important to focus on the marginal contributions of a fund to the total risks and returns of the investors. This requires a marginal risk measure, like beta. However, the measure is also both an absolute and a relative measure. It provides a measure of whether a manager beats the market, as well as suggesting the magnitude of over/under performance.

### Jensen's Alpha (1968)

Of these three traditional measures, the regression-based Jensen's Alpha is most commonly used in academic research. It provides a measure of whether a manager beats the market, as well as suggesting the magnitude of over/under performance.

Jensen's Alpha is also a reward for the management risk and a reward for the market risk measure, simultaneously. However, it uses a different concept of risk. To explain, we first need to realise that this measure's framework is taken from various capital asset pricing model (CAPM). In this model, among the assumptions, it is taken that every investor holds a diversified portfolio. This allows investors to diversify away some of their investment risk, leaving them exposed only ‘systematic’ or non-′systematic′ diversifiable market-related risk. Jensen's Alpha uses only systematic risk for scaling a portfolio's return. Alpha measures the deviation of a portfolio's return from its equilibrium level, defined as the deviation of return from the risk-adjusted expectation for that portfolio's return. For ranking purposes, the higher the alpha, the better the performance. The fund beats the market, on a systematic risk adjusted basis, if Jensen's Alpha is greater than zero, and vice versa. For ranking purpose, the higher the Jensen's Alpha, the better the performance. The only problematic term in the above approach is the portfolio beta. This can be estimated by regressing the excess return on the fund (the return above the risk free-rate) on the excess return on the market, similarly defined. The intercept from running this regression is the Jensen Alpha). The fund beats the market, on a systematic risk adjusted basis, if Jensen's Alpha is greater than zero, and vice versa i.e. ACRARRB Non-‘Systematic’ Reward for Risk—Attribution Pricing Models Selection Process Analysis System/Capital Asset Pricing Models (APMSPAS/PCAPM) (T1) (T2) (T3) see Page 57-109, STCEF—‘Systematic’ Reward for Market Strategic Portfolio Optimization Process Analysis System/Capital Asset Pricing Models (SPOPAS/CAPMs) (T4) see Page 109-146

(iii) Benchmarking

The next issue is what we compare performance against. There are two broad investment strategies: passive diversification or an active investment strategy.

### Passive Diversification

If the former strategy is adopted, then the investor is seeking an appropriately diversified portfolio which the manager will purchase on his behalf. The investor should achieve a measure of return and risk commensurate with that achievable on a broadly diversified portfolio. If he is trying to invest in a liquid portfolio of Australian equities, such as the S&P 100 Australian index, then he should have a return and risk profile similar to that of this particular benchmark. It will then be held without much revision unless there are changes in the composition of the index.

### Active Investment Strategy

With a more active stock selection strategy, investing in a managed fund is worthwhile only if the manager can add more value than the investors could achieve themselves. Again, the fund's performance must be compared with an appropriate benchmark. The benchmark should be an efficient naive portfolio replicable by average investors at low costs. Ideally we require some composite measure of both return and risk. This composite measurement index must hold the risks of an evaluated portfolio constant, so that performance can be judged on the basis of risk-adjusted returns. We need to measure a portfolio's performance on two dimensions; relative performance (i.e. relative to other active portfolios) and absolute performance (i.e. relative to a benchmark) client profile i.e. Moderate Valuation Portfolio Risk Management Process Analysis(MVPRMPA) (T4) see Page 130.

### (iv) Ranking of Performance Persistence Survivorship Bias

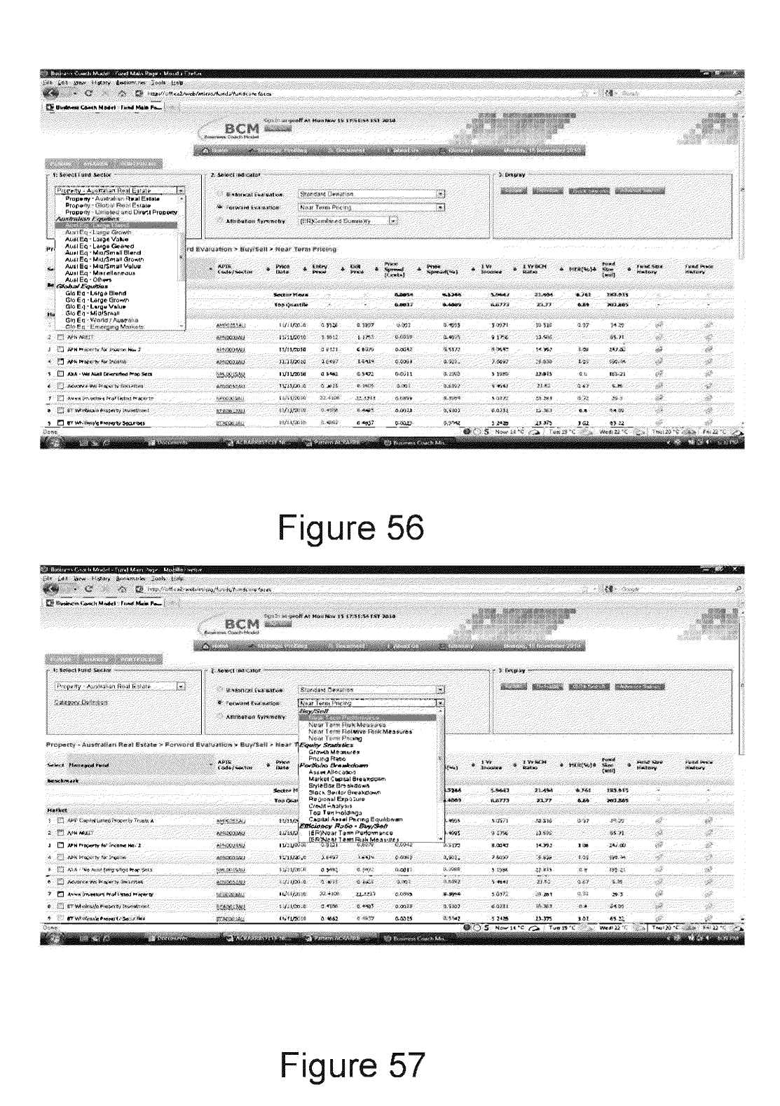

Ranking performance persistence studies face a problem called “survivorship bias”. This arises due to the introduction of bottoms-up/top down performance persistence ranking studies (see FIG. 56). This provides an awareness to the problem of “ranking survivor ship bias”, because some funds disappear during the monitored period being studied for buy/sell/hold. Generally due to the fluctuating nature of managed funds the good ones are being promoted and with poor performance will tend to fired or dropped from the line up. This is due to the “ranking survivorship bias” based algorithms i.e. absolute risk adjusted return relative benchmark, which measures positive ranking returns as the ascending order and positive risk as the descending order has the ability to instill performance persistence

The Managed Fund may close, merge or data on them may become unavailable, to the extent that being a survivor depends on past performance, using data based on surviving funds will bias upwards or downwards in the case of risk related represents the true top quartile benchmark for the asset class/sector of the managed fund performance. This is because the high-performing funds will tend to be over-represented in the sample. Funds with poor performance will tend to be merged or closed and will drop out of the sample.

Finally given to the extent that “ranking survivorship bias/performance persistence” is likely to be over-represented in the sample may lead to predictable biases because there is only room for one (1) or possibly two (2) of the Alpha performing funds in each sector of the asset class. This is because those Funds with lesser performance will tend to drop out of the “short list” sample i.e. Ranking Summary/Multi-Brand Fund Managers/Direct Shares Opportunities/Selection Process Analysis(RS/MB/FM/DSO/SPA)(T3) see Page 104

### (v) Conditional/Unconditional Alpha Performance Persistence

Performance persistence can be defined as a positive relation between performance ranking in an initial ranking period and the subsequent period. However whilst the majority of studies reach the same risk/return regression analysis conclusions, except the difference with Conditional/Unconditional Alpha represents a stronger performance persistence usage evidence by a Top Quartile benchmark for all composite risk/return/time regression analysis returns are measured in both changed/unchanged aggregated scored the Conditional (ERSPA)(T3)/Unconditional Alpha (TQSRSPA)(T3) approach to performance persistence that users a more truer concentration effect for capturing Absolute Alpha.

In other words this risk-adjusted/return/time methodology, due to the normalised consistency test by separating active Alpha from passive Beta performance through a comprehensive factor metrics employed by implementing Conditional/Unconditional Alpha for best practices and the usage of composite risk/return regression analysis for measuring the study of performance persistence avoids these plausible explanations for these conclusions about the low persistence of past performance, as more studies seem to find that bad past performance increased the probability of future bad performance. i.e. Efficiency Ratio Selection Process Analysis—ERSPA (T3) see Page 97), Top Quartile Strike Rates Election Process Analysis (TQSRSPA)(T3) see Page 99, Strongest Aggregate Score/Factor Evaluation Model/Core Spectrum/Risk/Return Opportunities Approach (SAS/FEM/CS/R/ROA (T2) see Page 80.

(vi) there are Plausible Explanations for these Conclusions about the Low Persistence of Past Performance
a. Performance comparisons can be quite misleading if not done properly such as keeping within; sector by sector and market to market, which provides the means for such risk-adjusted studies involve complicated computer analyses that are only available to research houses and academics.
   The first rule when analysing returns is to always remember to apply caution because it's only meaningful if adjusted for risk/volatility when comparing “like with like”.
b. The risk-adjusted studies therefore measure the potential value of past performance information in the hands of experts, not ordinary consumers. They do not reflect the information available to retail investors via advertisements, league tables or formal offer documents
c. The methods which work best in one set of market conditions will not work best at other times. For example, value and growth style managers tend to excel at different times. However, it is hard for a consumer to predict the likely market conditions over the next few years. One of the problems with many of these studies is that they might not track a manager through a full cycle of market conditions.
d. Where persistence was found, this was more frequently in the shorter-term, (one to two years) than in the longer term. The longer-term comparison may be more relevant to the typical periods over which consumers hold managed funds.
e. Where persistence was found, the “out-performance” margin tended to be small. Where studies found persistence, some specifically reported that frequent swapping to best performing funds would not be an effective strategy, due to the cost of swapping.
f. The findings are consistent with other research that shows that it is hard for fund managers to consistently outperform the relevant benchmark.
g. The future return on investments is extremely hard to predict, so a significant part of a fund's performance (compared to its peers) may be random luck.
h. More studies seem to find that bad past performance increased the probability of future bad performance.
i. Fund managers constantly strive to match the performance of competitors. If one firm is outperforming its peers, others will try to copy its methods and/or head hunt its staff. If it attracts a large inflow of funds it is likely to be difficult to place these funds and maintain relative performance, if it is an active as opposed to a passive fund.

### Part A Evidence of Academic/Empirical Studies of Non-Performance Persistence (Rewarded for Risk) (i.e., Attribution Pricing Models Selection Process Analysis System/Capital Asset Pricing Models (APMSPAS/PCAPM)(T1)(T2)(T3) see Page 57-109.

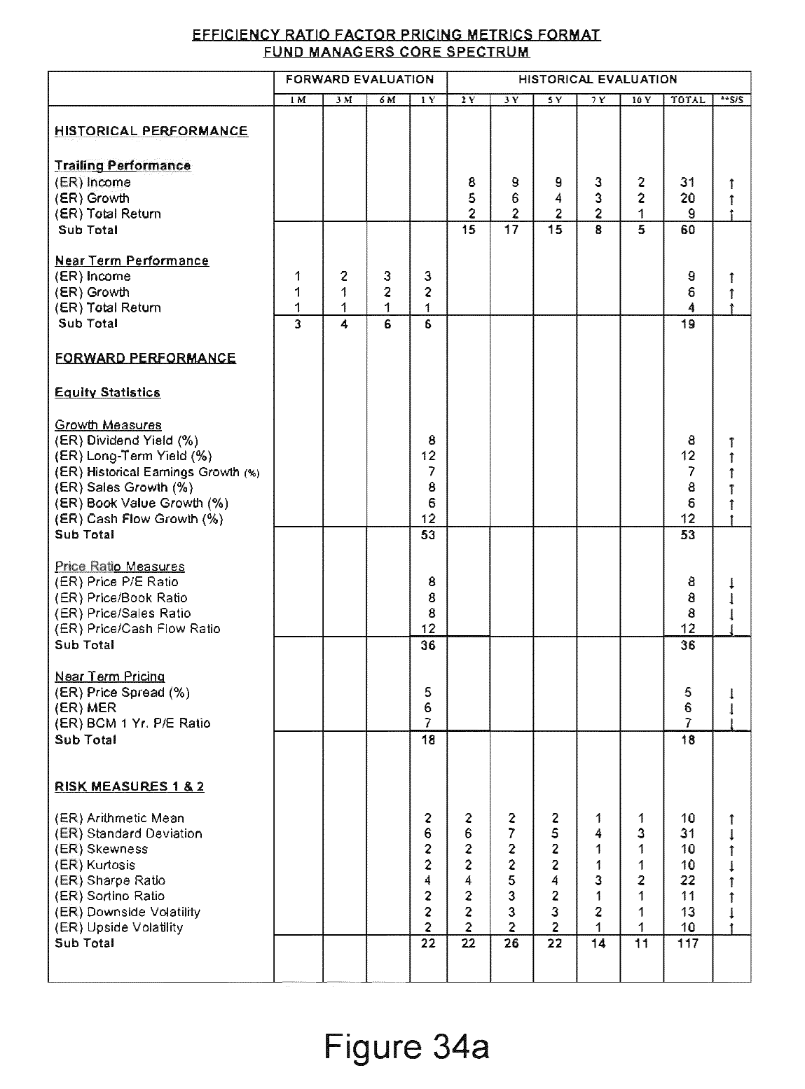

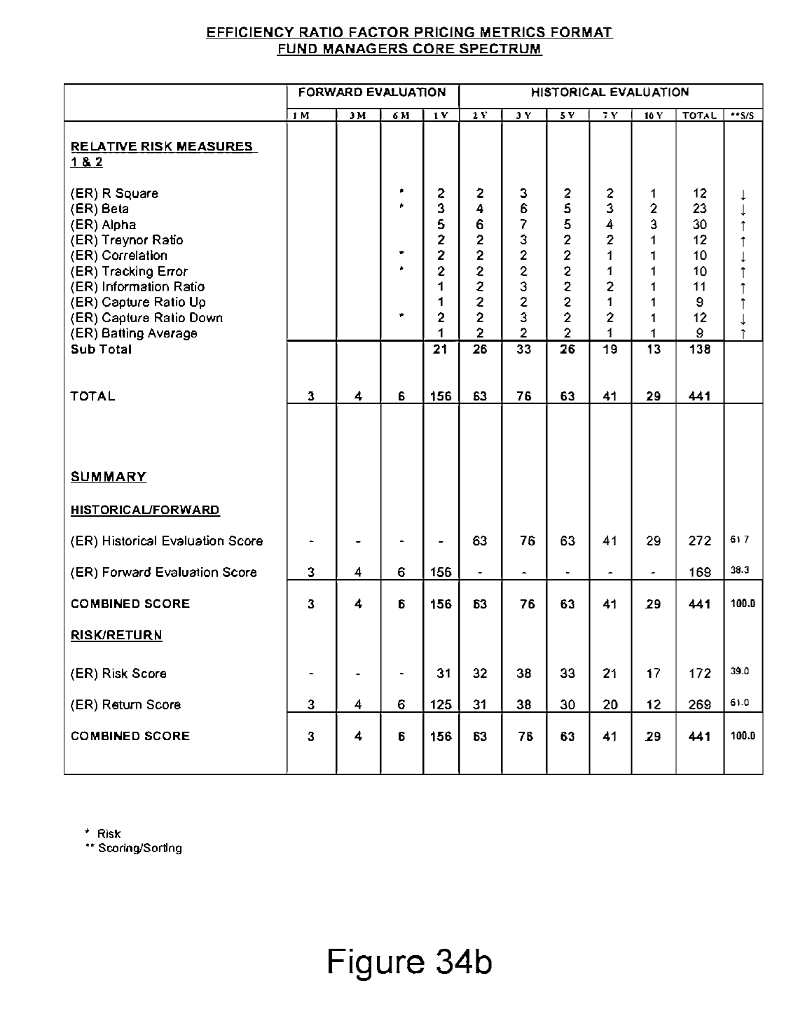

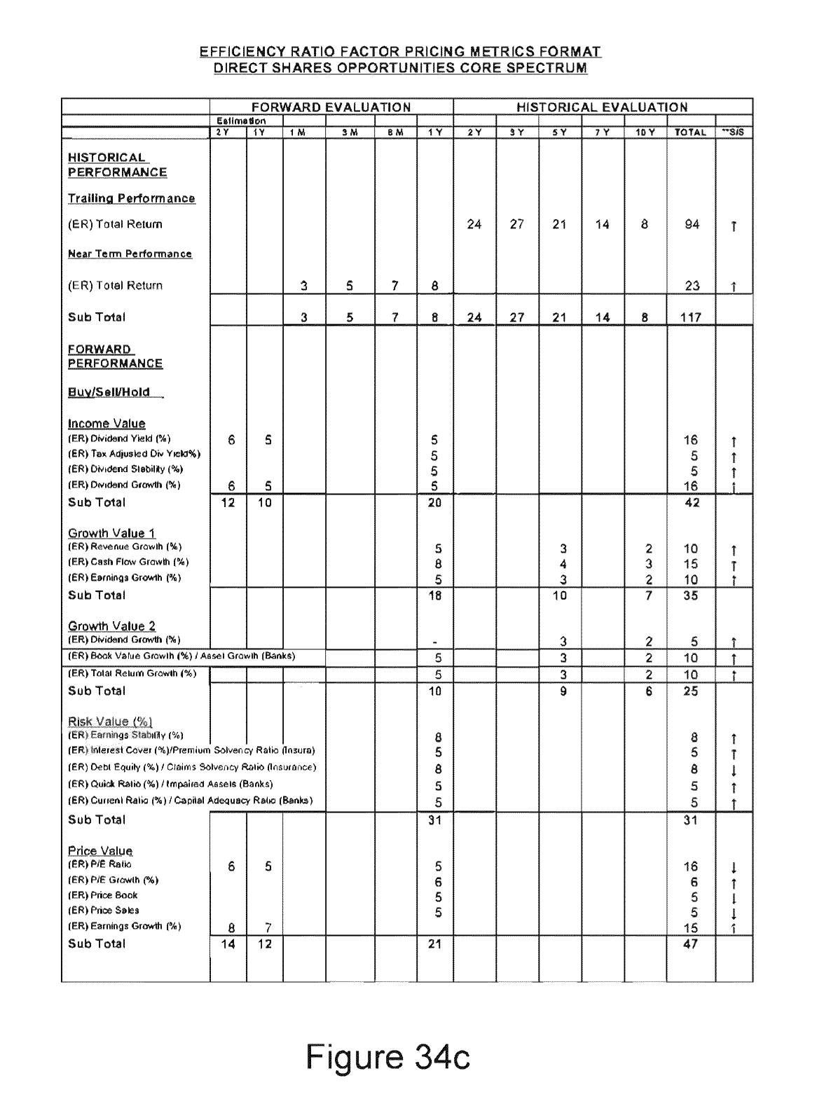

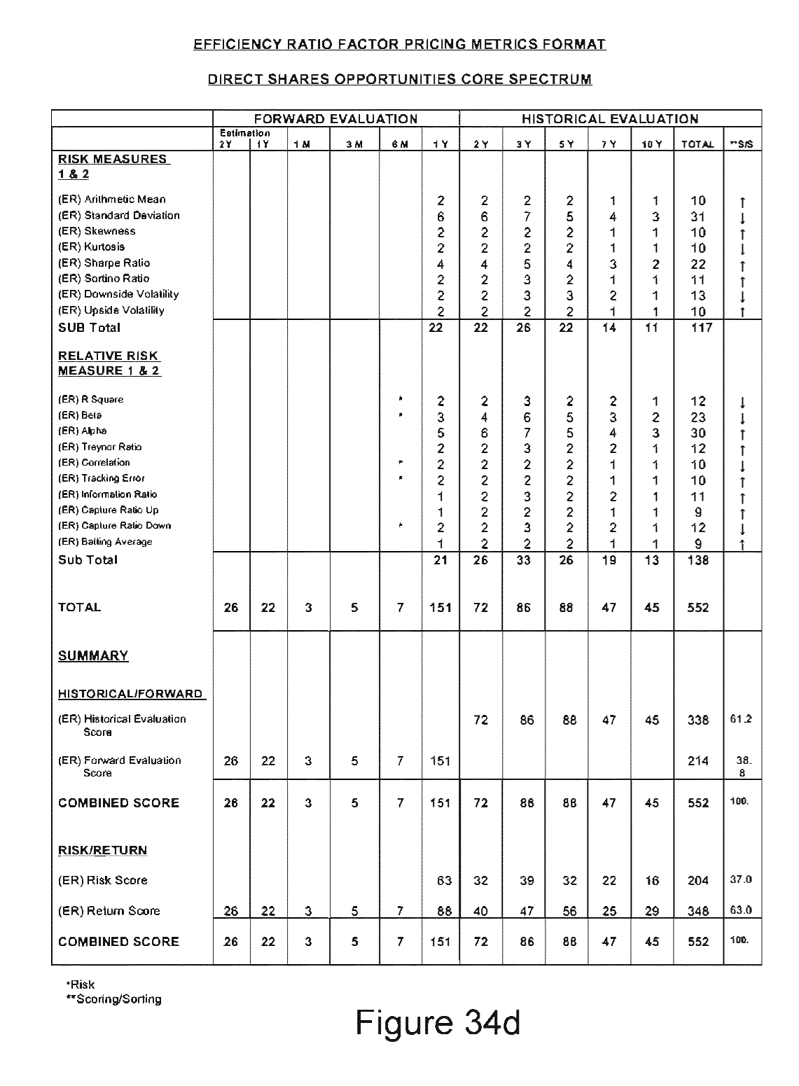

(i) The fact that ACRARRB has already been able to focuses on these academic/empirical performance persistence studies evidence by its strongest aggregate score methodology i.e. Strongest Aggregate Score/Factor Evaluation Model/Core Spectrum/Risk/Return Opportunities Approach (SAS/FEM/CS/R/ROA(T2) see Page 80 being a collection of composite risk/return score that makes it one of the most relevant factors in the real world situations, having kept in mind the concern facing most investors have an investment horizon of at least several years and given the combined risk/return ranking level of different funds represents a significant factor. Therefore by reviewing most of the these common methods associated these academic/empirical performance persistence studies and those methodologies used by ACRARRBSTCEF hardware (i.e. Systematic Building Blocks Flexibility Technique SBBFT (T1) see Page 61, and software i.e. Historical Evaluation Mean Variance (Quantitative)/Forward Evaluation Fundamental Research (Qualitative) Attribution Symmetry/Format Analysis (HEM V(Q)/FEFR(Q)/AS(FA)(T1) see Page 64, are broadly the major mechanisms that consistently drives the majority academic and imperical research; e.g. Khan and Rudd (1995) US. Returns are only meaningful if adjusted for risk/volatility based on Performance Metrics for comparing “like with like”.
(ii) The risk-adjusted studies involve complicated computer analyses that measure the value of past performance based on the unconditional Top Quartile performance i.e. Top Quartile Strike Rates Election Process Analysis (TQSRSPA)(T3) see Page 99. Thus evidence of persistency test, when absolute return data is analysed, makes its potentially stronger for longer, given when returns are adjusted for risk rather than relative return e.g. Wood, Mackenzie (2002) such information in the hands of experts and not ordinary consumers, suggests results should only be interrupted by academics or available to research houses.
(iii) By ACRARRB employing an regression analysis technique associated with Conditional/Unconditional Alpha that's driven by HEMV(Q)/FEFR(Q)/AS(FA)(T1) see Page 64 for best practices to study performance persistence that depicts the Best of a Breed funds. e.g. Soucik (2002). By Conditional/Unconditional Alpha means in regression analysis; based on a risk adjusted return relative benchmark over multi time horizon data points, that separates the Alphas (excess over Top Quartile) from the Betas (Top Quartile benchmark) for i.e. Alpha Extraction/Factor Evaluation Model/Core Spectrum/Concentration Approach (AE/FEM/CS/CA(T2) see Page 75, Efficiency Ratio Selection Process Analysis-ERSPA (T3) see Page 97, Pricing/Factor Evaluation Model/Core Spectrum/Quantitative/Qualitative/Concentration Approach—P/FEM/CS/Q/Q/CA (T2) see Page77 and FIG. 32a, 32b, 32c, Scoring/Sorting/Factor Evaluation Model/Core Spectrum/Symmetry of Distribution Approach S/S/FEM/CS/SODA(T2) see Page 78, Strongest Aggregate Score/Factor Evaluation Model/Core Spectrum/Risk/Return Opportunities Approach(SAS/FEM/CS/R/ROA (T2) see Page 80.
(iv) Likewise ACRARRB specifically employs an Unconditional Alpha regression measure, that measures performance prediction by regressing current standard Top Quartile Alphas measures represents the base on which superior performance is judged. However as a documental statement the ACRARRB conditional measures is more informative about future performance than are unconditional measures (i.e. average Alphas and Betas). e.g. Christopherson, Person and Glassman (1998) US report that persistence becomes stronger as the future return horizon increases out to three years. They argued that institutional investment managers are likely to use current information about the state of the economy when forming expectations about returns i.e. Top Quartile Strike Rates Selection Process Analysis (TQSRSPA)(T3) see Page 99, together with its typical extraction technique i.e. Pricing/Factor Evaluation Model/Core Spectrum/Quantitative/Qualitative/Concentration Approach—P/FEM/CS/Q/Q/CA (T2) see Page 77 and FIG. 34a, 34b, 34c, Scoring/Sorting/Factor Evaluation Model/Core Spectrum/Symmetry of Distribution Approach S/S/FEM/CS/SODA(T2) see Page 78, Strongest Aggregate Score/Factor Evaluation Model/Core Spectrum/Risk/Return Opportunities Approach (SAS/FEM/CS/R/ROA (T2) see Page 80.
(v) Good past performance seems to be, at best, a weak and unreliable predictor of future good performance over the medium to long term. About half the studies found no correlation at all between good past and good future performance. Where persistence was found, this was more frequently in the shorter-term, (one to two years) than in the longer term. The longer-term comparison may be more relevant to the typical periods over which consumers hold managed funds e.g. Daniel, Grinblatt, Titman and Wermers (1997) US, confirm that that the momentum effect on stock returns and persistent use of momentum strategies by fund manager is the main reason for performance persistent. Thus for this example the investor is looking for leading macro economic indicator for cyclical knowledge information feed back that likely to reflect favourable or unfavourable micro business conditions i.e. Micro/Macro/Knowledge Gap Feedback Methodology/Core Selection/Back Testing/Track Error (M/M/KGF M/CS/BT/TE (T2) see Page 84, Miss-Pricing Direct Share Opportunities Selection Process Analysis (MPDSOSPA)(T3) see Page 99, Market Price Watch Process Selection Analysis (MPWSPA)(T3) see Page103.
(vi) ACRARRB have explored how these key variables of Attribution Symmetry Metrics, i.e. the Efficiency Ratio Ranking Summary together with Top Quartile Strike Rate-Ranking Summary combined with their respective Historical/Forward Summaries, based on risk/return/time horizons of three (3), six (6) and twelve (12) months, two (2), three (3), five (5), seven (7) and ten (10) years that looks behind the Fund Managers as to the way the manage money e.g. Elton, Gruber and Blake (1996) US concluded in favour of the existence of performance persistence in the short run (1 Year) and in the long run (3-year) past returns are better than one-year's data in predicting returns over the next three years when ranking is done on a risk-adjusted basis, suggests there's more to persistence of performance than the ‘hot hands” phenomenon i.e. Ranking Summary/Multi-Brand Fund Managers/Direct Shares Opportunities/Selection Process Analysis (RS/MB/FM/DSO/SPA) (T3) see Page 104.
(vii) The aim of the Market/Sector/Relative Strength/Trend works on the principle that, the process of Top Down/Bottoms Up, which simply means by choosing firstly the strongest sector then secondly choose in that same sector for the strongest DSO/FM, boosts your chances of success. Furthermore the Market/Sector/Relative Strength/Trend is basically an instrument for managing risk by matching investment opportunities to an individual investment profile based on a correlated technique through the information arbitrage approach of the HE/FE/AS(T1) which has the ability to line up all sector investments that are always on par with good opportunities thus eliminating the possibility of second guessing e.g. Allen and Tan (1999) UK confirmed that if past performance is a good indicator of future performance we would expect superior managers in the first test period to continue to exhibit superior performance in the second test period, and so on. Overall they find that both raw and risk-adjusted returns exhibit evidence of persistence in the long run but not in the very short run. They also explore the relationship between performance and volatility by dividing funds into two groups: high and low variance. The performance in both of these groups exhibits repeat-winner patterns suggesting that superior performance is not conditioned purely by risky investment strategies i.e. Market/Sector/Relative Strength/Trend/Direct Shares Opportunities/Fund Manager/Selection Process Analysis (M/S/RS/T/DSO/FM/SPA) see Page 106, Historical Evaluations/Forward Evaluations/Attribution Symmetry (HE/FE/AS) (T1) see Page 64.
(viii) The first part of modelling is predicting how much we think that an active Fund Manager, is likely to outperform. However the expectation you can get from active Alpha is a huge question, but unfortunately, the mathematics on its own is not very useful. It basically gets down to if the has talent, they continue to drive the Alpha up just by continuously increasing the level of risk. As a result, there are two types of risks—systematic risk and non-systematic risk. Systematic risk is related to the market and is affected by the economy, while the non-systematic risk on specific risk is correlated to the market and is instead specific to a particular company. Modern portfolio theory states that since non-systematic risk can be reduced through diversification, aggregate investors should not be compensated for bearing this risk as they can hold the market portfolio, which in theory is perfectly diversified e.g. Carhart (1997) US. avoid funds with persistently poor performance, funds with high returns last year have higher than average expected returns in the next year, but not in years thereafter, and so on as more studies seem to find that bad past performance increased the probability of future bad performance. Where persistence was found, the “out-performance” margin tended to be higher. Where studies found persistence, some specifically reported that frequent swapping to best performing funds would not be an effective strategy, due to the cost of swapping i.e. Equilibrium Combined Effect Evaluation Selection Process Analysis/Reward For Risk—Fund Managers/Free Cash Flow-Shareholders Yield (ECEEPA/RFR-FM/FCF-SY) see Page 100.
(ix) The High Conviction approach means an opportunity of higher returns compared to large over diversified holdings in a portfolio with regards this as combining two or more expected that has the effect of reducing negative returns regarded as impacting on a reasonable proxy that investors are willing to pay a premium. However changing times and unpredictable markets mean long term assumptions challenges and new methodologies, which can get really complicated without the required tools that can offer good opportunities as well as provides capital protection. Therefore the necessity for constant statistical/graphical monitoring for micro/macro market/sector/relative strength/trends Unlike quantitative risk and return the being a accumulative Micro and Macro graphical trend whose key variables represent interest rates, inflation and deflation, that punctuate the financial equilibriums of the economic paradigms housing, liquidity and corporate profits bubbles concludes that analyses perusing expected Alpha consist of superior investment focus and expertise skills of back-testing feedback to be able to hack this universe participate in the long term returns by converting quantitative analysis into financial forecasts. However the qualitative risk analysis is not as easy to standardise and quantify into a direct numerical output e.g. Wood, Mackenzie (2002). It depends on the time periods. The results differ according to different periods. It seems to them to be impossible to tell when a period of persistency will be apparent and when it will not, that: “short-term persistence (good or bad) is to be expected. In large part it is nothing more than a particular trust's investment style or approach being in (or out) of favour dependent on the phase of the economic cycle. A failure to recognise these cycles can lead investors (whether retail or institutional) to purchase a manager at the top of its cycle or sell at the bottom. i.e Micro/Macro High Conviction Approach/Factor Evaluation Model/Core Spectrum/Opportunity Higher Returns (M/M/HCA/FEM/CS/OHR (T2) see Page 82.
(x) Alpha is the value that most investors aspire to add to the portfolio under management. This new equilibrium combined methodology being the Attribution Symmetry realistically adopting factor modeling/superior for active risk management skills, are the true decision makers through the respective capital asset pricing factor mechanisms i.e. Efficiency Ratio, Top Quartile and Miss-Pricing and the being one of the finest practice method for acquiring active risk management skills, captures and displays a robust quantitative/qualitative selection process as to reasonable proxies that test the specific skills and experience.
   Rightly so portfolio selection risk management which may need to be challenged and to explored new methodologies that fund the right mix of investments, that represents the knowledge gap information arbitrage approach for extracting Alpha thus also represents a unique investment skills technique utilizing market multiple selection process knows how to select pedigree investments by looking what's behind them. This multi capital asset pricing models tends to make an optimize position because it seeks attribution style represents opportunities in search of absolute portfolio selection capability is the proof that remains in the purity of the forecast e.g. Hallahan (1999) Aus; This study uses three (3) methodologies to explore the information content of fund performance history for groups of funds differentiated by investment objective: 1. Regression analysis; 2. Contingency table (raw returns); and 3. Top and bottom quartile rankings to explore the information content of fund performance history for groups of funds classified by investment objective. The results of the regression analysis suggest that there is evidence in support of persistence in performance for the particularly on a risk-adjusted basis, but more ambiguous evidence in relation to the multi-sector funds. Contingency table analysis of fund performance histories of varying lengths reveals quite different results depending on whether raw or risk-adjusted returns are used. The use of raw returns creates an overall impression of performance reversals compared to risk-adjusted returns i.e. Efficiency Ratio Selection Process Analysis-ERSPA (T3) see Page 97, i.e. Top Quartile Strike Rates Selection Process Analysis (TQSRSPA)(T3) see Page 99, Miss-Pricing Direct Share Opportunities Selection Process Analysis (MPDSOSPA)(T3) see Page 99, Equilibrium Combined Effect Evaluation Selection Process Analysis/Reward For Risk—Fund Managers/Free Cash Flow-Shareholders Yield (ECEEPA/RFR-FM/FCF-SY) see Page 100.
(xi) Finally, one of the most powerful and telling conclusions regarding performance persistency managed funds discovered by ACRARRB stresses that when making conclusions about the performance of managed funds, it is critical to providing an accurate and unbiased environment that for the current purposes is the variation in performance according to the choice of risk adjusted return relative benchmark according to a data point framework of various factor pricing metrics in an effort to identify (in a consistent regression methodology setting) the most accurate and least biased methodology such as; Top Quartile repeated for a matrix of 1, 3, 6, 12 months 1, 2, 3, 5, 7, 10 years e.g. Soucik (2002) uses an extensive Australian data set consisting of monthly returns covering 636 equity funds over a fifteen-year period between 1985 and 1999. One key finding in Soucik for current purposes is the variation in performance according to the performance metrics benchmark. He concludes that the choice of benchmark has a critical impact on performance results. Likewise he uses a regression methodology [see Grinblatt and Titman (1992)] to test for persistence in managed funds. He investigates how past periods of different duration impact on various prediction time frames (both up to five years). To form his test samples he first selects a portfolio of randomly selected funds comprising 25% of the population, a ratio found to best balance the robustness of the sample with the risk of cross-portfolio repeats (see Barber, Lyon& Tsai, 1999). If he seeks to find the relationship between the past 36 months of returns and future 12 months, the study period will equal 48 months. He eliminates survivorship bias by randomly selecting fund existing at the end point of each study period, not the starting point. This process is then repeated for a matrix of 12 months of past returns up to 60 months returns (past) selection and used to predict returns for anything from 12 months future returns out to 60 months (future prediction months) in quarterly intervals.
   The above analyses suggest that it is possible to predict performance and that a longer estimation window is required for fixed interest funds as opposed to equity funds. In other words about five years of monthly data are needed to predict three years of future performance. This is not surprising given likely term structure effects. The picture for equity funds is more equally balanced in that to look forward three years you need a past window of three-year returns.
   These above analysis sets do not tell the whole story. The ability to predict appears to be more concentrated in the extremes of the distribution. As noted in some of the previously-mentioned UK studies, it is the very poor-performers and the top performers who tend to have some degree of persistence in performance. The other problem is how far ahead you are trying to predict. Soucik found that more powerful predictions are associated with performance prediction out to two years and beyond this i.e. Attribution Pricing Models Selection Process Analysis System/Capital Asset Pricing Models (APMS PAS/CAPM) (T1) (T2) (T3) see Pages 57-109.
      Part B—Portfolio Performance Persistance/Rewarded for MARKET/CAPITAL ASSET PRICING MODELS (PPP/RFR/CAPMs) i.e. Strategic Portfolio Optimization Process Analysis System/Capital Asset Pricing Models (SPOPAS/CAPM S)(T4)

### The Important Criteria for a Strategically Targeted Correlated Efficient Frontier (SCTEF)

One of the problems with many of these studies is trying to extract the APP(RFR)CAPMs which in essence represents Alpha Investment Performance Persistence (Rewarded for Risk) and Alpha Portfolio Persistence (Rewarded for Market), consequently the future returns on investments would be to extremely hard to predict, through a full cycle of market conditions without the appropriate ACRARRBSTCEF building blocks. Therefore a significant part of a performance persistence (compared to its peers) avoids random luck or risk.

Therefore due to the findings are consistent with US, UK, Aus Performance Persistence research that shows that it is hard for Fund Managers to consistently outperform the relevant benchmark thus ACRARRBSTCEF avoids absolute reliance on past high performance persistence approach, but rather includes as an additional consistency test for Efficient Frontier i.e. Moderate Valuation Portfolio (MPVRMPA (T4) being the basics for; Academic and Empirical Studies Portfolio Diversification evidence by appropriate best practices Alpha Performance Persistence (Rewarded for Risk) and Alpha Portfolio Persistence (Rewarded for Market).

Finally, whilst we recognised value and growth style managers tend to excel at different times but without the Economists Consensus Macro Rotation Asset Class/Retracement Asset Allocation (ECMACAA) this makes it a lot harder for a investors to predict the likely market conditions evidence by allowing investors to diversify away some of their investment risk, which would leave them exposed only ‘systematic’ or non-diversifiable market-related risk. Therefore MPVRMPA (T4) Portfolio Construction process i.e. Strategic Asset Allocation/Tactical Asset Allocation/Strategic Portfolio Optimized and Projected Forecasting CAPMs (SAA/TAA/SPO/PER) would urge the analysis to go on the outlook for; the SAA weightings for a standard diversified, TAA imply going “overweight” or “underweight” the various asset classes versus your bespoke SAA/SPO weighting for desired investor risk tolerance and PER expected returns by going forward and back testing the performance of this portfolio against the past 20 years history.

Thus Additional Information Usage Associated with Alpha Performance Persistence (Rewarded for Risk) and Alpha Portfolio Persistence (Rewarded for Market) as Follows.
(i) Without the basic building blocks that decides the bespoke asset class from which to achieve the appropriate asset allocation for an investor represents the main core drivers for performance persistence considering the continuous monitoring of global and domestic economic cycles and life cycle challenges of the investors objectives and needs. It is not surprising that the appropriate asset allocation will differ for most investors, depending on the return expectations, risk tolerance (can you sleep at night test), time horizon and the stage of your life cycle (for an individual) i.e. Systematic Building Blocks Flexible Technique (SBBFT (T1) see Page 62, Historical Evaluations/Forward Evaluations/Attribution Symmetry (HE/FE/AS) (T1) see Page 70.
(ii) A standard Client Profile questionnaire to determined risk profile category of the investor criteria will be processed through the typical (5) i.e. Conservative, Moderately Conservative, Balance, Moderately Aggressive, Aggressive i.e. Diversified Investor Style Type Utility Function (DISTUF) see Page 125.
(iii) A moderate valuation portfolio risk management process analysis technique avoids extrapolating returns from a set of market conditions based risk/return/random luck, thus as a strategic portfolio optimization tool it can utilizing multiple Fund Managers/Direct Shares as a strategies process for efficient frontier. Therefore through it's the all important systematic building block such as the SBBFT (T1) that makes an excellent risk management tool, which can deliver performance persistence returns with a much lower over all risk correlation. In addition therefore the focus being on a risk adjusted return makes a enhanced strategy as follows; delivers gains and protect capital sought by members; separating market risk from management risk enables predictability from such trade-off and respective out comes; also acts as compliance protection style portfolio; micro/macro factor variables determined by their relative strategic merit such as rotational asset allocation and retracement asset class/sector; the problem with fund of fund mangers tend to let the portfolio drift; and put your money where the top score ensures how to qualify for out-performance.
   e.g. Jensen's Alpha (1968)—In this capital asset pricing model (CAPM) assumes that every investor holds a diversified portfolio (plus a few other assumptions). This allows investors to diversify away some of their investment risk by a systematic market-related risk adjustment, thus leaving them exposed only ‘systematic’ or non-diversifiable market-related risk. Jensen's Alpha uses only systematic market-related risk adjustment for scaling a portfolio's return. Alpha measures the deviation of a portfolio's return from its equilibrium level, defined as the deviation of return from the risk-adjusted expectation for that portfolio's return i.e. Moderate Valuation Portfolio (MPVRMPA (T4) see Page 129, Attribution Pricing Models Selection Process Analysis System/Capital Asset Pricing Models (APMSPAS/CAPM) (T1) see Pages 57-109, Strategic Portfolio Optimization Process Analysis System/Capital Asset Pricing Models (SPOPAS/CAPM'S) (T4) see Pages 109-146.
(iv) However due to the deficiency of Jensen's Alpha CAPM that uses only systematic risk for scaling a portfolio's return only, this them exposed the Jensen's Alpha to a non-diversifiable market-related risk, since without the MPVRMPA smart all-in one CAPM (SAA/TAA/SPO/PER) now allows investors to diversify away not only the investment risk that carries a significant performance persistence advantage yet at the same time leaving them less exposed systematic′ or non-diversifiable market-related risk such as performance persistency emphasis on a Portfolio Construction mechanism for risk adjusted (by regressing the excess return on the Portfolio above the risk free-rate) i.e. SAA/TAA/SPO/PER-CAPM e.g. Jensen's Alpha (1968)—In this capital asset pricing model (CAPM) assumes that every investor holds a diversified portfolio (plus a few other assumptions). This allows investors to diversify away some of their investment risk by a systematic risk-free rate adjustment, thus leaving them exposed only ‘systematic’ or non-diversifiable market-related risk. Jensen's Alpha uses only systematic risk-free rate adjustment for scaling a portfolio's return. Alpha measures the deviation of a portfolio's return from its equilibrium level, defined as the deviation of return from the risk-adjusted expectation for that portfolio's return i.e. Moderate Valuation Portfolio(MPVRMPA(T4) see Page 129, Economists Consensus Macro Rotational Asset Class/Retracement Asset Allocation Process Analysis (ECMRAARACPA) (T4) see Page 124.
(v) A proper functional Part B SPOPAS/FCAPMs (T4) represented by the combined and becomes the efficient frontier problem which can get really complicated without the required tools for measuring strategic portfolio optimization. approach is to utilise the core markets/sector/relative strength/trend (M/S/RS/T)(T3) and to surround it with low risk/high performance specialists This new paradigm approach discovery represented by Part A APMSPAS/CAPMs (T1)(T2)(T3) that covers core spectrum for the of miss-pricing of risk right down to the value add through a unique attribution symmetry technique. Portfolio optimization analysis system represented by both Part A and Part B makes it easier to protects capital by ensuring a suitable choice across the board relies on the systematic building blocks for extracting double Alpha.
   This is where the SAA/TAA/SPO/PER would be controlled by investor, thus allows acceptable risk return out comes within their acceptable risk profile. The objective will be to identify the best of a breed according to the asset class/asset allocation and to continue with them in such a way as to satisfy the stated investment objectives. The SPOPAS/CAPM's(T4) tends to make an optimise position of M/S/RS/T/SPA(T3) by managing better returns through ECMRACRAAPA (T4)/DISTUFM(T4) thus trading off volatility against the main market according to the investors tangible risk tolerance, concluding with the right SCTEF asset allocation phenomenon represents over 90% as to the accuracy response of a portfolio volatility return and a 70% response chance regarding the value add return; hence the importance of asset mix cannot be overlooked. The SPOPAS/CAPM's(T4) likewise is driven by the goals of successful investing is to take positions on securities that exhibit discrepancies between observed prices and fundamental values. i.e. Jensen's Alpha (1968) the regression-based Jensen's Alpha is most commonly used in academic research. It provides a measure of whether a manager beats the market, as well as suggesting the magnitude of over/under performance. In this model, among the assumptions, it is taken that every investor holds a diversified portfolio. This allows investors to diversify away some of their investment risk, leaving them exposed only ‘systematic’ or non-‘systematic’ diversifiable market related risk For ranking purposes, the higher the Alpha, the better the performance.
   Alpha measures the deviation of a portfolio's return from its equilibrium level, defined as the deviation of return from the risk-adjusted expectation for that portfolio's return. The problem as we know it is the fact is the investor is not simultaneously, reward for the management risk and a reward for the market risk measure. However, it uses a different concept of risk. To explain, we first need to realise that this measure's framework is taken from various CAPMs. Jensen Alpha uses only systematic risk for scaling a portfolio's return. The fund beats the market, on a systematic risk adjusted basis, if Jensen Alpha is greater than zero, and vice versa. The only problematic term in the above approach is the portfolio beta. This can be estimated by regressing the excess return on the fund (the return above the risk free-rate) on the excess return on the market, similarly defined. The intercept from running this regression is the Jensen Alpha i.e. Moderate Valuation Portfolio Risk Management Process Analysis (MVPRMPA)(T4) see Page 130, Quality Assessment Quarterly Review Process Analysis (QAQRPA(T4) see Page 133.
   Typically a MPVRMPA (T4) consist of these four (4) traditional measures for portfolio construction i.e. SAA/TAA/SPO/PER, are simultaneously changing to the rewards for the management risk and a reward for the market risk according to the investors risk tolerance.

### (i) Strategic Asset Allocation (SAA)

a. The starting point, in fact are building block for portfolio construction, is one's SAA. So what is your appropriate weighting to the key asset classes. This will typically consist of the following: Cash, Fixed Income, Equities, A-REITs (listed property securities) and Alternatives.
b. By being negatively correlated (asset allocated) to the asset classes effectively, lowers the volatility away from risk of a total portfolio.
c. It's important asset allocated accordingly at what stage of your life cycle investors are at. Clearly, for an individual your SAA benchmark weightings will differ if you are 25 years of age versus 50 years of age.
d. The SAA weightings for a standard diversified balanced fund typical of a moderate Australian investor profile.
e. You need more defensive income exposures the closer you get to pension phase.
f. It will also differ if you are a long-term Annuity Fund, that seeks to pay out all income received annually or reinvest.
g. For an Annuity Fund, there would be a little more allocation to Alternatives. This is consistent with many other large global Endowment Funds, and various Sovereign Wealth Funds globally.

The weightings across the asset classes for our above example are: 5% Cash (must always be liquid and accessible); 30% Bonds (this includes Australian government bonds, Semi-government bonds, high quality corporate bonds, some high yield securities and global bonds swapped back into Australian dollars (AUD); 50% Equities (importantly this includes both domestic equities and global equities using typically the MSCI benchmarks); 5.0% Real Estate (which is typically Australian Real Estate Investment Trusts—A-REITs—which are listed. One can model direct property for bespoke clients such a large a Not For Profit Funds given many have large property holdings; 10.0% i.e. Moderate Valuation Portfolio Risk Management Process Analysis (MVPRMPA) (T4) see Page 130.

### (ii) Tactical Asset Allocation (TAA)

There are other elements to asset allocation such as “tactical” sector tilts to TAA which imply going “overweight” or “underweight” the various asset classes versus your bespoke SAA weighting. The SAA is the long run benchmark that aims to deliver the expected returns reflecting risk appetite. The TAA overlay is simply the additional performance one is seeking through cycles (short run) given the various valuation models.

It depends on the time periods. The results differ according to different periods. It seems to them to be impossible to tell when a period of persistency will be apparent and when it will not. A failure to recognise these cycles can lead investors (retail or institutional) to purchase a manager at the top of its cycle or sell at the bottom. This is not a recipe for successful investment e.g. Wood Mackenzie (2002) further caution that: “short-term persistence (good or bad) is to be expected. In large part it is nothing more than a particular trust's investment style or approach being in (or out) of favour dependent on the phase of the economic cycle i.e. Top Ten Holdings Blending Mandate Process Analysis (TTH BM PA)(T4) see Page 113, Quality Assessment Quarterly Review Process Analysis (QAQRPA(T4) see Page 133.

(iii) Strategic Portfolio Optimisation (SPO)

The SPO asset allocation is the appropriate core driver for an investor who is looking for performance persistence through their life cycle, of many economic cycles.

It is no surprise that the appropriate asset allocation will differ for most investors, depending on the return expectations, risk tolerance (can you sleep at night test), time horizon and the stage of your life cycle (for an individual). Investors tend to be far more risk cautious when it comes down to making a decision regarding their investment portfolio, because it seems that any involvement in financial decisions is centred around their risk tolerance level, meaning the containment of their perceived risk, should relate within their comfort zone which where uncertainty is concerned the choice is related between being rewarded for more favourable outcomes than accepting more unfavourable outcomes.

Therefore SPO approach means the appropriate SAA/TAA/PER optimisation by default according to the Economists Consensus (i.e. rotational asset class/retraceable asset allocation) that satisfies the above client's typical Diversified Investors Style Type Utility Function e.g. Wood Mackenzie (2002) It follows that many Diversified Portfolio performances go through cycles periods of out-performance are followed by periods of under-performance. They concluded by cautioning that the kind of long-term consistent out-performance that may indicate skill through economic cycles, i.e. Economists Consensus Macro Rotational Asset Class/Retracement Asset Allocation Process Analysis (ECMRAARACPA)(T4)/Diversified Investor Style Type Utility Function Models (DISTUFM) (T4) see Page 126, Moderate Valuation Portfolio Risk Management Process Analysis (MVPRMPA) (T4) see Page 130.

### (iv) Projected Earnings Rate (PER)

As a result most analysis would know that PER is a separate asset allocation exercise that needs to be routinely forecasted before the basic Moderate Valuation Portfolio (Portfolio Construction) is finally completed. Therefore the basic understanding of the PER standard is as follows.

The aim is populate the portfolio with the Best of the Breed (Top Quartile Best Practices and above) through conditional (ERSPA) and unconditional (TQSRSPA) factor means the use of weighted factor-varying according to pricing metrics. Therefore through high aggregate score enables the separation of Alpha and Beta, which according to academic and imperial have the potential to be able to forecast with confidence. e.g. Elton, Gruber and Blake (1996) US. concluded in favour of the existence of performance persistence in the short run (1 Year) and in the long run (3-year) past returns are better than one-year's data in predicting returns over the next three years when ranking is done on a risk-adjusted basis, suggests there's more to persistence of performance than the ‘hot hands” phenomenon i.e. Historical Evaluations/Forward Evaluations/Attribution Symmetry (HE/FE/AS)(T1) see Page 70, Conditional-Efficiency Ratio Selection Process Analysis-ERSPA (T3) see Page 80, or of (i.e. Unconditional-Top Quartile Strike Rates Election Process Analysis (TQSRSPA)(T3) see Page 99, accordingly to their respective Strongest Aggregate Score/Factor Evaluation Model/Core Spectrum/Risk/Return Opportunities Approach (SAS/FEM/CS/R/ROA(T2) see Page 80. Ranking Summary/Multi-Brand Fund Managers/Direct Shares Opportunities/Selection Process Analysis (RS/MB/FM/DSO/SPA)(T3) see Page 104, i.e. Top Ten Holdings Blending Mandate Process Analysis (TTHBMPA)(T4) see Page 113, Quality Assessment Quarterly Review Process Analysis (QAQRPA(T4) see Page 133
a. Next to back test the outlook for expected returns of the current asset classes going forward so as to gauge the respective similarities in market forces for the past 20 years that could influence the current portfolio going portfolio going forward. In other words your asset allocation over time will be the core driver of your total investment returns. Most investors should be diversified across all asset classes, and within each asset class, to help lower the volatility of your portfolio returns e.g. Christopherson, Person and Glassman (1998) argue that institutional investment managers are likely to use current information about the state of the economy when forming expectations about returns i.e. Micro/Macro/Knowledge Gap Feedback Methodology/Core Selection/Back Testing/Track Error (M/M/KGFM/CS/BT/TE (T2) see Page 84, Micro/Bottoms-Up/Graph Feedback Methodology/Core Selection/Back Testing/Tracking Error (Micro/BU/Graph(FM/CS/BT/TE(T2) see Page 87, Macro Top-Down/Graph Feedback Methodology/Core Selection/Back Testing/Tracking Error (MacroTD/GraphFM/CS/BT/TE(T2) see Page 90.
b. Hence the clear goal of course is to have exposure to asset classes that are negatively correlated through a cycle. For example the 1991-92 Australian recession (our last recession), the Asian financial crisis (1997/98), the technology bubble pop of late 2000, the unforgiving GFC (2008) and the recent European credit crunch are some clear examples that diversified portfolios significantly lower the volatility of your portfolio. The art of portfolio diversification is that it effectively reduces the risks and helps increase your wealth systematically over time. i.e. Top Ten Holdings Blending Mandate Process Analysis (TTHBMPA) (T4) see Page 113), The Classic Portfolio Optimizer Process Analysis (CPOPA) (T4) see Page115, Economists Consensus Macro Rotational Asset Class/Retracement Asset Allocation Process Analysis (ECMRAARACPA) (T4)/Diversified Investor Style Type Utility Function Models (DISTUFM) (T4) see Page 126, Moderate Valuation Portfolio Risk Management Process Analysis (MVPR MPA) (T4) see Page129), Quality Assessment Quarterly Review Process Analysis (QA Q R PA(T4) see Page133).
c. Finally in summary, we have aimed to explore the basic concepts and building blocks regarding the art of portfolio diversification through a Strategic Portfolio Optimisation SPO) for an average moderate investor profile. It is quite clear that diversification across all the asset classes, and importantly within, are such key concepts that all investors need to be cognizant of in their wealth accumulation. Your asset allocation must reflect your return expectations, the amount of risk you employ (volatility) to meet your objectives and your time frame (which reflects your stage of your lifecycle). Everyone will effectively need to explore their own bespoke SAA weighting benchmarks, as we all have different requirements and risk appetites. It will probably differ to the weightings used in this note. Going forward, the expected returns from the SAA benchmark we analysed above is a long term estimated portfolio return of 7.75% combined with an estimated portfolio risk of 7.60%. If we use a risk free rate of 5.25% we get a Sharpe ratio of 0.33. Of note, costs need to be considered for all investors, but there is an optimal portfolio allocation that will meet your return expectations and take into account the level of volatility that is appropriate for your needs over time. It is all about meeting ones expectations.
   What to Concluded from these Broad-Ranging Academic/Imperial Methodologies when Measuring a Fund's Performance at Investors Preferred Risk i.e. Absolute Concentrated Risk Adjusted Return Relative Benchmark Strategically Targeted Correlated Efficient Frontier (ACRAR RBSTCEF)

The two forms of persistence, absolute and relative, have been distinguished in the literature. A fund possesses absolute performance persistence if it is able to consistently beat a specific benchmark. This has implications for the Efficient Market Hypothesis, or the speed with which information is reflected into security prices. This also has implications about the merits of actively managed versus index funds. On the other hand, a fund possesses relative performance persistence if its performance is consistently above the average performance of a cohort of funds. Evidence of relative persistence has implications for Fund Managers choices between investments. Therefore what can we conclude from this broad-ranging literature outlined above. Many of the early studies were prompted by the development of MPT and thus focused on performance relative to a market benchmark. More recently greater emphasis has been placed on the issue of absolute performance persistence relating to a specific benchmark. However the academic studies use two main techniques to study performance persistence.

Nevertheless, even if a strategy worked in one period there is no guarantee that it will continue to work in the next. This leads on naturally to the issue of performance persistence. If past performance is going to be of use to investors, we need to know whether past performance (good or bad) is linked to future performance (good or bad); ie “performance persistence. ACRARRBSTCEF reviewed their major findings vis-à-vis on “performance persistence” similarities such devoted mechanism—a Top Quartile risk adjusted return relative benchmark regression analysis that sorts and scores according Risk/Return/Time Horizon; the good and bad mean variance and forward fundamentals performance that's provides a more broad based overview analysis of the markets/sectors/relative strength/trend e.g Soucik (2002)—Likewise whose performance technique virtually suggests the same routine such as, to form his test samples he first selects a portfolio of randomly selected funds comprising 25% of the population He investigates how past periods of different duration impact on various prediction time frames (both up to five years). These above analysis sets do not tell the whole story. The ability to predict appears to be more concentrated in the extremes of the distribution. As noted in some of the previously-mentioned UK studies, it is the very poor-performers and the top performers who tend to have some degree of persistence in performance. The other problem is how far ahead you are trying to predict. Soucik found that more powerful predictions are associated with performance prediction out to two years and beyond this i.e. Conditional-Efficiency Ratio Selection Process Analysis-ERSPA(T3) see Page 97, or of (i.e. Unconditional-Top Quartile Strike Rates Election Process Analysis (TQSRSPA)(T3) see Page 99, accordingly to their respective Strongest Aggregate Score/Factor Evaluation Model/Core Spectrum/Risk/Return Opportunities Approach (SAS/FEM/CS/R/ROA) (T2) see Page 80, Ranking Summary/Multi-Brand Fund Managers/Direct Shares Opportunities/Selection Process Analysis (RS/MB/FM/DSO/SPA) (T3) see Page 104.

If there is a link then this information can assist investors to make better investment choices. If there is no link between past performance and future performance in a statistical sense, then knowledge of past performance will not help an investor in choosing a likely high performance fund or in avoiding a probable below-average performer.

Even if we measure a fund's returns over a time interval accurately, this is only half the story. Measuring a fund's performance is more complicated than merely computing its realised or expected, returns.

### Two Sources of the Performance Measurement

One approach is a regression analysis of risk-adjusted returns from a benchmark (using Jensen's Alpha). The studies then examine the correlation between Alphas in the prior period and the later period.

The second approach is to compare returns (not risk adjusted) between funds in similar asset categories. Medians or quartiles are used to compare rankings in the prior period and the later period. This is the contingency table approach.

### Systematic Performance Persistence (Reward by the Market)

Academic studies invariably concentrate on whether a Fund's (i.e. ACRARRB) and Portfolio (i.e. STCEF—(Strategic Portfolio Optimization Process Analysis System/Capital Asset Pricing Models (SPOPAS/CAPMs) (T4) see Page 109-146) returns out-perform that's on some specific/appropriate benchmark (which typically might be a composite market index). Performance is not superior if it cannot match that of a comparably risky diversified benchmark portfolio. One potential strategy is passive diversification which should produce a performance which has the same return and risk characteristics as the market average (e.g. a composite market index). If the fund manager takes on more risk by trying to choose winning stocks then the investor needs a measure of whether or not the policy that produced returns is commensurate with the extra risk level adopted. However, even if a strategy worked in one period there is no guarantee that it will continue to work in the next. This leads on naturally to the issue of having the appropriate tools that accurately measure this i.e. Top Ten Holdings Blending Mandate Process Analysis (TTHBMPA) (T4) see Page113, Classic Portfolio Optimizer Process Analysis (CPOPA) (T4) see Page115, Economists Consensus Macro Rotational Asset Class/Retracement Asset Allocation Process Analysis (ECMRAARACPA) (T4)/Diversified Investor Style Type Utility Function Models (DISTUFM) (T4) see Page 126, Moderate Valuation Portfolio Risk Management Process Analysis (MVPR MPA) (T4) see Page 129, Quality Assessment Quarterly Review Process Analysis(QAQR PA) (T4) see Page133).

### Non-Systematic Performance Persistence (Reward by the Risk)

If past performance is going to be of use for investors, we need to know whether past performance (good or bad) is linked to future performance (good or bad). If there is a link then this information can assist investors to make better investment choices as to “performance persistence”. If there is no link between past performance and future performance in a statistical sense, then knowledge of past performance will not help an investor in choosing a likely high performance fund or in avoiding a probable below-average performer by studying the three to five (3 to 5) years Ranking Summaries (see below) that accurately measure this. The issue is made even more complex by the fact that varied results have emerged from studies using similar methodologies or similar benchmarks With the major development of Markowitz (1952) Modern Portfolio Theory (MPT) and Jensen (1968) for his contribution to Strategic Portfolio Construction being the macro Alpha Reward by the Market (Systematic Risk) and via the multi specific process by the Capital Asset Pricing Model (CAPM), it was immediately obvious that the analysis provided a theoretical framework that could be applied to meet the challenges of performance measurement. Treynor (1965), Sharpe (1966), and Jensen (1968) were invention has realised their potential applications by using them as a special feature in MPT and CAPM for investment/portfolio performance evaluation i.e. ACRARRB—(Attribution Pricing Models Selection Process Analysis System/Capital Asset Pricing Models (APMSPAS/CAPM)(T1) (T2)(T3) see Page 57-109, (i.e. Conditional—Efficiency Ratio Selection Process Analysis—ERSPA(T3) see Page 97, or of (i.e. Unconditional—Top Quartile Strike Rates Election Process Analysis (TQSRSPA)(T3) see Page 99 accordingly to their respective Strongest Aggregate Score/Factor Evaluation Model/Core Spectrum/Risk/Return Opportunities Approach (SAS/FEM/CS/R/ROA(T2) see Page 80, Ranking Summary/Multi-Brand Fund Managers/Direct Shares Opportunities/Selection Process Analysis (RS/MB/FM/DSO/SPA) (T3) see Page 104. Micro/Macro/Knowledge Gap Feedback Methodology/Core Selection/Back Testing/Track Error (M/M/KGFM/CS/BT/TE (T2) see Page 84.

### Part A:—Attribution Pricing Model Selection Process Analysis System and Capital Asset Pricing Models (APMSPAS & CAPM'S)

### Absolute Concentration Risk Adjusted Return Relative Benchmark (ACRARRB)

The system 12 provides a set of systematic building blocks with flexible techniques and Capital Asset Pricing Models (CAPM) that introduce greater micro and macro benchmarking recognition for converting analysis into forecasts. The system 12 separates out various management performance components, such as Alpha, from various market multiple components, such as Beta, which tend to finish up making an optimized position. The aim is to seek Alpha driven solutions therefore giving the CAPM of Tier 2 the opportunity to perform multi-structured selection process represented by a statistical verification system with alternative back testing mechanism in analysing the Universal Comparison Information for skill driven traditional managed funds which consists of the best of a breed highest/strongest aggregate score in each asset class. As a result of this core spectrum selection technique, that represents a concentrated streamlined analysis with the superior arithmetic/geometric algorithm software, hugely improves the risk and return estimates through quantitative and qualitative capital asset pricing factor concentration models APMSPAS/CAPM (Tier 1, Tier 2, and Tier 3), that create good intrinsic value opportunities for out-performances and low volatility.

The system 12 is driven by the goals of successful investing that takes the positions on securities that exhibit discrepancies between observed prices and fundamental values. For example, academic analysis calls these discrepancies of the Fund Managers/Direct Share Opportunities “market anomalies”. The system 12 asks if they are real, or a mirage produced by a lack of understanding of the forces that drive the prices, by assessing purity of valuation which, in essence, is formulated by:
1. Historical Evaluation
2. Forward Evaluation; and
3. Attribution Symmetry.

This makes for an exceptional risk and return adjustment system that facilitates active management of an investment portfolio. That is, a portfolio where absolute risk adjusted return strategy is measured against relative benchmarks to finish up with an efficient Alpha/Beta portfolio selection. Thus, the system 12 can detect any increased exposure to markets or active management decision will be based on where the excess returns per unit of risk or information ratio/beta are most likely to occur.

Given the above considerations, the only way to achieve the purity of a proper full core spectrum Risk and Return investment analysis, which is capable of hacking the Universal Comparison Information that can construct an appropriate portfolio selection, is to begin to build the Hardware that will ultimately drives the Software. That is, what the Core Spectrum Factor Metrics consisting of:
1. Core Spectrum Symmetry of Distribution Factor Metrics (Hardware); and
2. Capital Asset Pricing Models Factor Metrics (Software).

Therefore, the processes performed in Tier 1 achieve that purity of a proper full core spectrum Risk and Return investment analysis which is capable of hacking the Universal Comparison Information that can construct an appropriate portfolio selection.

Furthermore, Tier 1 specifically houses the key Arithmetic, Geographic, Algorithm, Hardware, and Software System inputs that bring into play their efficiently driven components across the universe at large that link the drivers of Tier 2 and Tier 3.

Tiers 2 and 3 produce various factor concentration models for offering possible technical support. The higher the excess return per unit of risk, the greater will be the consistency of added value. Core Spectrum Capital Asset Pricing Model Factor Metrics (i.e. APMSPAS/CAPMs (T1-Primary) (T2-Secondary) (T3-Tertiary)) being the total attribution, or the market multiples score, has the ability to punctuate the financial equilibrium discrepancies between observed prices and fundamental values, by either accelerating, initiating or predicting their fair valuation after the mentioned Capital Asset Pricing Models.

The aim of this unique smart all-in-one systematic building blocks flexible technique process is to seek alpha driven solutions, hence this gives it the opportunity to perform streamline analysis through seventeen (17) capital asset pricing models with the superior arithmetic/geometric algorithm software being the key to the various market multiples components tends to make an optimise selection position.

### Tier 1: Primary Norminalisation Statistical Verification System (Arithmetic Algorithms Hardware/Software System)

### Attribution Pricing Models Selection Process Analysis System/Primary Capital Asset Pricing Models (APMSPAS/PCAPM) (T1)

With reference to FIGS. 27 and 28, the best risk reward opportunities possible are represented by Efficient Frontier Selections by diversifying into new asset classes or sectors that have a low correlation with existing asset classes selected benchmark. Therefore, the only way to achieve the purity of a proper full core spectrum Risk and Return investment analysis which is capable of hacking the Universal Comparison Information that can construct an appropriate portfolio selection is to begin to build the hardware that will ultimately drive the software for this invention component. Therefore, the APMSPAS/PCAPM (T1) acts as a collective agent which achieves the purity of a proper full core spectrum Risk and Return investment analysis which is capable of hacking the Universal Comparison Information that can construct an appropriate portfolio selection. Furthermore, the APMSPAS/PCAPM (T1) specifically houses the key Arithmetic/Geographic/Algorithm/Hardware/Software System inputs that bring into play their efficiently driven components across the Universal Comparison Information at large that link the drivers of Tier 2 and Tier 3 that produce their various factor concentration models framework for offering possible technical support. However, in association with the all important provider of the purity of a proper full core spectrum Risk and Return investment analysis which is capable of hacking the Universal Comparison Information that can construct an appropriate multi-solution to problems solving for portfolio selection.

Altogether, the APMSPAS/PCAPM (T1) system represents Micro/Macro Behavioural Structured Software Models selection processes for Total Attribution Technique with these components are vital in meeting the multi needs and requirements of the financial planner, which therefore makes the Tier 3 approach a correlation with the supreme technique. Thus, the system 12 can be used to make sound economic financial decisions based on rewarded for risk equilibrium. That is, Efficient Market Hypothesis (Supply and Demand) rather than making Behavioural Financial (Emotional Decision) thus being able to detect any increased exposure to markets or active management decision will be based on where the excess returns per unit of risk or information ratio/beta are most likely to occur. The higher the excess return per unit of risk, the greater will be the consistency of added value, to finish up with an efficient Alpha/Beta portfolio that takes out second guessing.

Therefore to begin with, the APMSPAS/PCAPM (T1), being the Primary/Normalisation Statistical Verification System instrument for managing risk and return by matching investment opportunities to an individual's investment profile correlation qualities, in relation to the associated “Attribution Symmetry” factors which ultimately result in the reported core full spectrum, requires the APMSPAS/PCAPM (T1), acting on behalf of each of the following pricing models:
1. Systematic Building Blocks Flexibility Technique (SBBFT (T1));
2. Historical Evaluation Mean Variance(Quantitative)/Forward Evaluation Fundamental Research (Qualitative)/Attribution Symmetry Format Analysis(HEMV(Q)/FEFR(Q)/ASFA(T1)); and
3. Historical Evaluations/Forward Evaluations/Attribution Symmetry (HE/FE/AS(T1))

The best risk/reward opportunities possible are represented by a norminalisation statistical verification system which in essence is achieved by the APMSPAS/PCAPM (T1). Therefore the only way to achieve that proper purity of a full core spectrum Risk and Return investment analysis which is capable of hacking the universe for a pedigree selection to construct an appropriate portfolio selection is to begin to build the hardware (i.e. SBBFT (T1)) whereby the systematic building blocks market risk and return exposure sensitivity is captured by symmetry of distribution. Therefore, this unique Arithmetic Algorithms Software System on autopilot, that is, the HEMV(Q)/FEFR(Q)/AS(FA) (T1) that is responsible attribution symmetry can deliver Alpha returns with a much lower overall risk correlation, can't be changed, will ultimately drive the software for this invention component represents the heart of this very logic, being a collective agent under this invention achieves that purity market multiple selection process knows how to select pedigree investments by looking behind the Fund Managed/Direct Share Opportunities (FM/DSO). Furthermore, the HE/FE/AS (T1) analysis which is capable of hacking the universe through the flexible technique by information arbitrage that can construct an appropriate portfolio selection, by diversifying across boundaries into new asset classes or sectors that has a low correlation with existing asset classes selected benchmark.

### 1. Systematic Building Blocks Flexibility Technique (SBBFT (T1))

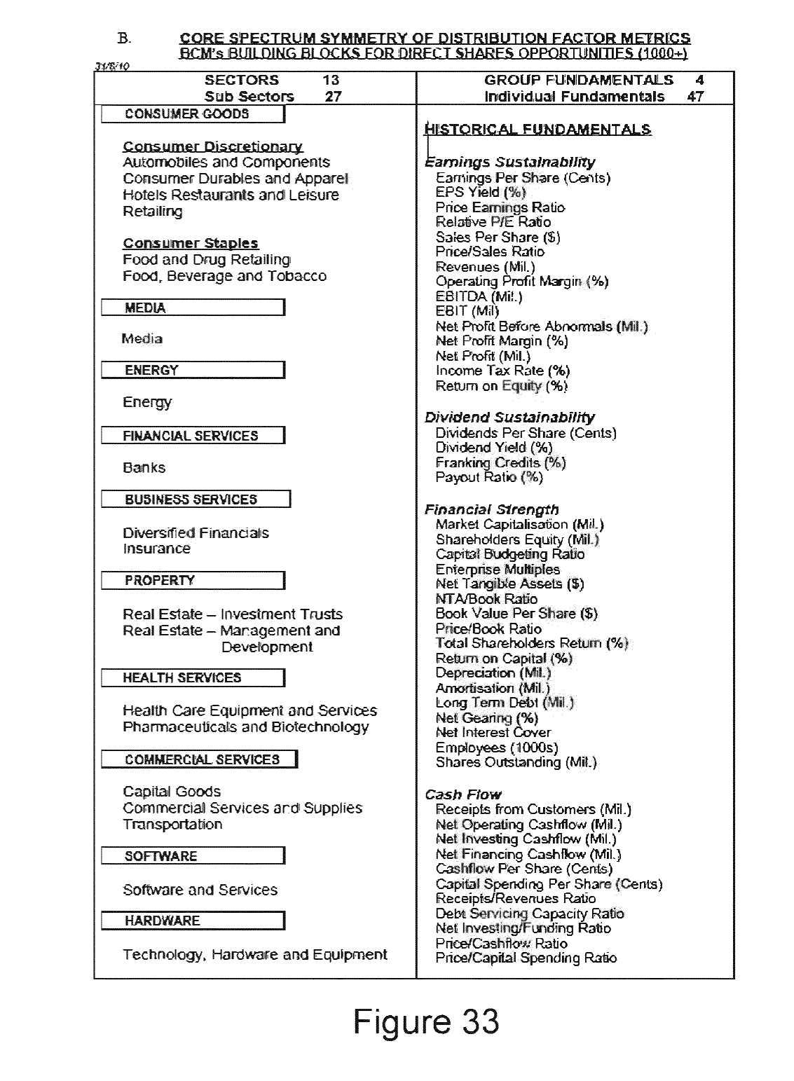

The importance of systematic building blocks, such as those shown in FIGS. 32 and 33, in SBBFT (T1) is that it unbundles the assets into asset classes and sub-sectors. Using this, the SBBFT (T1) provides a technique for extracting Alpha. Subsequently the SBBFT (T1) offers a good practice method for acquiring Core Spectrum Symmetry of Distribution Factor Metrics which means absolute concentrated risk adjusted return relative benchmark. For example, this is covered by the following Data Points:
a. All Risk;
b. All Performance (Blend, Growth, Value);
c. All Mean Variance;
d. All Fundamental;
e. All Asset Class;
f. All Sectors;
g. All Historical Evaluation;
h. All Forward Evaluation;
i. All Quantitative;
j. All Qualitative;
k. All Micro;
l. All Macro;
m. All Economists Consensus;
n. All Rotational Asset Class;
o. All Retraceable Asset Allocation;
p. All Ranking Increase Decrease Risk and Return;
q. All Investor Style Type;
r. All Time Series;
s. All Scenario Outcomes; and
t. All Efficient Frontier.

As a result this makes the SBBFT (T1) building blocks more capable of hacking the Universal Comparison Information for active risk management skills that can construct full core spectrum risk/return purity for portfolio selection. Therefore the SBBFT (T1) micro normalisation multi-filter hardware system that manages a core spectrum risk/return for portfolio selection and a systematic portfolio structured optimisation that provides an implied capital protection mandate for clients/members portfolio optimisation that acts as compliance management plan.

By designing with SBBFT (T1), the financial planner is aiming to provide constant returns, no matter what's happening in the market, by trading off volatility against the main market. The ability to use the basic building blocks to select the pedigree investments solutions increases the flexibility of financial planer and increases the possibility of tailoring the portfolio exactly to the needs of the investor.

The SBBFT (T1) comes in the form of statistical data and other indicators used by professionals to gauge the markets like business sentiments, investment and employment levels and major commodity prices associated with the problem of knowing when to Buy, Sell or Hold.

The Systematic Building Blocks Flexible Technique being one of quantitative/qualitative factor modelling and traditional methods, a sector and sub-sector mechanisms which arranges the FM/DSO/M/S/RS/T/SPA(T3) according to larger and smaller capitalisation that enter and exit the universe at both ends of the market cap spectrum, thus attaining a new level of risk standards by way of flexible techniques. Therefore by careful flexible design techniques that can capture the market risk exposure of beta mean variances/fundamentals, through the systematic building blocks such as the SBBFT (T1) which in turn all the statistical software that measures the sensitivity of those particular security in the portfolio are provided by HEMV(Q)/FEFR(Q)/AS(FA)(T1). While the potential value-add from an investment is more significant, the potential loss from the mispricing of risk is also greater.

Subsequently as a means to verification of the that brings us to the most important part of which is the basis for the SBBFT (T1) modelling apparatus, thus having the scope to illustrate what true investment decision making is all about, because the system 12 provides absolute concentrated risk adjusted return relative benchmark which contains this efficient investment outcomes due to it's self adjusting mechanism or equilibrium approach. As such, the only risk that should be rewarded is the market risk. Exposure to market risk is captured by beta, which measures the sensitivity of returns statistical and all the mean variances/fundamentals on the particular security and the portfolio to market. Therefore, SBBFT (T1) through Alpha Metrics forms into a true superior value accordingly based on an in-built technique of efficient self adjusting structural hardware/software mechanism approach combined with utilising multiple strategies processed through systematic building blocks, that builds solutions for their clients/members in much the same way so as to continuously select the pedigree investments that asset allocate across the relative strength asset classes according to the consistency of the changing times and unpredictable markets which can mean long term assumptions about portfolio risk management and portfolio construction may need to be challenged and new methodologies explored by a new breed of financial planners. Therefore, the system 12, by strategy definition, stands for the purity forecasts of Factor Metric outcomes technique and as a result the system 12 consists of multi structured Building Blocks, such as those shown in FIGS. 32 and 33, that aim to the construct Investment Portfolio based on the traditional approach on relying on populating the selected FM/DSO/M/S/RS/T/SPA (T3) thus spread across the appropriate asset class according to the perceived client's/member's risk profile.

As a result, the SBBFT (T1), consisting of multi structured Building Blocks, aims to construct an investment portfolio based on the traditional approach on relying on populating the selected FM/DSO/M/S/RS/T/SPA(T3) thus spread across the appropriate asset class according to the perceived investor's risk profile thus spans both Part A and Part B. That is, the APMSPAS/CAPMs (T1)(T2)(T3) and the SPOPAS/FCAPM's (T4). Thus, it's unique robust hardware/software quantitative/quantitative dedicated usage construct technique i.e. Core Spectrum Symmetry of Distribution Factor Metrics which means absolute concentrated risk adjusted return relative benchmark.

Few financial planners have a clear investment focus and expertise to rival the superiority which realistically lies in its Structure Hardware/Software For Factor Normalisation i.e APMSPAS/CAPMs (T1)(T2)(T3) of the various market multiples components to be able to hack the universe, no matter what multiples Micro/Macro usage procedure or transmit across structural boundaries for portfolio selection/risk management scenarios with the idea of minimising the market movements.

### 2. Historical Evaluation Mean Variance (Quantitative)/Forward Evaluation Fundamental Research (Qualitative)Attribution Symmetry/Format Analysis (HEMV(Q)/FEFR(Q)/AS(FA) (T1)

The HEMV(Q)/FEFR(Q)/AS(FA) (T1) a selection process that expresses active management tends to focus almost exclusively on the identification of Alpha opportunities. The HEMV(Q)/FEFR(Q)/AS(FA) (T1) explores alternative ways of approaching the concentration factor to achieve the purity of the forecasts through a proper full core spectrum risk and return analysis. However, there is a need to shift emphasis away from the traditional historical definition and think about risk as a combined mean variance, fundamental and optimisation. As a result, through the HEMV(Q)/FEFR(Q)/AS(FA)(T1) attribution symmetry usage, for both Managed Funds and Direct Share Opportunities, is unique in that it creates a bigger picture of Absolute Concentrate Risk Adjusted Return Relative Benchmark.

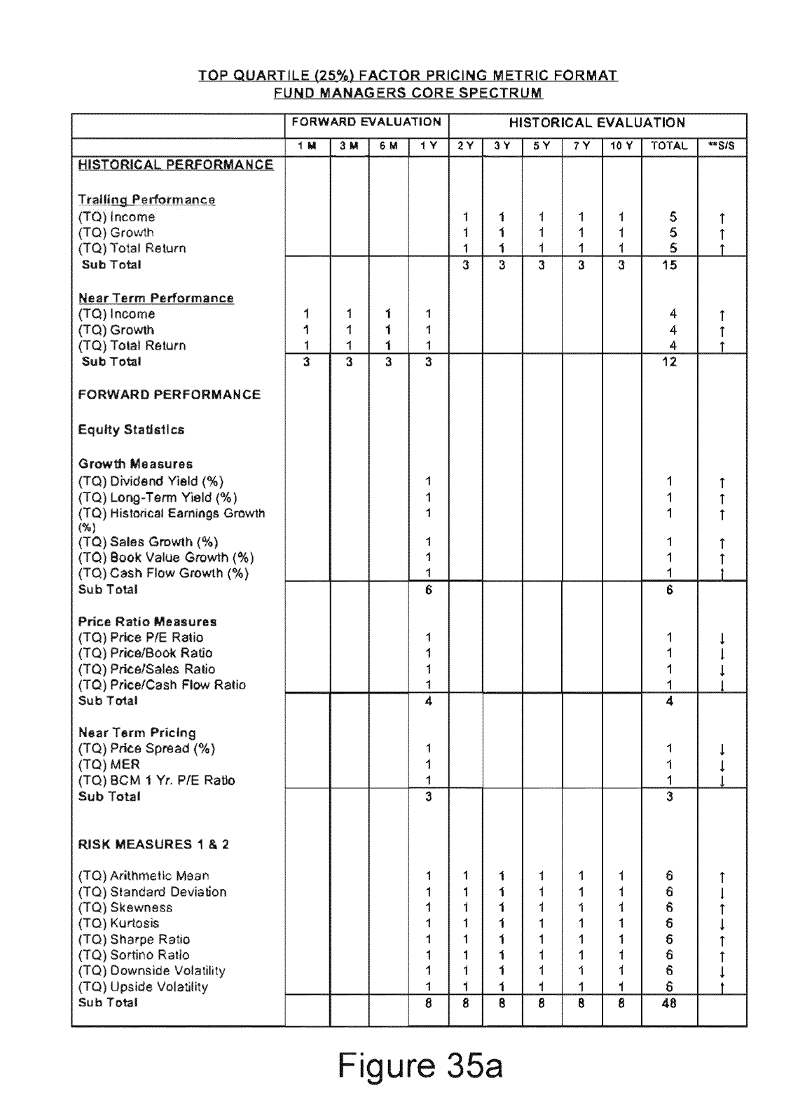

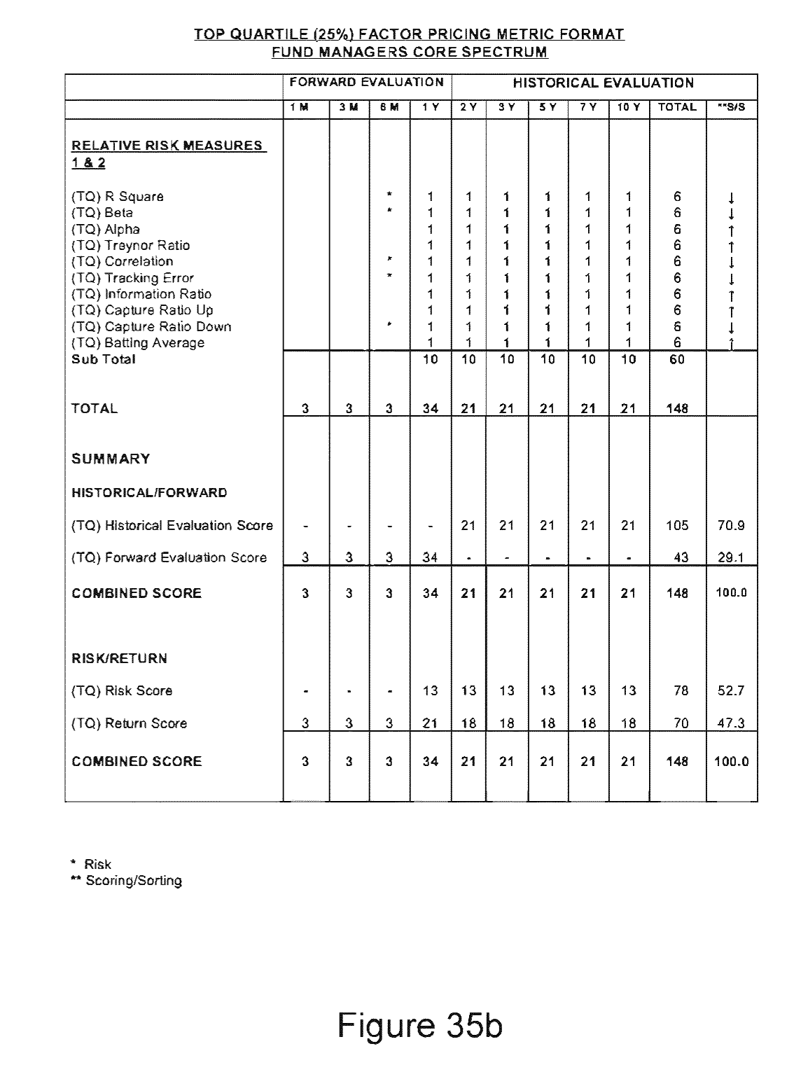

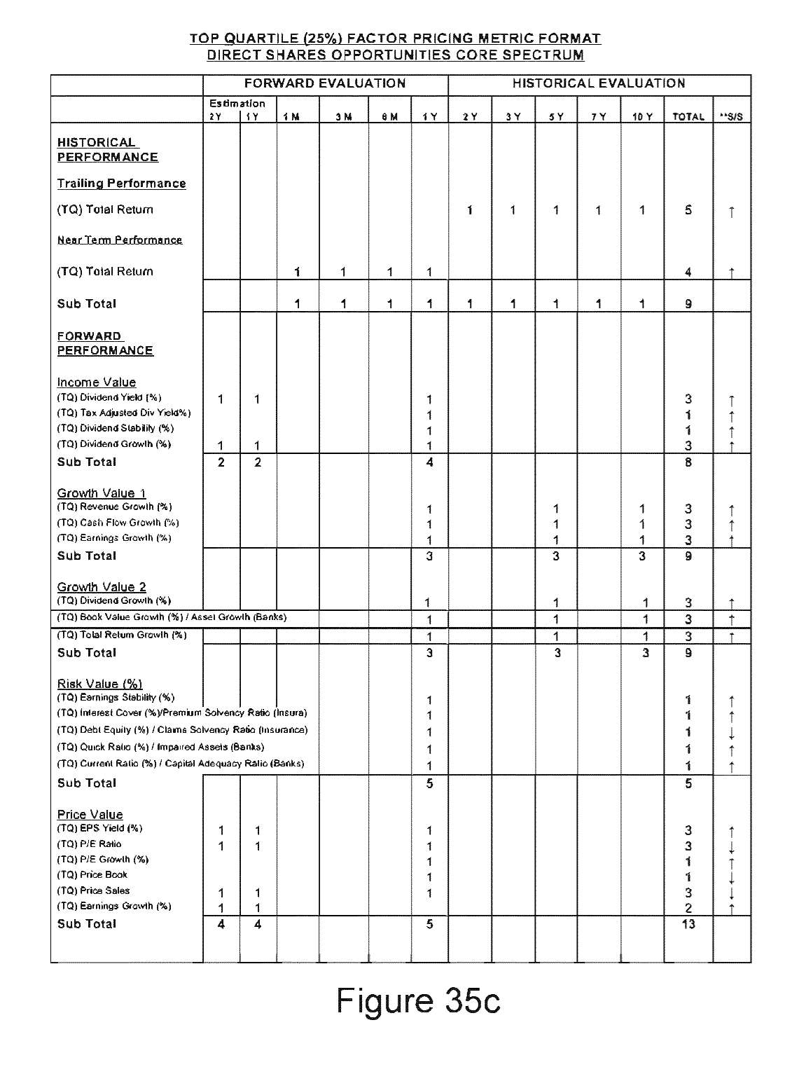

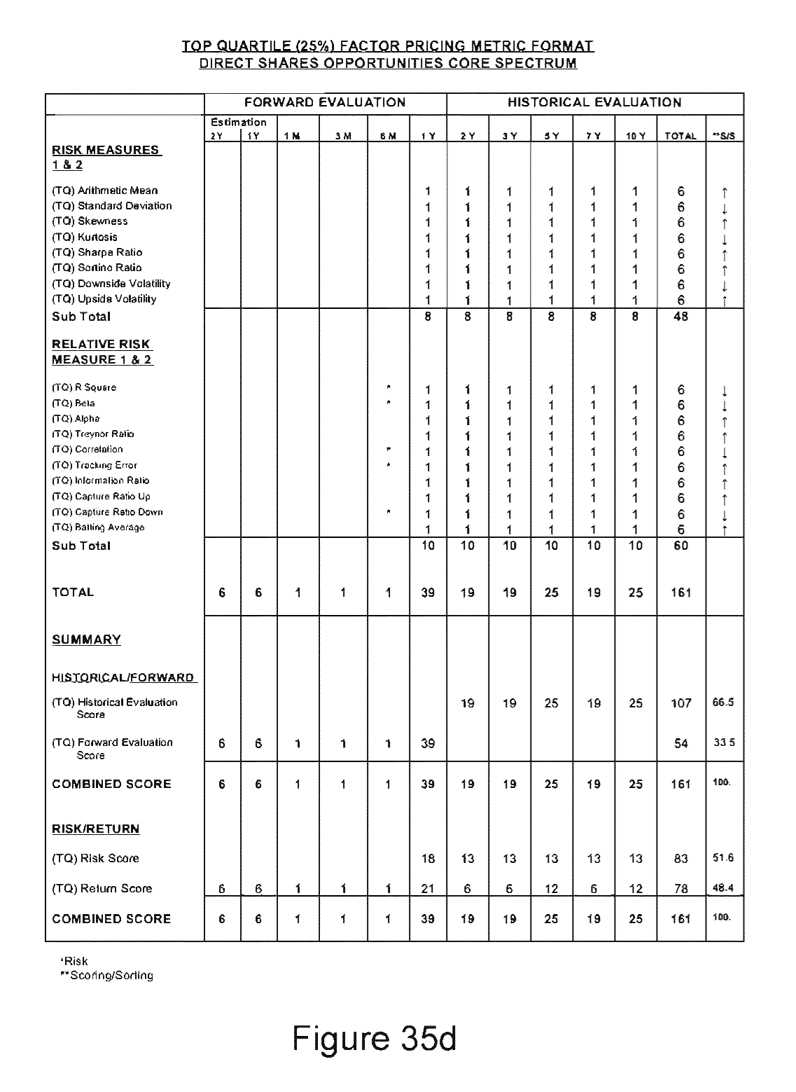

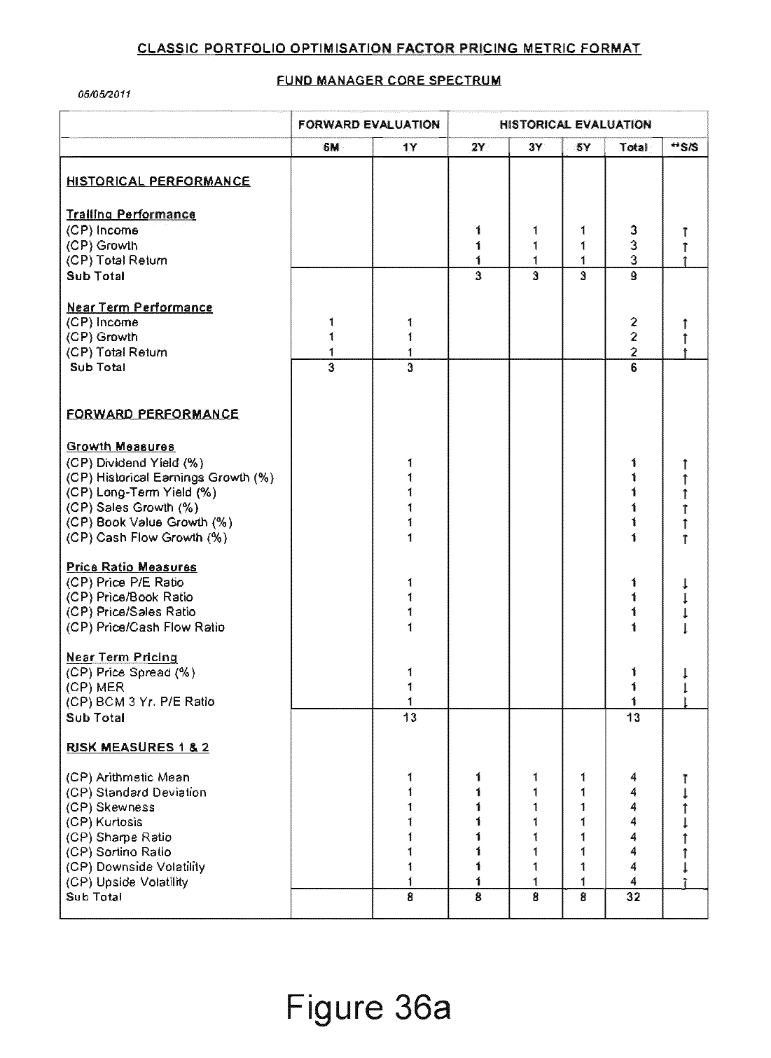

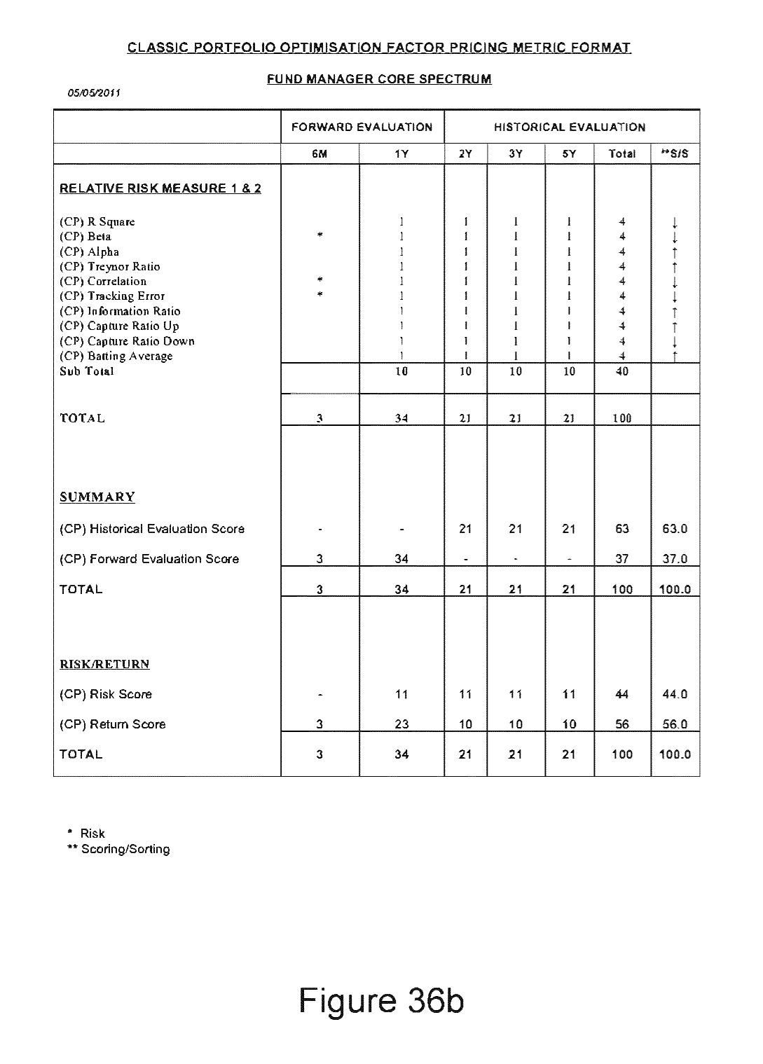

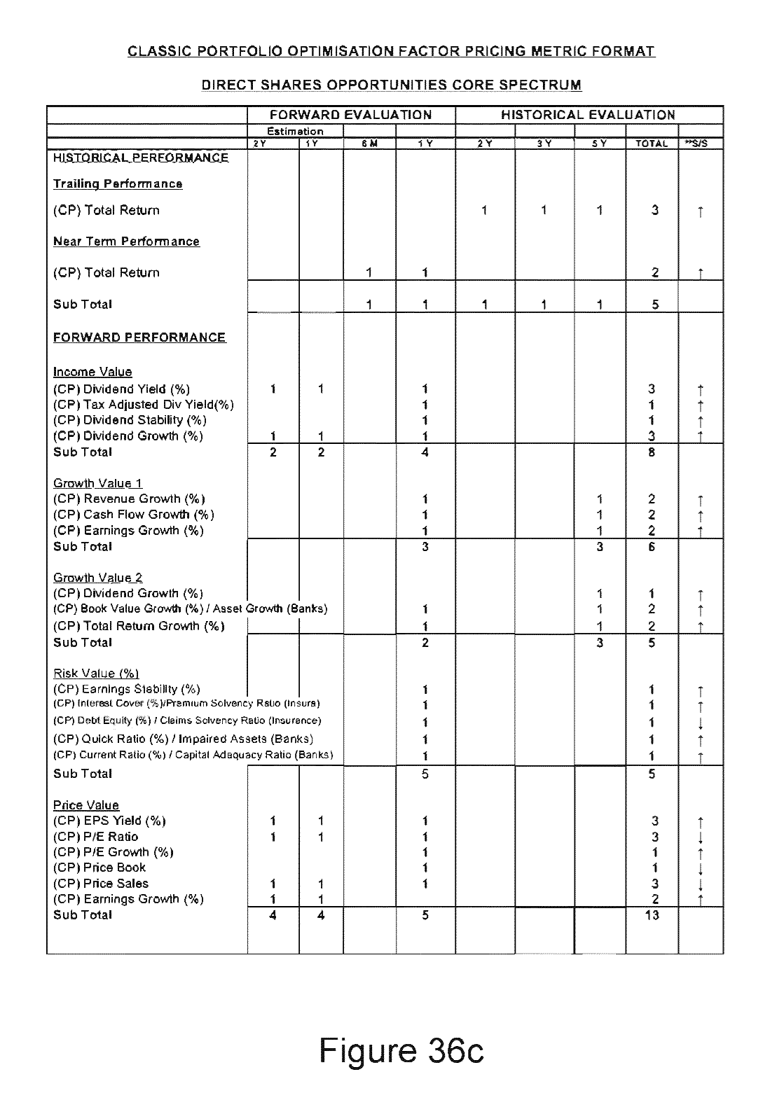

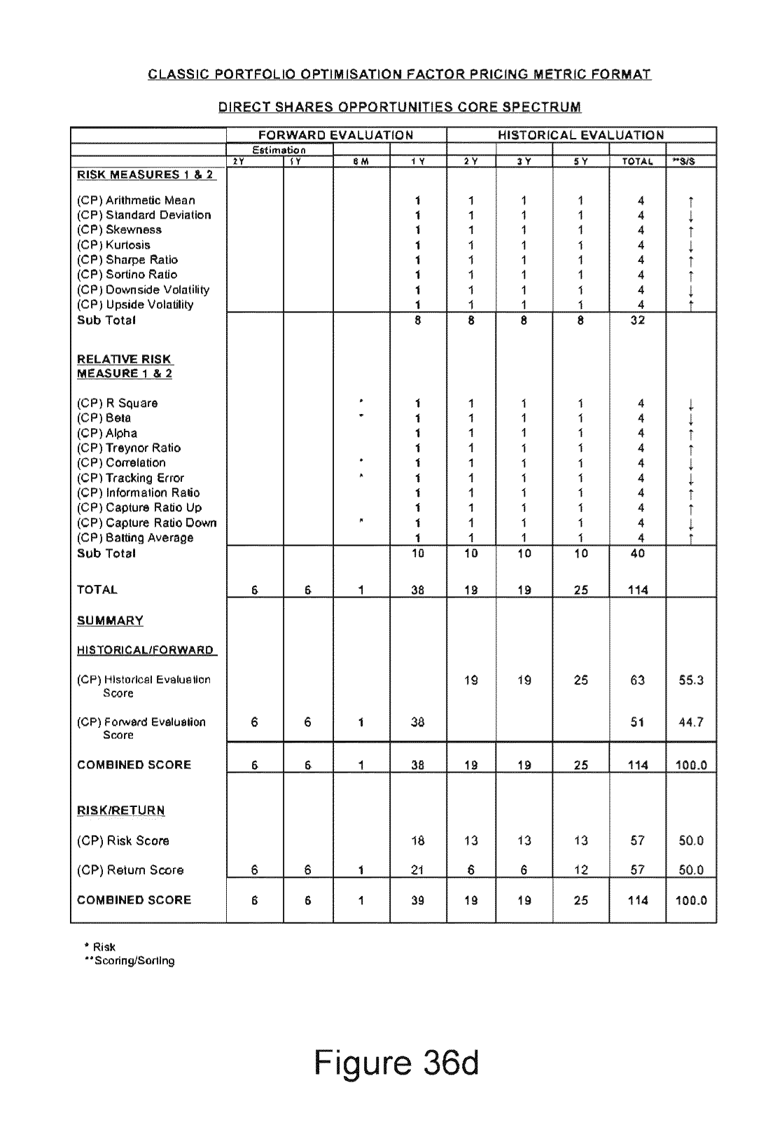

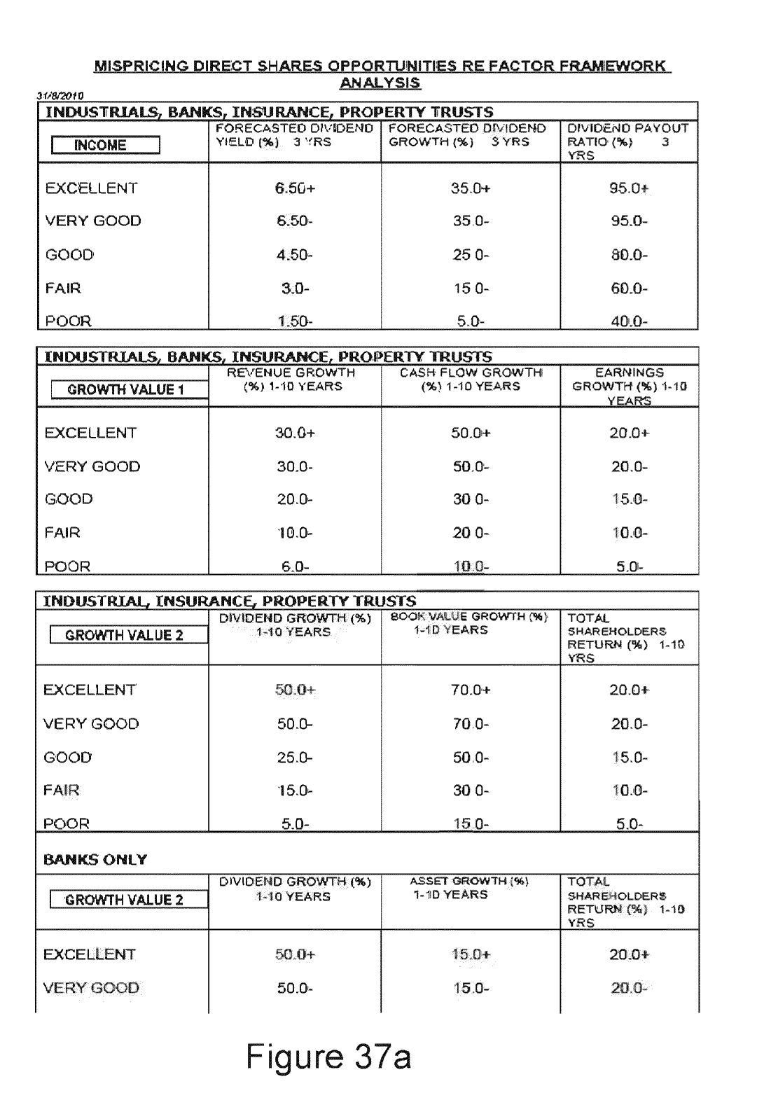

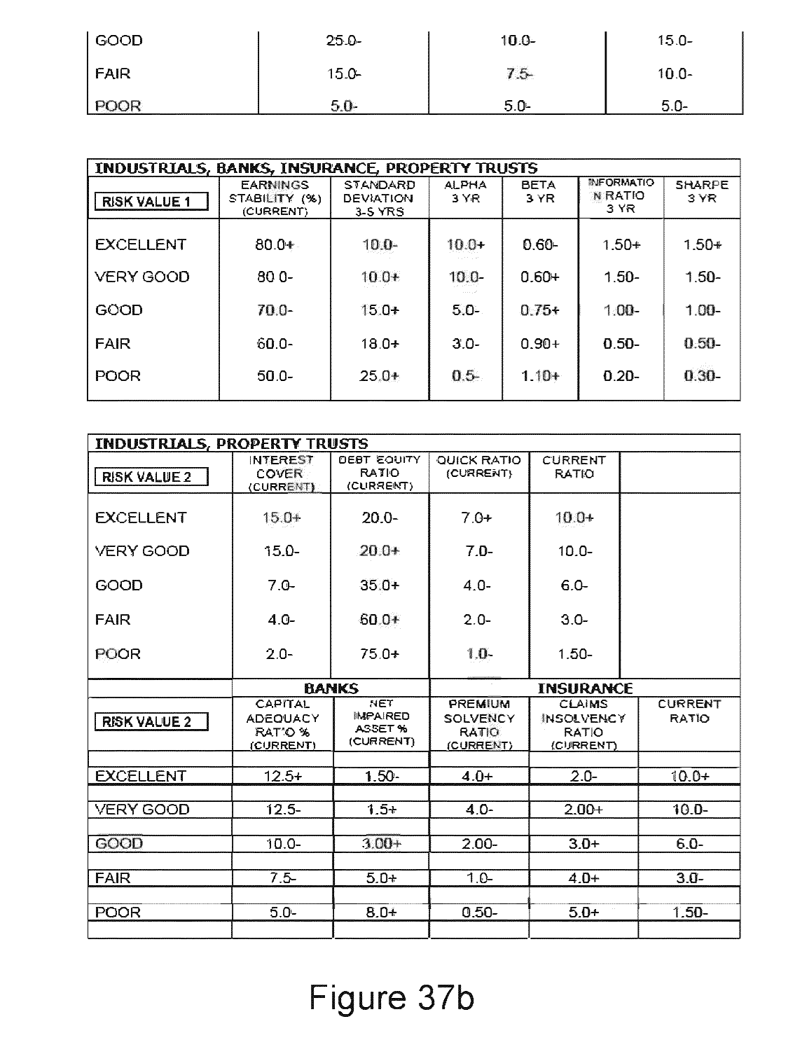

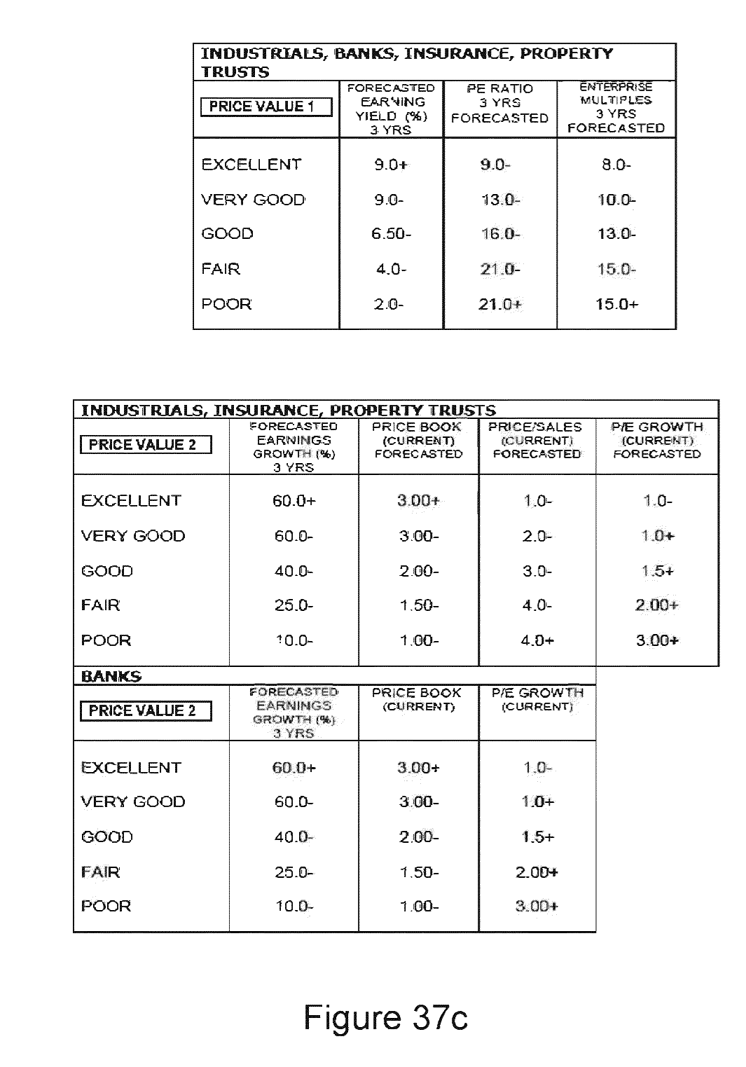

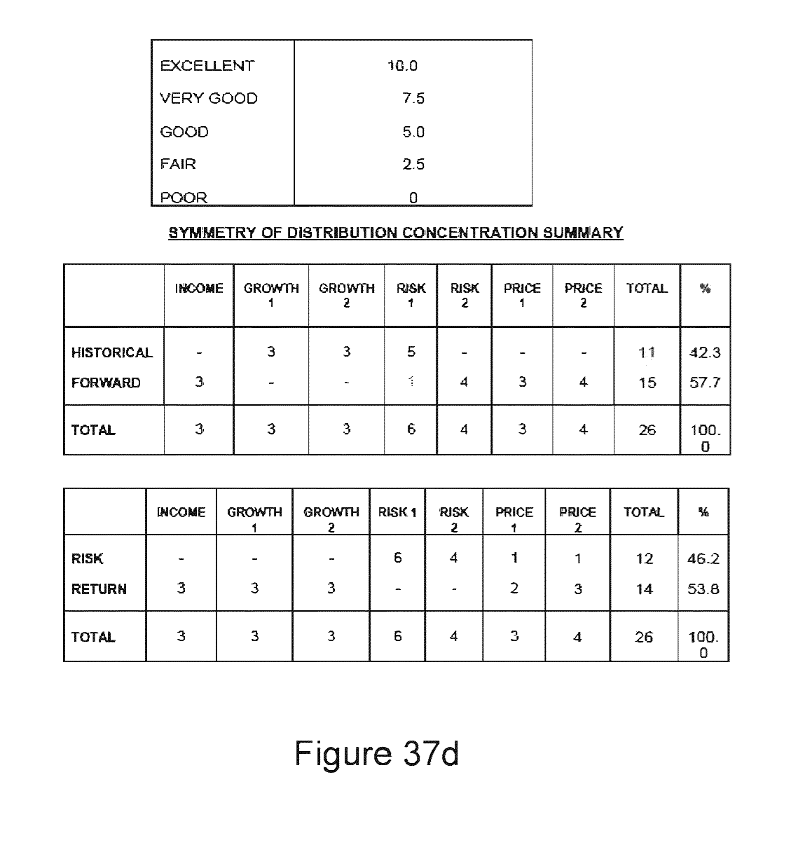

The robust Efficiency Ratio (ER), Top Quartile (TQ), Classic Portfolio Optimisation, and Miss-Pricing (MP) Usability Factor Metrics on which this aspect of the invention is built are set as follows:
1. Unchanged Dependent Factor Pricing Metrics for Fund Managers Efficiency Ratio is shown in FIGS. 34a & 34b;
2. Unchanged Dependent Factor Pricing Metrics for Direct Shares Opportunities Efficiency Ratios is shown in FIGS. 34c & 34d;
3. Changed Independent Factor Pricing Metrics for Fund Managers Top Quartile (TQ) is shown in FIGS. 35a & 35b;
4. Changed Independent Factor Pricing Metrics for Direct Shares Opportunities Top Quartile (TQ) is shown in FIGS. 35c & 35d;
5. Changed Independent Factor Pricing Metrics for Fund Managers Classic portfolio optimisation is shown in FIGS. 36a & 36b; and
6. Changed Independent Factor Pricing Metrics for Direct Shares Classic portfolio optimisation is shown in FIGS. 36c & 36d; and
5. Unchanged Dependent Factor Pricing Metrics for Direct Shares Opportunities Mispricing (MP) is shown in FIGS. 37a to 37d.

The system 12 applies the above-mentioned factor metrics to the Universal Comparison Information for each investment in the system 12 and generates corresponding ranking scores. The financial planner can use the ranking scores to compare investments thereby obviating the need to mine (drill down) through the Universal Comparison data and rely on his or her judgement to select the best investments for a given investment portfolio. The above described factor metrics are used for exemplary purposes only. The specific numbers shown in the drawings can vary depending without departing from the nature of the invention. For example, the numbers can vary in accordance with changes in economic climate from country to country.

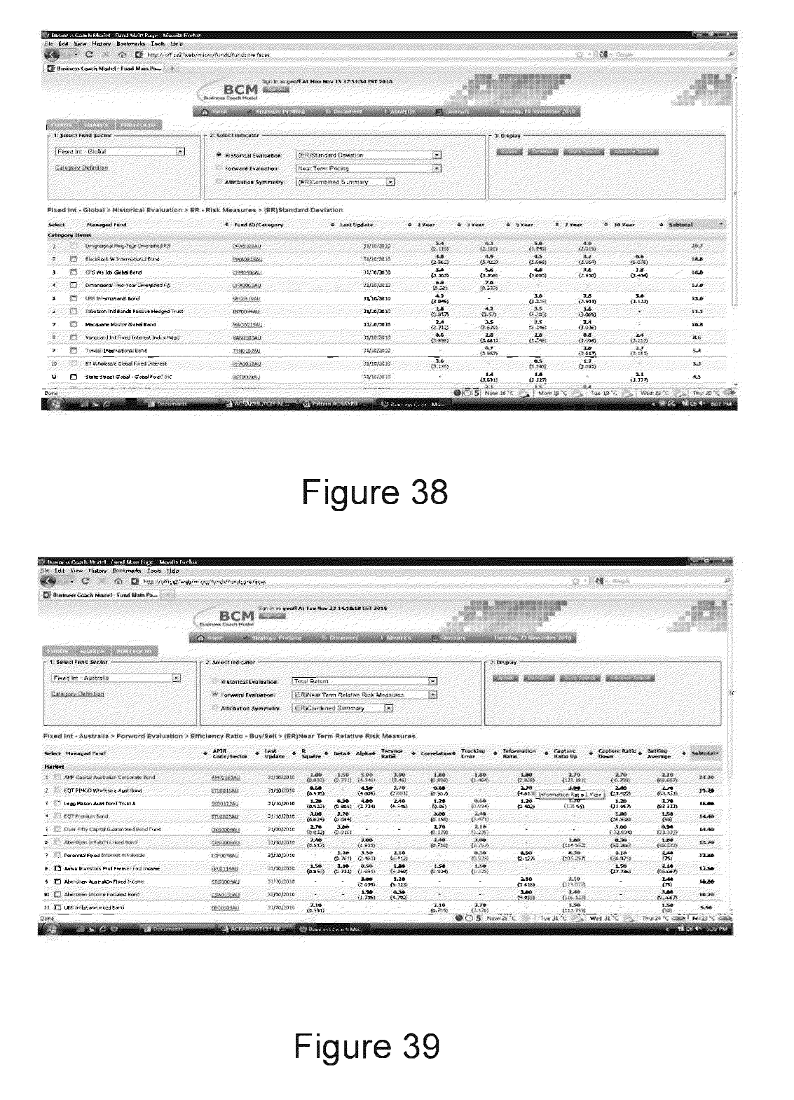

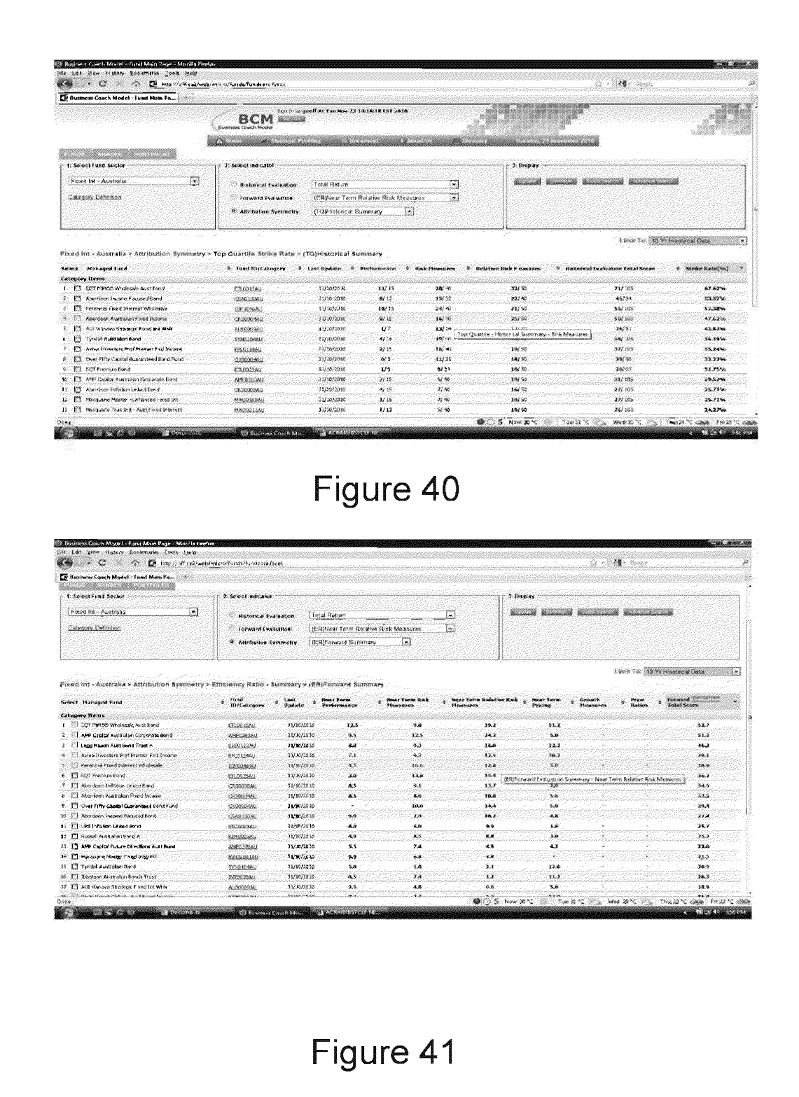

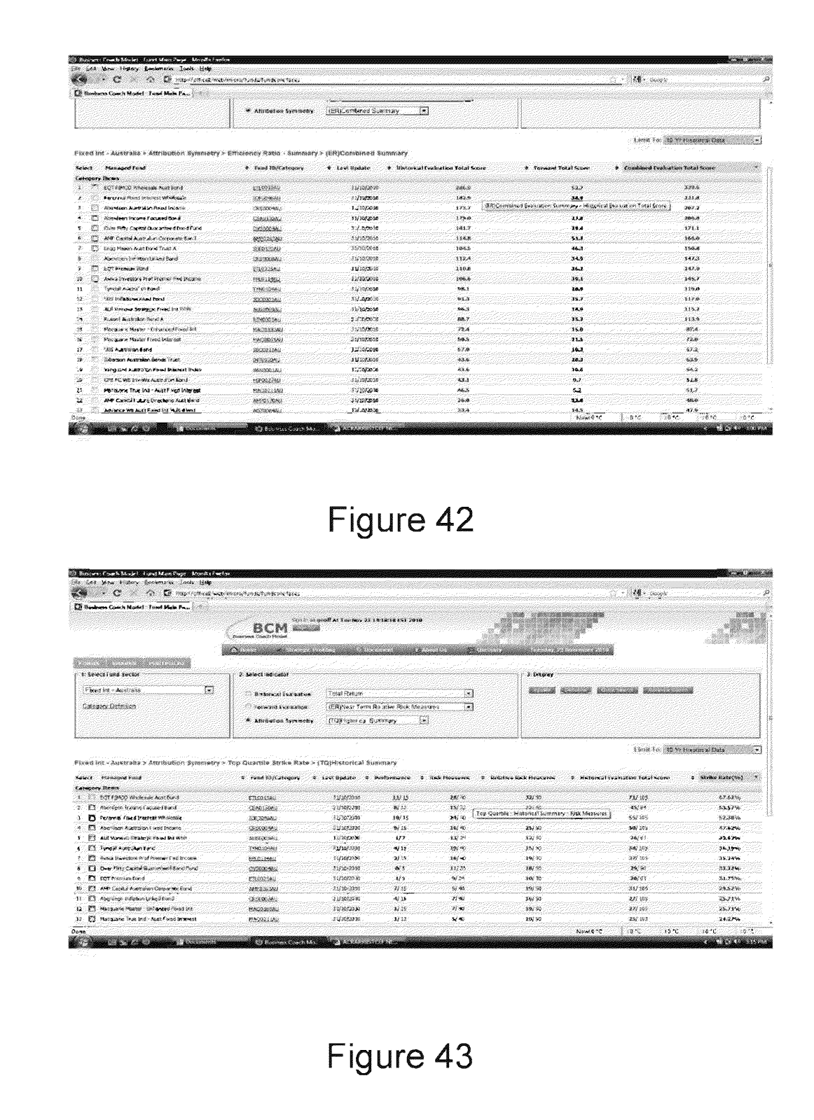

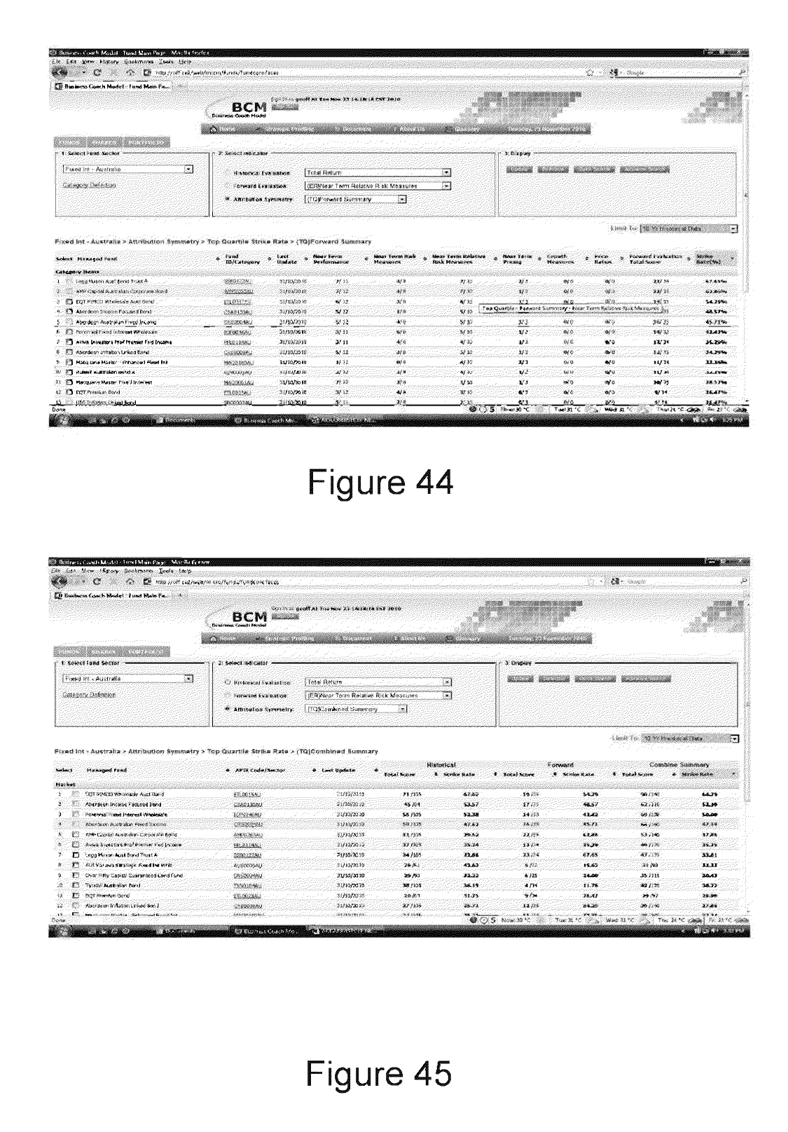

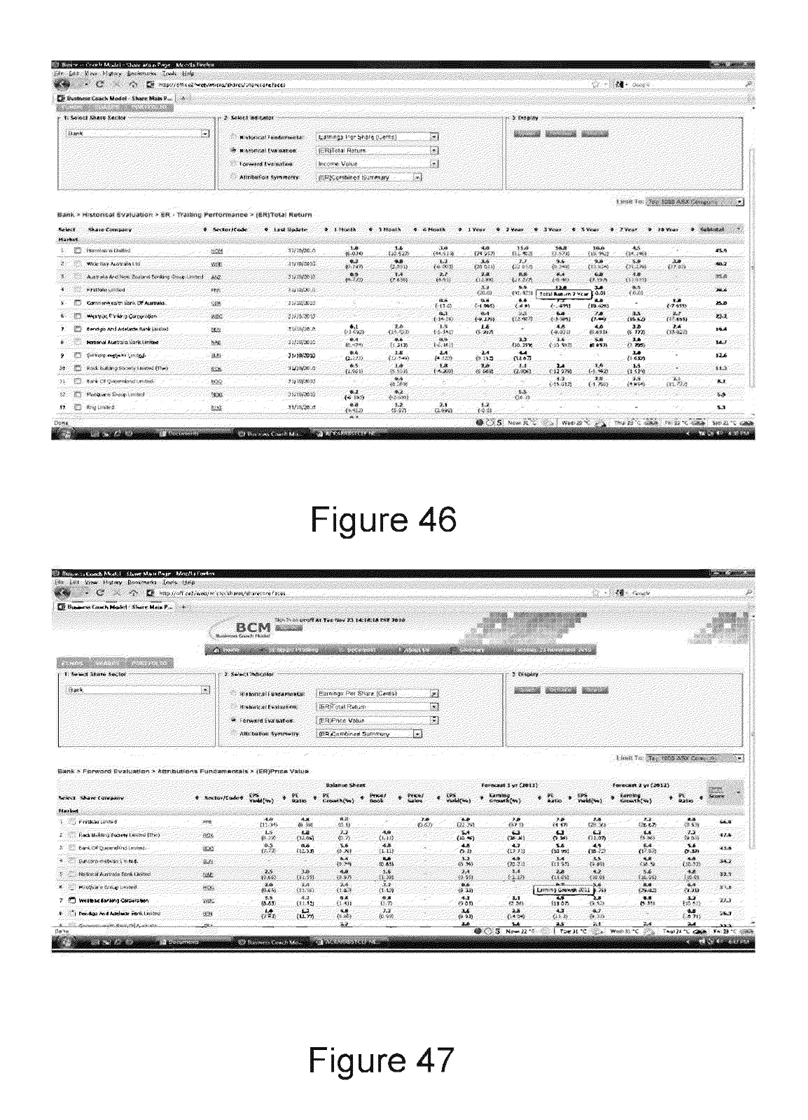

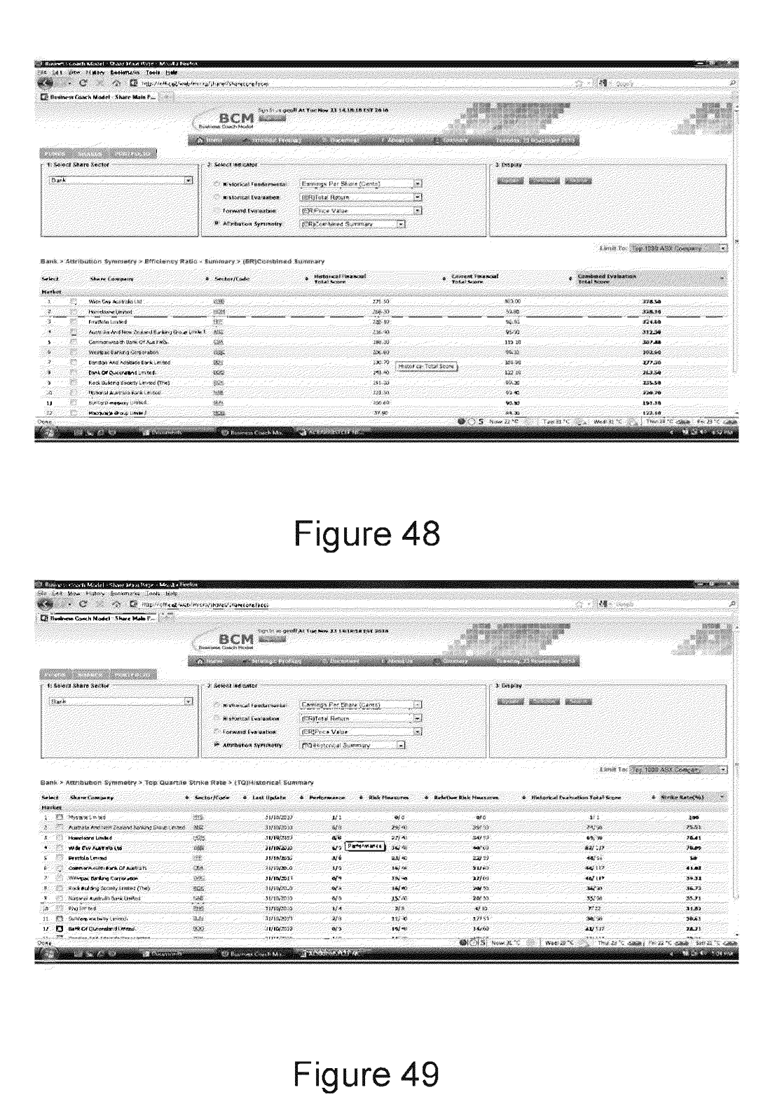

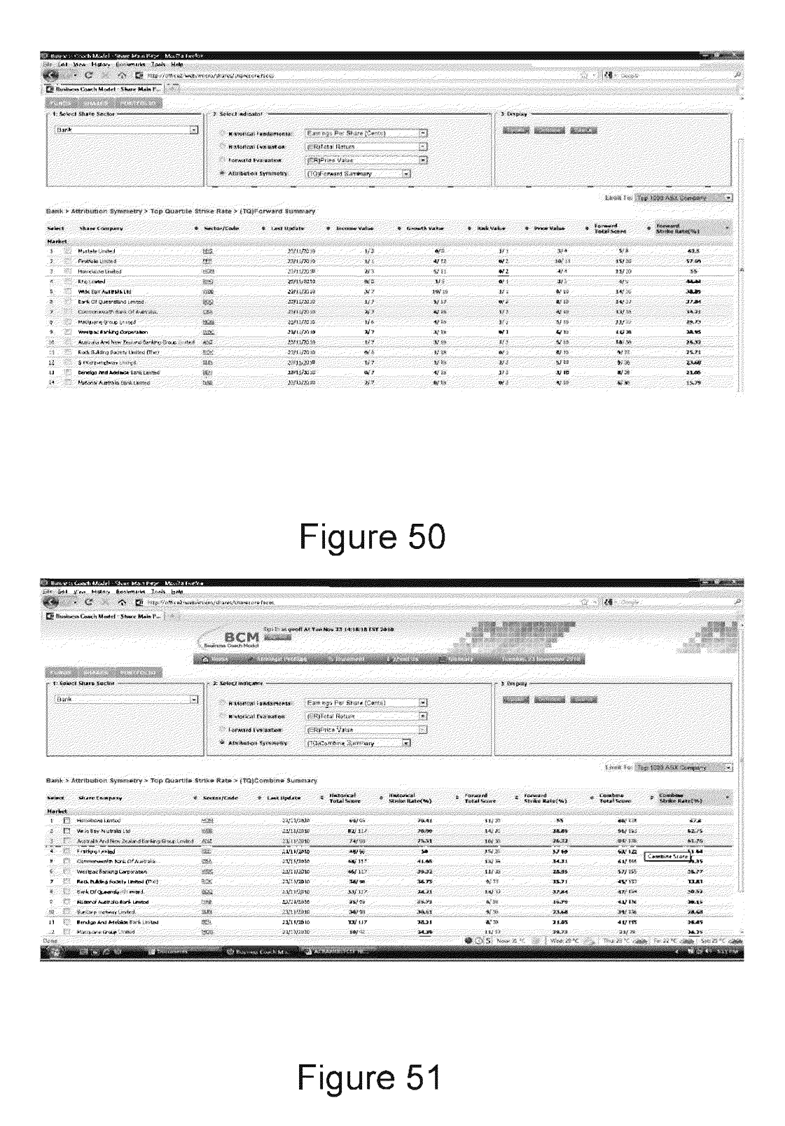

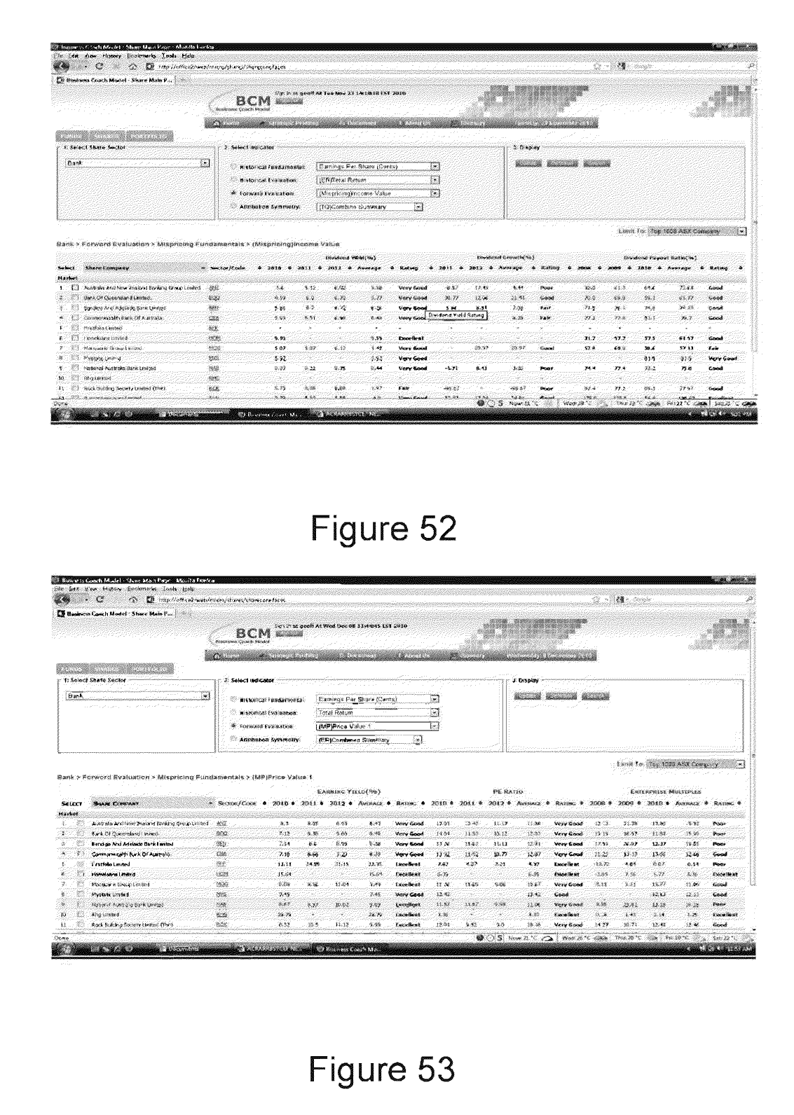

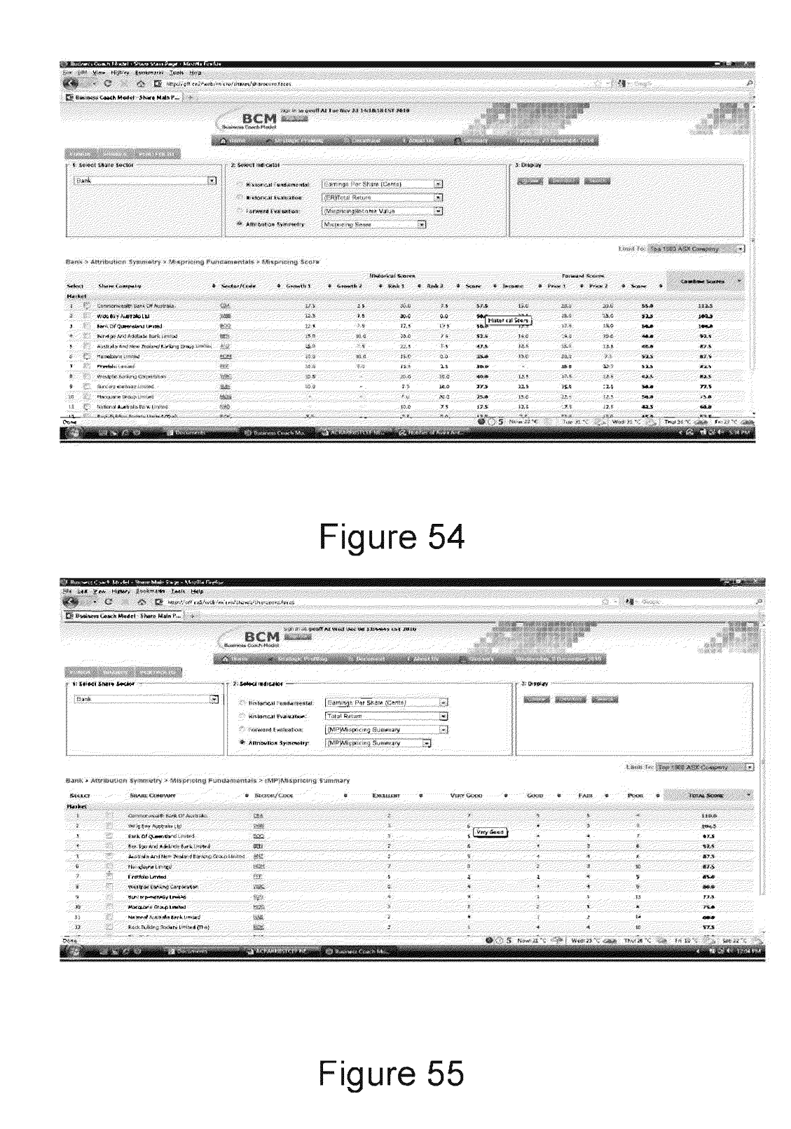

Examples of how the financial planner uses the system 12 to implement HEMV(Q)/FEFR(Q)/AS(FA) (T1) are set out below:
1. Managed Funds:
a. Scoring:
   i. Historical Evaluation, Efficiency Ratio Standard Deviation is shown in FIG. 38; and
   ii. Forward Evaluation, Efficiency Ratio Near Term Relative Risk Measures is shown in FIG. 39;
b. Sorting:
   i. Attribution Symmetry, Efficiency Ratio Historical Summary is shown in FIG. 40;
   ii. Attribution Symmetry, Efficiency Ratio Forward Summary is shown in FIG. 41; and
   iii. Attribution Symmetry, Efficiency Ratio Combined Summary is shown in FIG. 42;
c. Scoring and Sorting:
   i. Attribution Symmetry, Top Quartile Historical Summary is shown in FIG. 43;
   ii. Attribution Symmetry, Top Quartile Forward Summary is shown in FIG. 44; and
   iii. Attribution Symmetry, Top Quartile Combined Summary is shown in FIG. 45; and
2. Direct Shares Opportunities:
a. Scoring:
   i. Historical Evaluation, Efficiency Ratio Total Return is shown in FIG. 46; and
   ii. Forward Evaluation, Efficiency Ratio Price Value is shown in FIG. 47;
b. Sorting:
   i. Attribution Symmetry, Efficiency Ratio Combined Summary is shown in FIG. 48;
   ii. Attribution Symmetry, Top Quartile Historical Summary is shown in FIG. 49;
   iii. Attribution Symmetry, Top Quartile Forward Summary is shown in FIG. 50;
   iv. Attribution Symmetry, Top Quartile Combined Summary is shown in FIG. 51; and
c. Scoring and Sorting:
   i. Forward Evaluation, Mispricing Income Value is shown in FIG. 52;
   ii. Forward Evaluation, Mispricing Price Value 1 is shown in FIG. 53;
   iii. Attribution Symmetry, Mispricing Score is shown in FIG. 54; and
   iv. Attribution Symmetry, Mispricing Score is shown in FIG. 55.

With HEMV(Q)/FEFR(Q)/AS(FA) (T1), the financial planner is able to explores the three major alternative ways of approaching the concentration of diverse full core spectrum approach such as not only the Mean and the Variance but also take into account the Forward Fundamentals(Asset/Liability) that will achieve the Optimality outcome thus makes it a reasonable proxies for premiums for which investors are prepared to pay.

The HEMV(Q)/FEFR(Q)/AS(FA)(T1) uses some of the finest practiced methods for acquiring the Best of a Breed, that the financial planners decision maker could adopt in order to enhance their skills. The HEMV(Q)/FEFR(Q)/AS(FA) (T1) can now explored how the key variables of Attribution Symmetry Metrics (i.e. the Efficiency Ratio Ranking Summary) together with Top Quartile Strike Rate Ranking Summary thus combined with their respective Historical and Forward Summaries, looks behind the Managed Fund and Direct Share Opportunities as to the way they manage money. Likewise as a result of these micro/macro key variables above, there are a strong need for a multi-tasked instruments manufactured by the system 12 that has the ability of managing the new Micro/Macro Global Investment Market yet at the same time can continuously select and manages these markets. However, the HEMV(Q)/FEFR(Q)/AS(FA) (T1) is driven by the goals of successful investing that takes the positions on securities that exhibit discrepancies between observed prices and fundamental values. For example academic analysis call these discrepancies of the “Fund Manager and Direct Share Opportunities market anomalies” and ask if they are real or a mirage hype, produced by a lack of under standing of the forces that drive the prices compared to their purity of valuation. Therefore, the system 12 assists in making sound economic financial decisions based on reward for risk equilibrium. That is, Efficient Market Hypothesis (EMH) (Supply and Demand) rather than making Behavioural Financial (BF) (Emotional Decision). Hence, this underlying investment strategy rationality provided by the system 12 represents not only “The Goal for Successful Investing but also its Broad Investment Risk Management Optimality System Targeted to an Efficient Frontier”. Therefore, accordingly, to build the hardware approach which consists of the Core Spectrum Symmetry of Distribution Factor Metrics such for example, this is covered by the following Data Points:
a. All Risk;
b. All Performance (Blend, Growth, Value);
c. All Mean Variance;
d. All Fundamental;
e. All Asset Class;
f. All Sectors;
g. All Historical Evaluation;
h. All Forward Evaluation;
i. All Quantitative;
j. All Qualitative;
k. All Micro;
l. All Macro;
m. All Economists Consensus;
n. All Rotational Asset Class;
o. All Retraceable Asset Allocation;
p. All Ranking Increase Decrease Risk and Return;
q. All Investor Style Type;
r. All Time Series;
r. All Scenario Outcomes; and
s. All Efficient Frontier.
   being the Systematic Building Blocks i.e. SBBFT (T1).

Subsequently followed by the software support of Core Spectrum, Factor Metrics (i.e. HEMV(Q)/FFER(Q)/AS(FA) (T1)) which in essence is formulated by the process such as the Historical Evaluation/Forward Evaluation/Attribution Summary for which makes it is an exceptional risk and return adjustment system for active management of an absolute risk adjusted return strategy measured against relative benchmarks to finish up with an efficient Alpha and Beta portfolio selection, thus being able to detect any increased exposure to markets or active management decision will be based on where the excess returns per unit of risk or information ratio/beta are most likely to occur. The higher the excess return per unit of risk, the greater will be the consistency of added value, and therefore in recognition that some FM/DSO are more market related than others due to the superior facility such as Core Spectrum Capital Asset Pricing Model Factor Metrics i.e. APMSPAS/CAPM's (T1-Primary) (T2-Secondary) (T3-Tertiary) being the total attribution or the market multiples score of the which has the ability to punctuate the financial equilibrium discrepancies between observed prices and fundamental values, by either accelerating, initiating or predicting their fair valuation of these after mentioned Capital Asset Pricing Models, may not control omnipotence (all powerful, almighty invincible) but at least may spare the pain of putting all your money in an ad hoc information arbitrage system that may go wrong. Therefore, the more you put your investment on “auto pilot”, the less risk that you will crash them. Because a computer driven model is far superior than the human brain in analysing, sorting/scoring and evaluating because of its unlimited capacity in aggregating literally thousands of calculations in a split second.

### 3. Historical Evaluations/Forward Evaluations/Attribution Symmetry (HE/FE/AS) (T1)

The HE/FE/AS (T1) provides the Micro/Macro console information arbitrage facility based on robust symmetry of distribution building blocks hardware i.e. SBBFT (T1) and software HEM V(Q)/FFER(Q)/AS(FA)(T1) that creates a bigger picture of absolute risk adjusted return relative benchmark captured through systematic core spectrum that selects strongest aggregate scoring and sorting and format technique that drives the Efficient Frontier Portfolio Construction.

To facilitate HE/FE/AS (T1), the system 12 provides a Systematic Range of the type Hardware Building Blocks Norminalisation Flexible Techniques, as shown in FIG. 56. Further, the system 12 provides a Systematic Range of the type Software Building Blocks Norminalisation Flexible Techniques, can now explored how the key variables of Attribution Symmetry Metrics (i.e. the Efficiency Ratio Ranking Summary together with Top Quartile Strike Rate Ranking Summary) thus combined with their respective Historical/Forward/Risk/Return Summaries, looks behind the Managed Fund and Direct Share Opportunities as to the way they manage money, as shown in FIG. 57.

The information arbitrage facilitated by HE/FE/AS (T1) provides for greater back-testing benchmarking which overcomes the crude scoring and sorting valuation framework and provides the purity of a proper full core spectrum capable of hacking the Universal Comparison Information. The HE/FE/AS(T1) has the ability to focus on the one on one type case studies that effectively isolates the outcomes is very relevant because it provides implied buy/sell/hold selection, implied compliance protection and implied capital protection

The HE/FE/AS (T1) takes on the characteristics upon which to perform this analysis, being a micro and macro behavioural structured hardware model and for that reason it creates such interesting benchmarks, based on symmetry of distribution of full core spectrum best practices results format. Its uniqueness makes a very important contribution, because everything you want to know about an investment can be revealed about it in the form of mean variances and fundamental evaluation because of the nature of information arbitrage analysis format technique hence the need for a semi-automatic console facility based on individual screen shots. Therefore likewise the HE/FE/AS (T1) by its very nature, being a collective agent thus each pricing model consisting of a set of strategic norminalisation techniques/realistic factors/historical/forward multiples acting as “total plural attribution” thus representing the Tier 1—Norminalisation Statistical Verification System therefore being under the same banner as the SBBFT (T1) and HEMV(Q)/FEFR(Q)/AS(FA) (T1). Therefore, the HE/FE/AS (T1) which makes the information arbitrage a semi-auto operation via a console mechanism makes it a smart all-in-one process that has the multi-task ability of the HEMV(Q)/FEFR(Q)/AS(FA) (T1) to continuously select the pedigree investments solutions. In much the same way the HE/FE/AS (T1) uses an addition console mechanism in preference to the auto-pilot style system, which is connected to the building blocks structure that acts as a information arbitrage for portfolio selection and risk management scenarios with the idea of minimising the market movements of the FM/DSO/M/S/RS/T/SPA (T3) by hedging away from risk in accordance to the APMSPAS/CAPMs (T1)(T2)(T3) reward for risk Capital Asset Pricing Equilibrium Models.

This makes the HE/FE/AS (T1) an exceptional information arbitrage risk adjustment system which works on the principle through scenario back testing that you can make it do what you want, but can't manipulate any market out-performance. However, when FM/DSO gets volatile, through the HE/FE/AS (T1) information arbitrage can provide constant returns, no matter what's happening around you, albeit managing better returns by trading off volatility against the main market. The ability to use the information arbitrage with the basic building blocks to select the pedigree investments solutions increases the flexibility of financial planners and increases the possibility of tailoring the portfolio exactly to the needs of the investor. Therefore, the HE/FE/AS (T1) aims to the construct the investment portfolio based on the information arbitrage approach but relying on traditional approach in populating the selected FM/DSO/M/S/RS/T/SPA (T3) spread across the appropriate asset class according to the perceived investor's risk profile. Therefore, the verification structural technique as structured by APMSPAS/CAPMs (T1)(T2)(T3) takes on the role of counselor/guides aiming to keep the financial planners investment strategies selection on the right course not only in difficult times but at all times. Financial planner ends up with major implications if they don't follow this routine, such as could end up with highly risky asset classes and financial products that fail to deliver in the future.

What the HE/FE/AS(T1) is doing other than creating pedigree by the traditional mean variance/fundamental optimisation method yet at the same time it looks at the need to shift emphasis away from the traditional auto pilot historical definition of just looking at the Strongest Aggregate Score but rather each individual mean variances for each individual products risk/return view point and without thinking about the overall Historical and Fundamentals Evaluations. Thus, the reward for risk is where the matching characteristics between mean variance and fundamentals equate through the HE/FE/AS (T1) information arbitrage mechanism such as “Historical/Forward/Symmetry of Distribution Approach”. In other words, it makes it easier to explain economically how APMSPAS/CAPM(T1)(T2)(T3) is driven by market prices constantly moving in equilibrium, according to Income, Growth and Risk. Hence, Absolute Concentrated Risk Adjusted Return Relative Benchmark (ACRARRB) (the landmark mantra of this invent ion) because it represents not only “The Goal for Successful Investing but also its Broad Investment Risk/Return Management Optimality System Targeted to an Efficient Frontier” being the underlying theme of this invention. In other words, for pedigree product attribution, the only free lunch in investments comes from the APMSPAS/CAPMs (T1)(T2)(T3) called Statistical Verification System technique which in turn establishes the best risk/reward opportunities possible are represented for Efficient Frontier. For instance its unavoidable not to use the HE/FE/AS (T1) as a sort of reference driven modelling by diversifying into new asset classes or sectors that have a low correlation with existing asset classes which are typically the traditional asset classes of equities, fixed interest, property and cash, the efficient frontier can be improved to yield better risk reward opportunities, however the HE/FE/AS(T1) capital protection style while the potential value-add from client's/member's investments is more significant, but the potential loss of not being able to hack the universes myriad of information is only as good as the short term capacity of the human brain therefore from the mispricing point of view, this presents an even greater potential risk.

### Tier 2:—Secondary/Vertical Statistical Verification System (Arithmetic/Geometric Algorithms Software System)

### APMSPAS/Secondary Capital Asset Pricing Model (APMSPAS/SCAPM's) (T2)

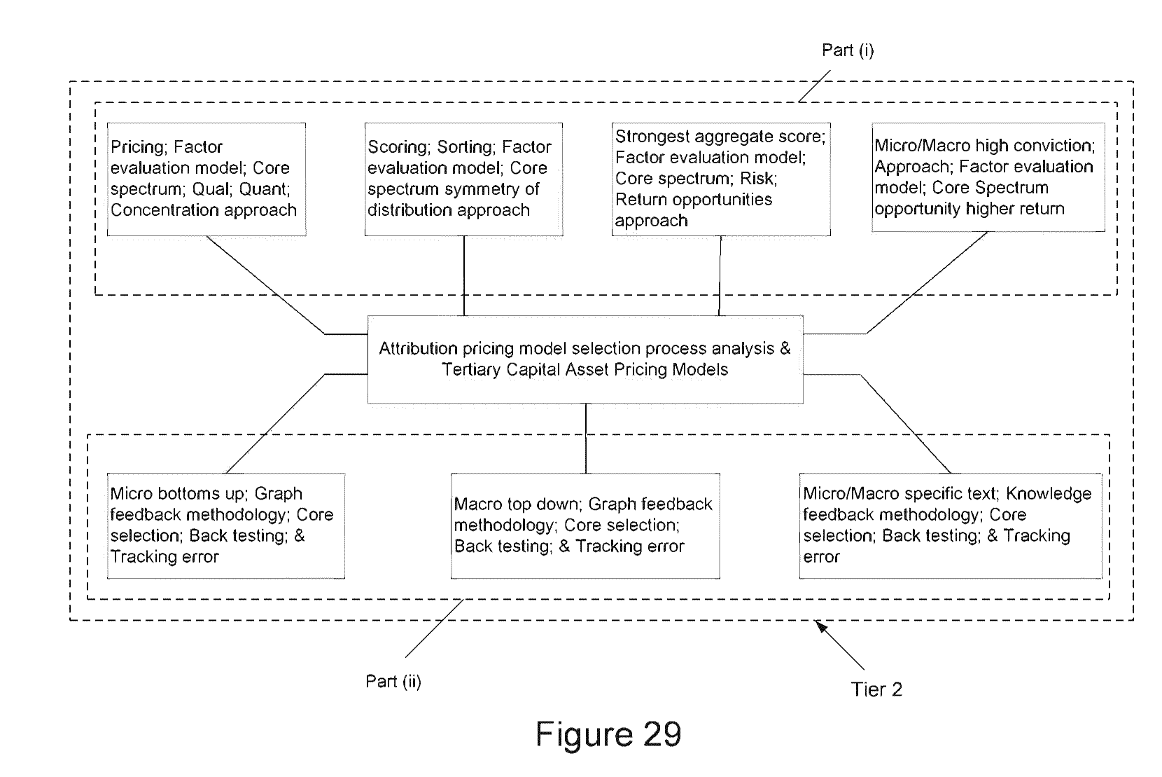

With reference to FIGS. 27 and 29, the APMSPAS/SCAPM's (T2) creates an opportunity to perform a streamline analysis with the superior arithmetic/geometric algorithm software, that provides a complete vertical statistically verification system driven efficiently across the universe thus improving risk and return estimates through condition and restraint factor concentration models that seeks Alpha opportunities. The HEMV(Q)/FEFR(Q)/AS(FA) (T1) extracting Alpha mechanism makes a powerful prediction potential value-add through matching characteristics between historical and mean variance (quantitative)/fundamentals/forward (qualitative)/attribution optimality capital asset pricing factoring modeling that creates reasonable proxies for premiums that investors are willing to pay for it's superiority. By looking at the total attribution symmetry, especially to create a bigger picture should look behind investment that considerably out-performs the average benchmark hence the more concentrated the index/benchmarks being the crux of diversification the more that it drives the AE/FEM/CS/CA (T2) Alpha, that remains true to form in spite of changing times and unpredictable markets. Therefore the M/M/KGFM/CS/BT/TE (T2) captures the micro/macro knowledge gap feedback methodology analysis problem requires new look kits for projecting estimated risk/return into a forecast, such as the must be consistent with a robust strongest aggregate score and knowledge gap back testing tracking error evidence by:
a. systematic building blocks flexibility usage technique for extracting Alpha;
b. attribution symmetry is the core spectrum evaluation model for final Alpha extraction;
c. all research and forward looking statements factored into absolute risk adjusted return relative benchmark;
d. proper quantitative/qualitative factor scoring/sorting models creates superior selection skills
e. pricing factor models technique tends to make concentrated optimise positions
f. attribution symmetry captured through systematic scoring/sorting
g. strongest aggregate score regarded as a reasonable proxy that investors are willing to pay a premium;
h. attribution symmetry can deliver returns with a much lower overall risk correlation;
i. attribution symmetry continuously selects pedigree investments;
j. systematic building blocks flexibility technique for extracting Alpha;
k. attribution symmetry provides implied capital protection;
l. attribution symmetry process consistent with the strongest aggregate score; and
m. specific attribution symmetry offers opportunities for high conviction funds.

As particularly shown in FIG. 29, Tier 2 is divided into the following parts:

### Alpha Extraction/Factor Evaluation Model/Core Spectrum/Concentration Approach (AE/FEM/CS/CA (T2)):

a. Pricing/Factor Evaluation Model/Core Spectrum/Quant/Qual/Concentration Approach (P/FEM/CS/Q/Q/CA (T2));
b. Scoring/Sorting/Factor Evaluation Model/Core Spectrum/Symmetry of Distribution Approach (S/S/FEM/CS/SODA (T2));
c. Strongest Aggregate Score/Factor Evaluation Model/Core Spectrum/Risk/Return Opportunities Approach (SAS/FEM/CS/R/ROA (T2)); and
d. Micro/Macro/High Conviction Approach/Factor Evaluation Model/Core Spectrum/Opportunity Higher Return (M/M/HCA/FEM/CS/OHR (T2)); and
   ii. Micro/Macro/Knowledge Gap Feedback Methodology/Core Selection/Back Testing/Tracking Error (M/M/KGFM/CS/BT/TE (T2)):
a. Micro Bottoms-Up/Graph Feedback Methodology/Core Selection/Back Testing/Tracking Error (MicroBU/GraphFM/CS/BT/TE (T2));
b. Macro/Top Down/Graph Feedback Methodology/Core Selection/Back Testing/Tracking Error (MacroTD/GraphFM/CS/BT/TE (T2)); and
c. Micro/Macro Specific Text/Knowledge Feedback Methodology/Core Selection/BackTesting/TrackingError (M/M/SText/KFM/CS/BT/TE (T2)).

### Part I. Alpha Extraction/Factor Evaluation Model/Core Spectrum/Concentration Approach (AE/FEM/CS/CA (T2))

The AE/FEM/CS/CA (T2) is a full core spectrum models used in conjunction with absolute risk and return provides a guide to future ongoing sustainability. The score is more concentrated which drives the Alpha. The intrinsic value selection technique creates good opportunities for out-performance. The AE/FEM/CS/CA (T2) superiority in systematic instrument continuously extracting Alpha as its main goal for skill tradition provides much higher standard when it comes to analysing the universe because the AE/FEM/CS/CA (T2) understanding Alpha comes in as a myriad of statistics/data/graphs/other indicators solves the problem knowing when to buy, sell and hold. The AE/FEM/CS/CA (T2) knows what it takes to have the systematic building blocks that continuously drives Alpha, but not without some challenges including which valuation methodology of how to properly assess the ways of extracting Alpha. Subsequently, as part of this knowledge gap feed back problem is being able to read the micro and macro symmetry such as the absolute risk adjusted return relative benchmark selection spectrum process is the main embodiment discovery methods driver of the AE/FEM/CS/CA (T2).

Therefore, to fix the knowledge gap analysis problem requires new look kits for projecting estimated risk and return into a forecast. Consequently the AE/FEM/CS/CA (T2) extracting Alpha mechanism that looks at the total Attribution Symmetry through complete Vertical Statistical Verification System driven efficiently across the Universal Comparison Information that seeks Alpha opportunities by improving risk and return estimates through condition and restraint factor concentration models that performs streamline analysis with the superior arithmetic and geometric algorithm software, especially to create a bigger picture makes it a powerful prediction that creates reasonable proxies for premiums that investors are willing to pay for it's superiority. In other words, the AE/FEM/CS/CA (T2) looks behind investments that considerably out-perform the average benchmark then the more concentrated the index/benchmarks being the crux of diversification the more that it drives Alpha. Therefore, the HEMV(Q)/FEFR(Q)/AS(FA) (T1) (i.e. historical/forward/quantitative/qualitative/attribution micro/macro/capital asset pricing factoring models) are the knowledge gap feedback methodology source that potentially value-adds through matching characteristics between mean variance and fundamentals and optimality remains true to form in spite of changing times and unpredictable markets. Hence, the HEMV(Q)/FEFR(Q)/AS(FA) (T1) successful goal is by deriving Alpha expectations that strategically manages investment opportunities for matching risk/return outcomes to clients risk tolerance.

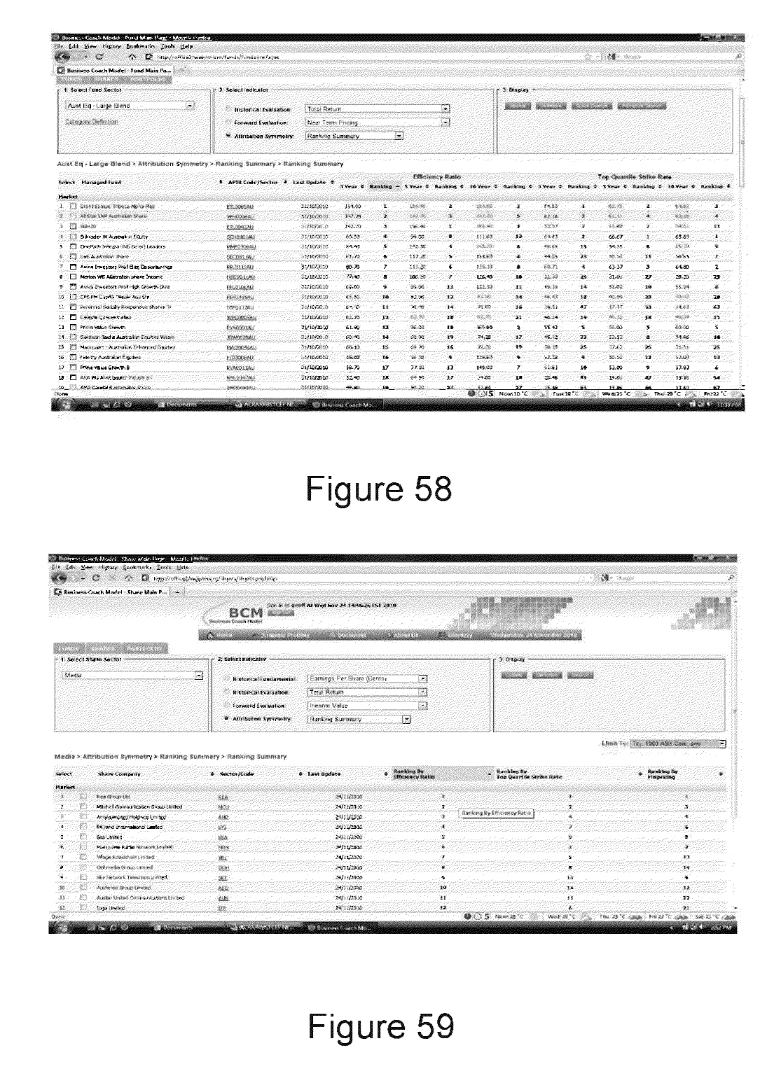

Examples of how the financial planner uses the system 12 to implement AE/FEM/CS/CA (T2) are set out below:
1. Managed Funds:
a. Scoring and sorting—Efficiency Ratio and Top Quartile
   i. Attribution Symmetry, Ranking Summary is shown in FIG. 58; and
2. Direct Shares Opportunities
a. Scoring and sorting—Efficiency Ratio, Top Quartile and Mispricing
   i. Attribution Symmetry, Ranking Summary is shown in FIG. 59.

### 1. Pricing/Factor Evaluation Model/Core Spectrum/Quantitative/Qualitative/Concentration Approach (P/FEM/CS/Q/Q/CA) (T2))

The P/FEM/CS/Q/Q/CA (T2) is one of the finest practice methods for acquiring the best of a breed that financial planner can adopt to enhance his or her skills since factor pricing mechanism increase selection diversification by turning a crude forward estimates into the purity of a forecast. The P/FEM/CS/Q/Q/CA (T2) is a systematic factor pricing models which provides a high standard of usability synergy which has the ability whilst its processing for value add to allow optimisation that generates Alpha ensures reasonable proxies for premiums, because in essence efficient market hypothesis is a product of attribution symmetry where the factor benchmark represents quality concentration of diversity. Consequently, the P/FEM/CS/Q/Q/CA (T2) improves risk and return estimates through quantitative and qualitative factor concentration models generally through top quality pricing metrics being the main goal of the processing system that instantly provides a high standard, which is testamentary to back testing and tracking error is good for minimum and maximum factor concentration modeling approach to pricing. Therefore the P/FEM/CS/Q/Q/CA (T2) appropriate deployment of unchanged task conditionable/dependable (i.e. Efficiency Ratio, Miss-Pricing) and changed task unconditional/independent (i.e. Top Quartile) factor pricing metric system objectives for target scoring approach based on conditional restraints mechanism spread over comprehensive data-base however the case study of task dependant factor pricing valuation system, developed specificity for rapidly valuating efficient Alpha/Beta markets.

Examples of the core spectrum capital asset pricing model factor metrics that are utilized by P/FEM/CS/Q/Q/CA (T2) are shown in FIGS. 32a to 36d.

### 2. Scoring/Sorting/Factor Evaluation Model/Core Spectrum/Symmetry of Distribution Approach (S/S/FEM/CS/SODA (T2))

The S/S/FEM/CS/SODA (T2) factor metric is a task system that regards absolute scoring and sorting as a high priority standard in generating Alpha. It's a study about opportunity for a quantitative (historical) and the qualitative (forward) mix approach thus improving risk/return estimates through factor concentration models which tend to make a optimise positions. Thus, through the S/S/FEM/CS/SODA (T2) systematic factor scoring/sorting models containing proper i.e. best practices quantitative/qualitative, best practices attribution symmetry and combined with the best practices for symmetry of distribution that captures the “sufficient/efficient selection efficient frontier”, creates a superior selection, process that's a valuable knowledge gap feed back that determines which of the products to populate. Therefore, such skills of the S/S/FEM/CS/SODA(T2) scoring/sorting system acts as normalisation approach that under pins a skills driven superiority in analysing innovated techniques to be able to hack the universe for various skills driven efficient alpha/beta pedigree selections.

Furthermore, as an additional endorsement for the actual S/S/FEM/CS/SODA (T2) strategic model portfolio selection implementation is advisable to understand the characteristics of information arbitrage matching facility (i.e. HE/FE/AS (T1)) creates a knowledge gap feedback methodology.

S/S/FEM/CS/SODA (T2) not only creates the traditional mean variance and optimisation method but to think about the asset/liability/fundamental problem, because it surrounded with a proper symmetry of distribution together with historical/fundamental/asset/liability tends to make a superior optimised position. Efficiency Ratio (i.e. ERSPA (T3)) factor models tend to be high extract grade of Alpha whilst Top Quartile (i.e. TQSRSPA(T3)) extracts a reasonable quality grade of Alpha. Multi-ranking systems including:
i. Tier 2—Vertical Statistical Verification System; and
ii. Tier 3—Horizontal Statistical Verification System meets the knowledge gap approach for extracting Alpha.

Factor concentration models still needs another vector type of due diligence that provides the micro/macro back testing/tracking error make it a truly efficient Alpha/Beta portfolio selection.

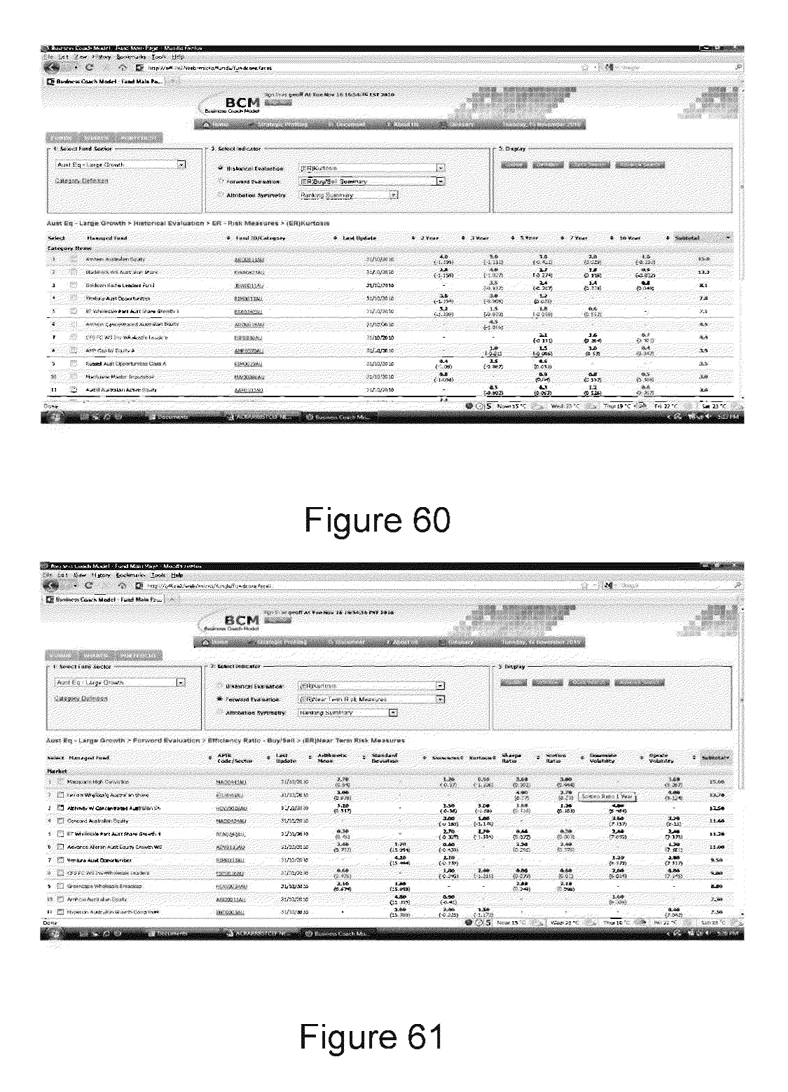

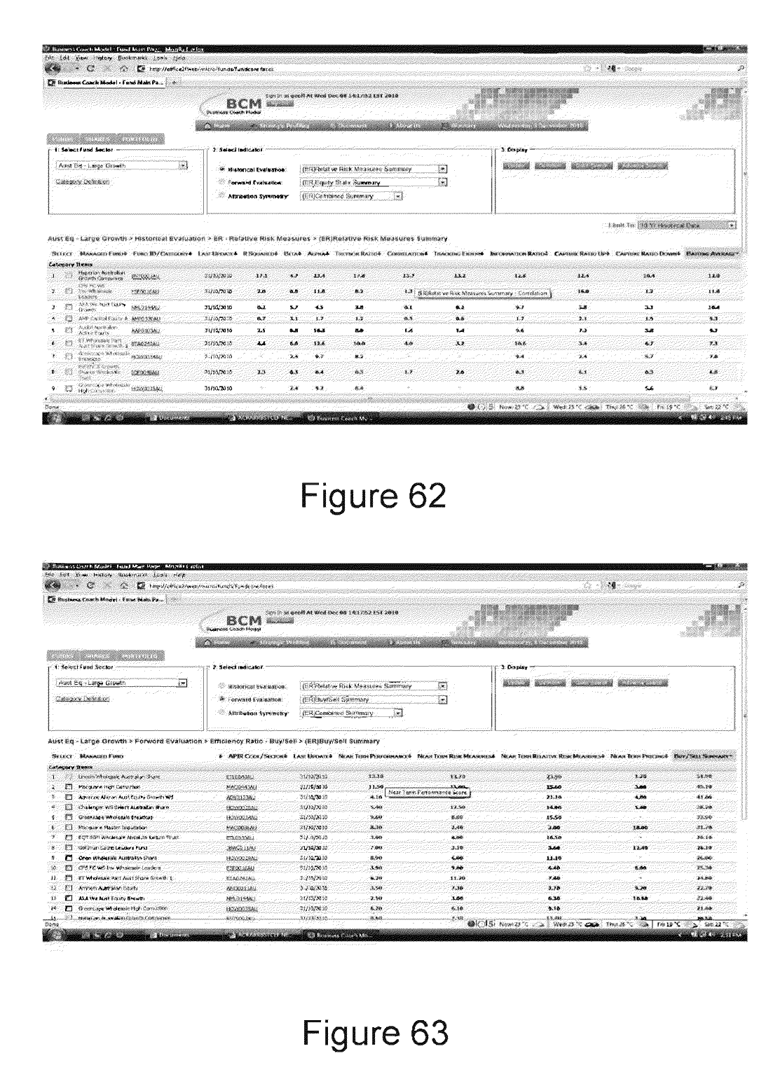

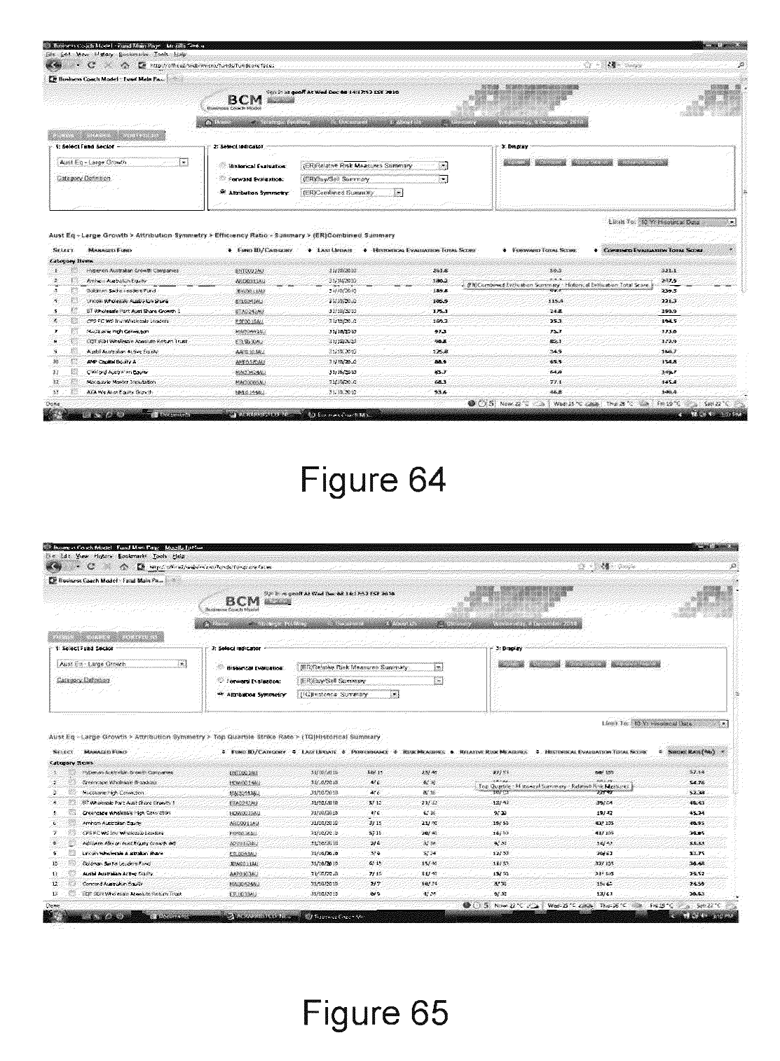

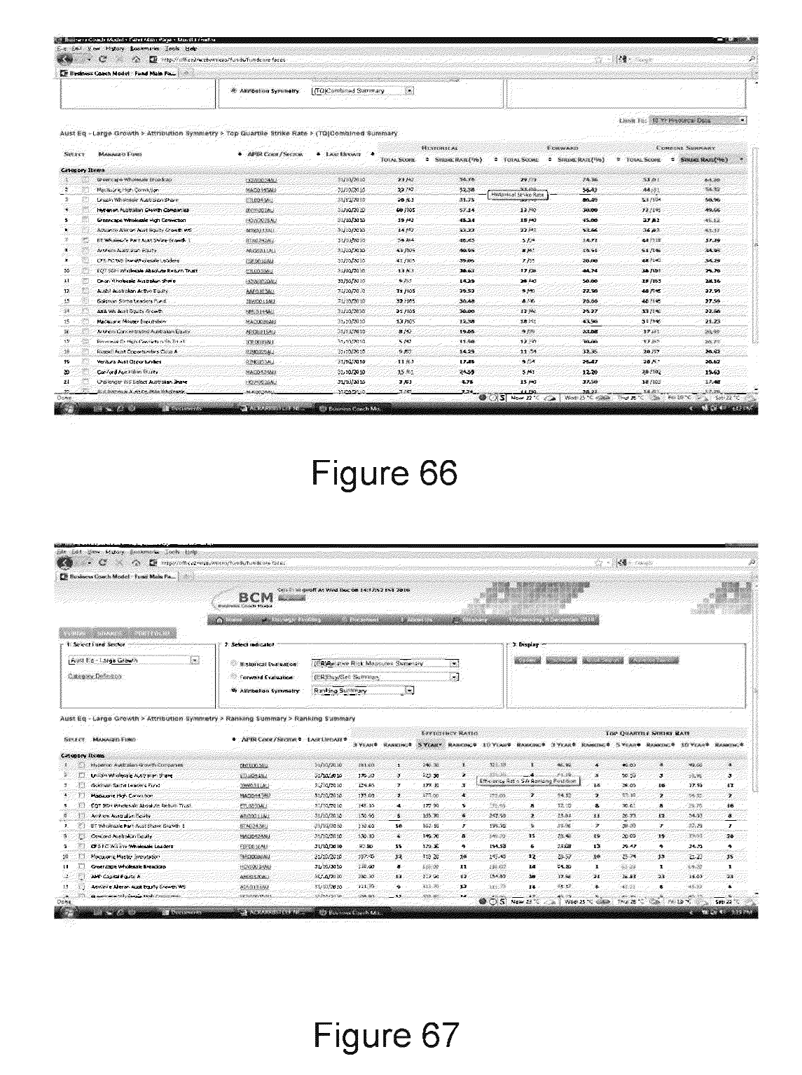

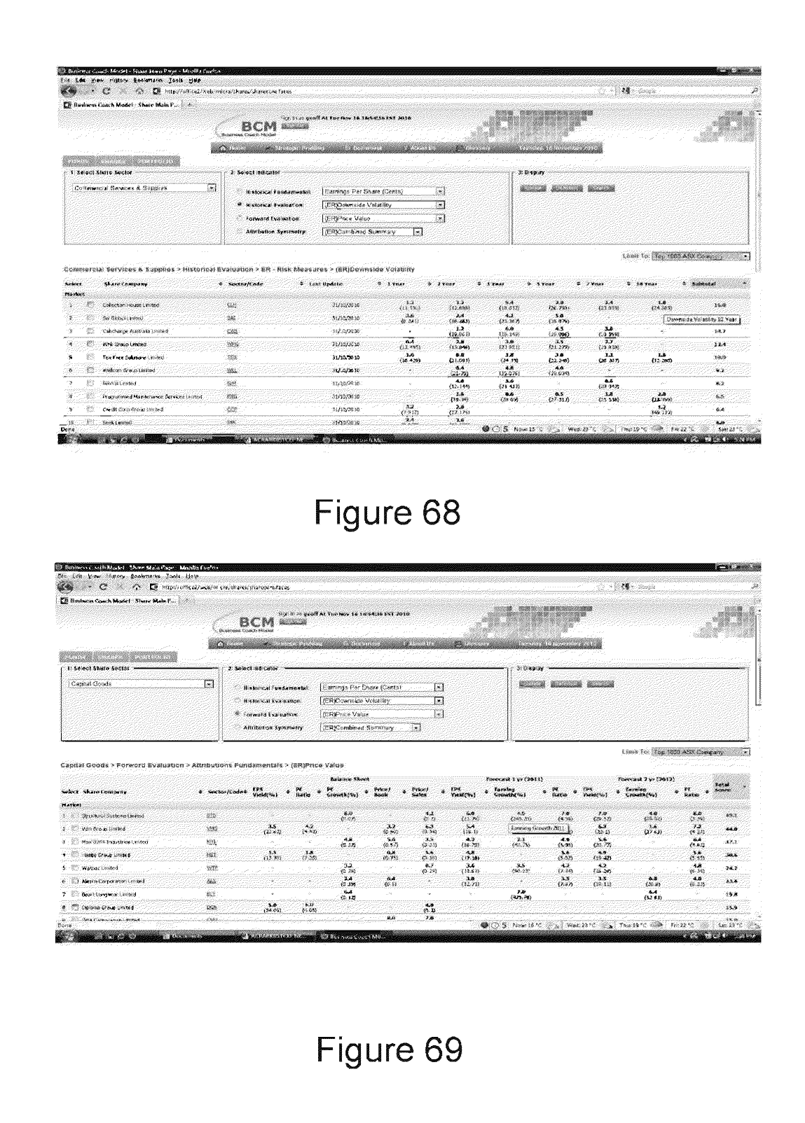

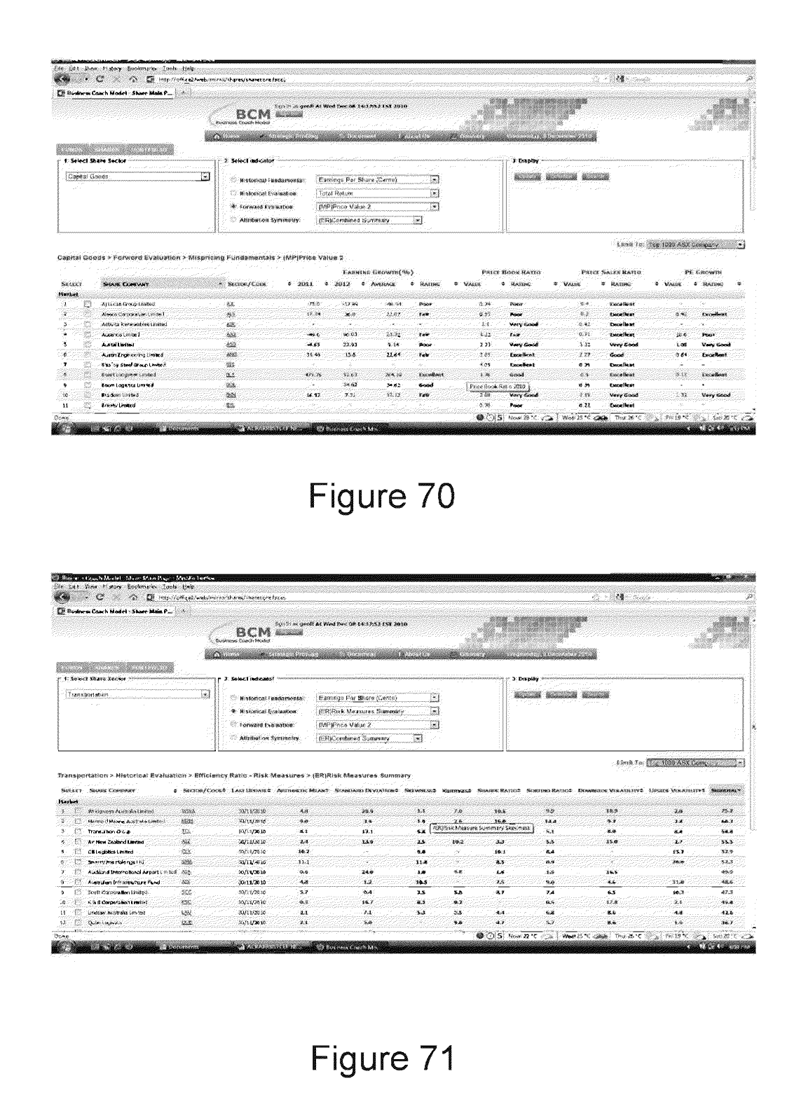

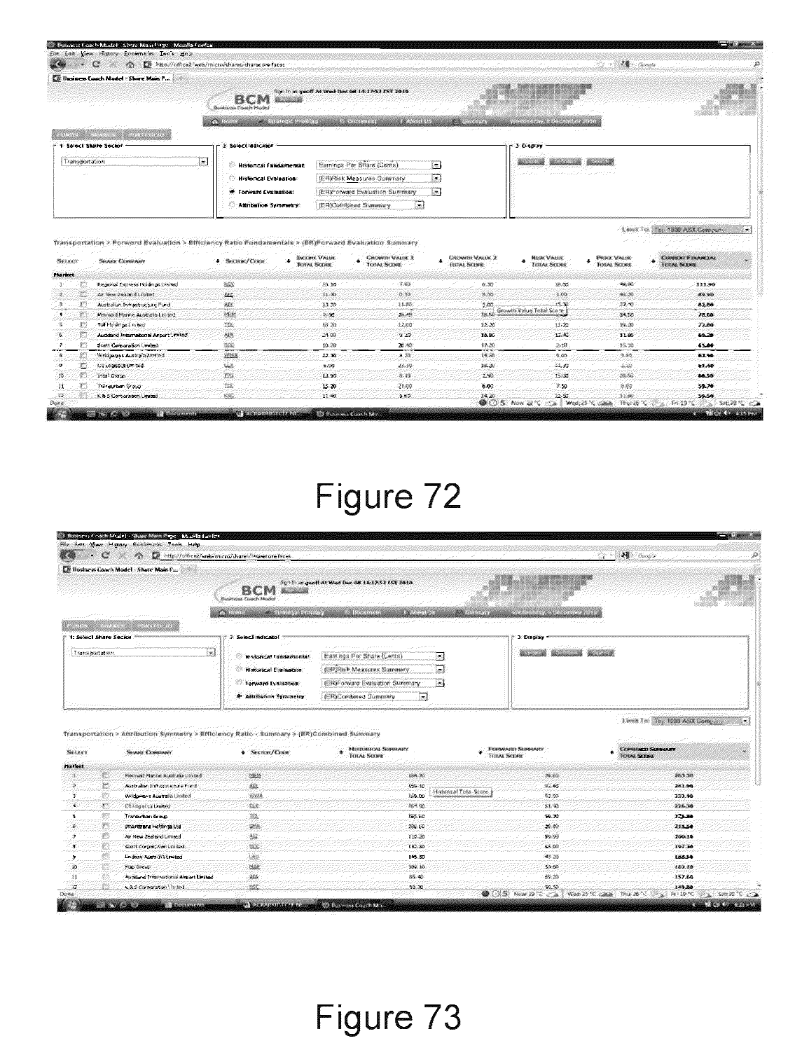

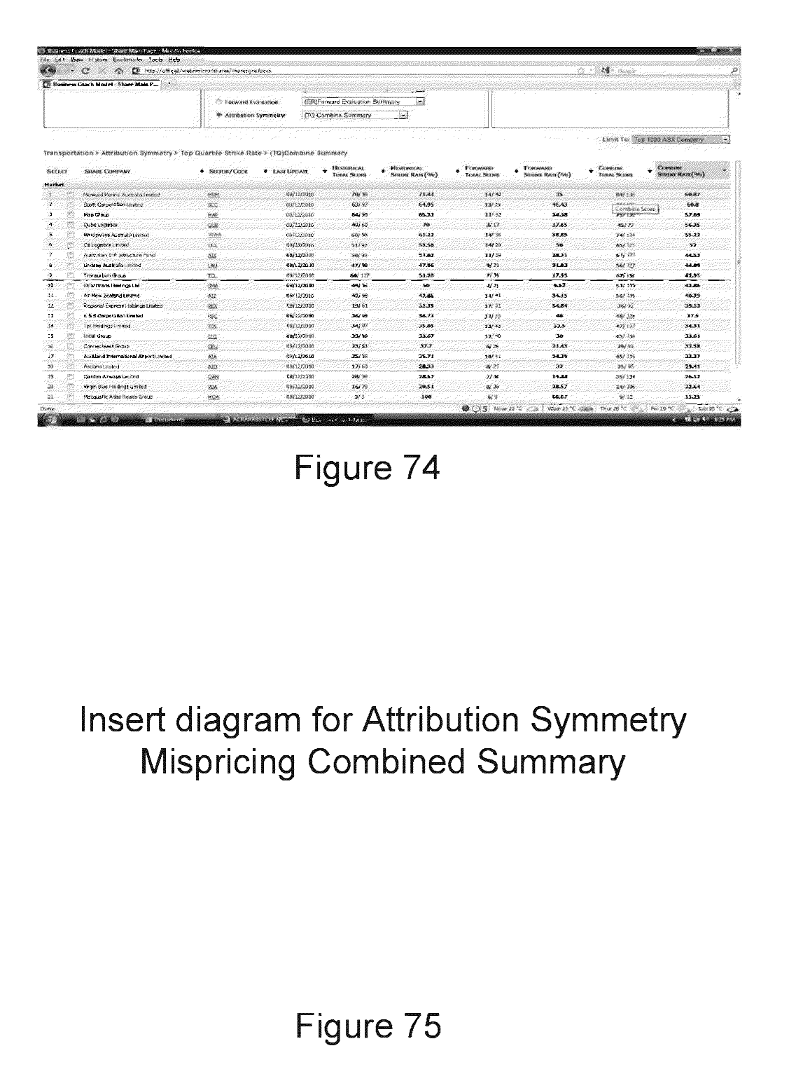

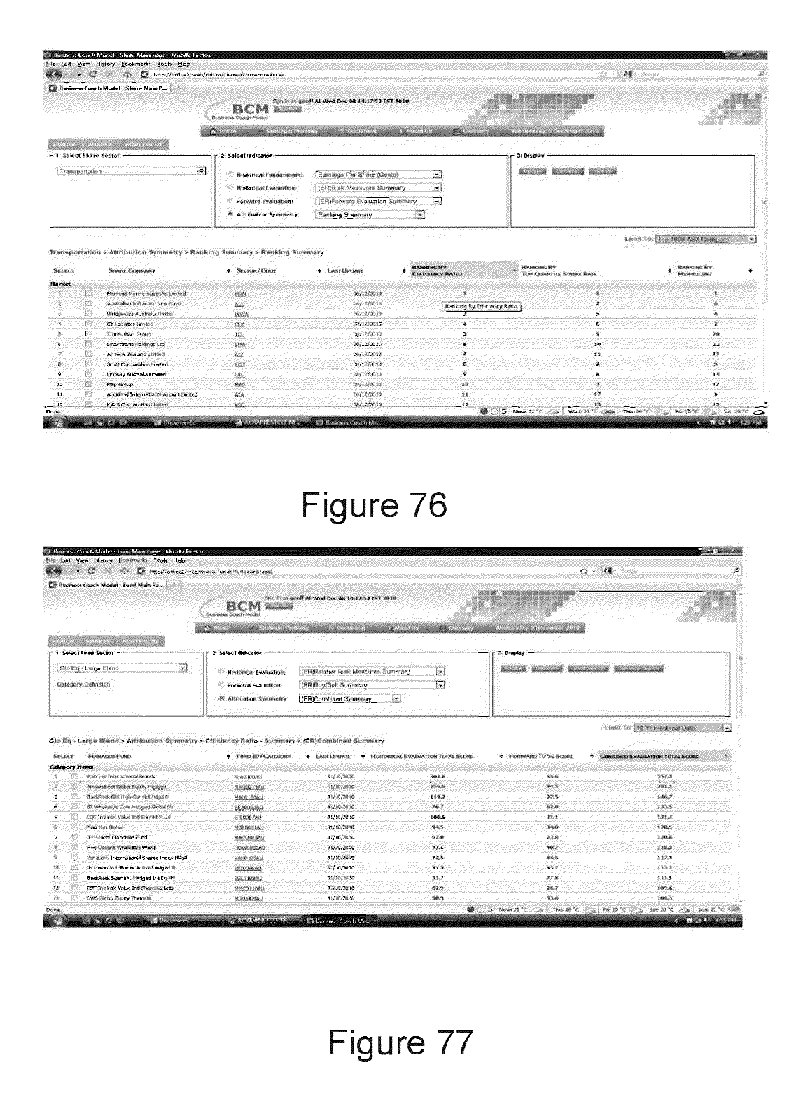

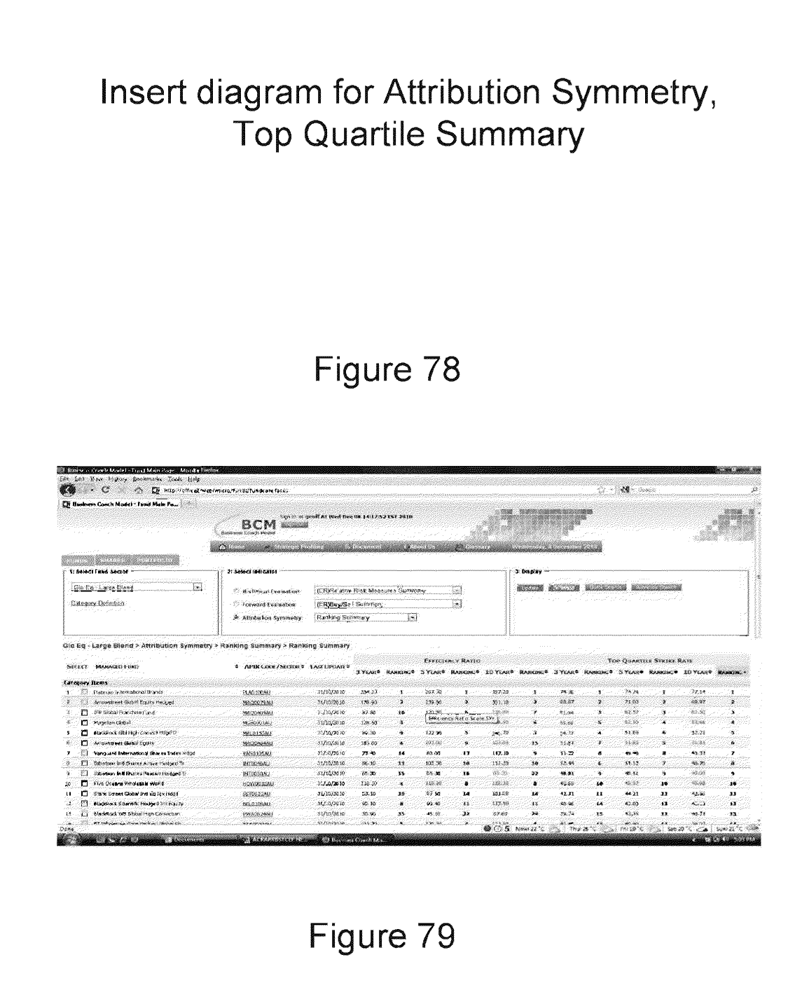

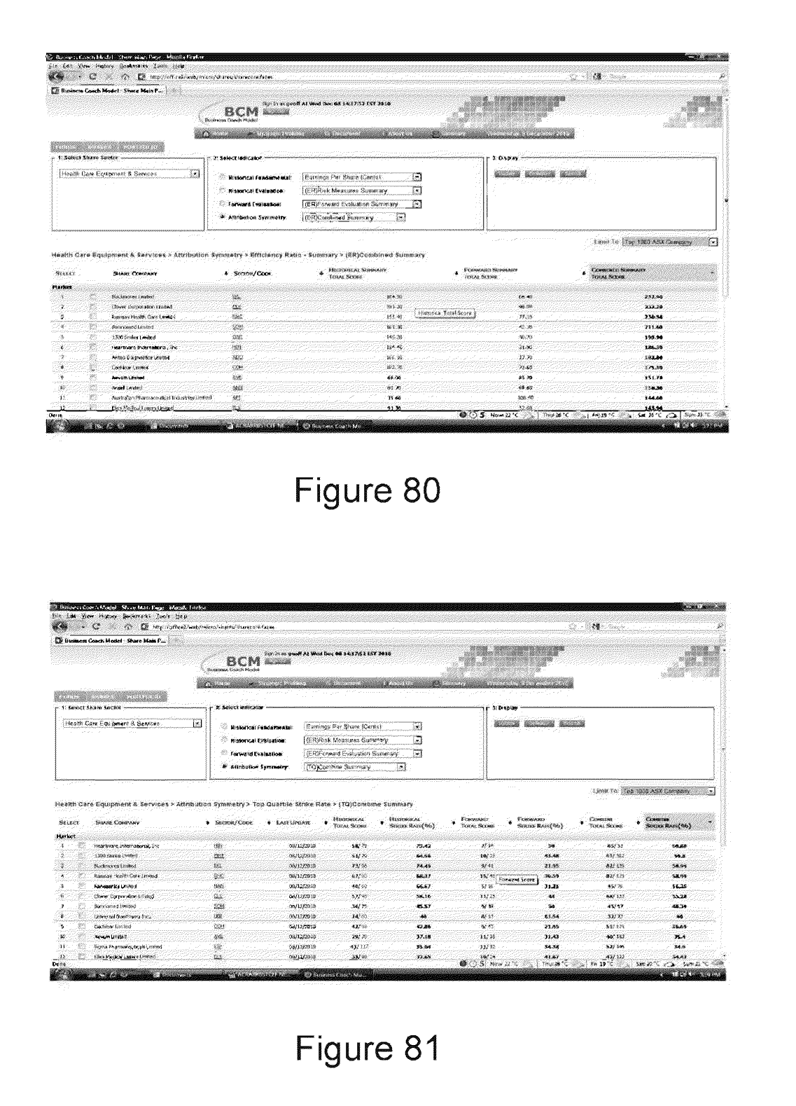

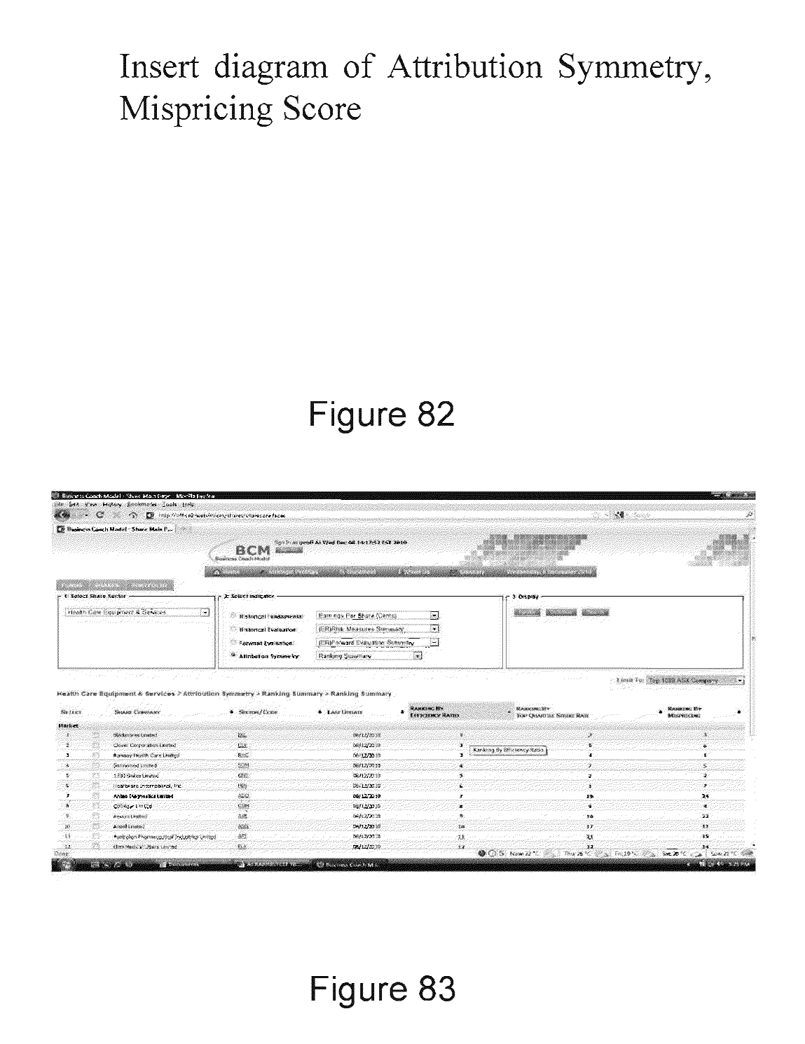

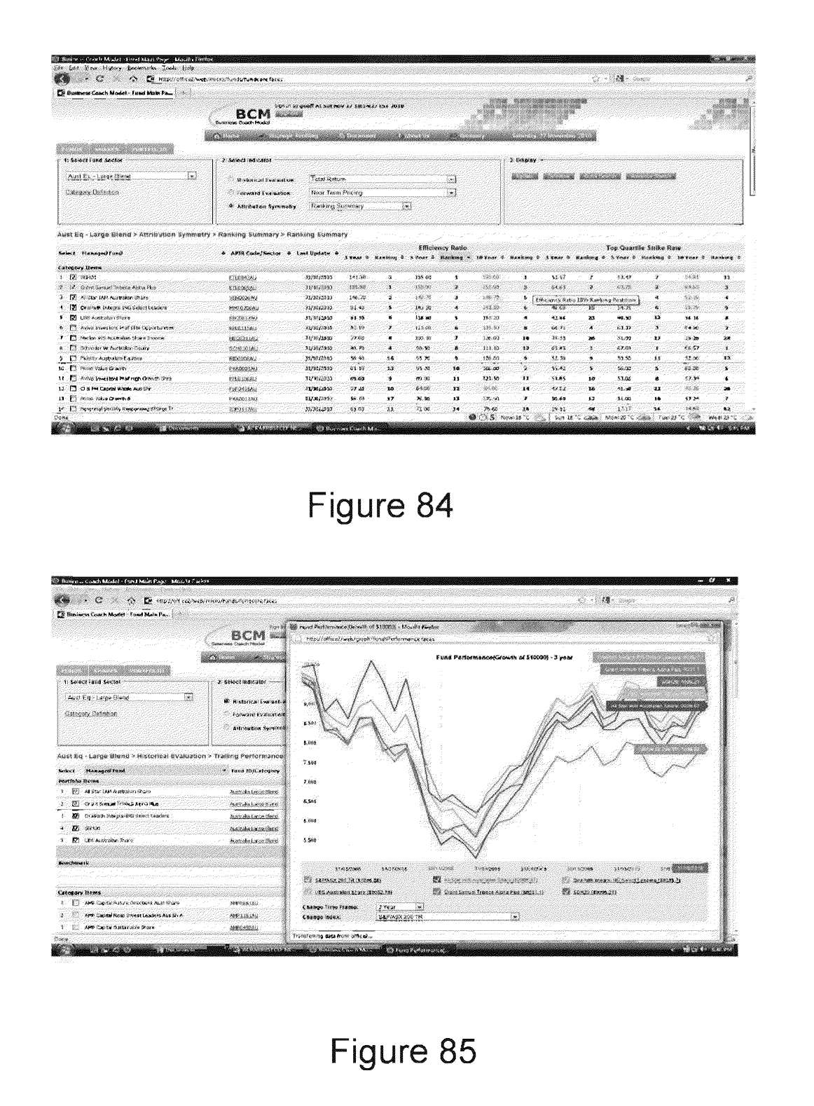

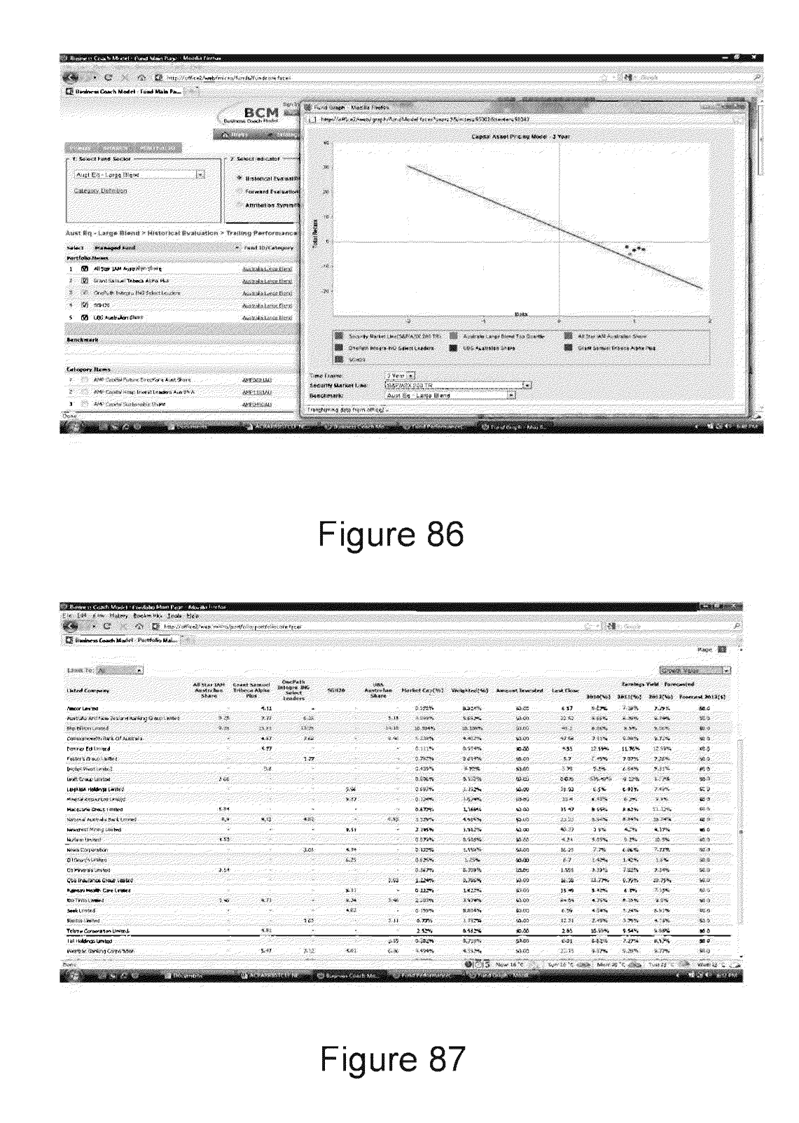

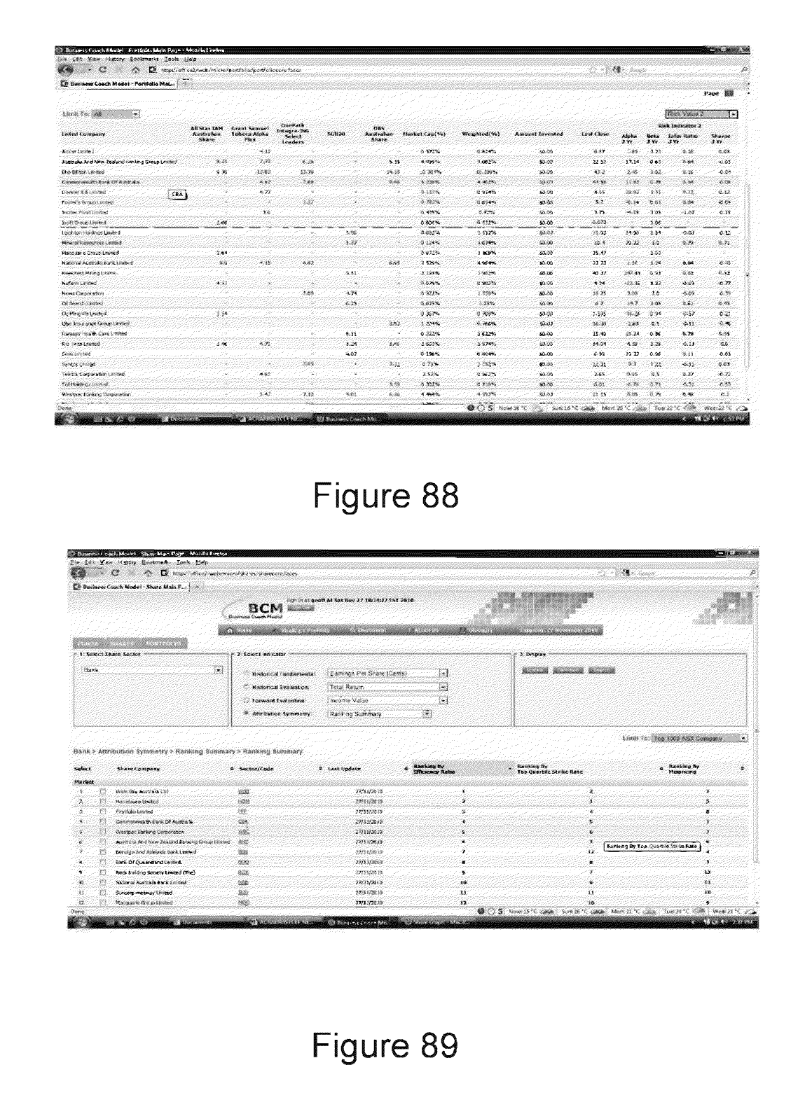

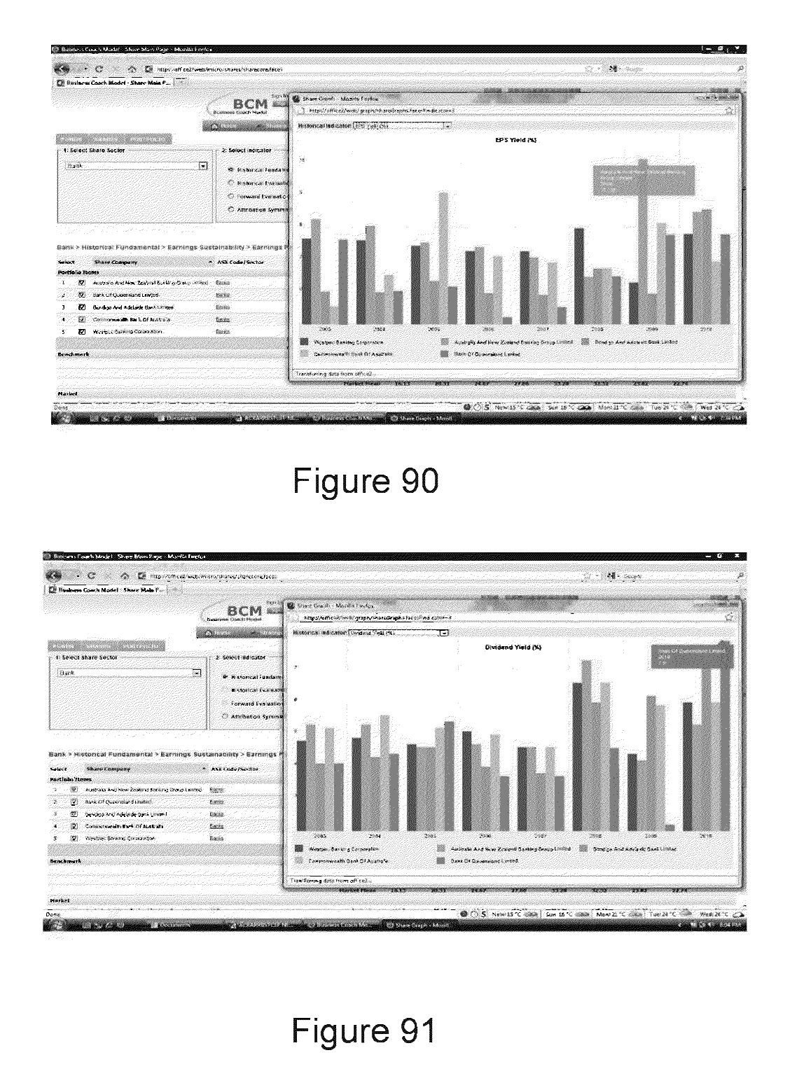

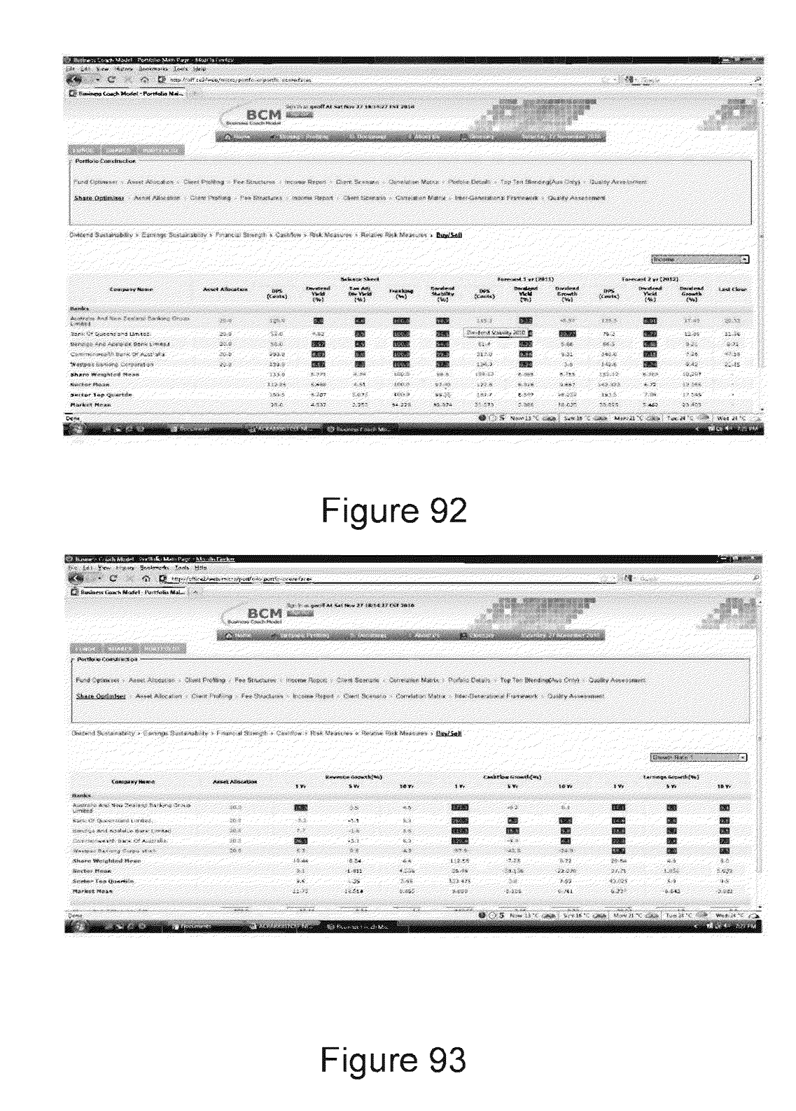

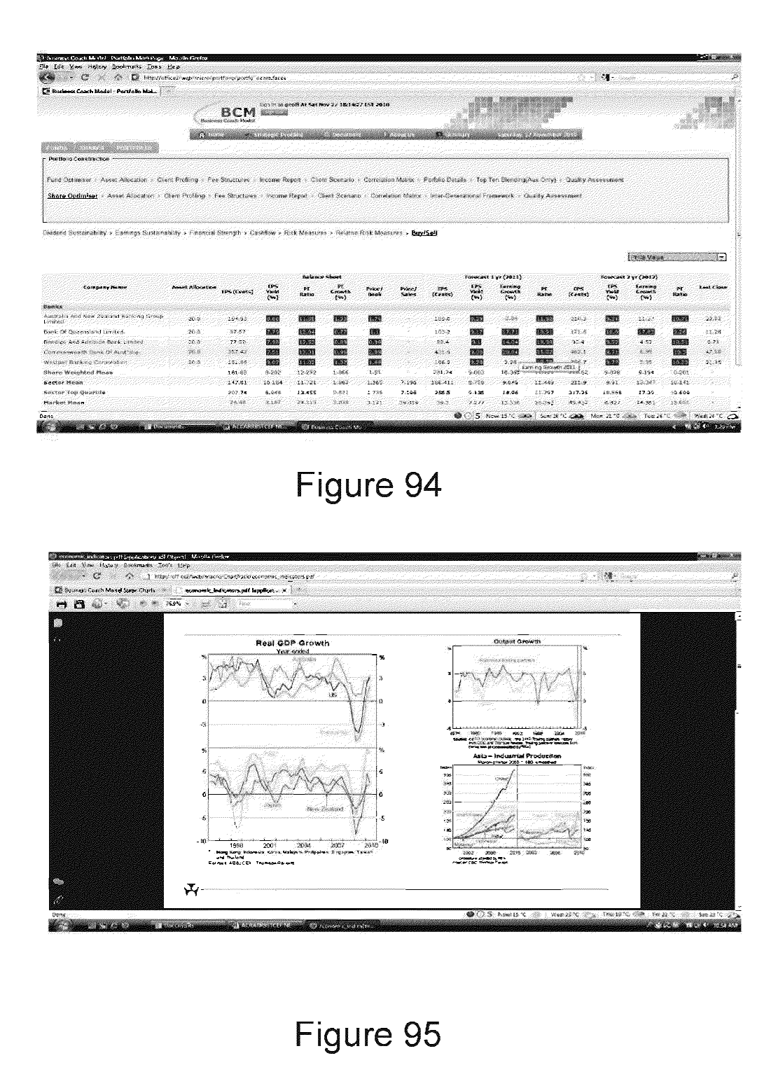

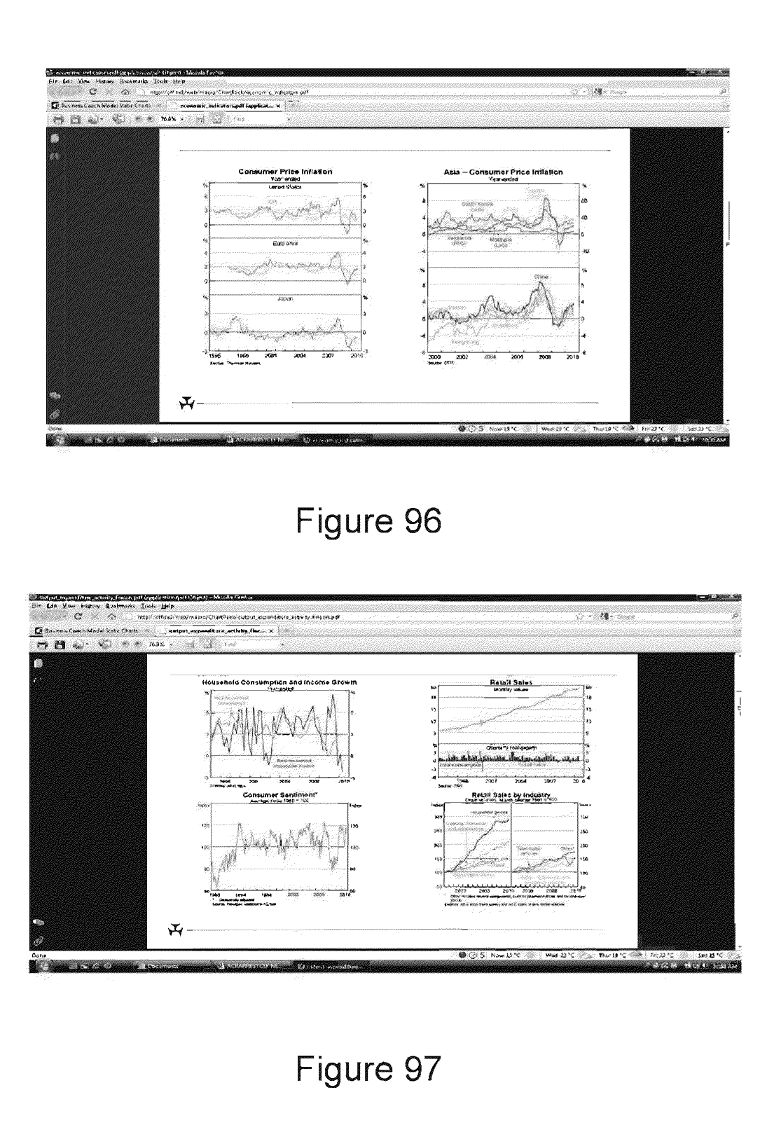

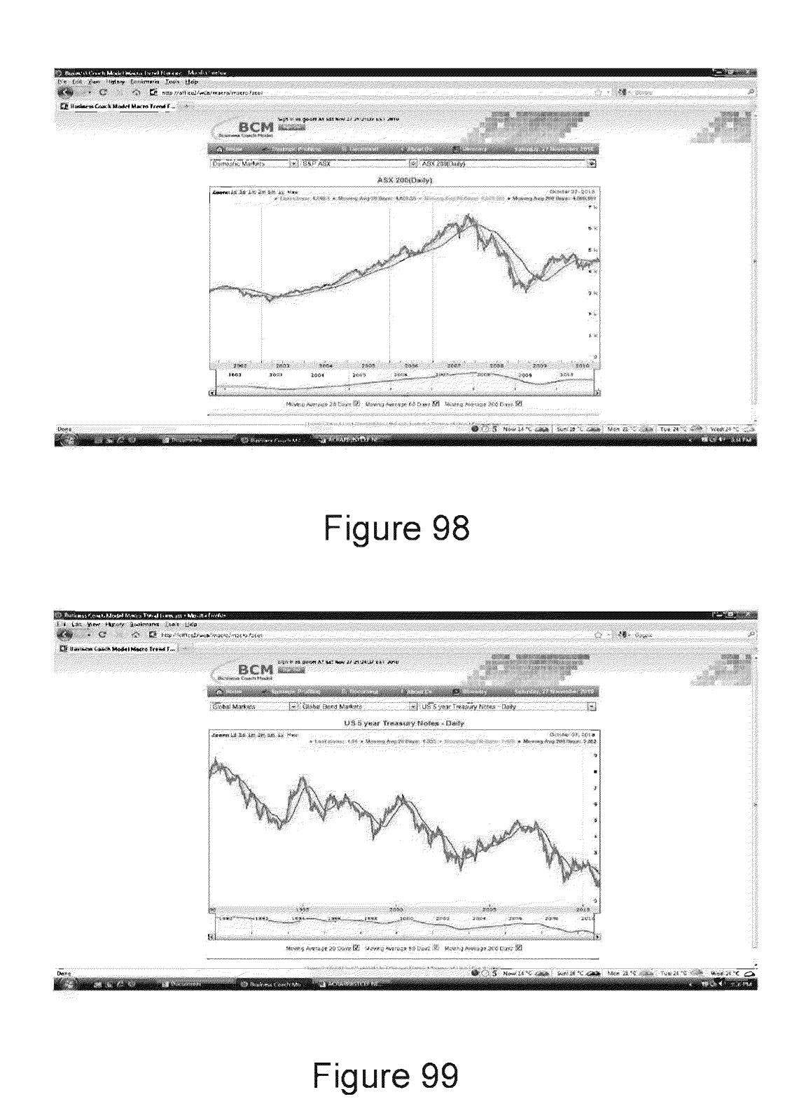

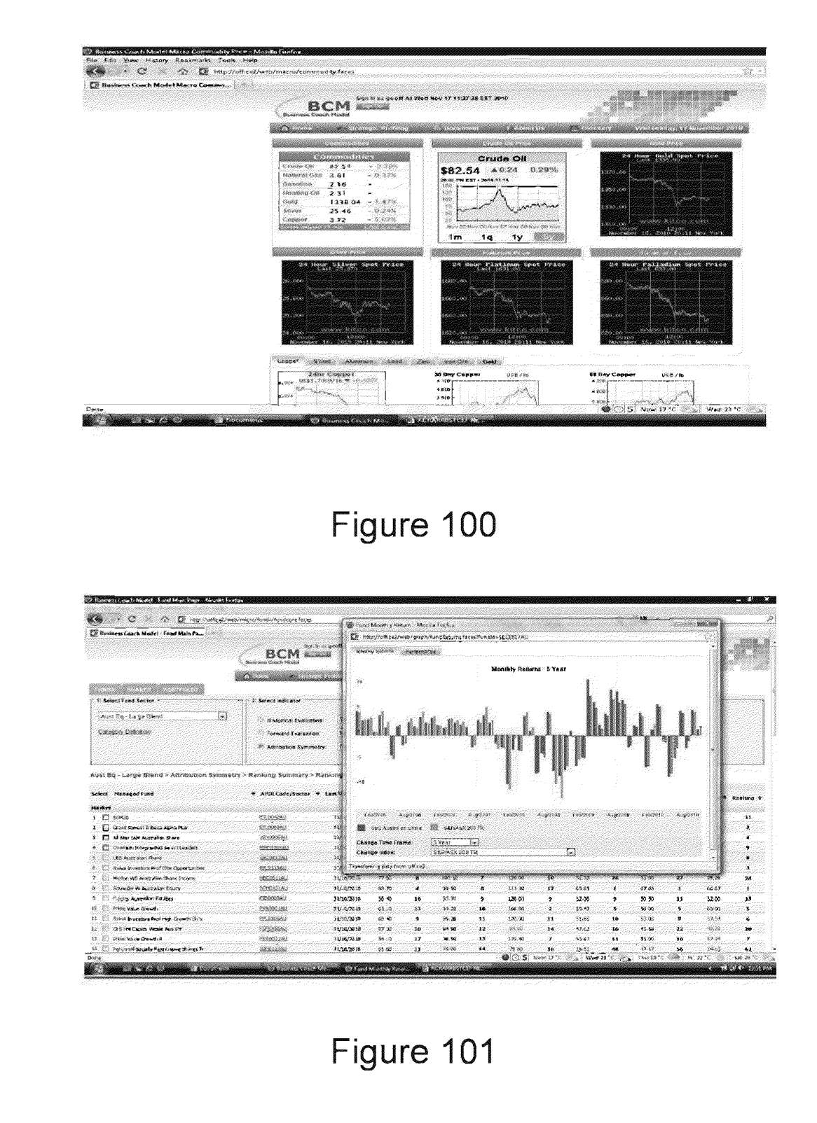

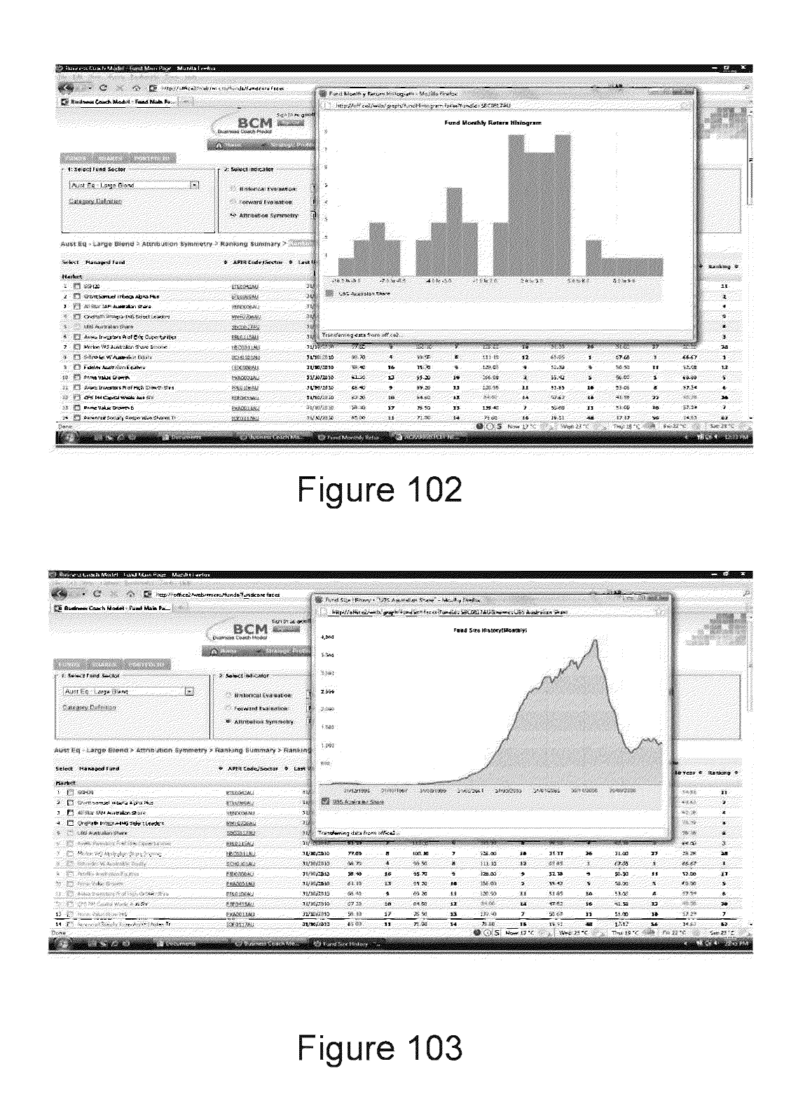

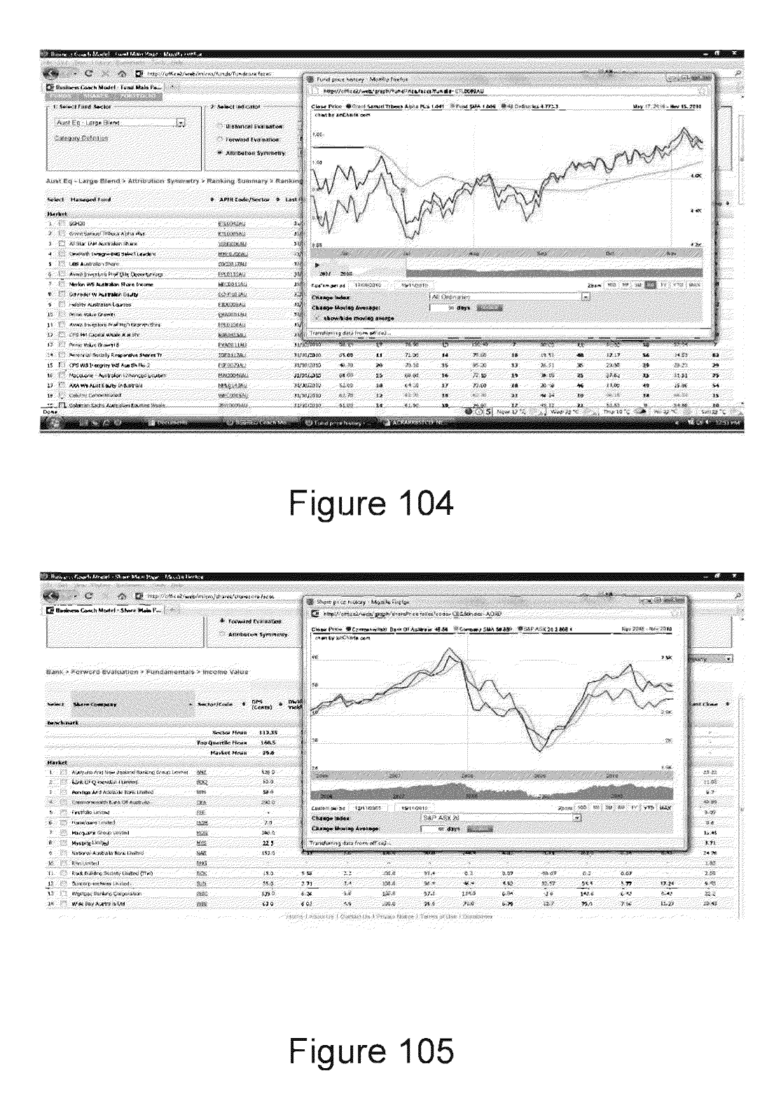

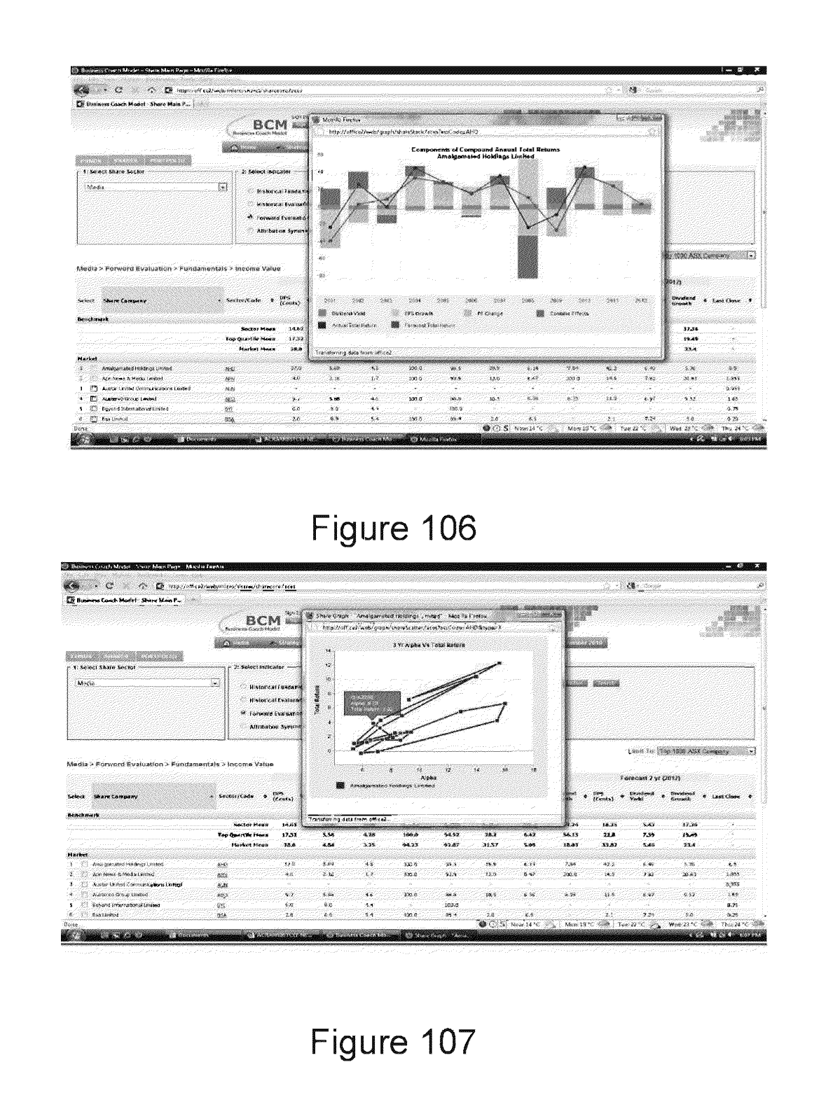

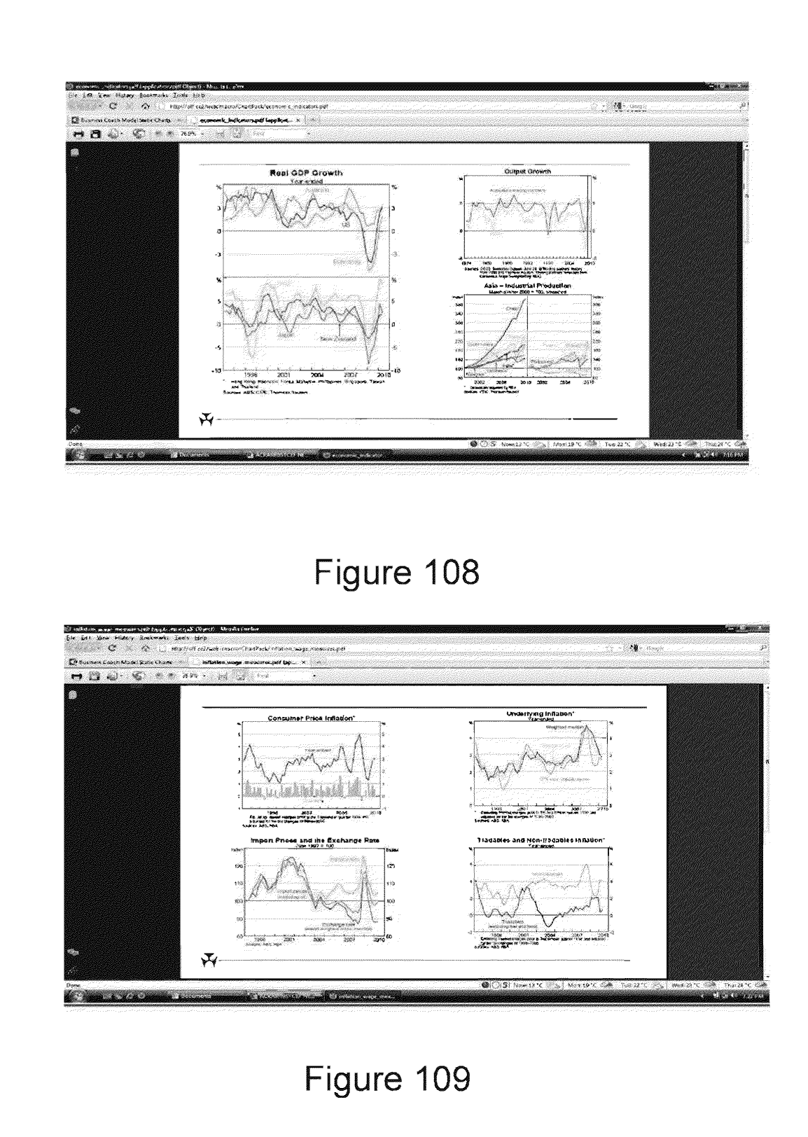

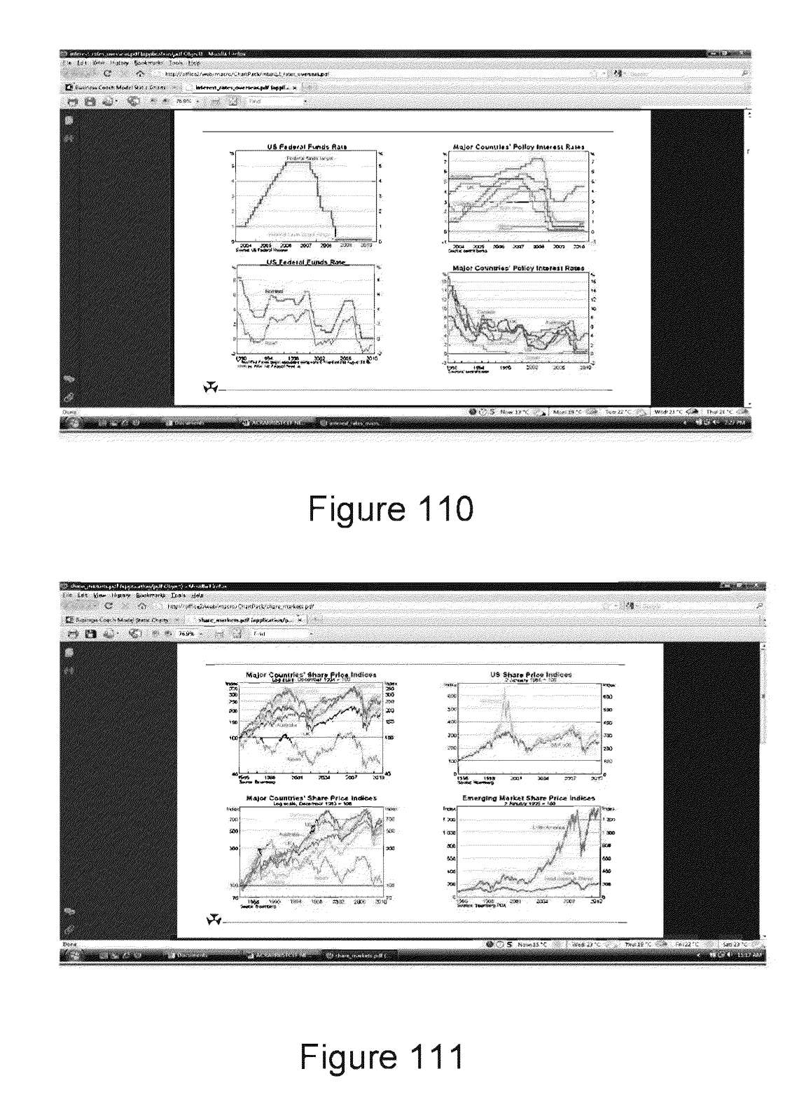

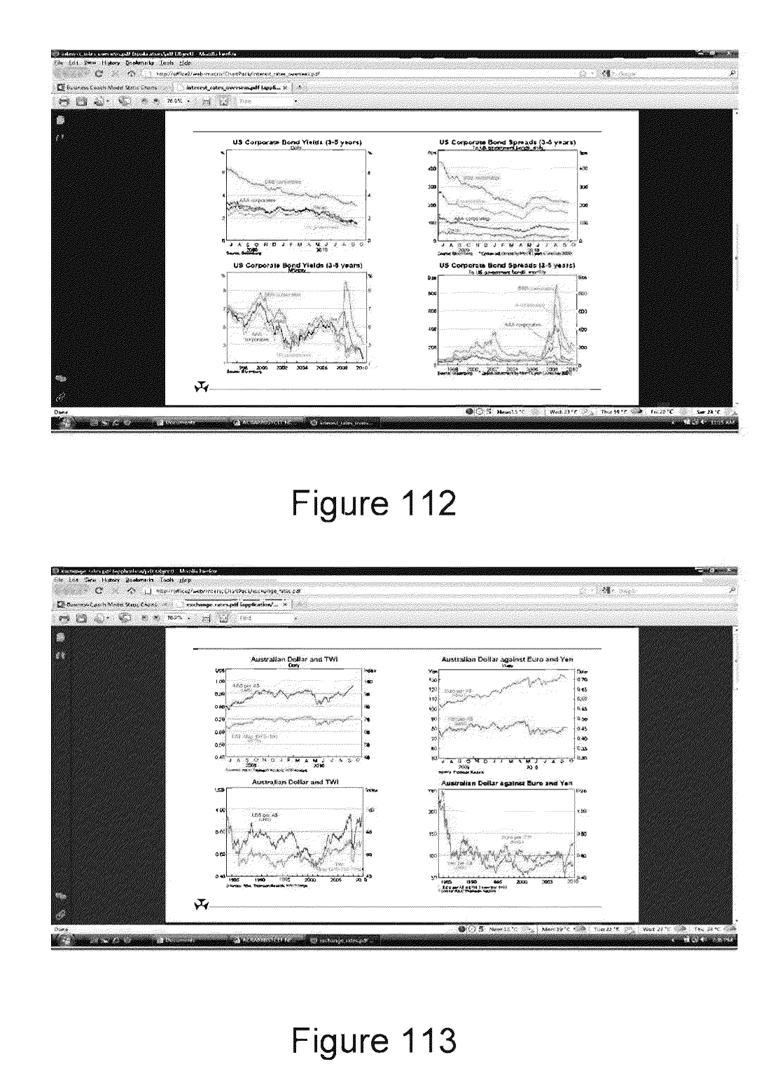

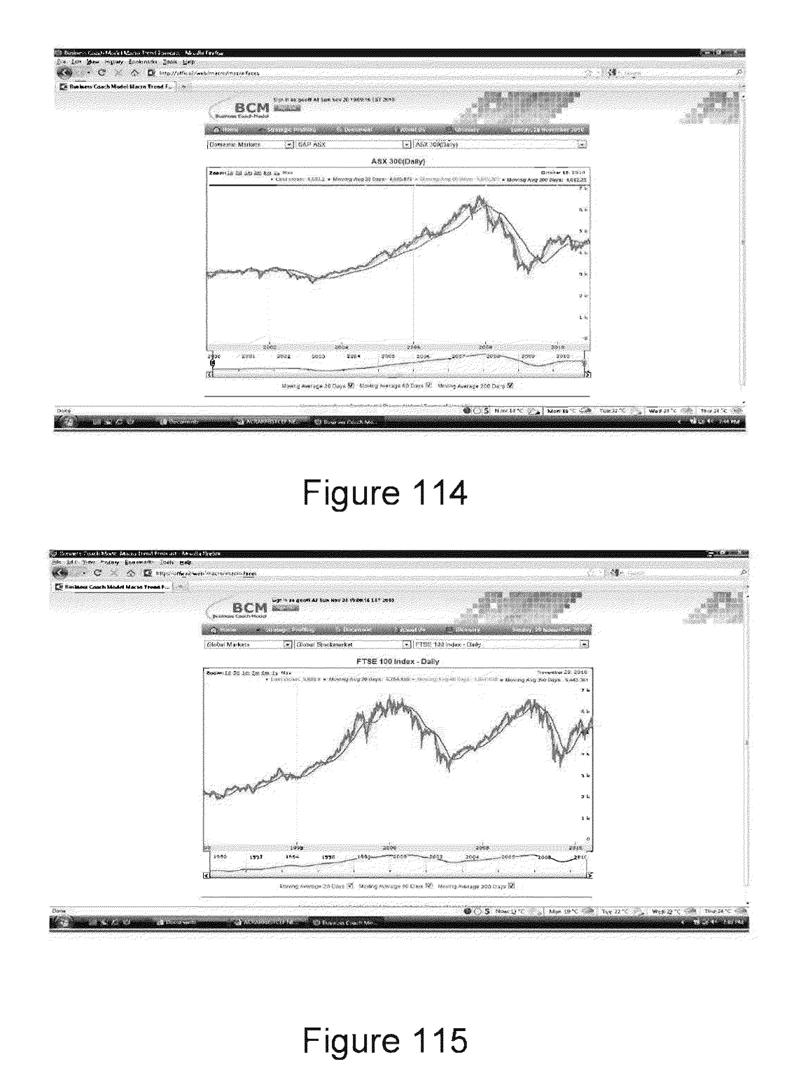

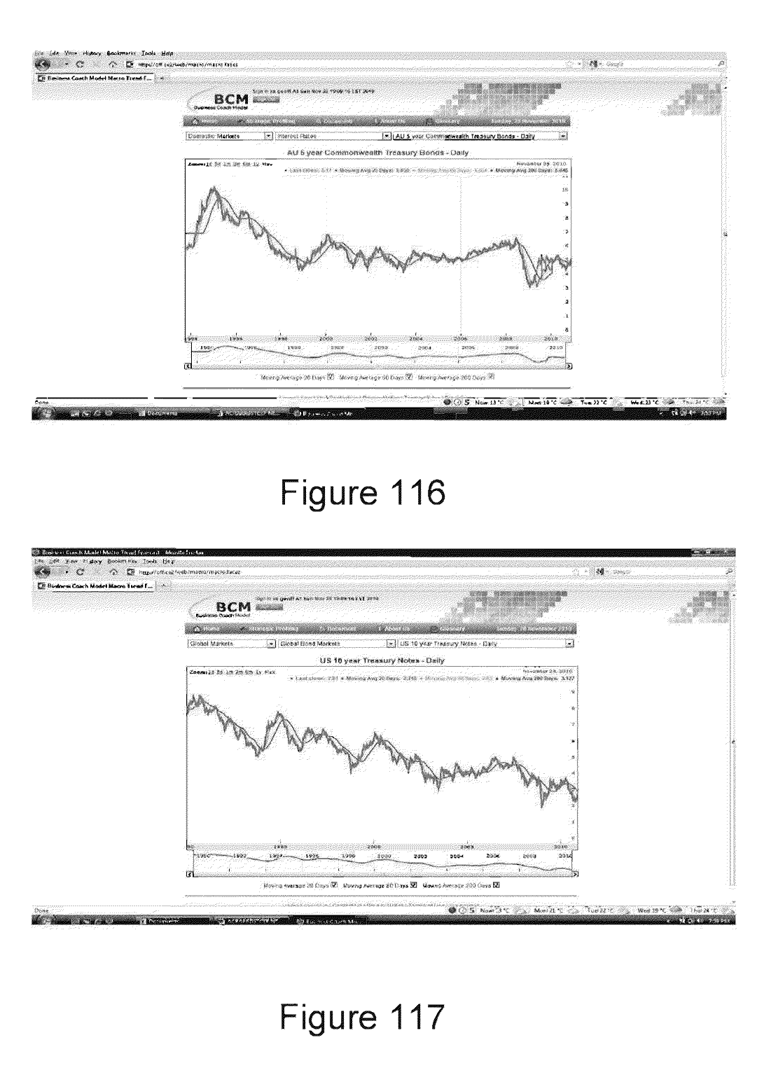

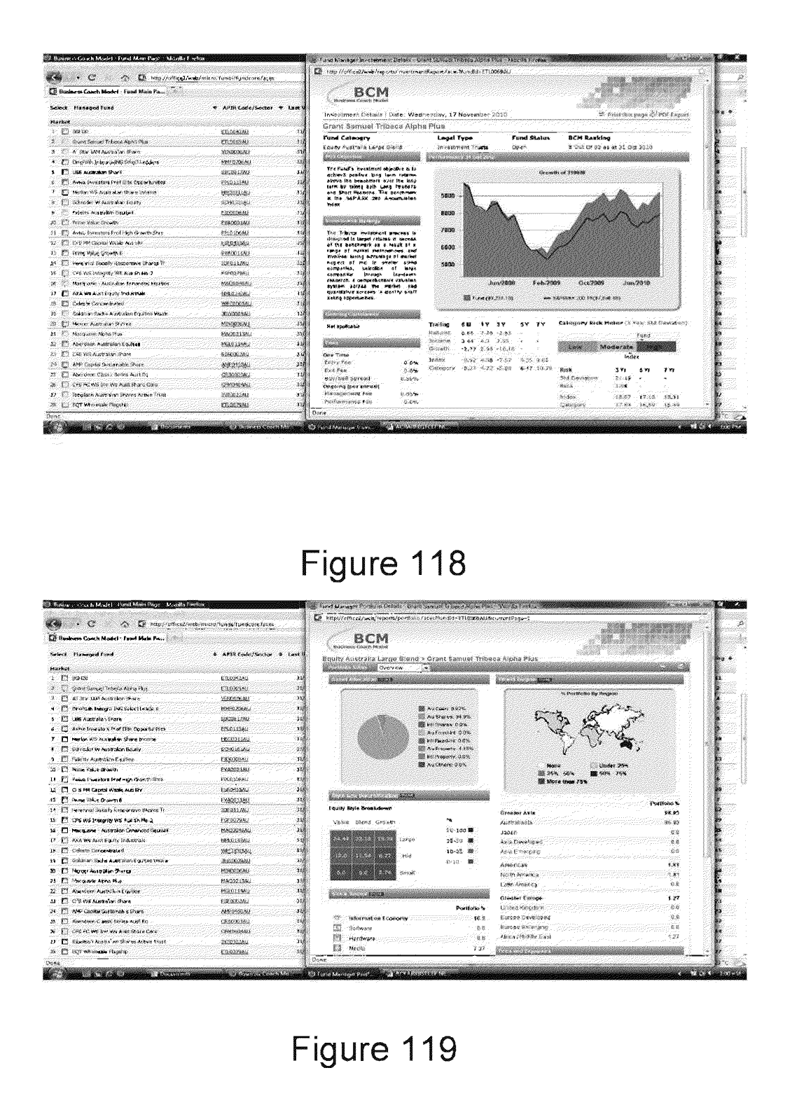

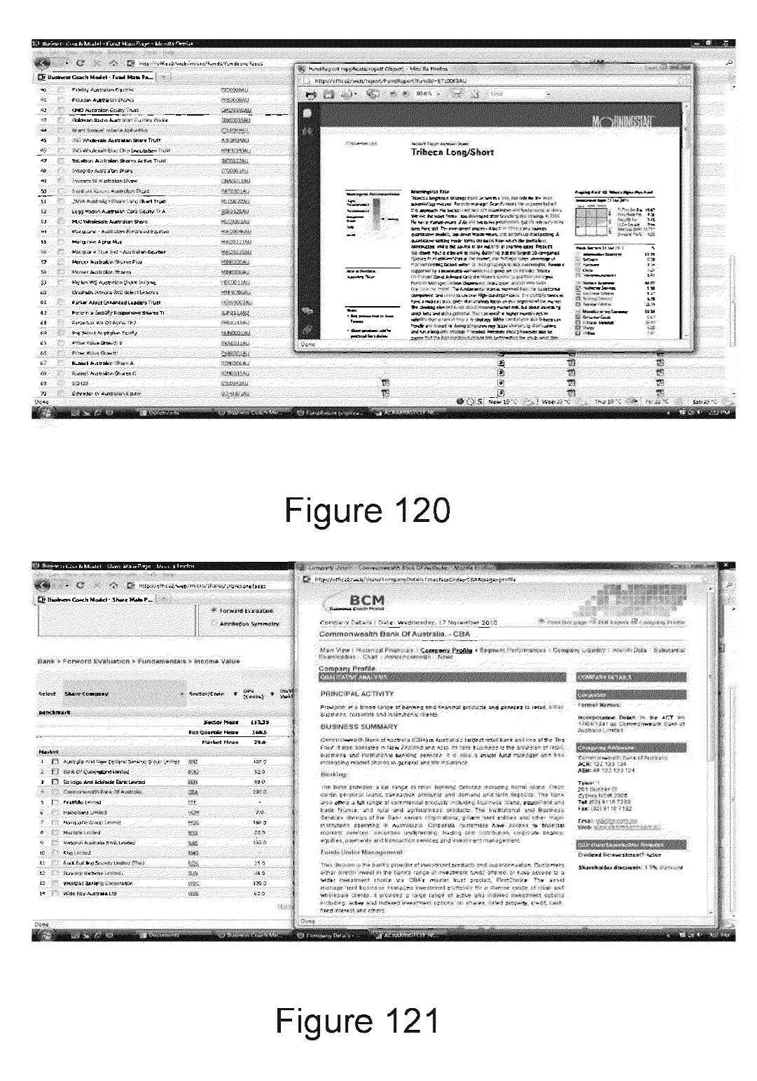

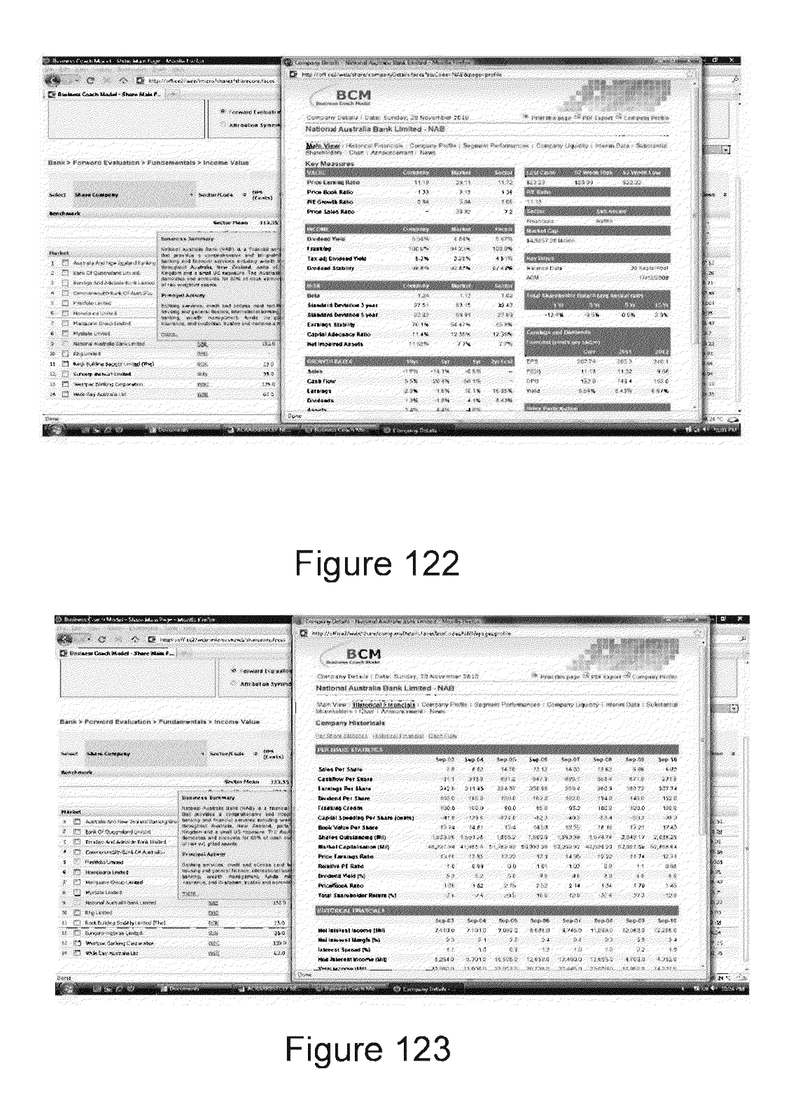

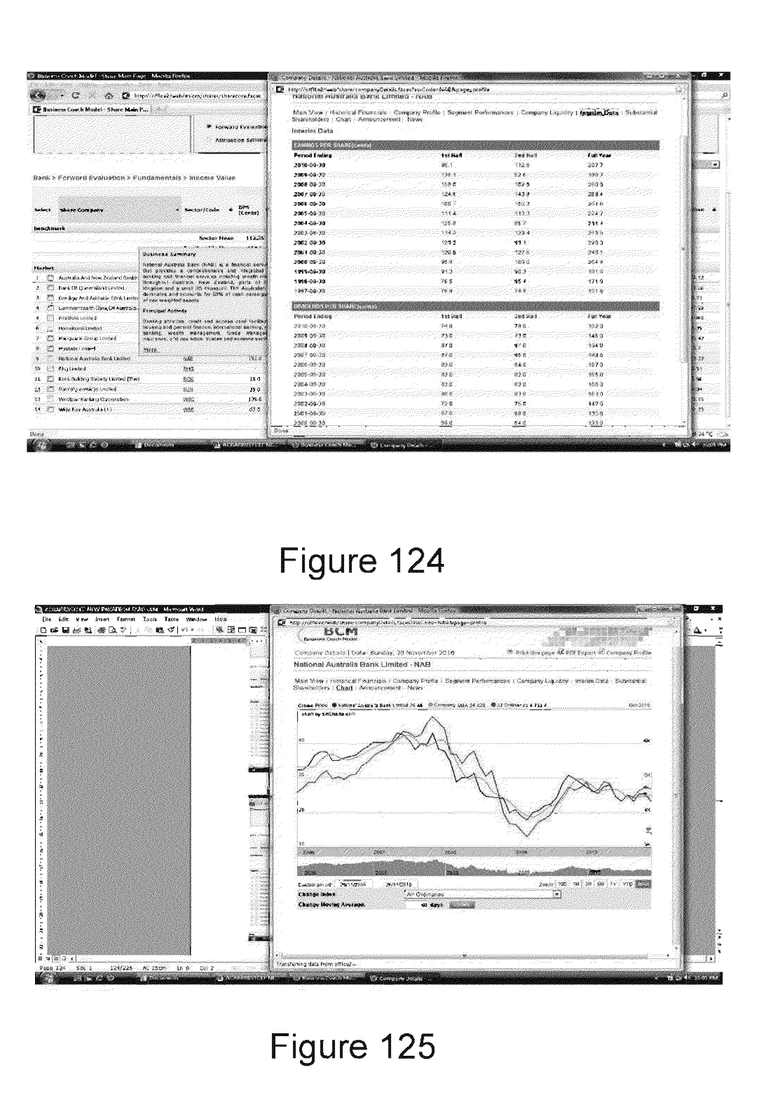

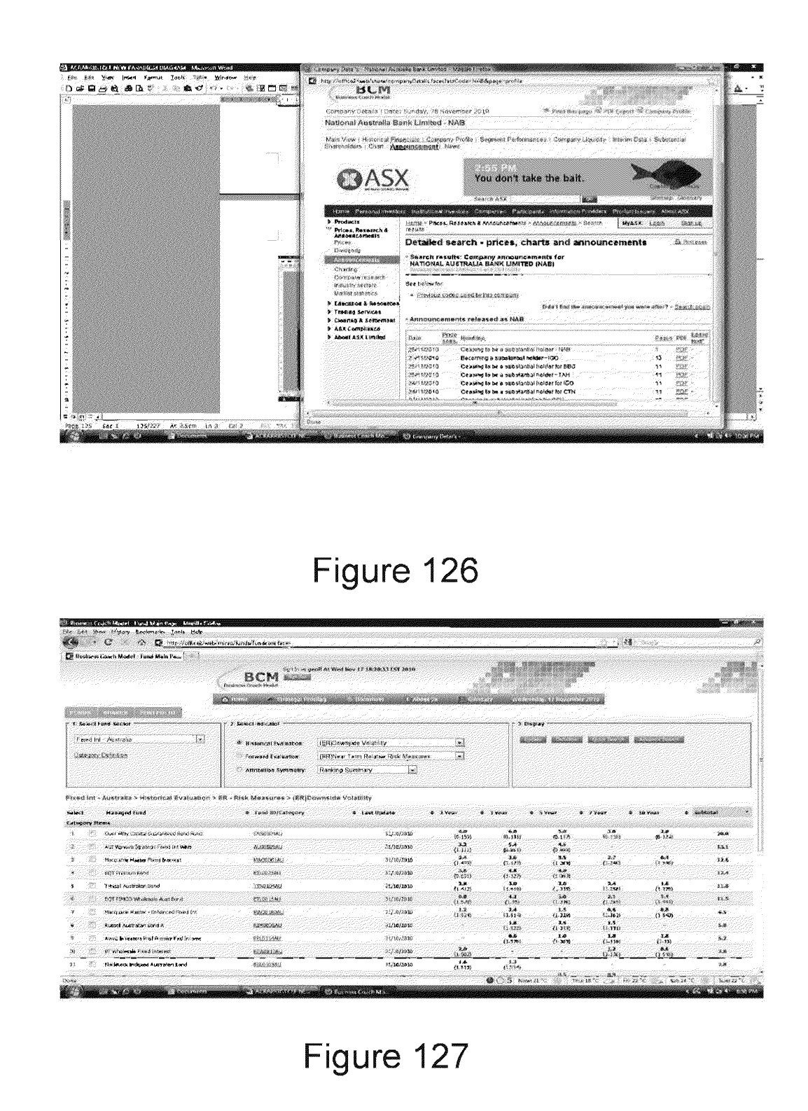

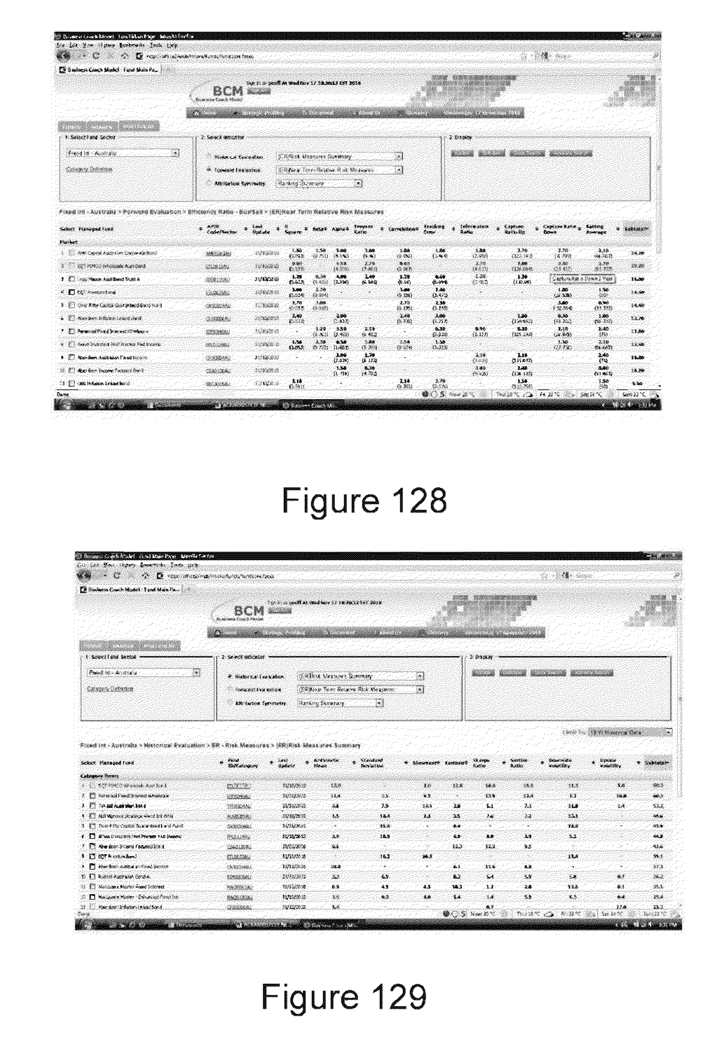

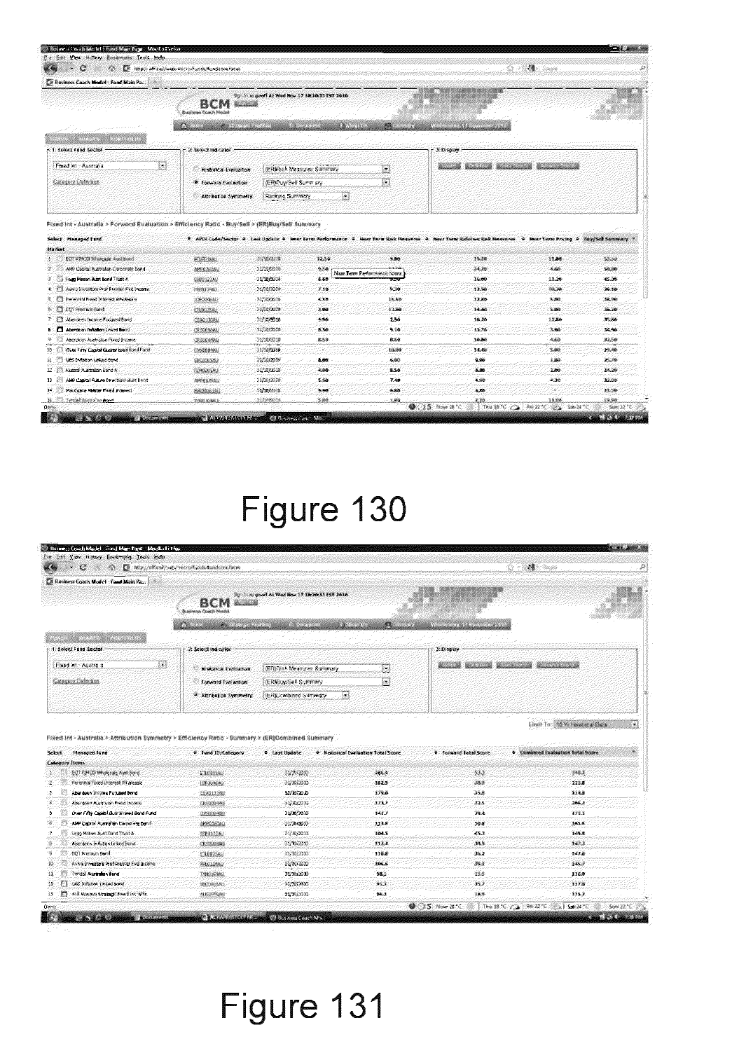

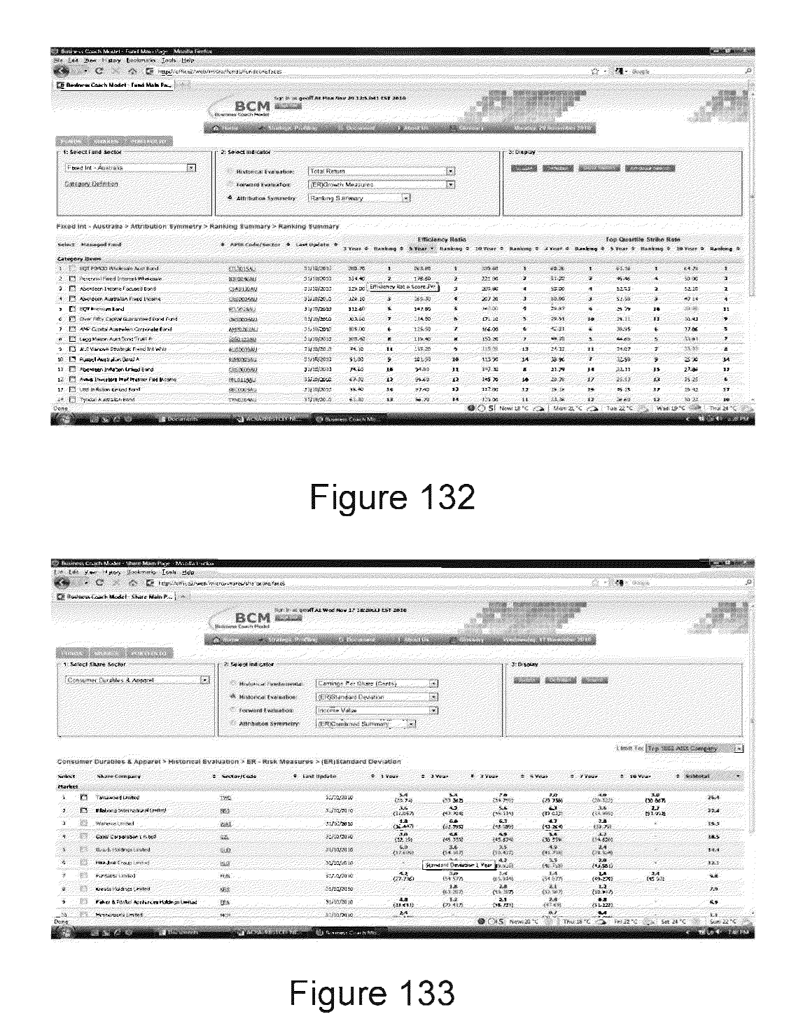

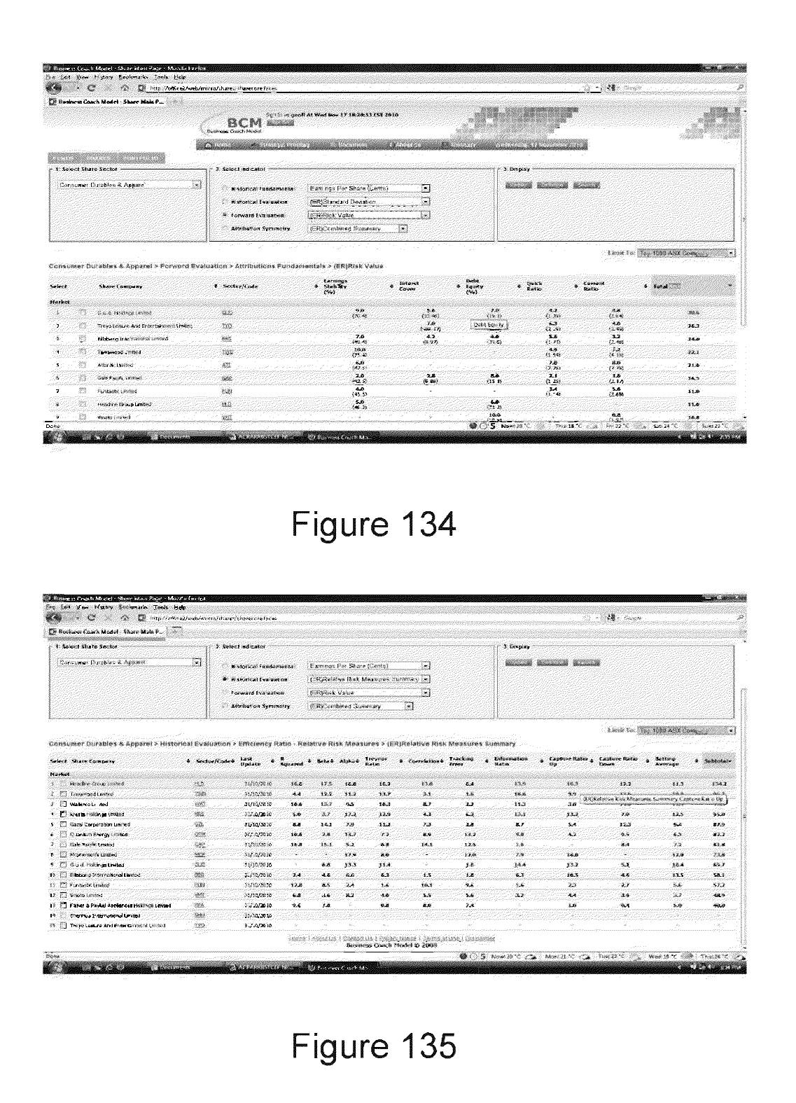

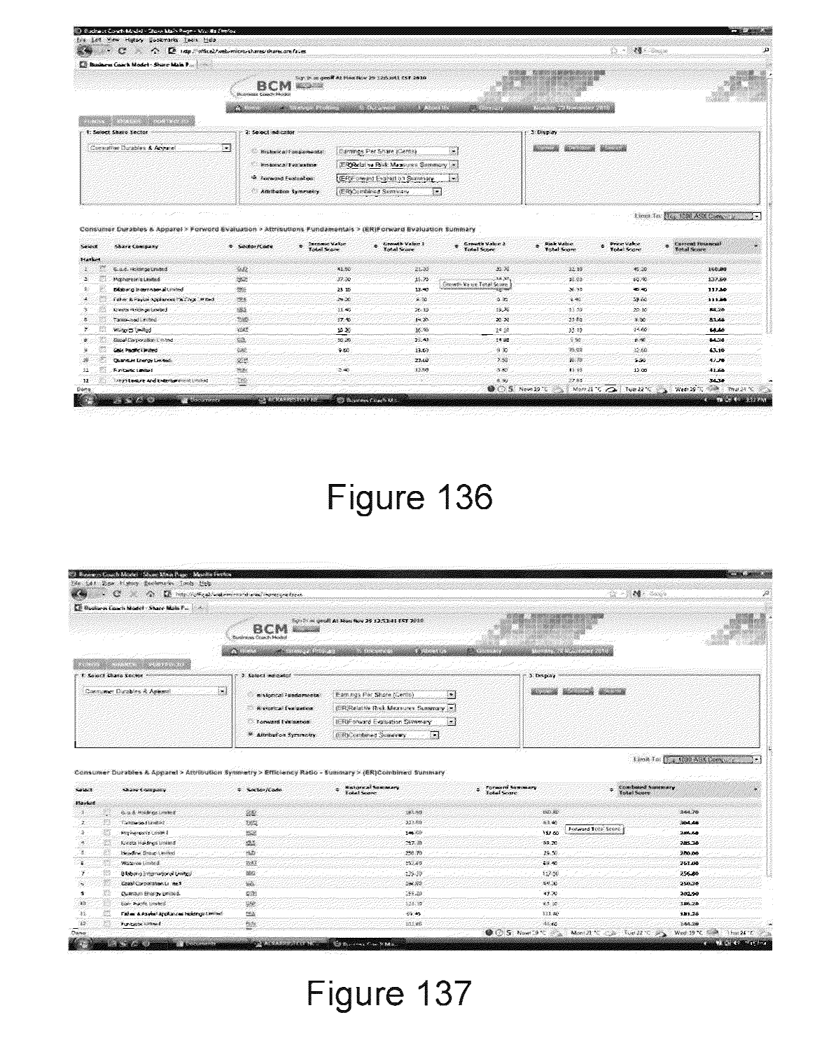

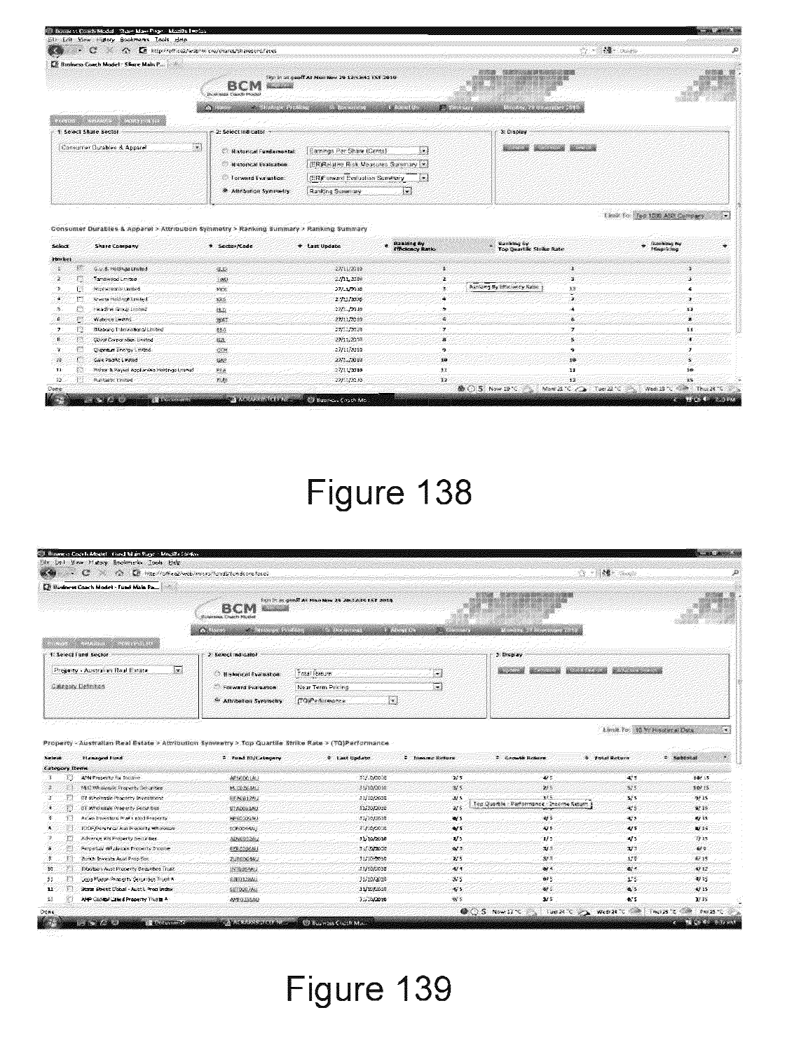

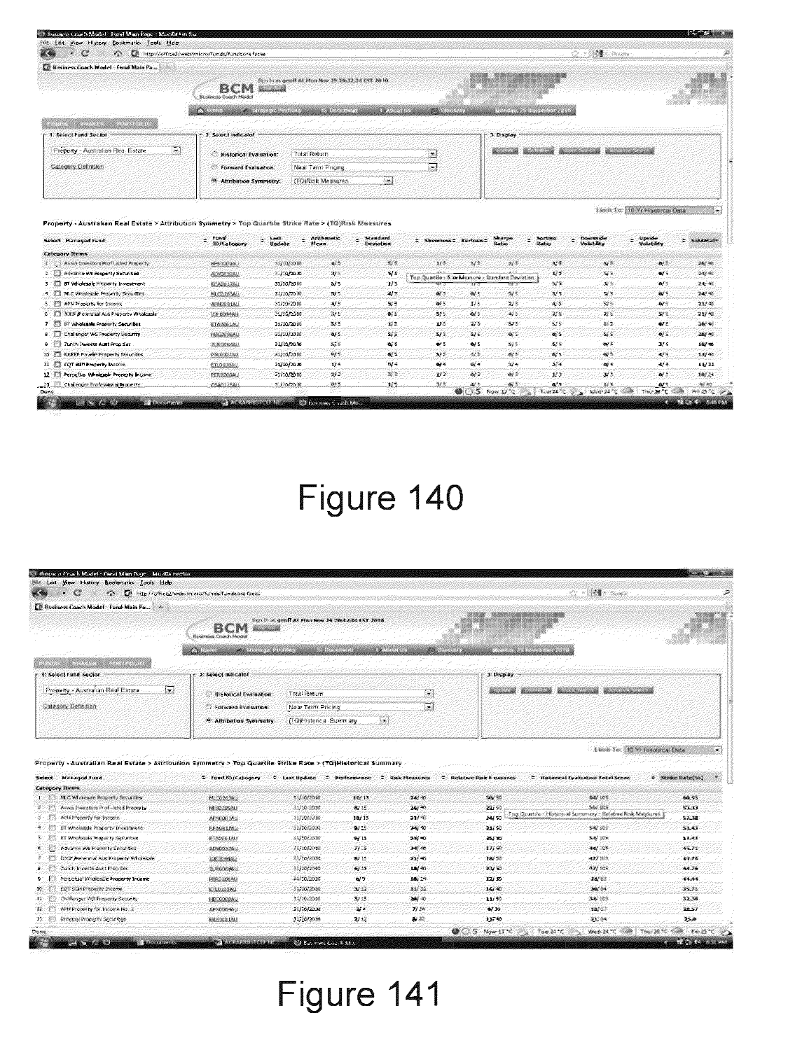

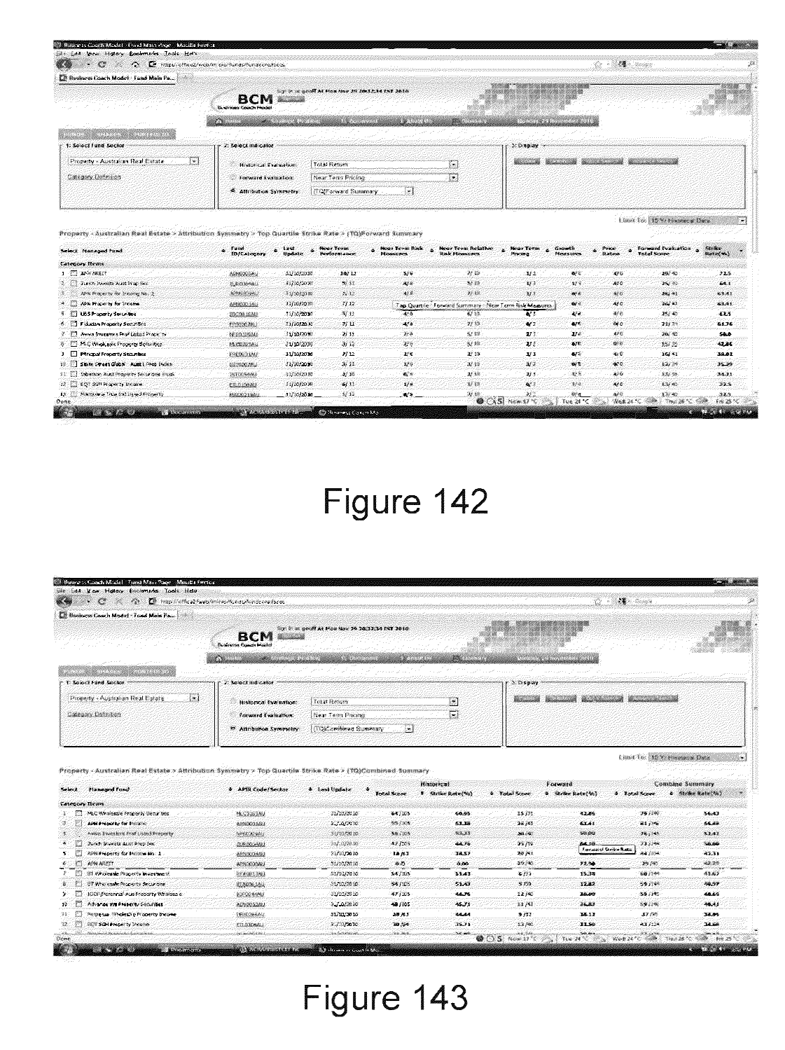

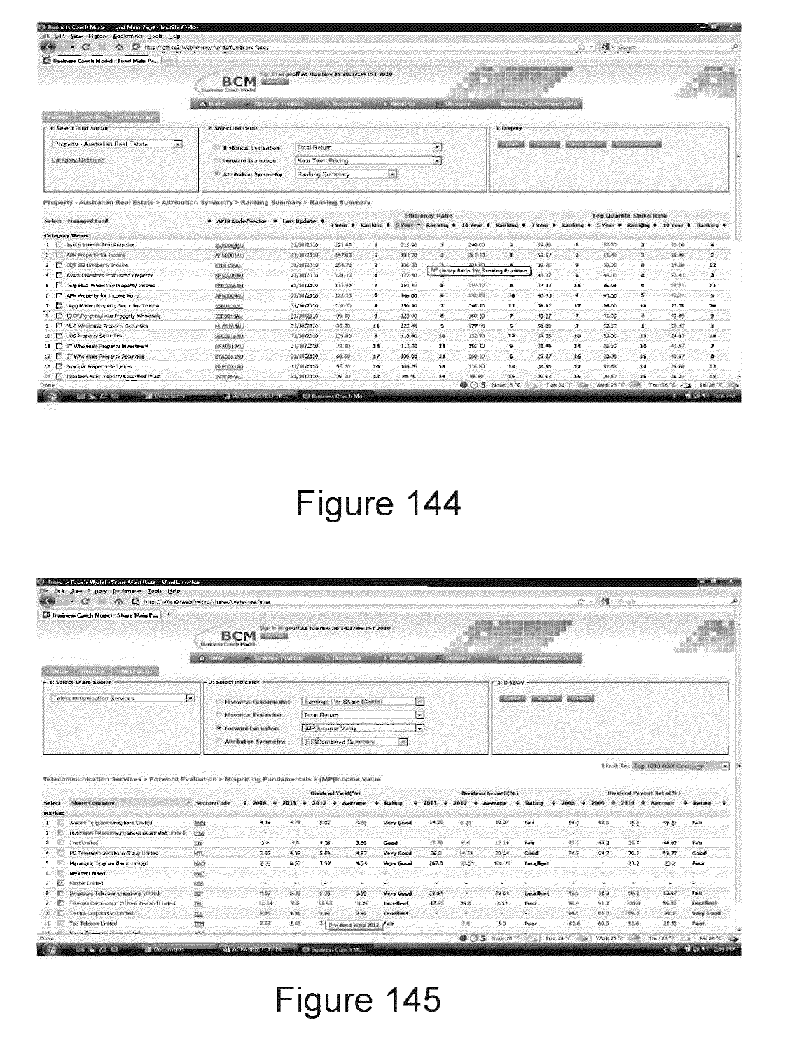

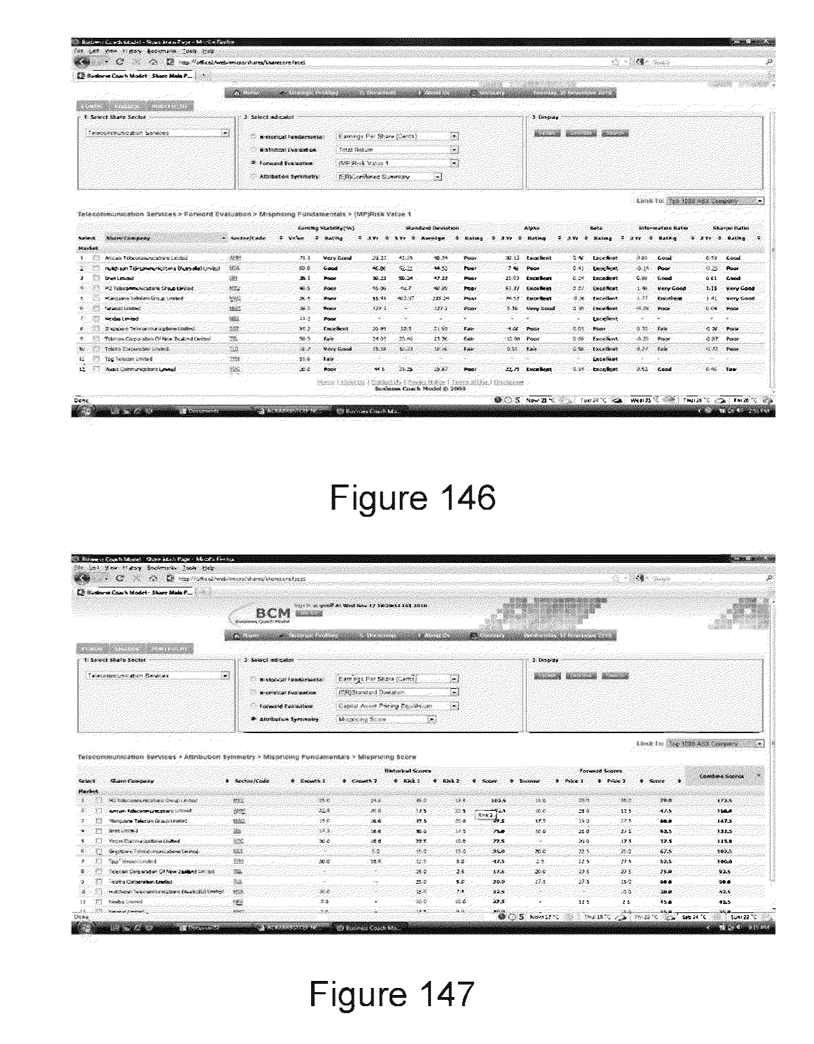

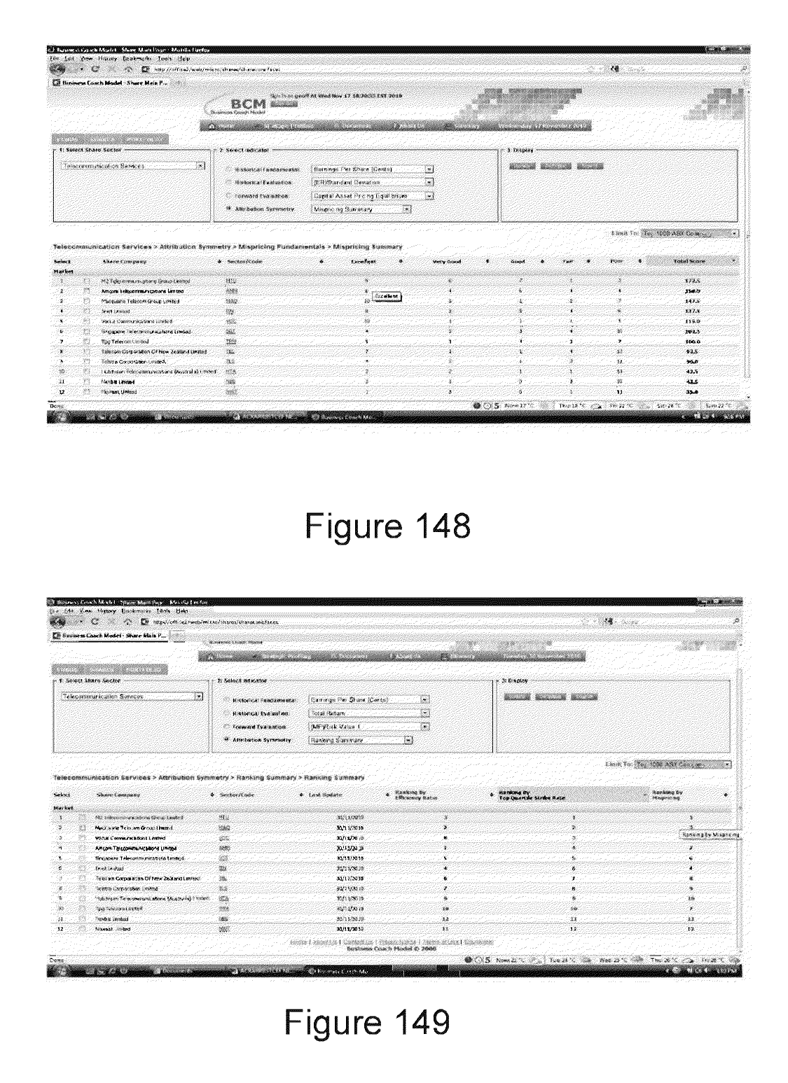

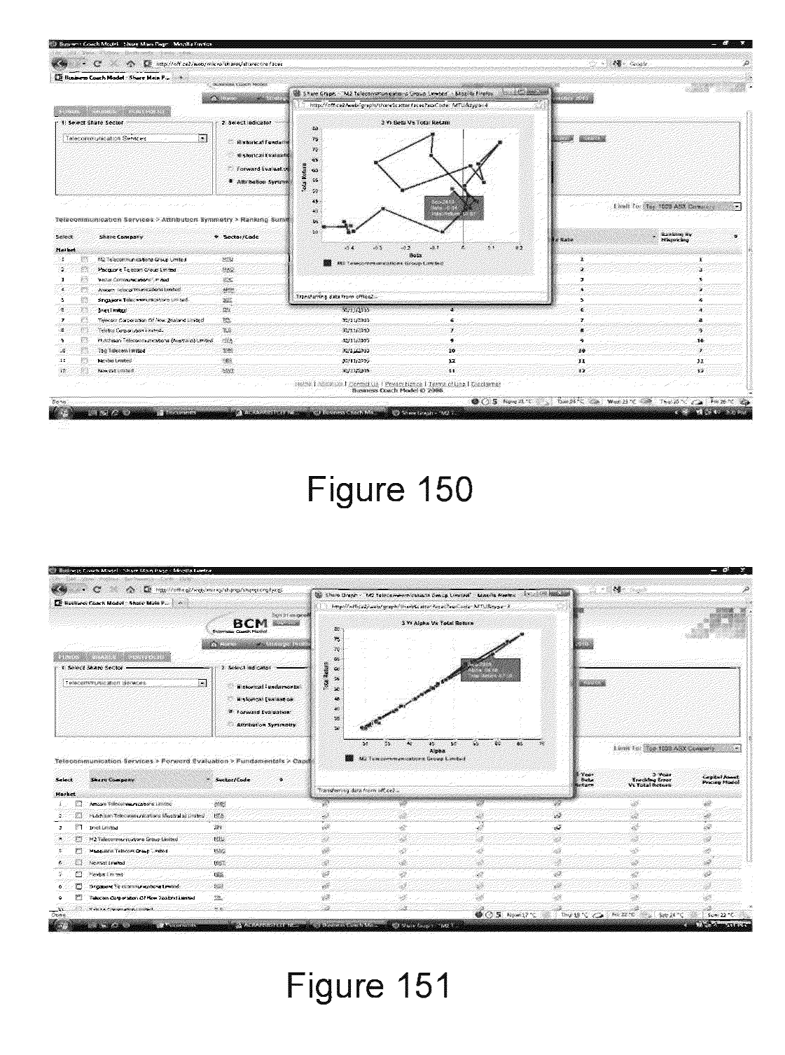

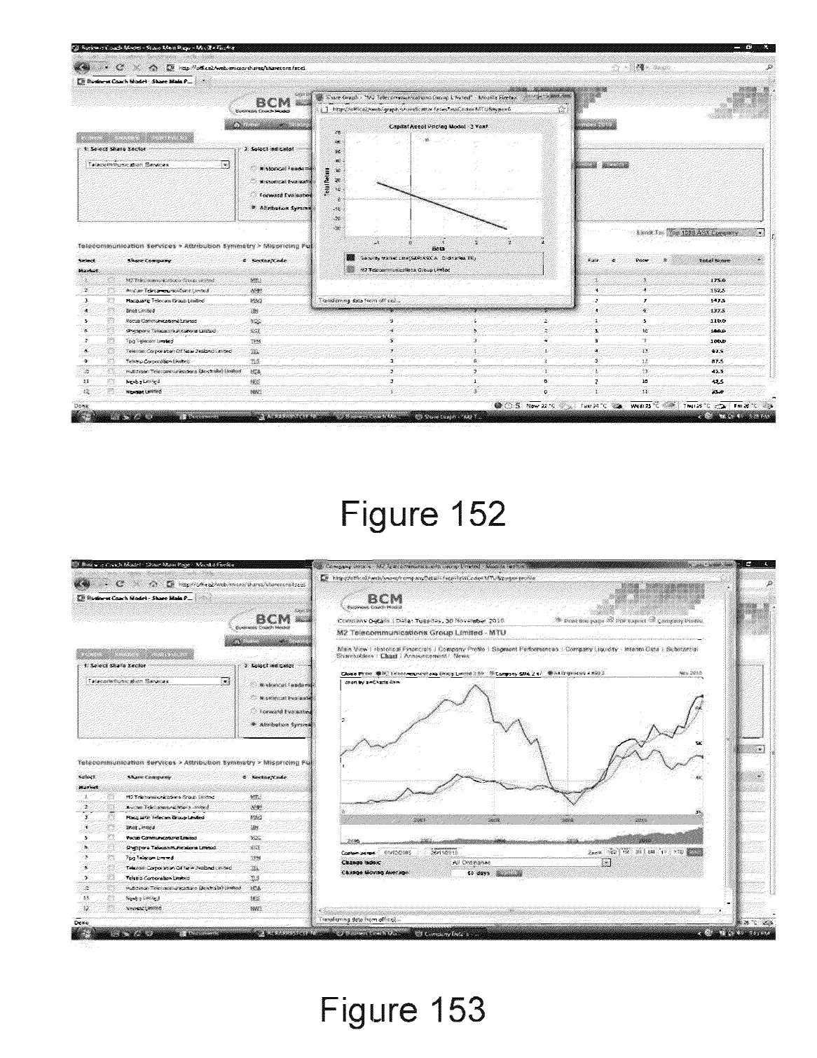

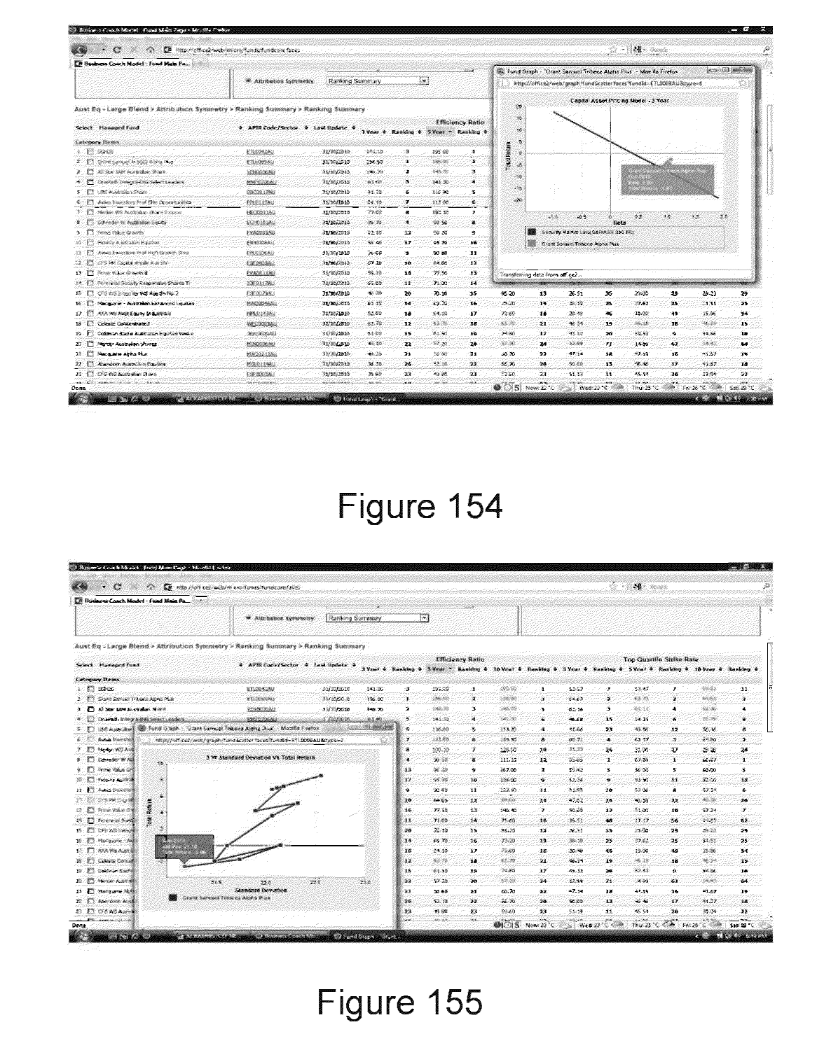

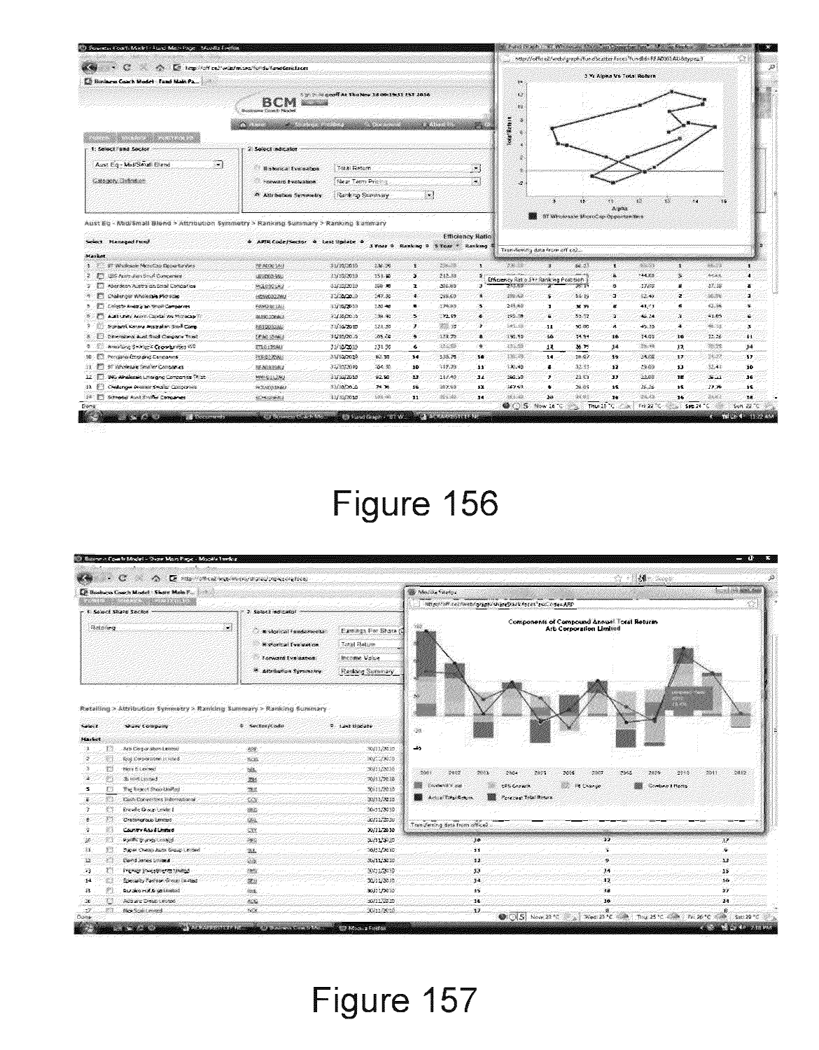

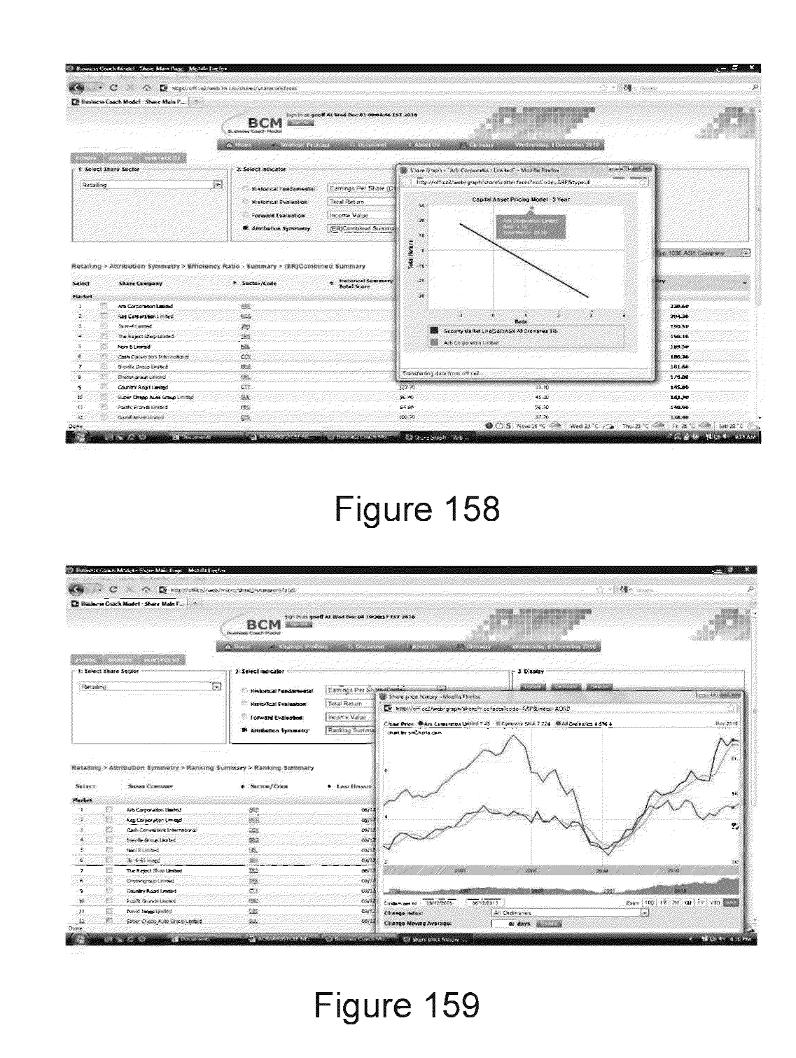

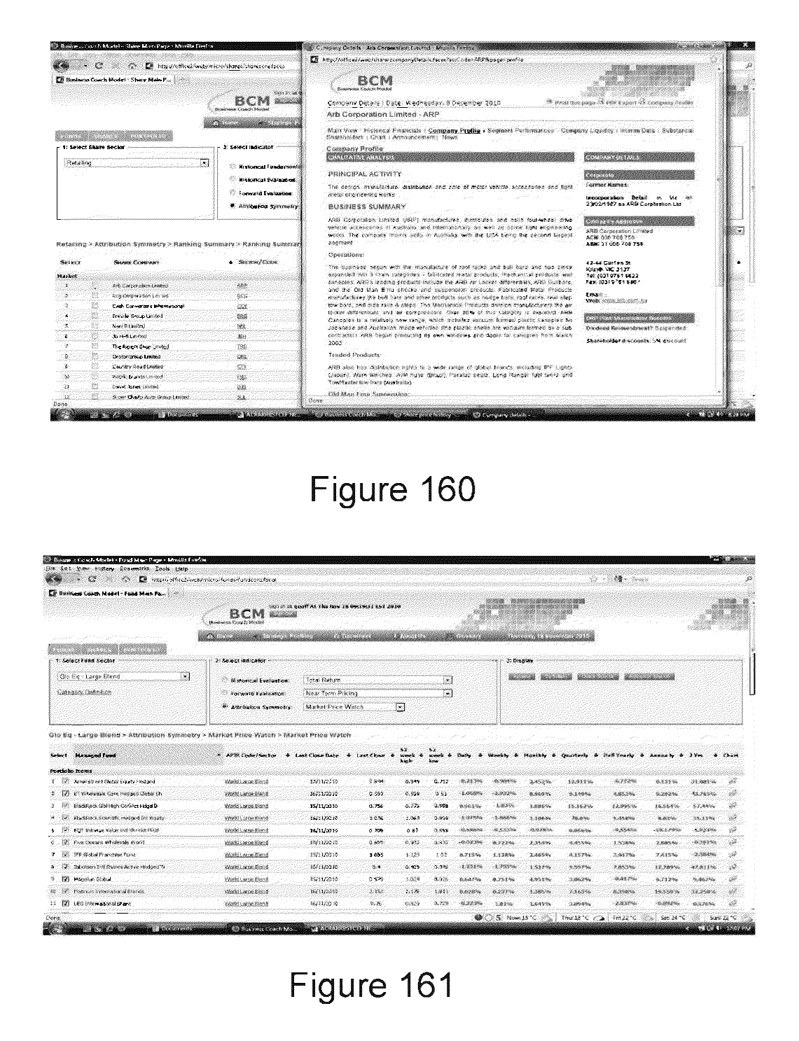

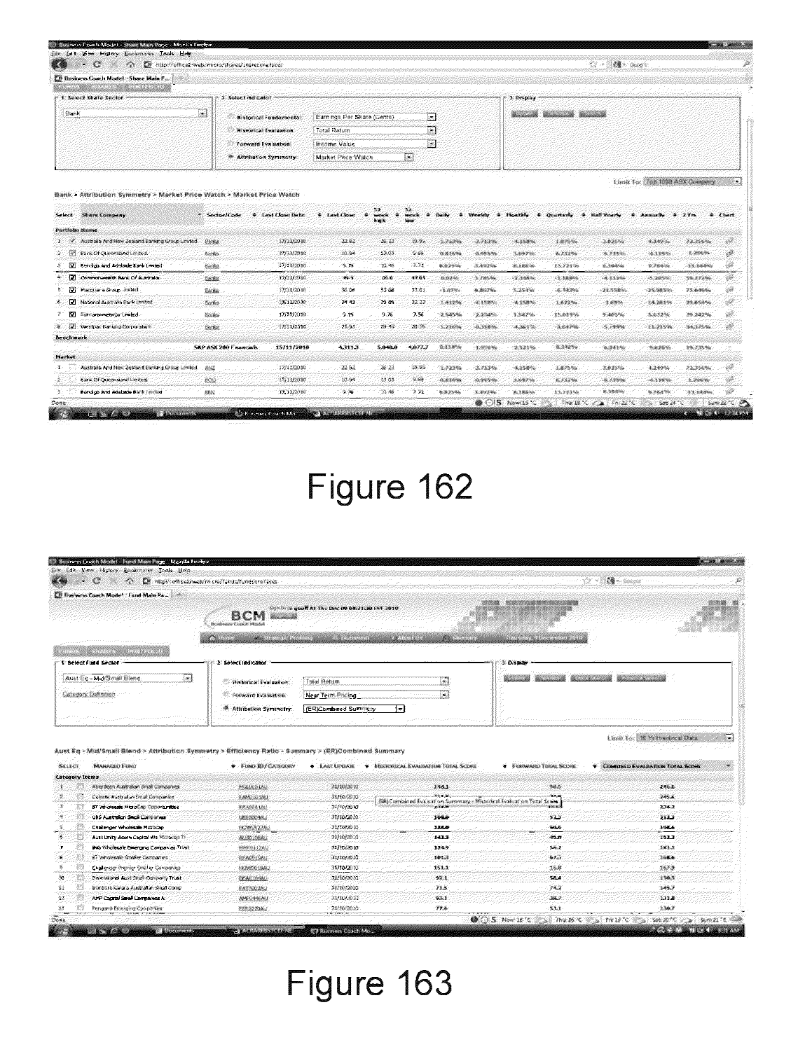

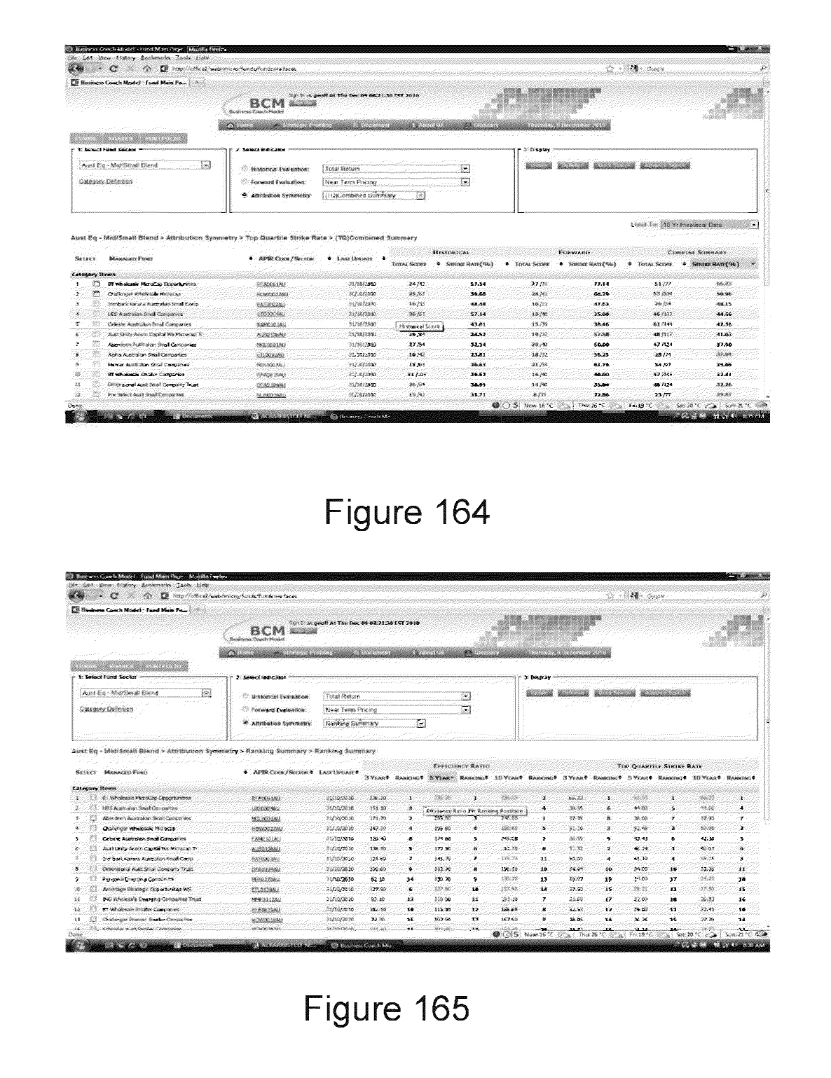

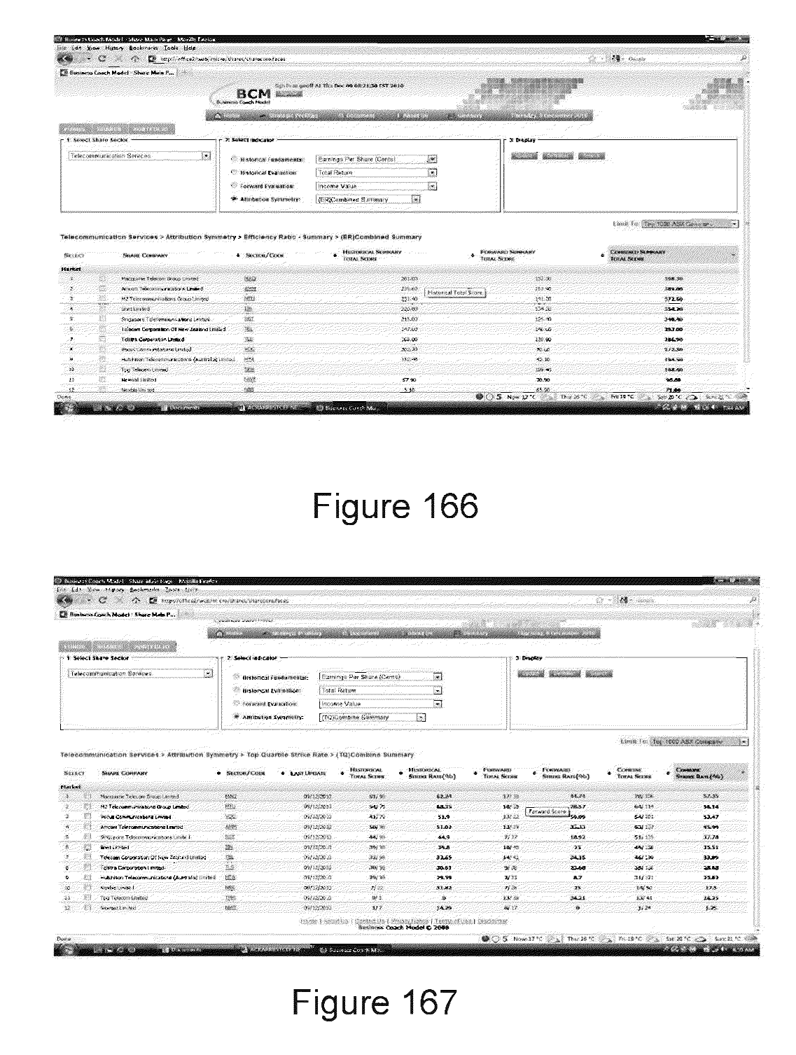

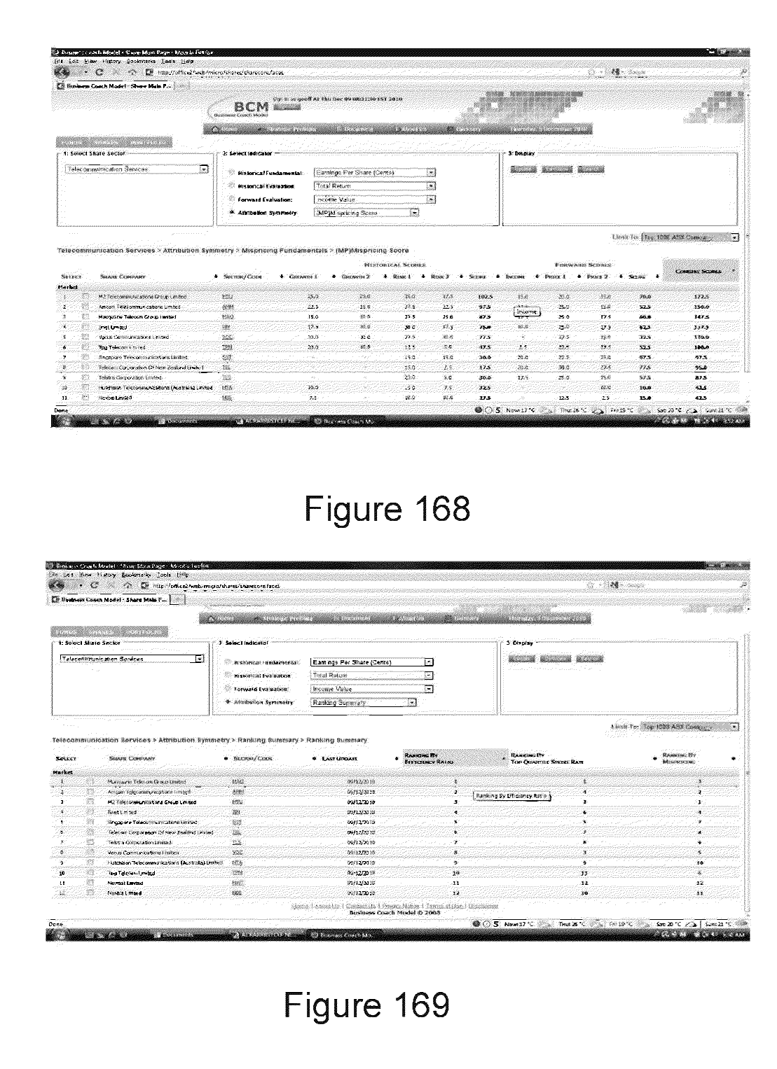

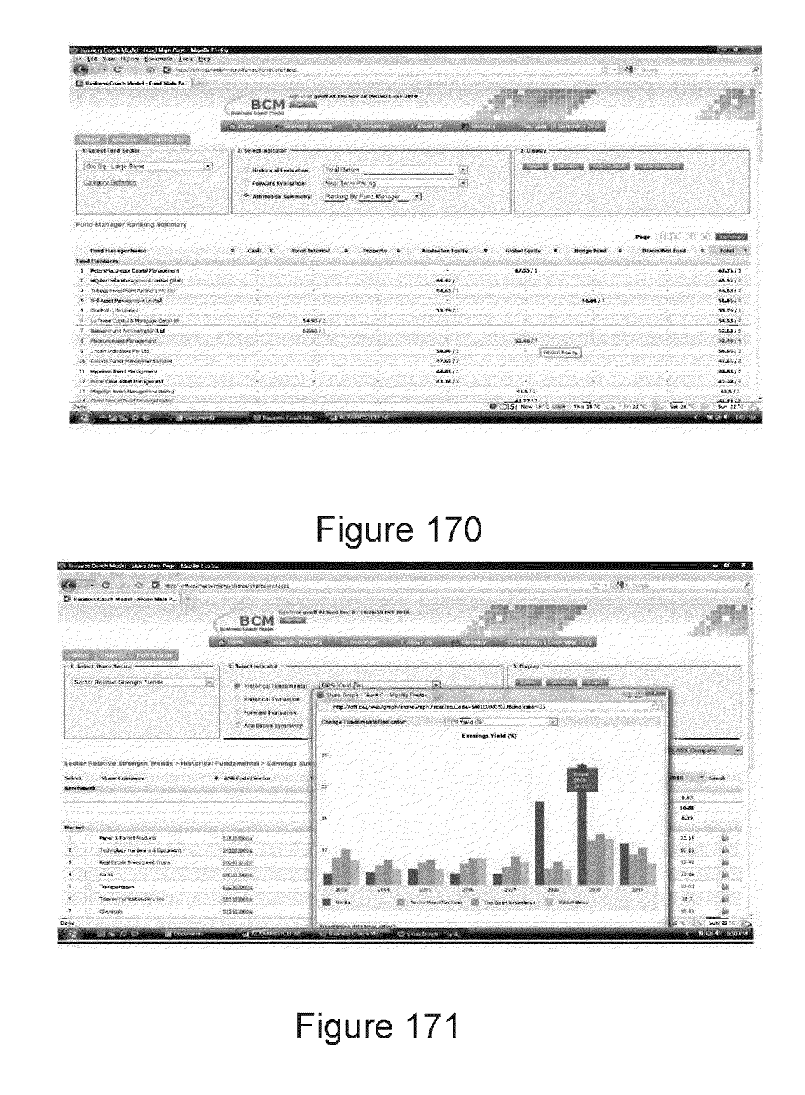

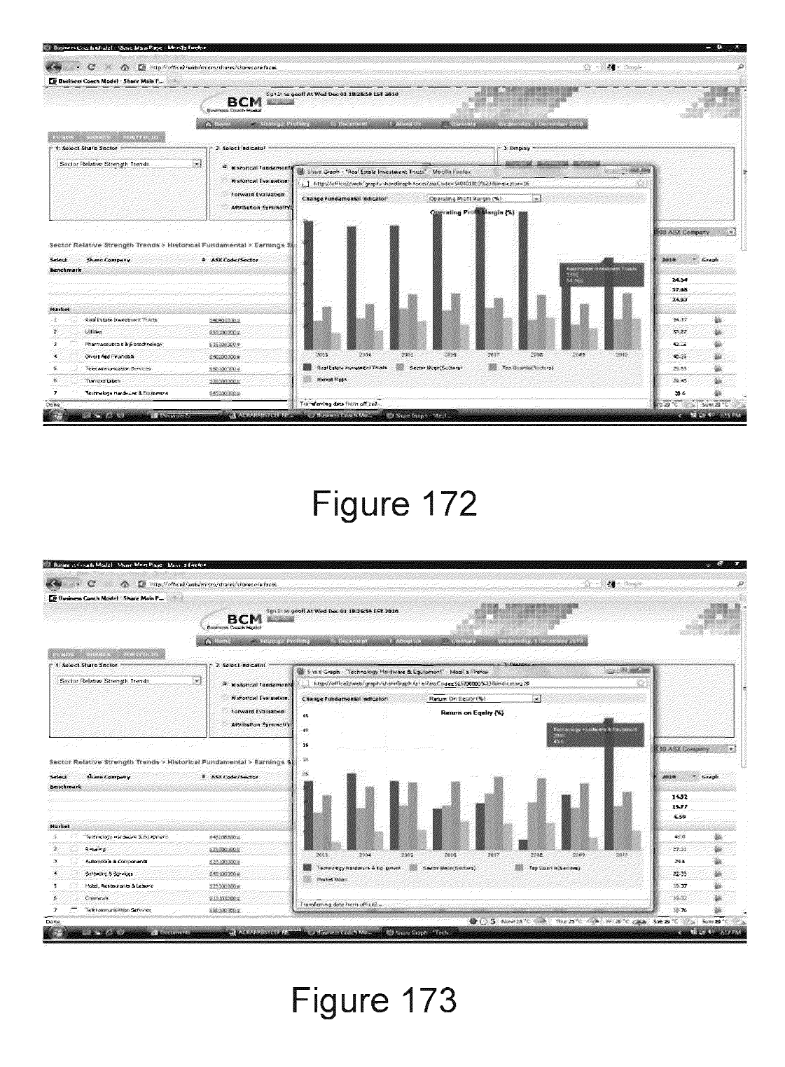

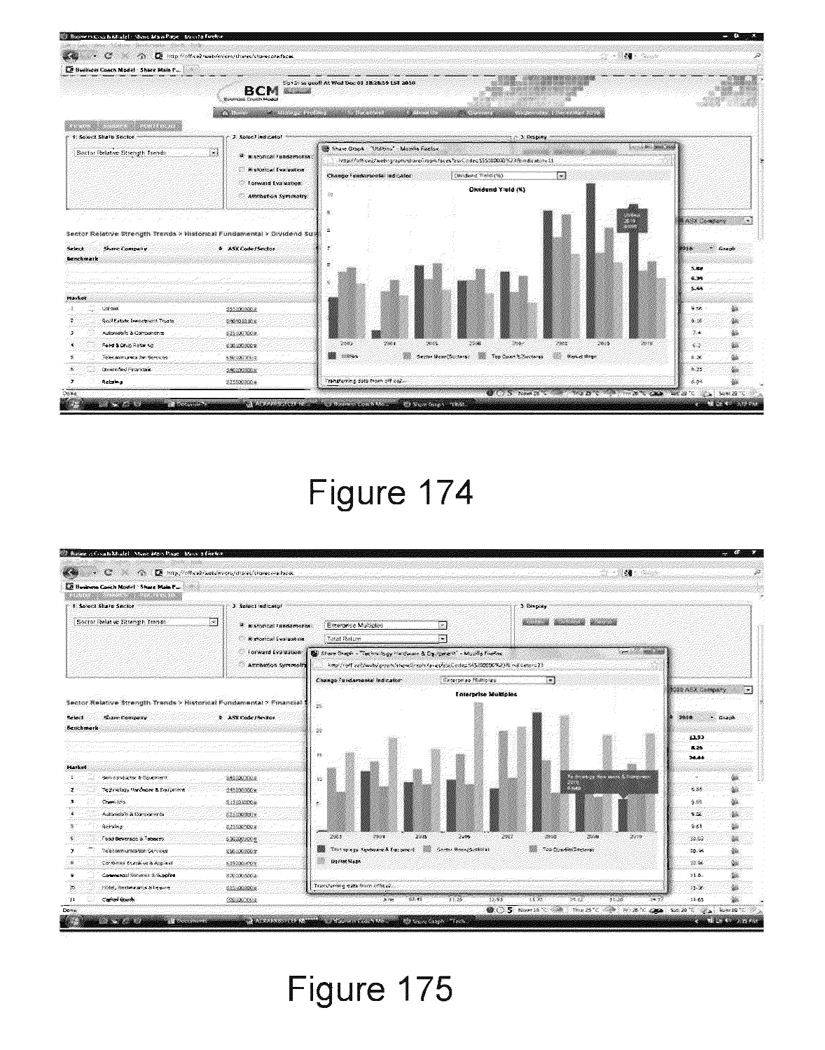

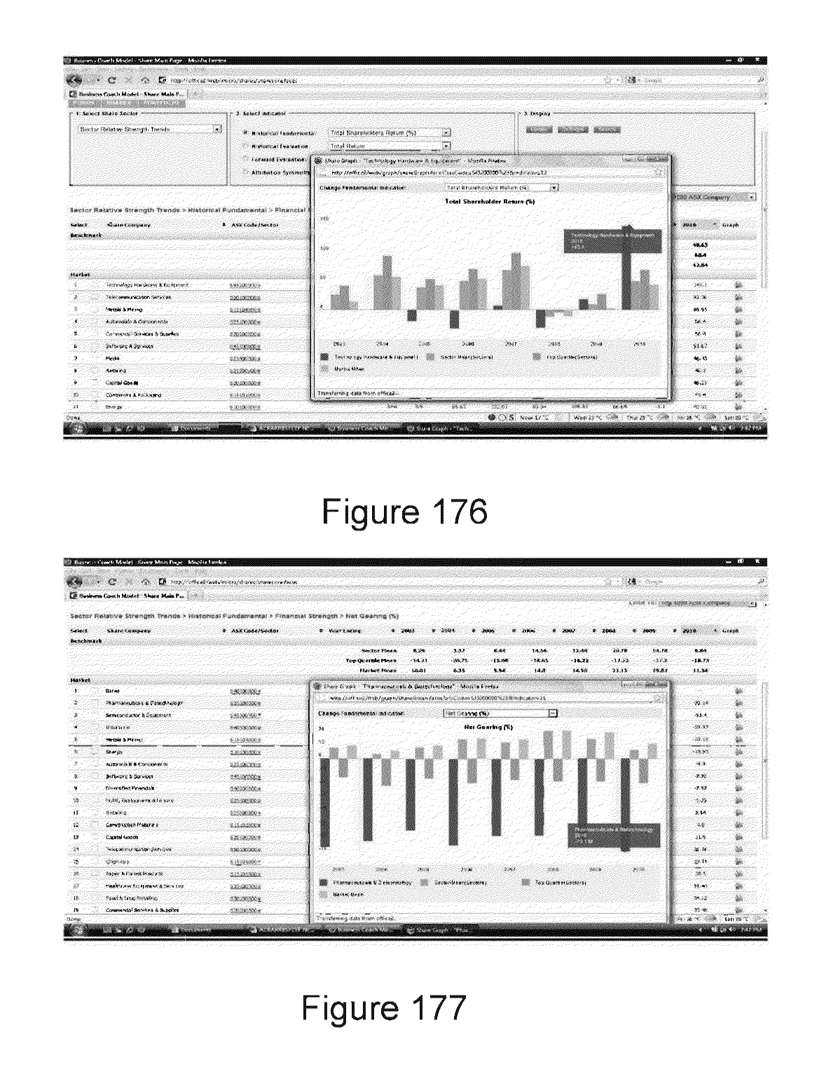

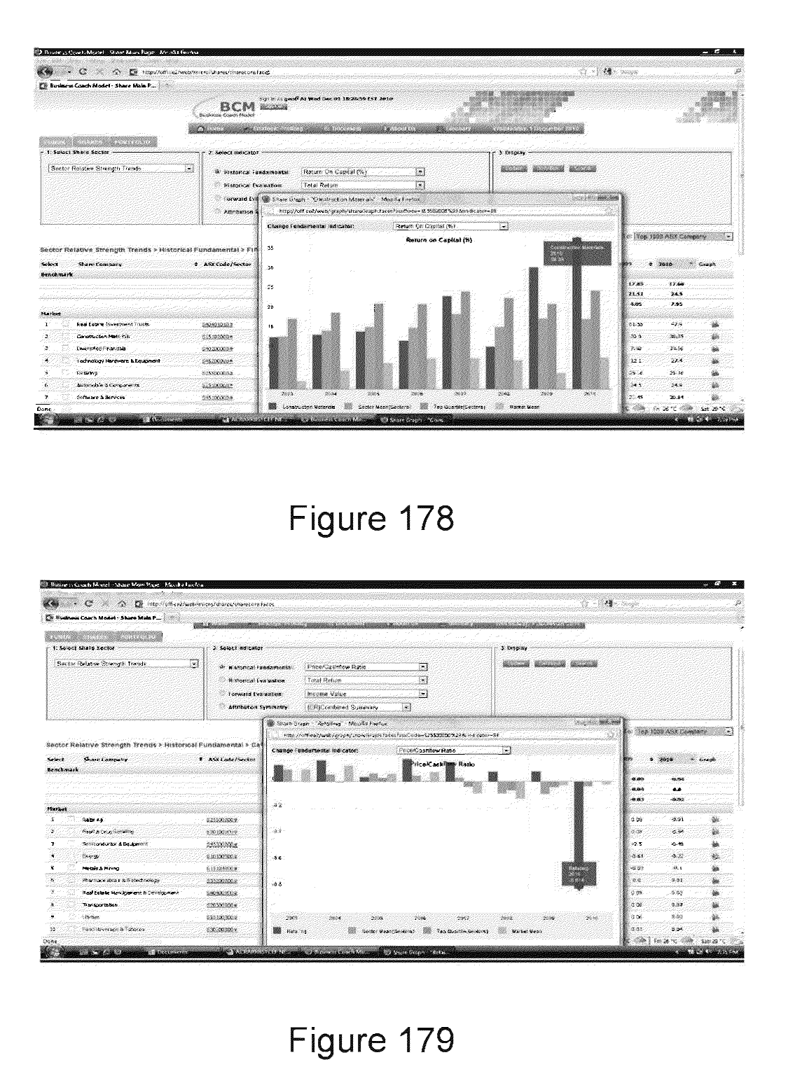

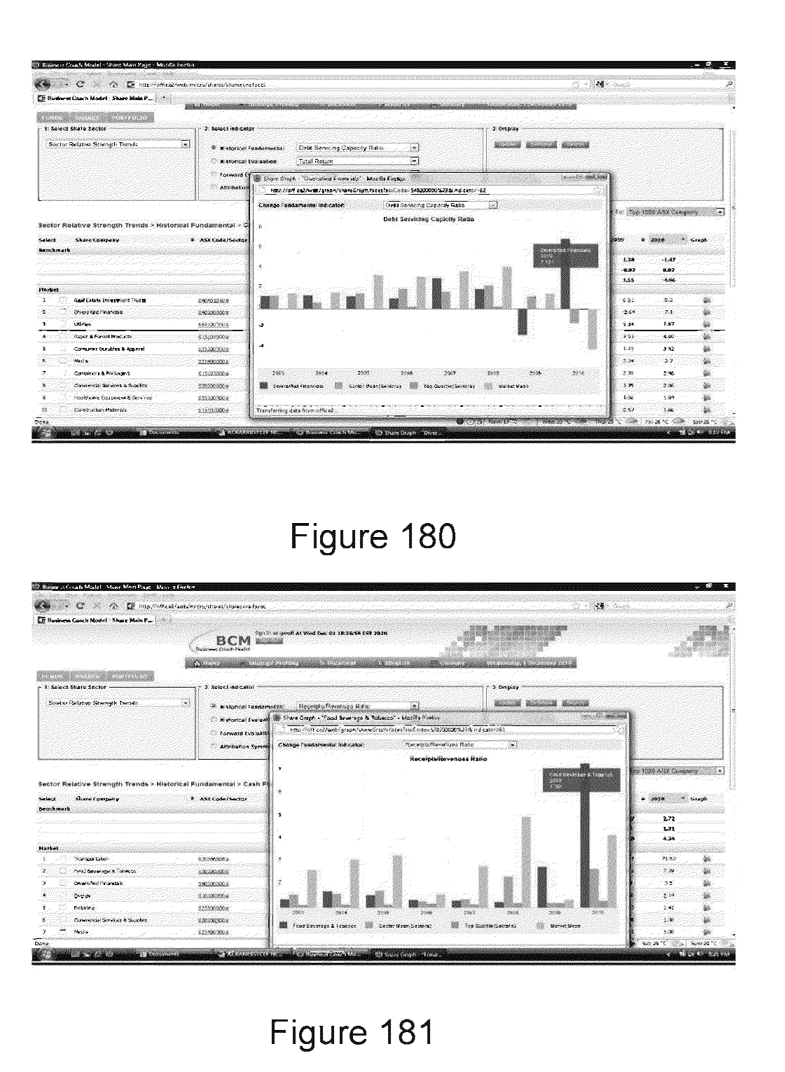

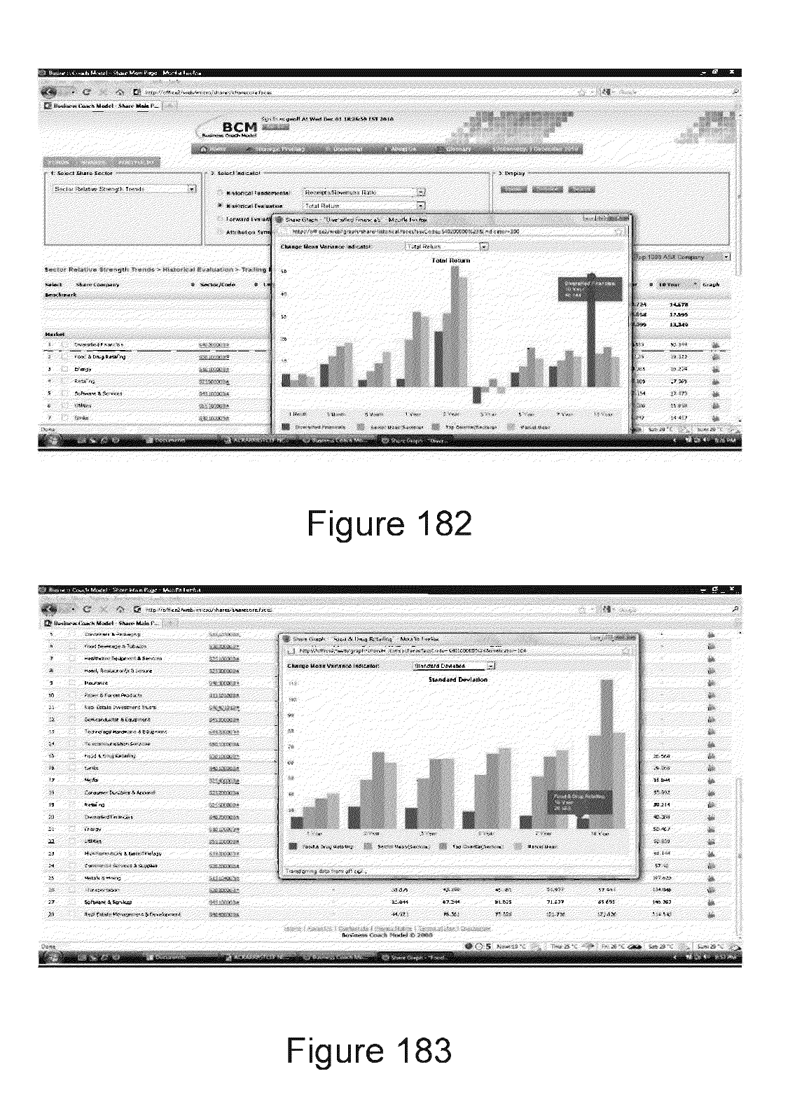

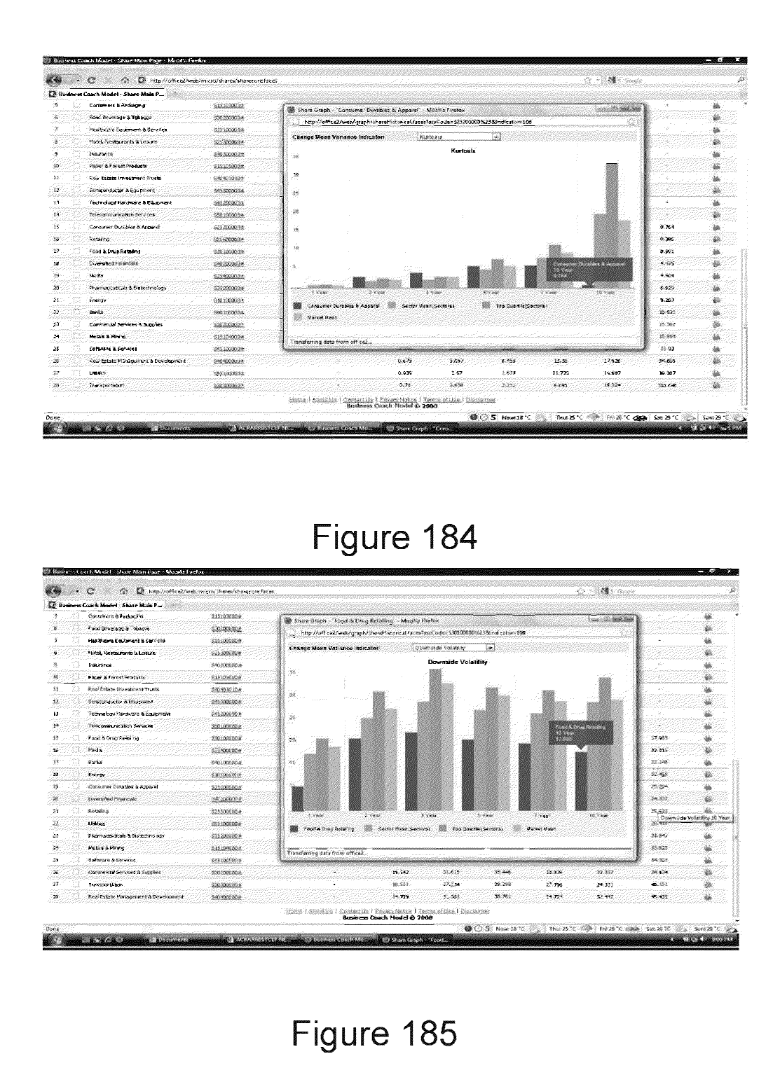

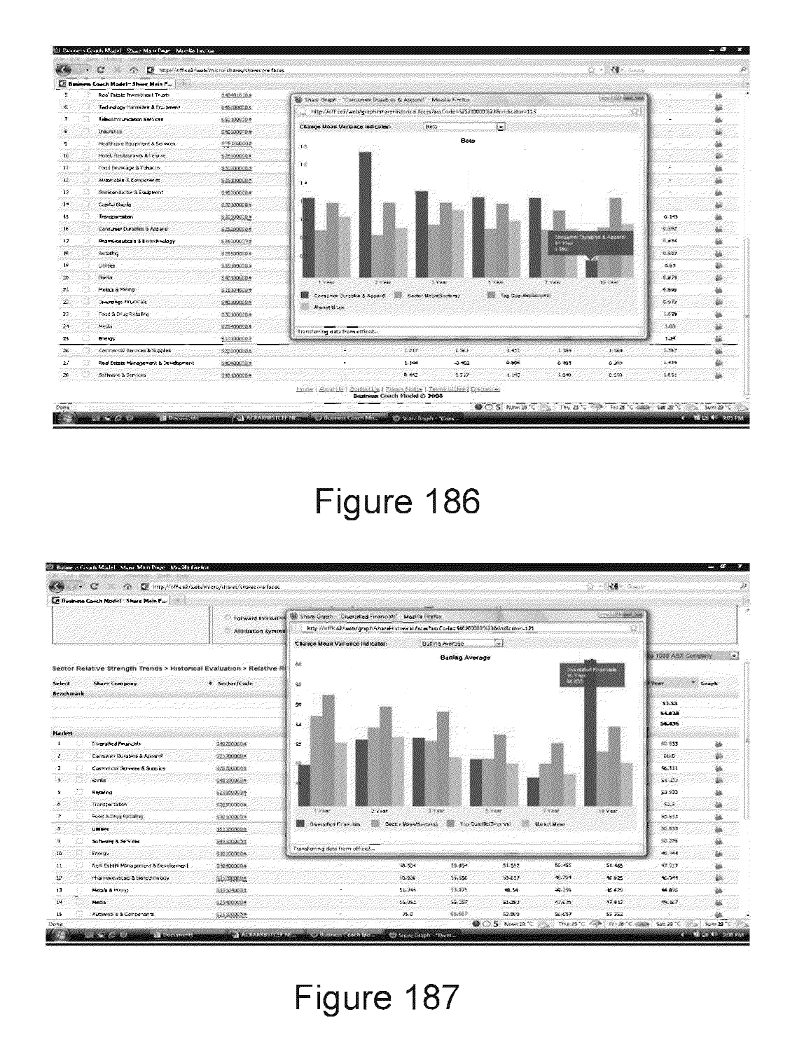

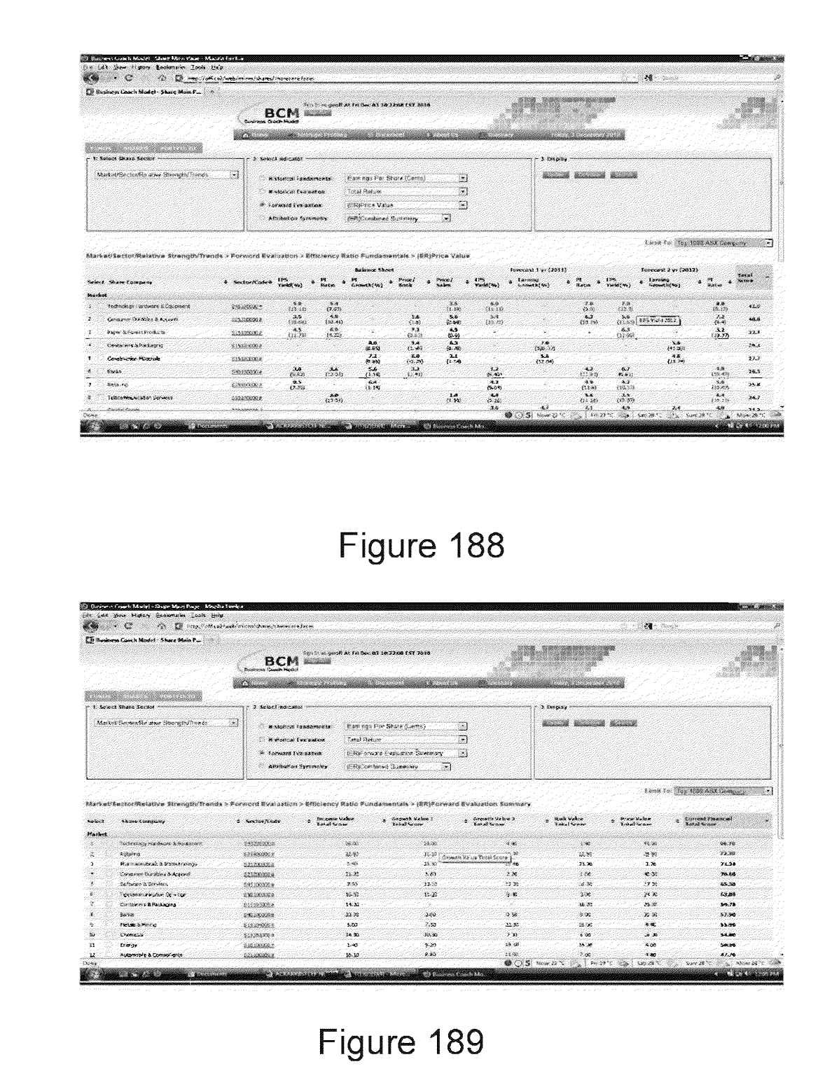

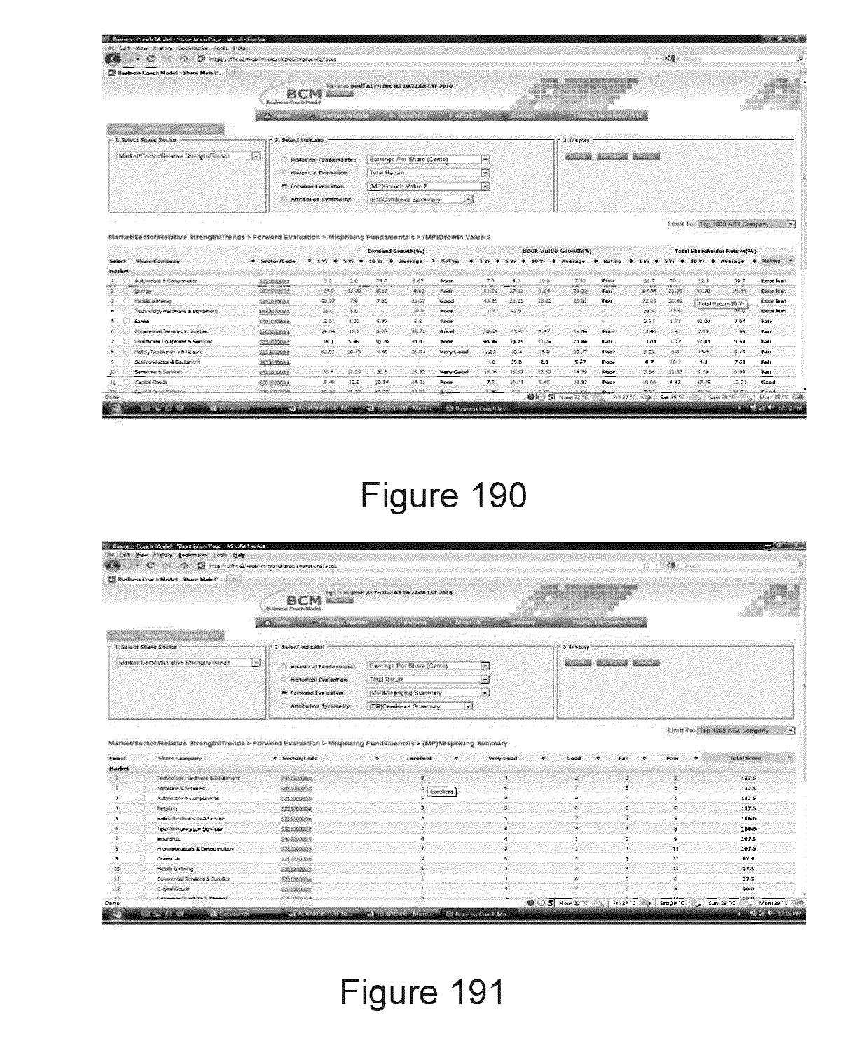

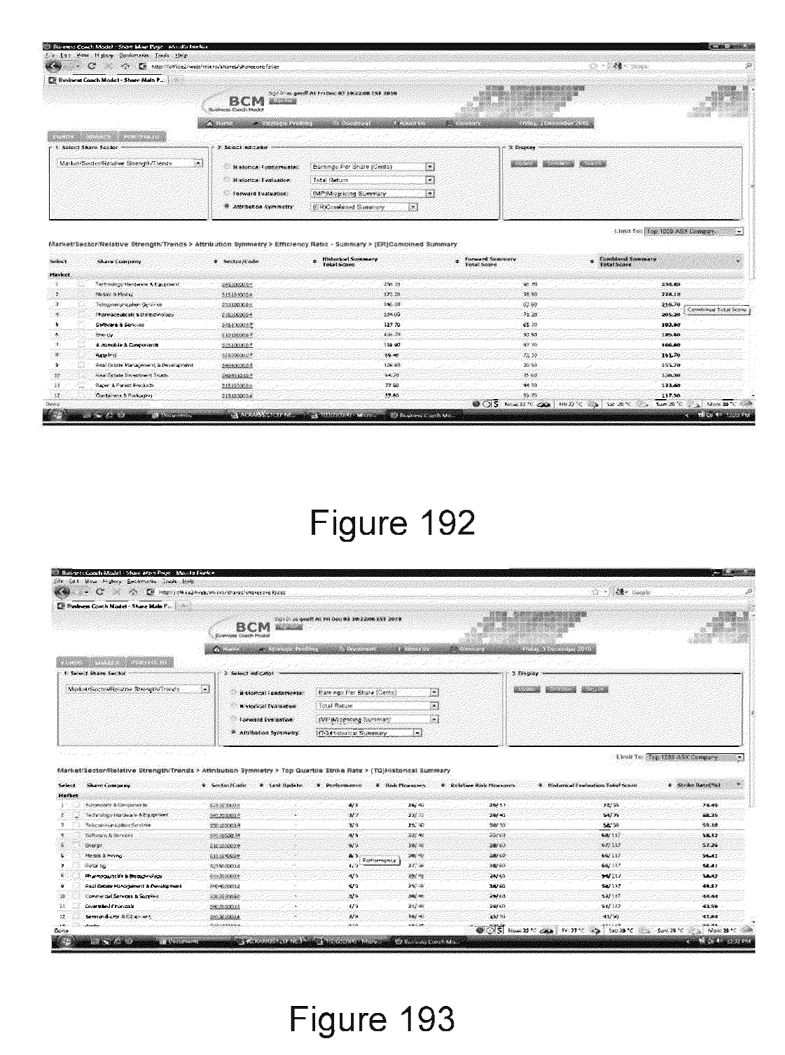

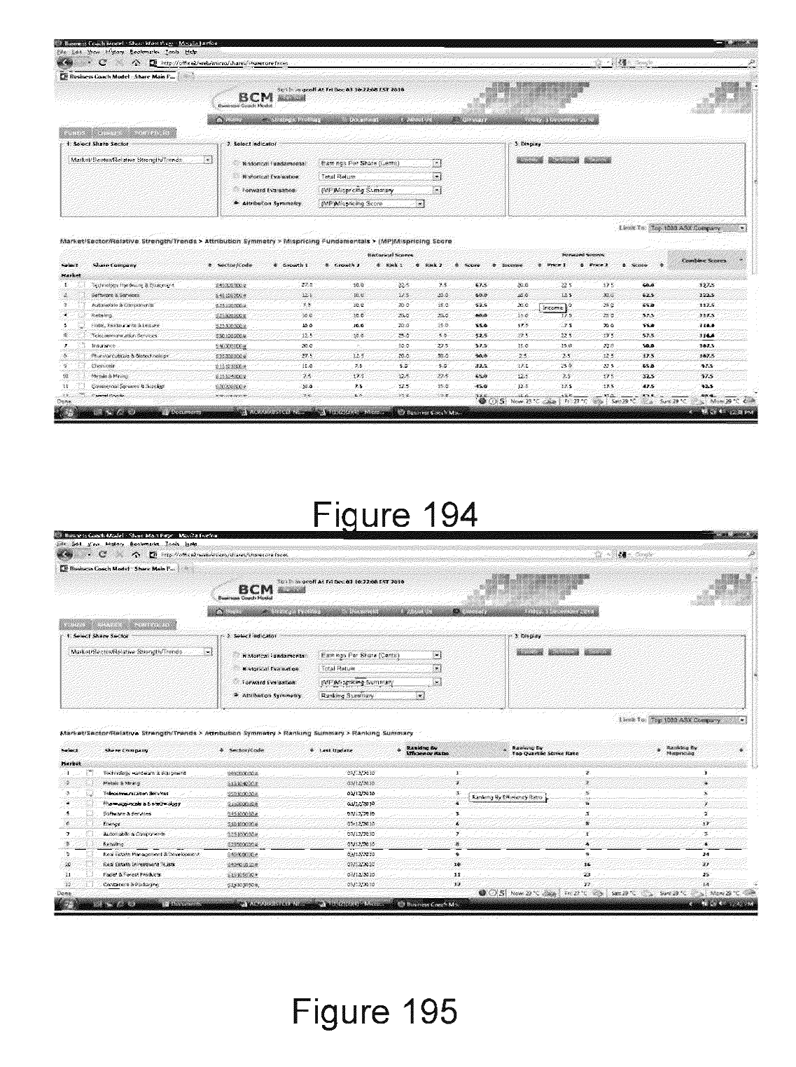

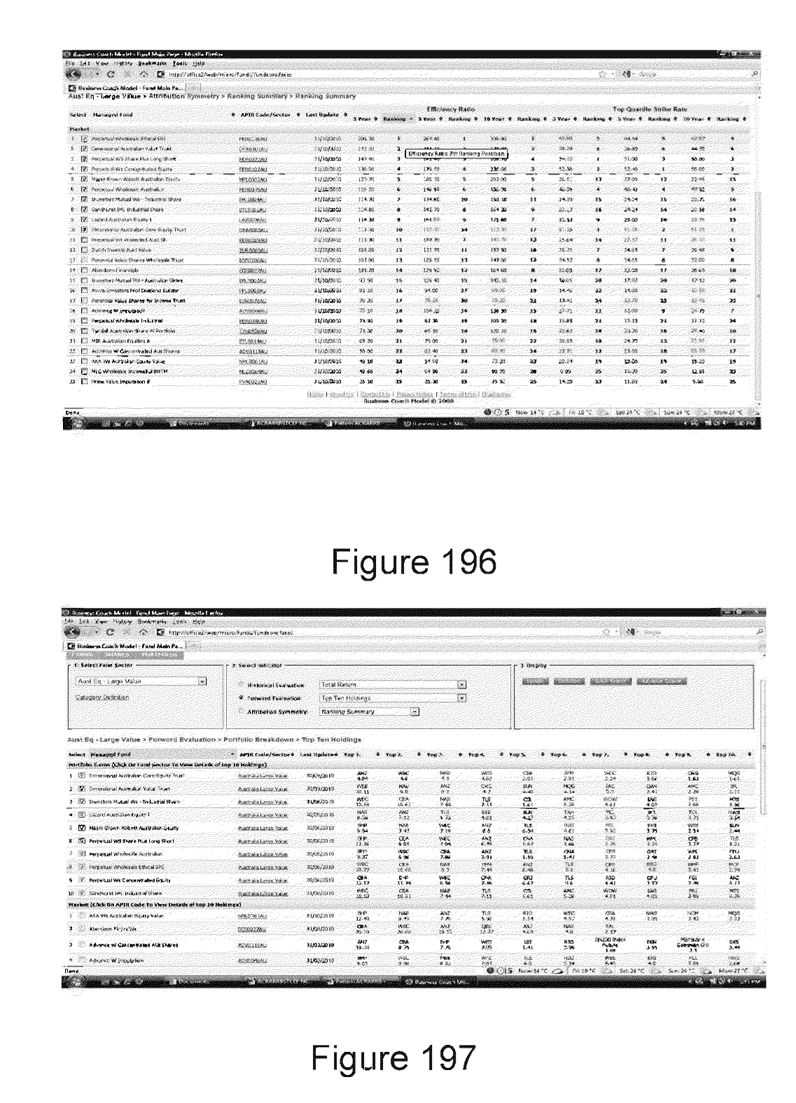

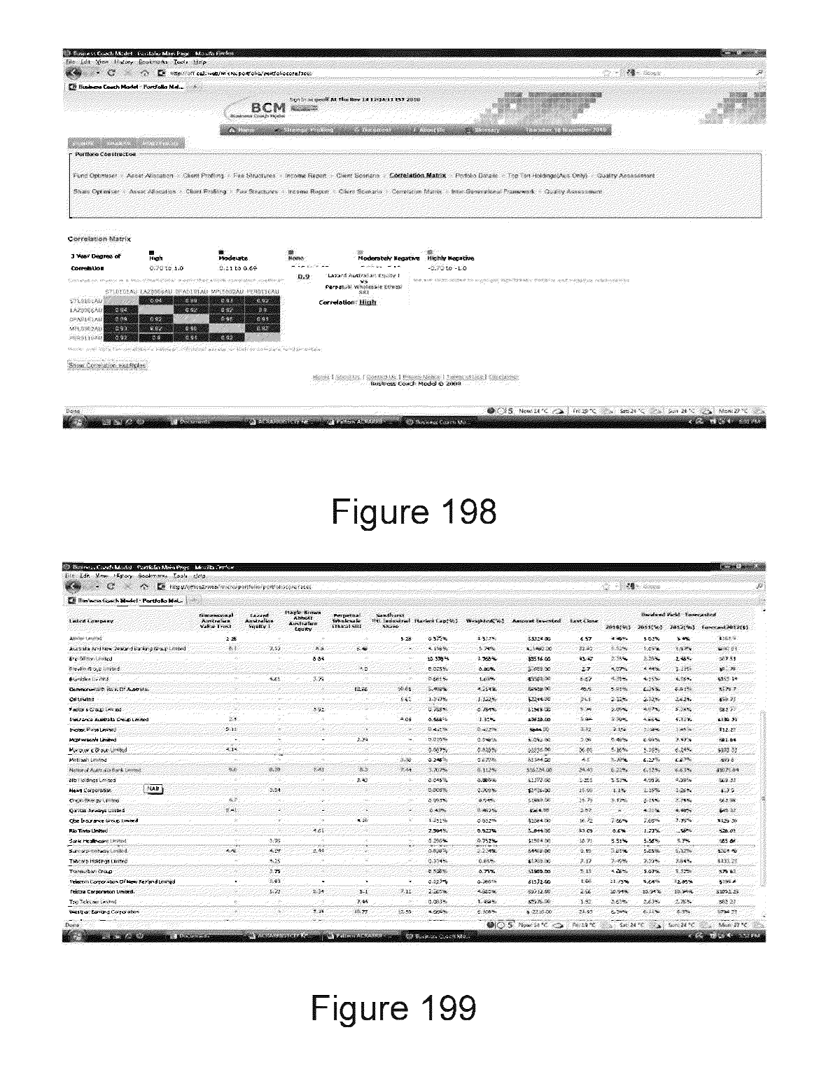

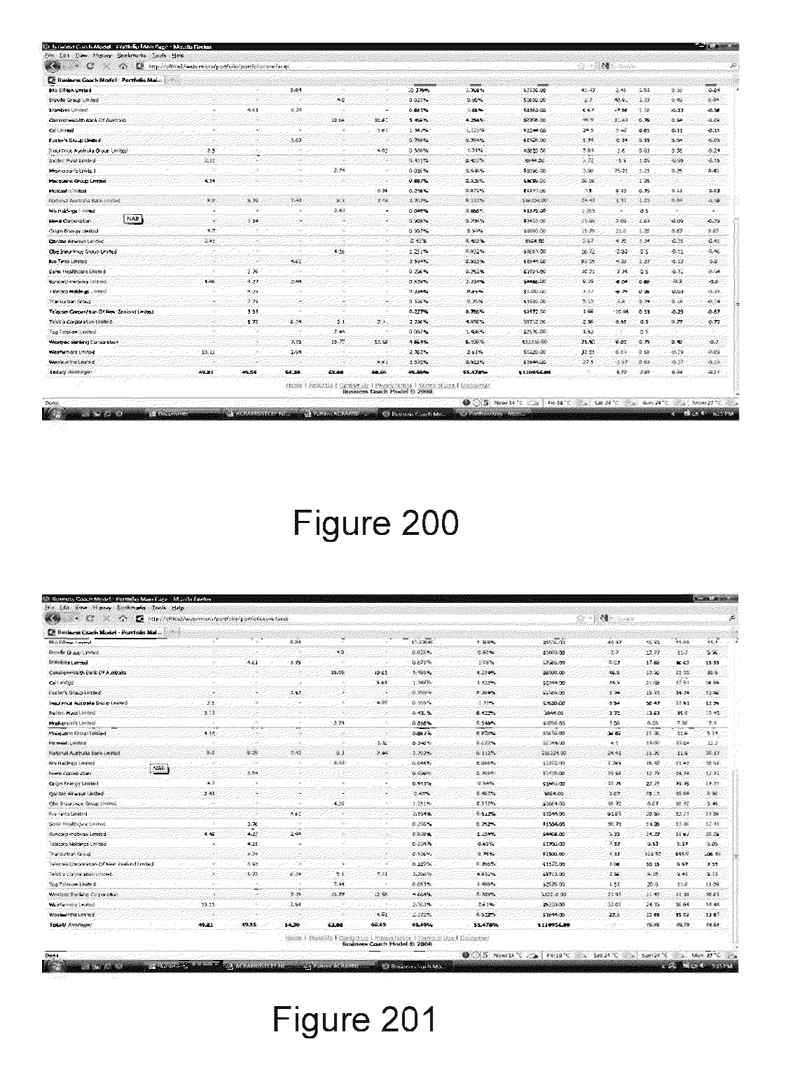

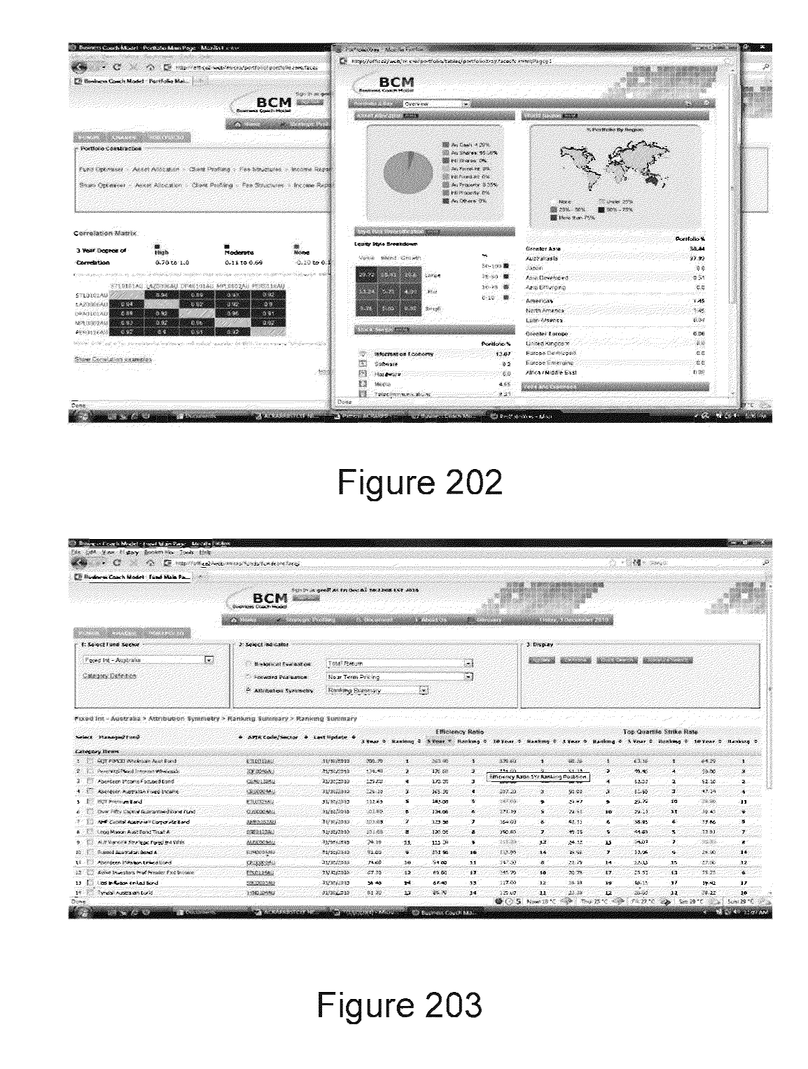

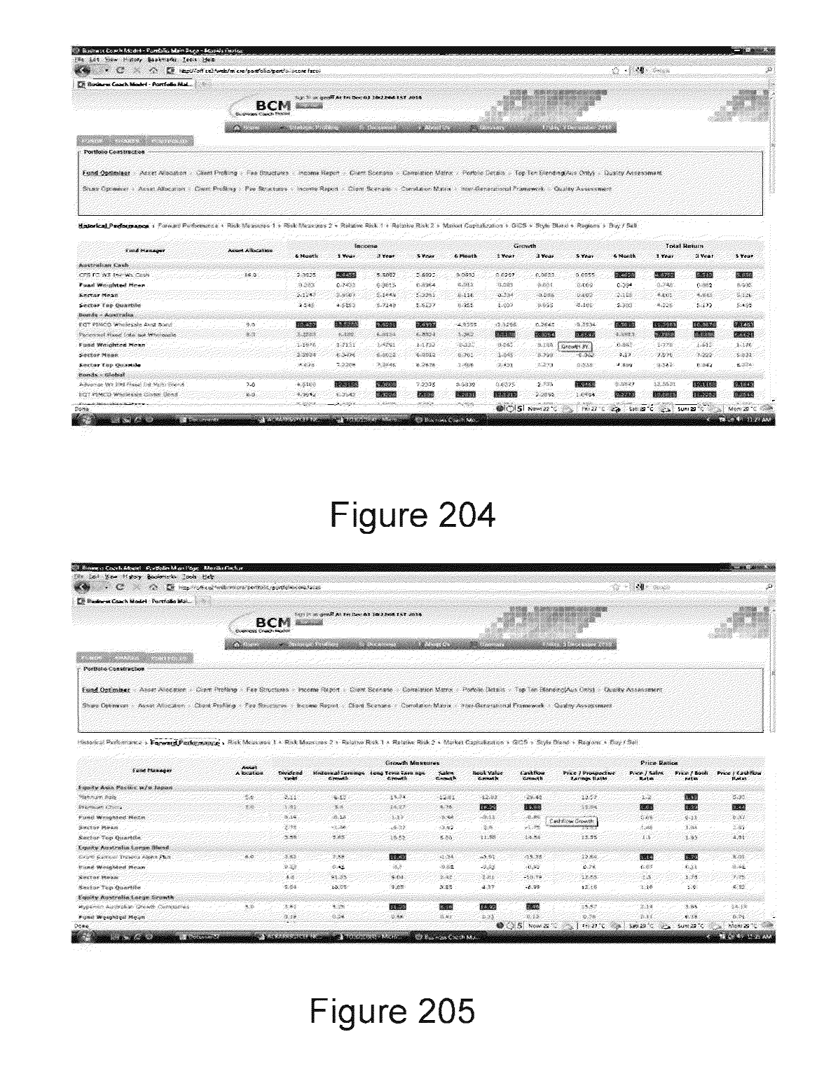

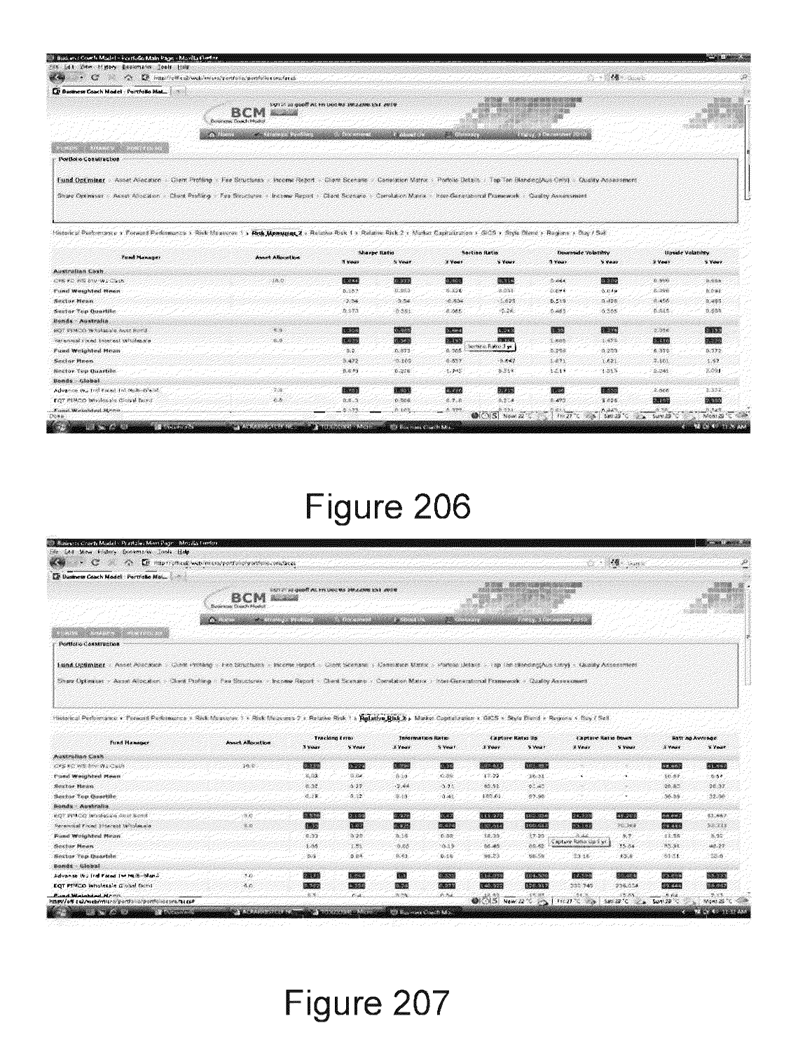

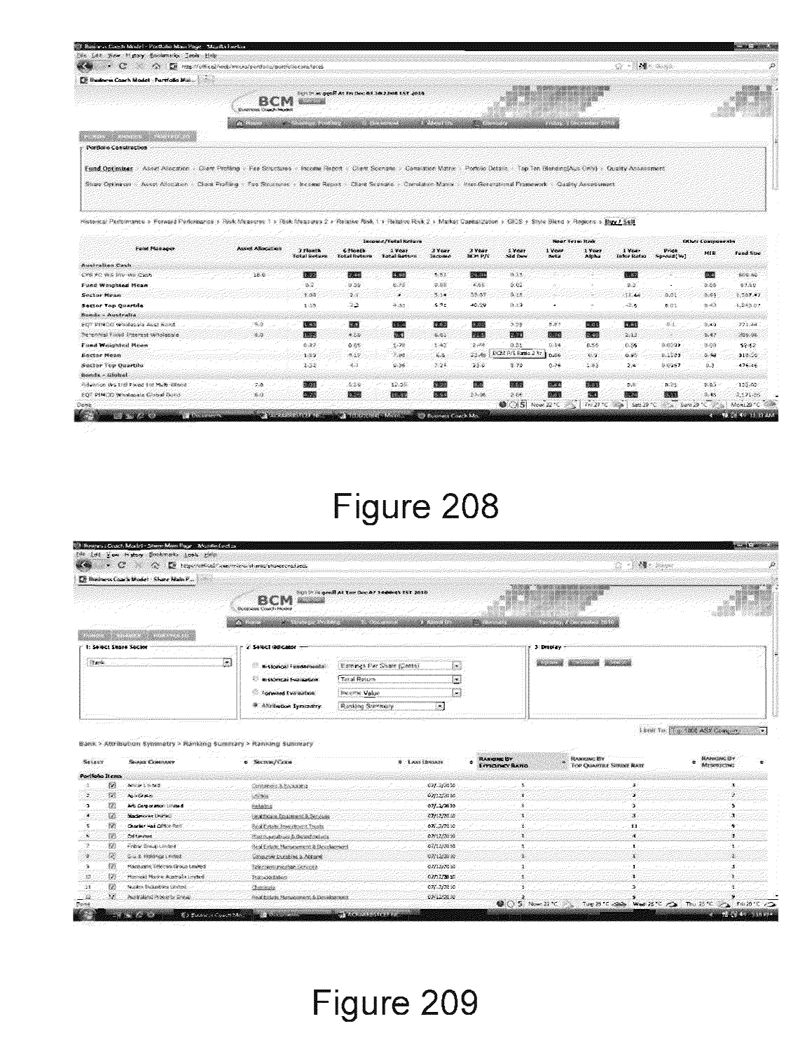

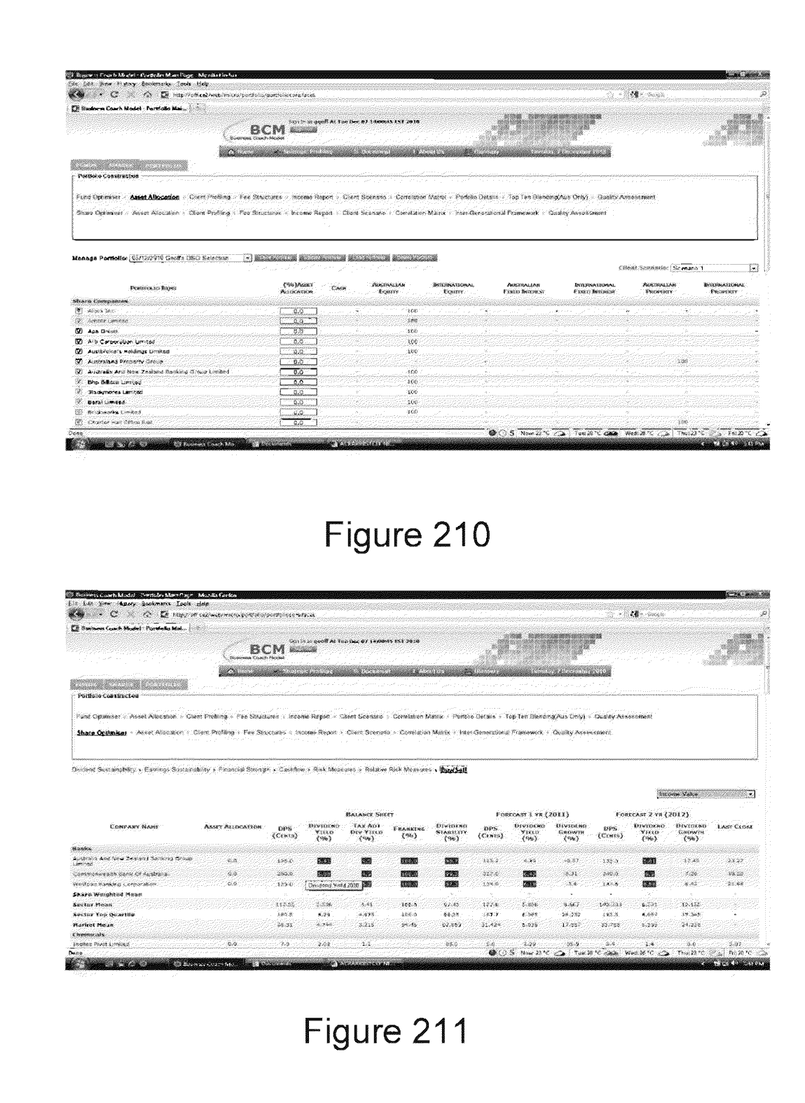

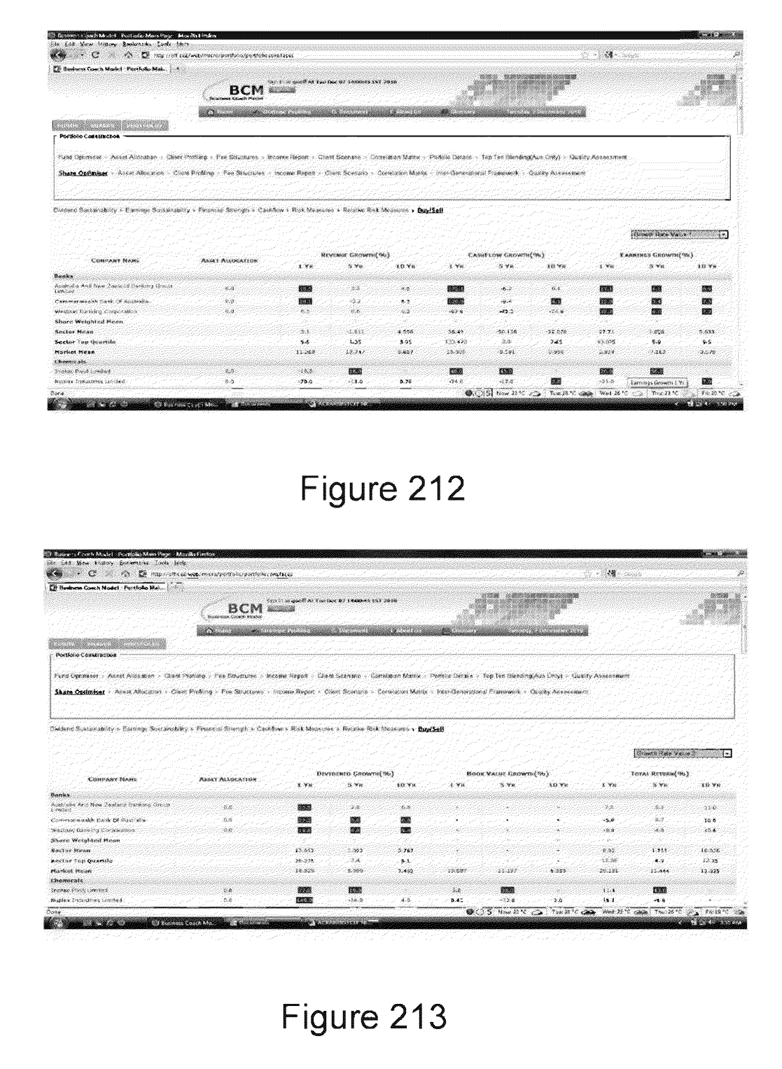

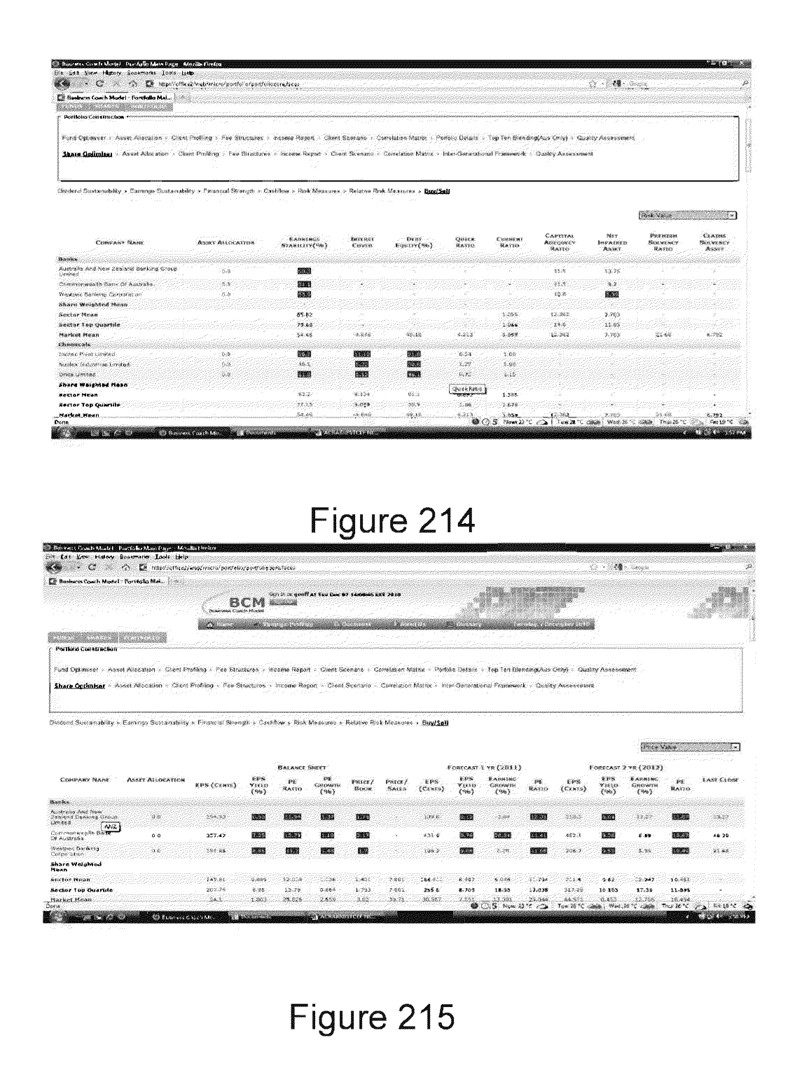

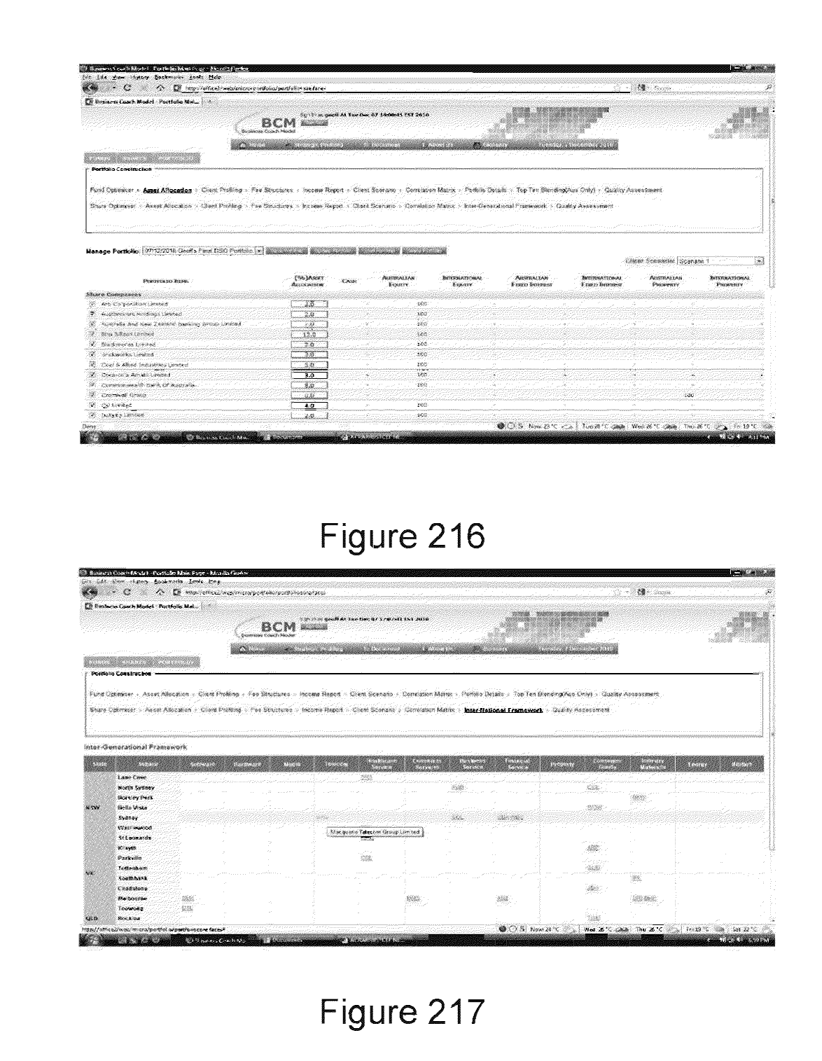

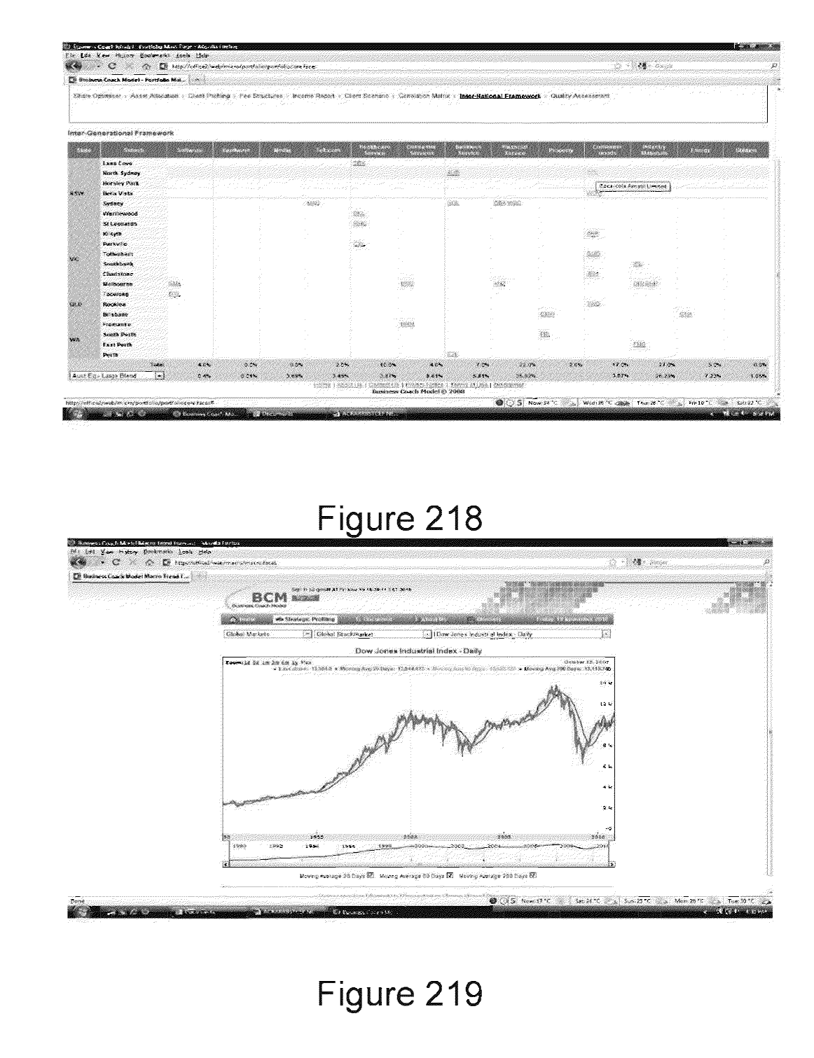

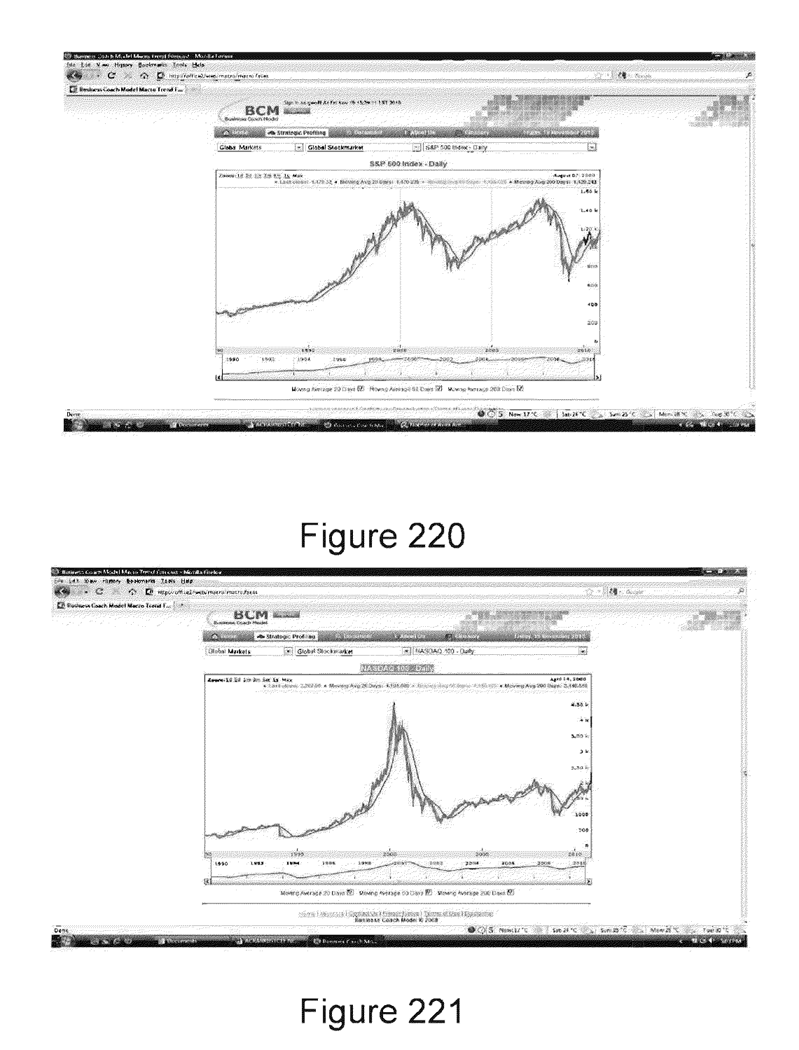

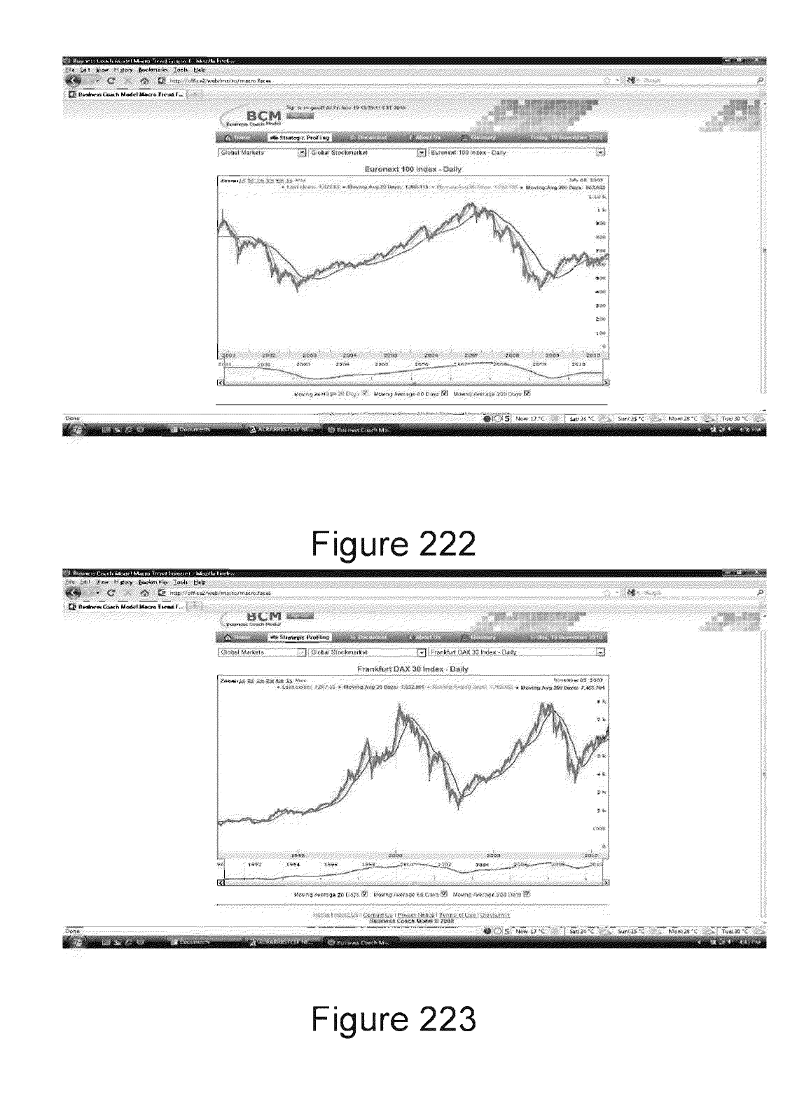

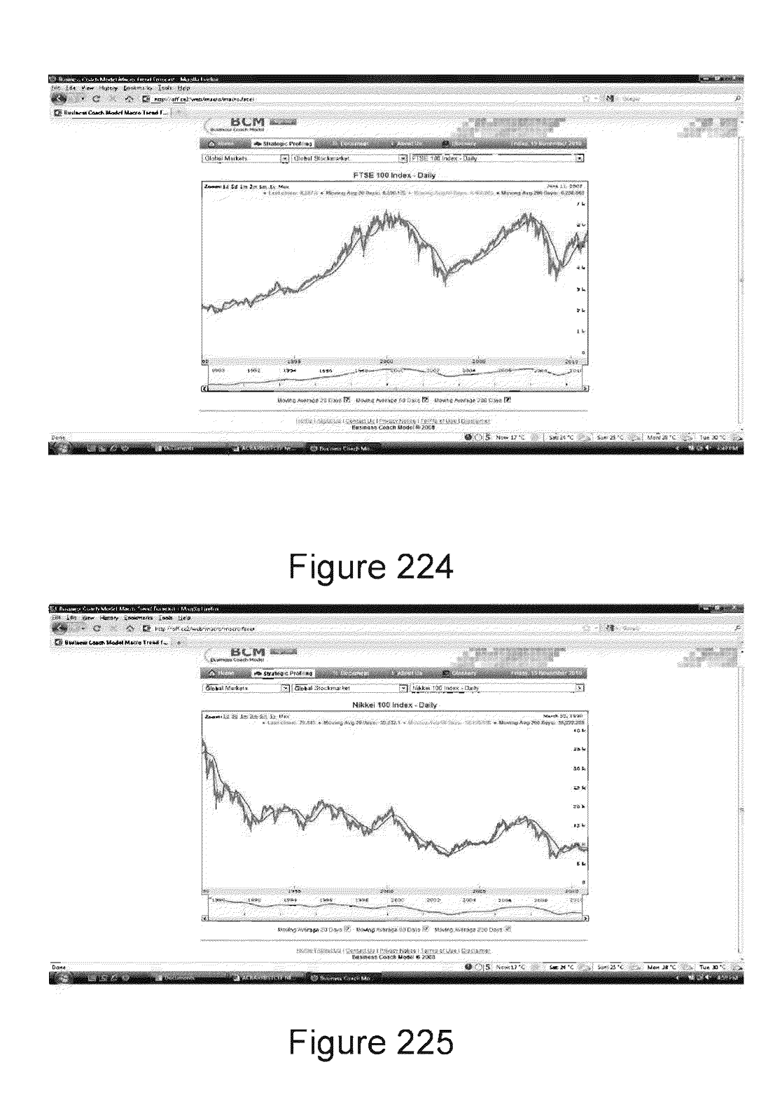

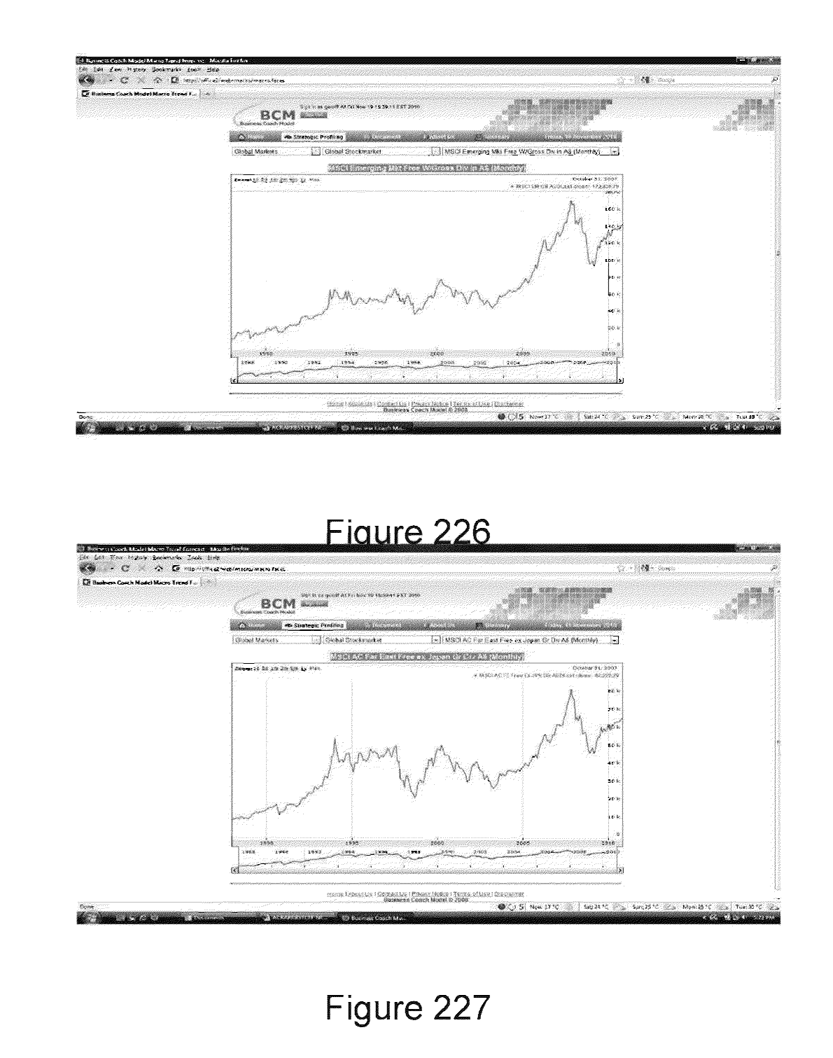

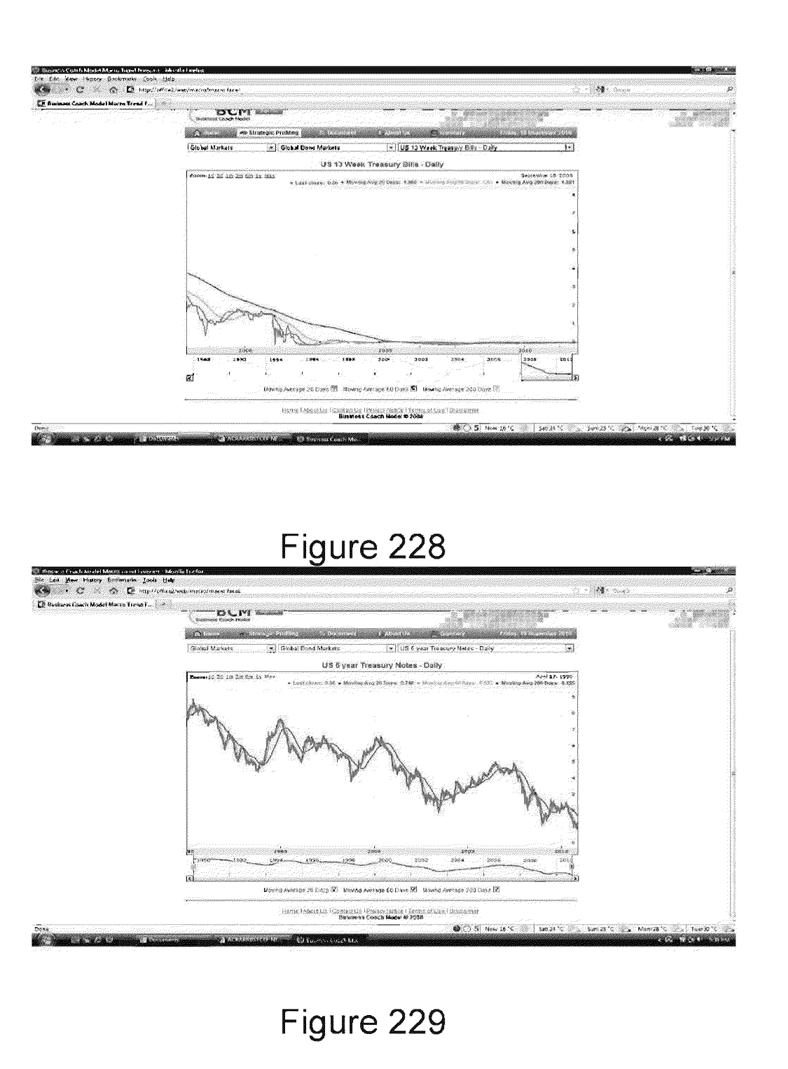

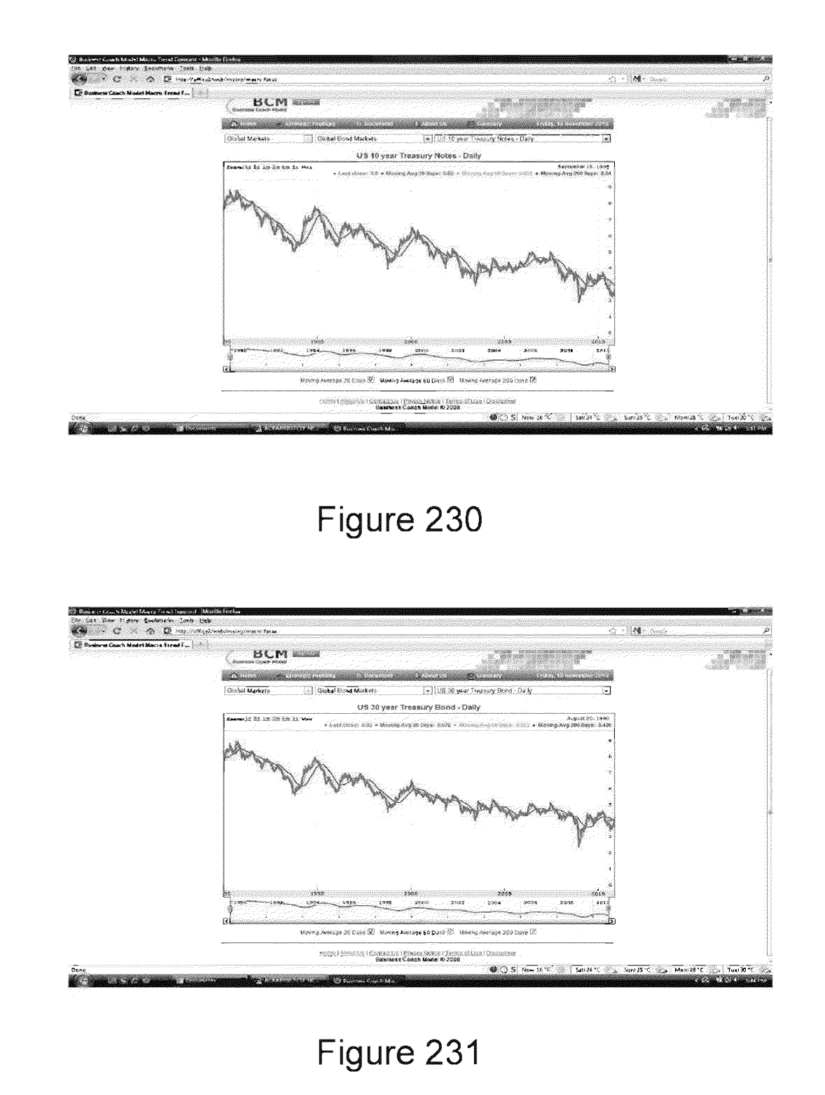

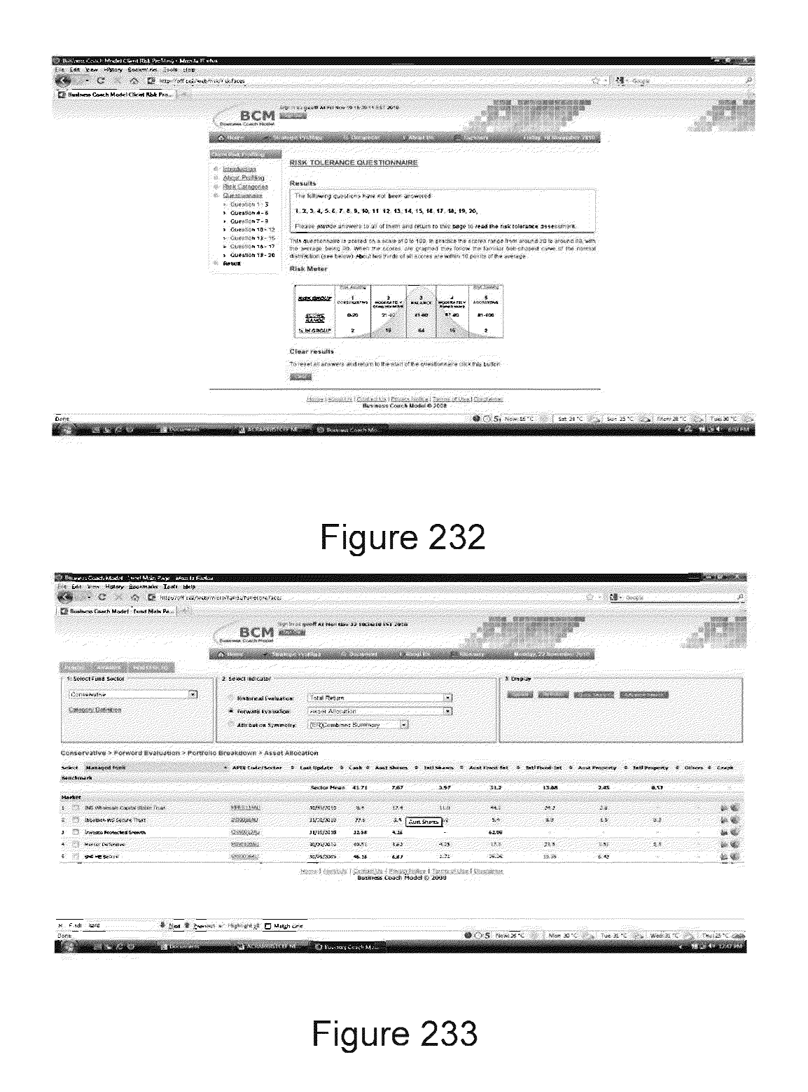

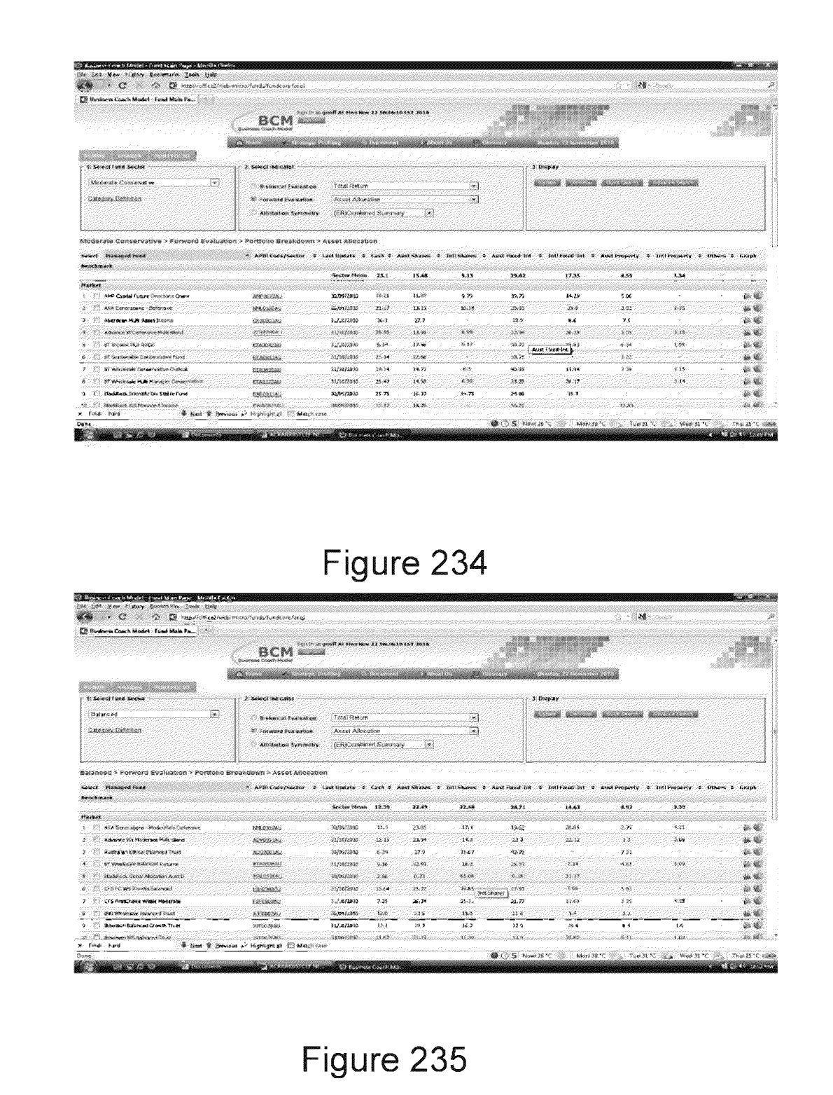

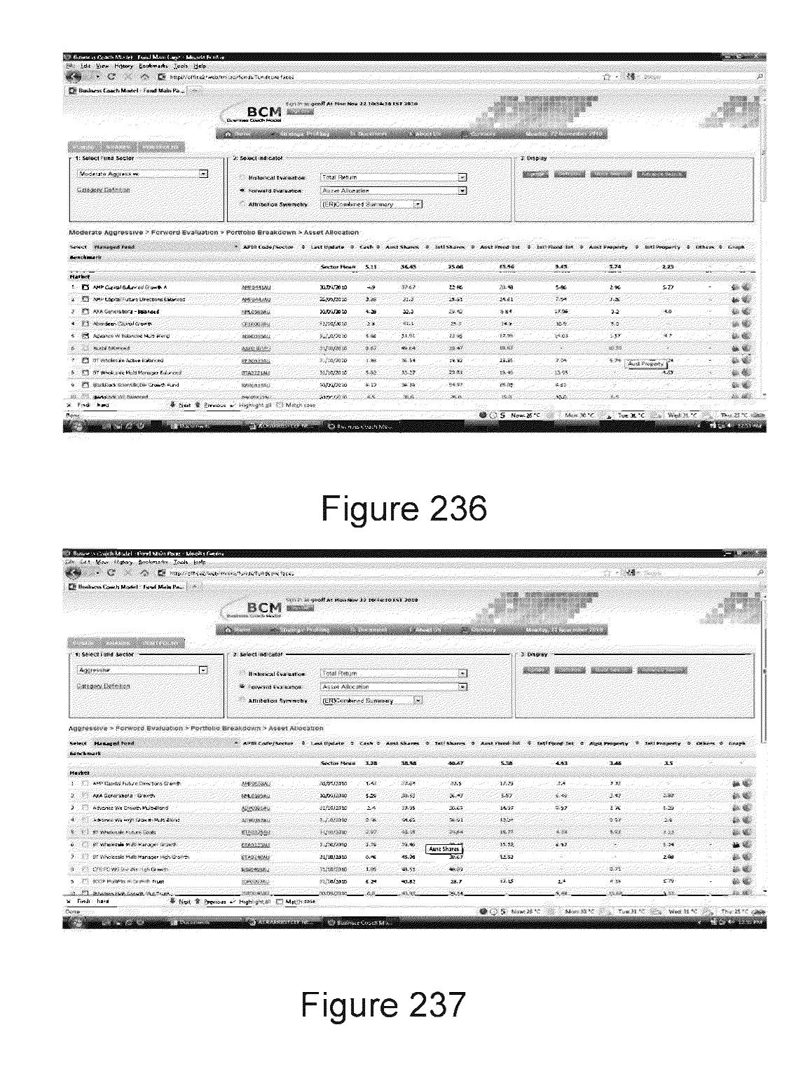

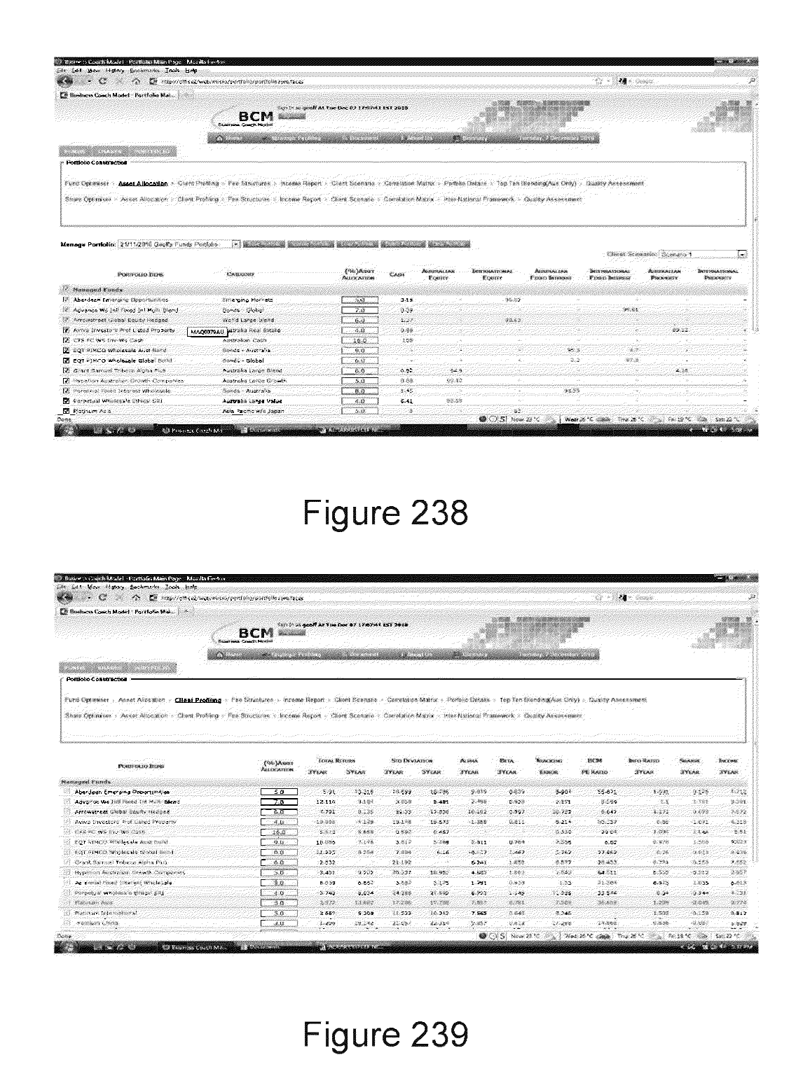

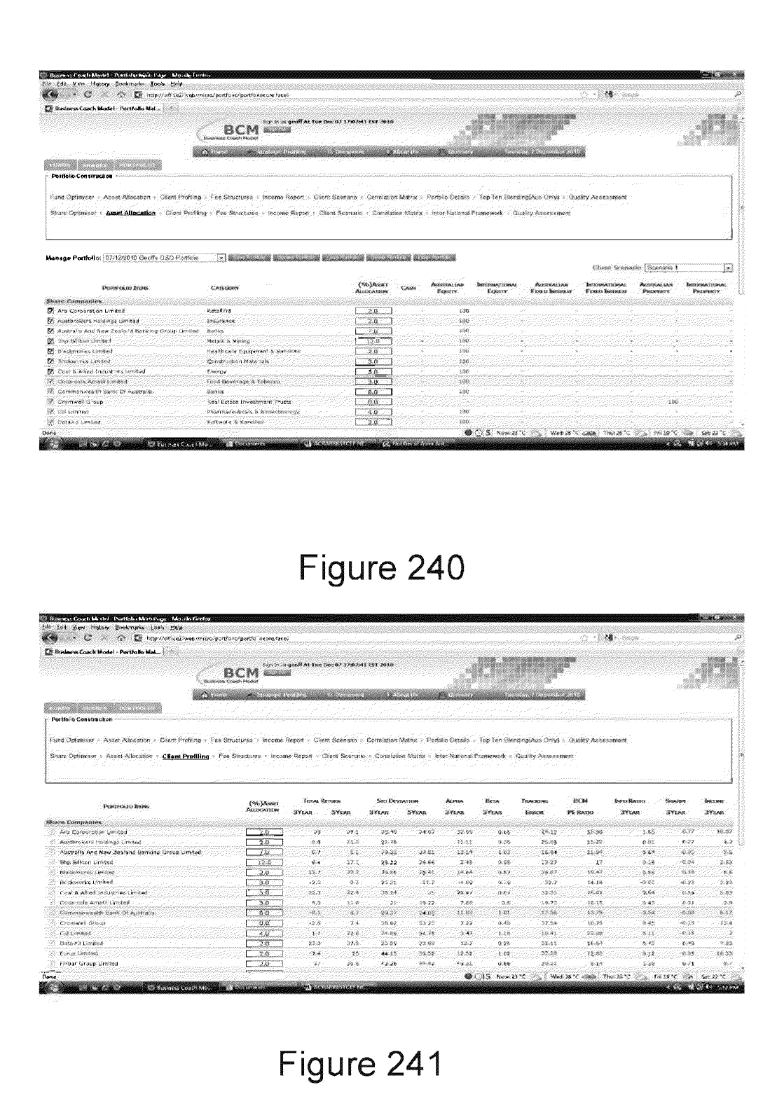

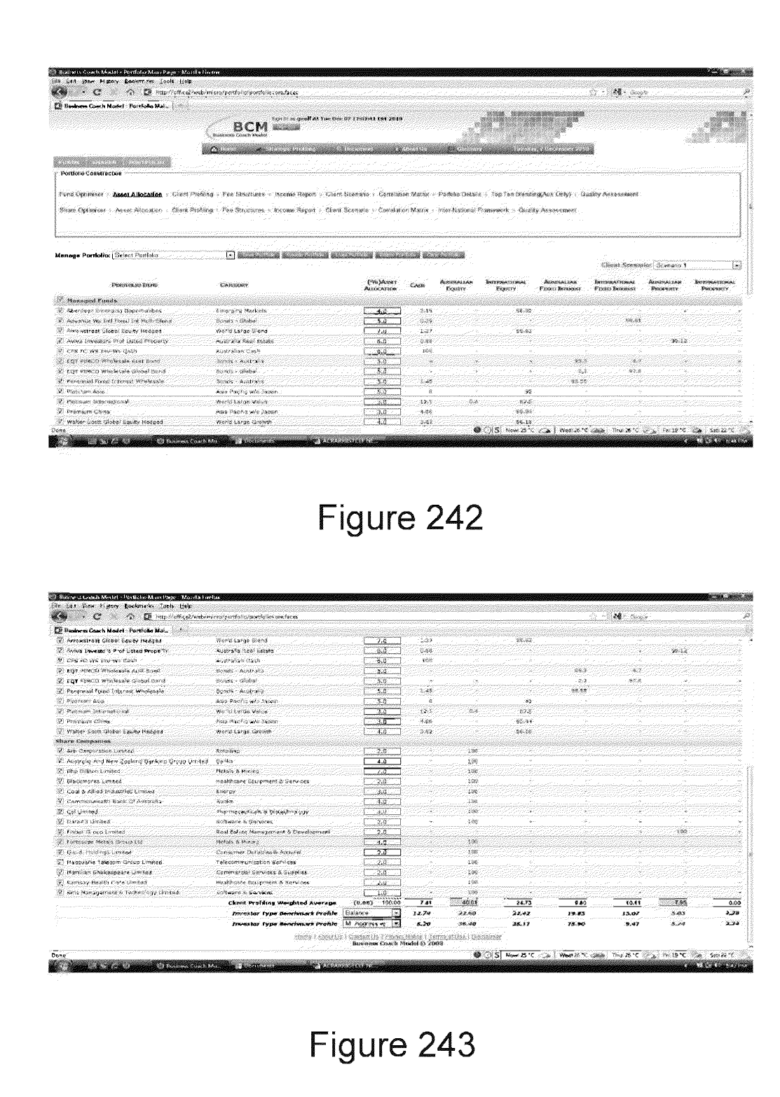

Examples of how the financial planner uses the system 12 to implement S/S/FEM/CS/SODA (T2) are set out below:
1. Managed Funds:
a. Scoring:
   i. Historical Evaluation, Efficiency Ratio Kurtosis is shown in FIG. 60; and
   ii. Forward Evaluation, Efficiency Ratio Near Term Risk Measures is shown in FIG. 61;
b. Sorting:
   i. Historical Evaluation, Efficiency Ratio Relative Risk Measure Summary is shown in FIG. 62;
   ii. Forward Evaluation, Efficiency Ratio Buy/Sell Summary is shown in FIG. 63; and
   iii. Attribution Symmetry, Efficiency Ratio Combined Summary is shown in FIG. 64;
   iv Attribution Symmetry, Top Quartile Historical Summary is shown in FIG. 65;
   v Attribution Symmetry, Top Quartile Combined Summary is shown in FIG. 66;
   vi. Attribution Symmetry, Ranking Summary is shown in FIG. 67; and
2. Direct Shares Opportunities:
a. Scoring:
   i. Historical Evaluation, Efficiency Ratio Downside Volatility is shown in FIG. 68; and
   ii. Forward Evaluation, Efficiency Ratio Price Value is shown in FIG. 69; and
   iii. Forward Evaluation, Efficiency Ratio Price Value 2 is shown in FIG. 70;
b. Sorting:
   i. Historical Evaluation, Efficiency Ratio Risk Measures Summary is shown in FIG. 71;
   ii. Forward Evaluation, Efficiency Ratio Forward Evaluation Summary is shown in FIG. 72;
   iii. Attribution Symmetry, Efficiency Ratio Combined Summary is shown in FIG. 73;
   iv. Attribution Symmetry, Top Quartile Combined Summary is shown in FIG. 74;
   v. Attribution Symmetry, Mispricing Combined Summary is shown in FIG. 75; and
   vi. Attribution Symmetry, Ranking Summary is shown in FIG. 76.

### 3. Strongest Aggregate Score/Factor Evaluation Mod E1/Core Spectrum/Risk/Return Opportunities Approach (SAS/FEM/CS/R/ROA (T2))

The aim of the SAS/FEM/CS/R/ROA(T2) being the Strongest Aggregate Score is to seek Alpha driven solution was for extensive data processing provisions needed to developed the technique of that underpins this equilibrium investment approach, because according to the APMSPAS/SCAPMs(T2), the only risk that should be rewarded is the market risk. Exposure to market risk is captured by beta mean variances/fundamentals, which measures the sensitivity of HEMV(Q)/FEFR(Q)/AS(FA)(T1), to provide statistical returns and all the particular security regarding the portfolio. While the potential value-add from an investment is more significant, the potential loss from the mispricing of risk is also greater. Therefore through APMSPAS/SCAPM(T2) technique for protecting capital by choosing a FM/DSO manager who can control risk on the downside, including the same with Standard Deviation, Beta, Alpha, Tracking Error, Sorting Ratio, Treynor Ratio, Upside Risk, Downside Risk, Skewness and Kurtosio. Therefore this makes the SAS/FEM/CS/R/ROA(T2) a superior Alpha driven decision making solution mechanism that are a reasonable proxies for premiums that the DG/FP/AC/MT/FM/SB are willing to pay for investment risk and it's superiority in analysing the universe for skill driven traditional DG/FP/AC/MT/FM/SB with the innovated techniques to be able to hack various FM/DSO/M/S/RS/T/SPA(T3) and components to make up those adjustments where they are needed. Therefore the SAS/FEM/CS/R/ROA(T2) tends to make an optimise position, by firstly determined which the products to populate and then populate them to Strategic Portfolio Asset Allocation Structure. The problem with Markowitz's approach is that the strategic asset allocation is based on historical market co-efficient correlation exposures whereas the SAS/FEM/CS/R/ROA(T2) Strongest Aggregate Score has now explored how these key variables of Attribution Symmetry Metrics, i.e. the Efficiency Ratio-Ranking Summary together with Top Quartile Strike Rate-Ranking Summary combined with their respective Historical/Forward Summaries, looks behind the FM/DSO as to the way the manage money.

The strongest aggregate score i.e. SAS/FEM/CS/R/ROA (T2) tends to make an optimize positions thus accordingly one of the finest practice methods for acquiring the best of a breed that decision maker/one could adopt in order to enhance their skills. The SAS/FEM/CS/R/ROA (T2) is about extracting core spectrum Alpha at the highest usability standard practice i.e. ERSPA(T3), TQSRSPA (T3) aimed at superiority selection in analysing the universe for skill driven traditional. Therefore intrinsic value selection technique enables to create good opportunities for out-performances/low volatility and because of this factor the strongest aggregate score is regarded as a reasonable proximity that investors are willing to pay a premium. Nevertheless for the SAS/FEM/CS/R/ROA (T2) to achieve its best results needs a broader micro/macro core selection process and the knowledge gap system through/market/sector/relative strength/trends that has the statistical/graphic/textual back-testing ability (i.e. M/M/KFGM/CS/BT/TE (T2)) to research by sectors for valuating efficient Alpha. However it's the micro/macro normalized back testing technique for core spectrum that makes up reasonable proxies for premiums.

Examples of how the financial planner uses the system 12 to implement SAS/FEM/CS/R/ROA (T2) are set out below:
1. Managed Funds:
a. Scoring and Sorting:
   i. Attribution Symmetry, Efficiency Ratio Combined Summary is shown in FIG. 77; and
   ii. Attribution Symmetry, Top Quartile Combined Summary is shown in FIG. 78; and
   iii. Attribution Symmetry, Ranking Summary is shown in FIG. 79; and
2. Direct Shares Opportunities:
a. Scoring and Sorting:
   i. Attribution Symmetry, Efficiency Ratio Combined Summary is shown in FIG. 80; and
   ii. Attribution Symmetry, Top Quartile Combined Summary is shown in FIG. 81;
   v. Attribution Symmetry, Mispricing Score is shown in FIG. 82; and
   vi. Attribution Symmetry, Ranking Summary is shown in FIG. 83.

### 4. Micro/Macro High Conviction Approach/Factor Evaluation Model/Core Spectrum/Opportunity Hither Returns (M/M/HCA/FEM/CS/OHR (T2))

The M/M/HCA/FEM/CS/OHR (T2) high conviction approach means an opportunity of higher returns compared to large over diversified holdings in a portfolio. The M/M/HCA/FEM/CS/OHR (T2) regards this as combining two or more expected SAS/FEM/CS/R/ROA(T2) (Strongest Aggregated Scores) Alphas i.e. ERSPA (T3) (Efficiency Ratio), TQSRSPA (T3) (Top Quartile) and MPSDSOPA (T3) (Miss-Pricing) that has the effect of reducing negative returns regarded as impacting on a reasonable proxy that investors are willing to pay a premium. However changing times and unpredictable markets mean long term assumptions challenges and new methodologies, which can get really complicated without the required tools that can offer good opportunities as well as provides capital protection. Therefore the necessity for constant statistical/graphical monitoring for micro/macro market/sector/relative strength/trends such as proper symmetry of distribution structured building blocks i.e. SBBFT (T1) process understanding a myriad of information of unbundle assets/statistics, the quantitative (historical) qualitative (forward) scoring mix approach that improves full spectrum valuation, micro/macro core selection process through/market/sector/relative strength/trends i.e. M/S/RS/T/DSO/SPA (T3) needs micro/macro knowledge gap feedback methodology needs back testing i.e. M/M/KFGM/CS/BT/TE (T2) provides that necessary Micro/Macro consistency with each other. Consequently the need to achieve intrinsic value selection technique enables creation of good opportunities for outperformance/low volatility. However the common approach is to utilize the core and surround it with low risk/high performance specialists multi strategic structured optimization makes it easier to protect capital, hence the core spectrum process to make it possible to understand why some FM/DSO are less market related and don't measure up to the best practices.

Examples of how the financial planner uses the system 12 to implement M/M/HCA/FEM/CS/OHR (T2) are set out below:
1. Managed Funds:
a. Scoring and Sorting:
   i. Attribution Symmetry, Ranking Summary is shown in FIG. 84;
   ii. Total Return, 15 Comparison/Compare Fun Performances is shown in FIG. 85;
   iii. Total Return, 15 Comparison/Capital Asset Pricing Equilibrium is shown in FIG. 86;
   iv. Top Ten Blend Mandate—Growth is shown in FIG. 87; and
   v. Top Ten Blend Mandate—Risk 2 is shown in FIG. 88; and
2. Direct Shares Opportunities
a. Scoring and Sorting
   i. Efficiency Ratio/Top Quartile/Mispricing is shown in FIG. 89;
   ii. Total Return—15 Comparison EPS Yield % is shown in FIG. 90;
   iii. Total Return—15 Comparison/Dividend Yield % is shown in FIG. 91;
   iv. Optimiser—Buy/Sell/Income Value is shown in FIG. 92;
   v. Optimiser—Buy/Sell/Growth Value 1 is shown in FIG. 93; and
   vi. Optimiser—Buy/Sell/Price Value is shown in FIG. 94.

### Part II. Micro/Macro/Knowledge Gap Feedback Methodology/Core Selection/Back Testing/Track Error (M/M/KGFM/CS/BT/TE (T2))

Unlike quantitative risk and return the M/M/KGFM/CS/BT/TE(T2) being a accumulative Micro and Macro graphical trend whose key variables represent interest rates, inflation and deflation, that punctuate the financial equilibriums of the economic paradigms housing, liquidity and corporate profits bubbles concludes that analyses perusing expected Alpha return scores such as AE/FEM/CS/CA (T2) consist of superior investment focus and expertise skills of back-testing feedback to be able to hack this universe participate in the long term returns by converting quantitative analysis into financial forecasts. However the qualitative risk analysis is not as easy to standardise and quantify into a direct numerical output. For example, how does a portfolio selection that is overweight poor corporate governance translate into a variability of returns estimate. How can DG/FP/AC/MT/FM/SB methodically use information that they know has significant value but is difficult to measure. In a sense, like the M/M/KGFM/CS/BT/TE (T2) qualitative analysis that results in FM/DSO valuation, there is no getting away from individual analyst judgement and this has to be accepted. However, it is possible to crudely score each of the risk factors investors are trying to assess with the objective of being approximately right rather than precisely wrong. Therefore the M/M/KGFM/CS/BT/TE (T2) has being able to capture each of the individual risks or factor exposure that enables a crude risk/return score to be compiled for each FM/DSO and then allows for a degree of comparison across a universe on a consistent basis. Using such a crude score would still provide a wide variance of risk estimation between one security that has low transparency, poor corporate governance, low quality earnings, high financial leverage and weak management and a second security that has high transparency, good corporate governance, high quality earnings, low financial leverage and strong management. In other words, the M/M/KGFM/CS/BT/TE (T2) captures the accumulative Micro/Macro key variables (i.e. the Core Spectrum Attribution Symmetry which means absolute concentrated risk adjusted return relative benchmark that works on the same underpinning principal because the reasoning behind this New Paradigm is about making sound economic financial decisions based on rewarded for risk equilibrium (i.e. the Efficient Market Hypothesis (EMH) (Supply and Demand) rather than making Behavioural Financial (BF) (Emotional Decision), hence this underlying investment strategy rationally provided by the Absolute Concentrated Risk Adjusted Return Relative Benchmark (ACRARRB) (the landmark mantra of this invention) because it represents not only “The Goal for Successful Investing but also its Broad Investment Risk Management Optimality System Targeted to an Efficient Frontier”. This is what the true investment decision making is all about i.e. absolute concentrated risk adjusted return relative benchmark which contains this efficient investment becomes a self adjusting mechanism or equilibrium approach, because according to the ACRARRB, the only risk that should be rewarded is the market risk. Exposure to market risk is captured by beta, which measures the sensitivity of returns statistical and all the mean variances/fundamentals on the particular security and the portfolio to market.

However according to the M/M/KGFM/CS/BT/TE (T2) micro/macro key variables, there is a strong need for a multi-tasked instrument that has the ability of managing the new Micro/Macro Global Investment Market that continuously select and manages the market for FM/DSO/M/S/RS/T/SPA(T3) yet at the same time has the ability to explain the drivers of future cash flows investments i.e. the pricing, the effect of globalisation, rising interest rates and deflating asset bubbles of housing, liquidity and corporate profits. The M/M/KGFM/CS/BT/TE (T2) use these analysis as to how they interact to affect equity values to develop a coherent investment discipline, yet at the same time, automatically asset allocating across the relative strength asset classes such as FM/DSO/M/S/RS/T/SPA (T3) with the idea of minimising the market movements of the portfolio by hedging away from risk in accordance with the clients risk tolerance. The goal of successful investing is to take positions on assets that exhibit discrepancies between observed prices and fundamental values. Researchers call these discrepancies “market anomalies” and ask if they are real or a mirage produced by a lack of under standing of the forces that drive prices and their returns. Therefore, as an additional explanation about the drivers of future cash flows investments and their pricing effect on Free Cash Flow Metrics, its advisable to study the other above four (4) most superior forms/effect in valuation creation of incremental profits according to “market anomalies discrepancies” meaning are they real or mirage produced by a lack of understanding of the forces that drive prices and their returns. However through the eyes of the M/M/KGFM/CS/BT/TE(T2) with its Specific Geometric Information Arbitrage Methodologies.

In short, the micro and macro knowledge gap feedback methodology i.e. M/M/KGFM/CS/BT/TE (T2) is other due diligence vector for micro/macro/knowledge gap feedback methodology for quantitative/qualitative factor research. Globalisation should cause real interest rates to remain flat or rise. For example changes in GDP mirrors change in corporate profits therefore GDP growth/corporate profit growth tend to track each other over time as this model uses GDP related inputs to estimate the parallel trends in corporate profits bubble. Most post-bubble economies are currently suffering from global financial imbalances due to the worst Global Financial Crises since the 1930's Great Depression leaving a excessive Sovereign Debt crises amongst the non Asian economies. Therefore the M/M/KGFM/CS/BT/TE (T2) through its graphical analysis will indicate as to how the statistical values interacted to the relative benchmark that forms a developed and coherent investment strategy discipline. Subsequently, the so called equilibriums of the economic paradigms (housing/liquidity/equity markets) historically were punctuated by interest rates/inflation—thus effects-earnings/P/E/Ratio/Shareholder Yield in an inverse fluctuated fashion.

The M/M/KGFM/CS/BT/TE (T2) use these analysis as to how they interact to affect equity values to develop a coherent investment discipline, yet at the same time, automatically asset allocating across the relative strength asset classes such as FM/DSO/M/S/RS/T/SPA(T3) with the idea of minimising the market movements of the portfolio by hedging away from risk in accordance with the clients risk tolerance. The goal of successful investing is to take positions on assets that exhibit discrepancies between observed prices and fundamental values. Researchers call these discrepancies “market anomalies” and ask if they are real or a mirage produced by a lack of under standing of the forces that drive prices and their returns. Therefore as an additional explanation about the drivers of future cash flows investments and their pricing effect on Free Cash Flow Metrics, its advisable to study the four (4) other (see Tier 3) most superior forms/effect in valuation creation of incremental profits according to “market anomalies discrepancies” meaning are they real or mirage produced by a lack of understanding of the forces that drive prices and their returns. However through the eyes of the M/M/KGFM/CS/BT/TE (T2) with its Specific Geometric Information Arbitrage Methodologies.

Examples of how the financial planner uses the system 12 to implement M/M/KGFM/CS/BT/TE (T2) are set out below:
1. Macro Static Charts:
   a. The collection of graphs shown in FIGS. 95 to 97; and
2. Macro Trend Forecast—Dynamic Graphs:
   a. Domestic Markets—ASX 200 Daily shown in FIG. 98;
   b. Global Markets—US 5 Yr Treasury Daily shown in FIG. 99; and
   c. Commodities Markets shown in FIG. 100.

### 1. Micro/Bottoms-Up/Graph Feedback Methodology/Core Selection/Back Testing/Tracking Error (Micro/BU/Graph (FM/CS/BT/TE (T2))

The aim of the Micro/BU/GraphFM/CS/BT/TE (T2) is that part of acquiring the combined feedback skills for finding the true potential for all investment outcomes including their ability to make tactical timing decisions in the market such as the absolute risk adjusted return strategy measured against relative benchmarks to finish up with an efficient Alpha/Beta portfolio that takes out second guessing. The feedback skills problem for DG/FP/AC/MT/FM/SB is that they often become confident about their ability to make tactical timing decisions in the market. This is the only way to achieve the purity of a proper full core spectrum Risk/Return investment analysis which is capable of hacking the universe that can construct an appropriate portfolio selection is to begin to build the hardware that will ultimately drive the software for each of the inventions. Therefore the Micro/BU/GraphFM/CS/BT/TE (T2) has the ability to capture each of the individual risks or factor exposure that enables a crude risk/return score to be compiled for each FM/DSO and then allows for a degree of comparison across a universe on a consistent basis. Using such a crude score would still provide a wide variance of risk estimation between one security that has low transparency, poor corporate governance, low quality earnings, high financial leverage and weak management and a second security that has high transparency, good corporate governance, high quality earnings, low financial leverage and strong management. In other words the Micro/BU/GraphFM/CS/BT/TE (T2) captures the accumulative Micro/Macro key variables data points i.e. the Core Spectrum Attribution Symmetry which means absolute concentrated risk adjusted return relative benchmark such as the relevant Data Points (i.e. All Risk, All Performance (Blend, Growth, Value), All Mean Variance, All Fundamental, All Asset Class, All Sectors, All Historical Evaluation, All Forward Evaluation, All Quantitative, All Qualitative, All Micro, All Macro, All Ranking Increase Decrease Risk/Return and over All Time Series).

Central to the central issue hence that part of the Micro/BU/GraphFM/CS/BT/TE (T2) systematic graphical information arbitrage building blocks forming the approach has the effect of being the most rigorously stressed tested for Buy/Sell/Hold that can be an important advantage to diversify, over all the key variables and filtered through about sixty plus (60+) market multiples components of the APMSPAS/CAPMs (T1)(T2) of this inventions
(a) Primary/norminalisation statistical verification system (T1) and is made up of three (3) dedicated quantitative/quantitative usage factor metric task capital asset pricing models.
(b) Secondary/vertical statistical verification system(T2) i.e is made up of seven (7) dedicated quantitative/quantitative capital asset pricing models which consists of Part (i) four (4) Alpha extraction core risk/return full spectrum models used in conjunction should better explain the portfolio selection absolute risk/return spectrum relative to the benchmark Part (ii) three (3) graphical back testing/tracking error information arbitrage regarding the micro/macro/knowledge gap feedback. Hence after a rigorous systematic norminalisation processing analysis therefore results in a set of historical/forward multiples that consists of strategic/realistic factors, having significant decision making ability due to their aggregate market multiples score.

The Micro/BU/Graph/FM/CS/BT/TE (T2) developed by an aggregate score through several systematic building blocks framework, thus for analysing multi technique scenario testing whereby the out-performance or relative strength of the FM/DSO selection process reflects an equilibrium reward for risk approach. Subsequently this underpins as to what the true investments decision making is all about, which naturally an efficient investment becomes a self adjusting mechanism or equilibrium approach, because, the only risk that should be rewarded is the market risk. Exposure to market risk is captured by Beta, which measures the sensitivity of returns statistical and all the mean variances/fundamentals on the particular security and the portfolio to market. The job of the Micro/BU/GraphFM/CS/BT/TE (T2) is to protect clients/members against the sort of value-destroying decisions, whether it is buying into a fashionable asset too late or selling out during what may be only a temporary downturn. The risk, for instance, is more than just the danger of temporary, volatile returns such as;

In short, the Micro/BU/Graph/FM/CS/BT/TE (T2) is developed through an aggregate score and again through several multi scenario testing usage technique such as various systematic building blocks frame works whereby the out-performance or relative strength of the FM/DSO selection process reflects an equilibrium reward for risk approach as evidence that the strongest aggregate score needs to be consistent with back testing/tracking error. Therefore, by accessing his massive multi graphic information arbitrage data based (see Table 10—Micro Graphical Trend Forecast Approach To Decision Making On Investment) for which enables the creation of good opportunities for out-performance. The perfect place to look for such opportunities in a volatile market place whereby a broader micro/macro knowledge gap system review searches for Alphas by sectors core selection process through/market/sector/relative strength/trends, creates proper mispricing analysis for strategic optimisation, thus makes it possible for better risk reward opportunities.

Examples of how the financial planner uses the system 12 to implement Micro/BU/Graph/FM/CS/BT/TE (T2) are set out below:
1. Fund Managers:
   a. Fund Monthly Return Bar Chart—3 Years shown in FIG. 101;
   b. Fund Monthly Return Histogram shown in FIG. 102;
   c. Fund Size History shown in FIG. 103;
   d. Fund Price History shown in FIG. 104; and
2. Direct Shares Opportunities:
   a. Share Price History shown in FIG. 105;
   b. Share Return Components shown in FIG. 106; and
   c. 3 Year Alpha v's Total Return shown in FIG. 107.

### 2. Macro Top-Down/Graph Feedback Methodology/Core Selection/Back Testing/Tracking Error (MacroTD/GraphFM/CS/BT/TE (T2))

The MacroTD/GraphFM/CS/BT/TE (T2) which is part of the Macro Trend Forecasting that is transformed into to “Strategic Macro Profiling Economics” that consists of one hundred and fifty or more Leading Indexes/Indicators, are presented by a typical five typical main Composite Indicators, i.e. World Outlook, Australian Outlook, Growth Sectors, Financial Markets and Domestic Wages and Prices. These include real money supply, stock market price indices, Residential Building Approvals, Non-Residential Building Approvals, Overtime Hours, Company Profits, Real Unit Labour Costs, Manufacturing Material Prices, Unemployment Rates, Public Sector Contribution To Output Growth, Terms Of Trade, Net Exports, Net Imports, Exchange Rates, Balance of Payments, Relative Strength Movement of Business Sectors, Long and Short-Term Interest Rates, Yield Spreads Between Foreign and Domestic Interest Rates, Commodity Prices, The Lagged Impact of Output on Prices on Productivity Growth, Wages, Material, Inflation and Import Prices. This enables the need for financial planners to keep their fingers on the economy pulse through the MacroTD/GraphFM/CS/BT/TE (T2) being a graphic macro information arbitrage trend forecasting mechanism because it indicates how various types of investments will perform and by tracking this extensive range of economic data such as index of leading indicators, investors will be able to determine the likely path of future economic growth and therefore better understand the economic back drop for the various markets.

Therefore with the innovated micro/macro techniques of the M/M/KGFM/CS/BT/TE (T2) such as the MicroBU/GraphFM/CS/BT/TE (T2), MacroTD/GraphFM/CS/BT/TE (T2) and M/M/SText/KFM/CS/BT/TE (T2) makes it possible to be able to hack various diverse range of investment products to suit the needs of every type, and components that meets the multi needs and requirements of the DG/FP/AC/MT/FM/SB. As a result by using the MacroTD/GraphFM/CS/BT/TE (T2) graphic information arbitrage is an advantage because it works on the same “Equilibrium Reward For Risk” principle as leading economic indices which are designed to anticipate and identify turning points in the World and Australian economy. The Leading Index is contained in the MacroTD/GraphFM/CS/BT/TE (T2) “Graph Screen Reports” produced daily and monthly. As well as examining Australia's leading indicators, the report also studies movements of co-incidental and lagging indicators of economic activity in the country, along with comparative data from overseas, but also the dangers imposed on the risk levels based on inflation, interest rates, economic growth, changes in government legislation and potential relative strengths and weaknesses of fund or stock selection.

Subsequently the MacroTD/GraphFM/CS/BT/TE (T2) forms part of the a graphic macro information arbitrage trend forecasting mechanism stress testing, that provides a guide to future ongoing sustainability of investor's risk and return, which forms the is the APMSPAS/TCAPMs (T3), consisting of seven (7) horizontal statistical verification systems (i.e. Efficiency Ratio, Top Quartile Strike Rate, Direct Share Mispricing, Free Cash Flow, Market Price Watch, Ranking Summary/Multi-Brand Fund Manager, and Market/Sector/Relative Strength/Trends Analysis). The APMSPAS/TCAPMs (T3) approach is to utilise the core FM/DSO/M/S/RS/T/SPA (T3) and to surround it with low risk/high performance specialists. This is where the user friendly APMSPAS/TCAPM's (T3) would be controlled by the DG/FP/AC/MT/FM/SB, thus allows acceptable risk return outcomes within the clients/members acceptable risk profile. The objective will be to identify the best of a breed of FM/DSO/M/S/RS/T/SPA(T3) and to continue with them in such a way as to satisfy the stated investment objectives of Strategic Macro Projection that tends to make an optimisation predictability position by relative alignment with Historical Evaluation/Forward Evaluation/Attribution Symmetry. Therefore the aim of the APM SPAS/TCAPM's (T3) is it's superiority in analysing the universe for skill driven traditional FM/DSO/M/S/RS/T/SPA(T3) with the innovated techniques to be able to hack various components to make up those adjustments where they are needed. One thing you can be sure about the MacroTD/GraphFM/CS/BT/TE (T3) and being a simulation technique that operates across traditionalist claims that, it can behave as a “True Decision Maker”. In fact this process represents the very state of “Absolute Risk Adjusted Return” indicative of minimal risk and maximum return over all the mean variances/fundamentals, yet on the other hand; makes it a good concentrated filter instrument for diversity for Strategic Asset Allocation representing relative benchmark, hence a strategist's dream. The MacroTD/GraphFM/CS/BT/TE (T2) for superior usage of extensive macro screening process to ensure that FM/DSO/M/S/RS/T/SPA(T3) it chooses is consistent with the moderate valuation investment style and risk management, which are run through a multi-macro screening process and a thorough analysis of the key economic indicators is conducted. With the ability of the MacroTD/GraphFM/CS/BT/TE (T2) being an instrument for managing combined effect reward for risk/return approach is about understanding the discrepancies forces between the “market anomalies” (real or a mirage) that respectively drive prices and returns which is rapidly becoming the world of the new investment landscape, that has the ability to truly understand FM/DSO selection pick objectives invariably lines up all investments on par with good opportunities, which will finish up with an efficient Alpha/Beta portfolio.

In short, the idea behind the MacroTD/GraphFM/CS/BT/TE (T2) is about managing absolute and relative risk in the globalisation equity spectrum choosing the strongest micro sector in the strongest macro market boosts your chances of success micro/macro core selection process via market/sector/relative strength/tends provides a guide to future on going sustainability. When dealing with market anomalies it's a question of; are the trends real or a mirage produced because understanding of the forces that drive prices and their returns is paramount. For example the direction of the yield curve points the way as to a good estimate of economic conditions and likewise the mathematics you can get from a traditional active managers is a huge question. As a result the MacroTD/GraphFM/CS/BT/TE (T2) understands the combined capital protection effect of reward for risk/return technique and the discrepancies forces of market anomalies because the strongest trend, tends to remain the strongest for some time. Therefore the importance of the MacroTD/GraphFM/CS/BT/TE (T2) knowledge gap feedback methodology is regarded as a reasonable proxy that investors are willing to pay a premium.

Examples of how the financial planner uses the system 12 to implement MacroTD/GraphFM/CS/BT/TE (T2) are set out below:
1. Collection of Static Graphs on the Global and Domestic Economy:
   a. The main economic indicator of the world shown in FIG. 108;
   b. Inflation and wage measures shown in FIG. 109;
   c. Interest rates overseas shown in FIG. 110;
   d. Global share markets shown in FIG. 111;
   e. Global bond markets shown in FIG. 112; and
   f. Global exchange rates shown in FIG. 113; and
2. Collection of Dynamic Graphs on the Global and Domestic Economy:
   a. The domestic share market—ASX S & P 300—Daily shown in FIG. 114;
   b. Global share market—FTSE 100 index daily shown in FIG. 115;
   c. Domestic interest rates—Au 5 Year Commonwealth Bonds—Daily shown in FIG. 116; and
   d. Global Bond market—US 10 year Treasury note—Daily shown in FIG. 117.

### 3. Micro/Macro/Specific Text/Feedback Methodology/Core Spectrum/Back Testing/Tracking Error (M/M/SText/FM/CS/BT/TE (T2))

As a result the M/M/SText/FM/CS/BT/TE(T2) tends to drive together the variable price changes/earnings upgrades, that investors should reap solid returns from significant forward market valuation. For example, with the assistance of M/M/KGFM/CS/BT/TE (T2) it easy to pick up any early trends and indications, such as the demand from China is still strong. Therefore, this means that the major mining companies RioTinto and BHP look under valued and delivering substantial returns even if base metal prices go side ways. However with the M/M/SText/FM/CS/BT/TE (T2) managing Core Spectrum through via various APMSPA/SCAPMs (T2) capital asset pricing models graph feedback methodology/core spectrum/back testing/tracking error mechanisms such as creates superior skills driven FM/DSO/M/S/RS/T/PA (T3). Likewise the M/M/SText/FM/CS/BT/TE T2) was specially built as a “visual interfaced/exposure model” that represents the full spectrum FM/DSO/M/S/RS/T/SPA(T3) of Global/Domestic/Sector Earnings Outlook, again therefore evidence by its the predominant reasoning behind this new paradigm trademark is about making sound economic financial decision based on rewarded for risk equilibrium i.e. Efficient Market Hypothesis (EMH) (Supply and Demand) rather than making Behavioural Financial(BF) (Emotional Decision), hence this underlying strategy is now provided by the Absolute Concentrated Risk Adjusted Return Relative Benchmark (ACRARRB) (being the mantra of this invention) because it represents not only “The Goal for Successful Investing but also its Broad Investment Risk Management Optimality System Targeted to an Efficient Frontier” thus being able to detect any increased exposure to markets or active management decision will be based on where the excess returns per unit of risk or information ratio/beta are most likely to occur. The higher the excess return per unit of risk, the greater will be the consistency of added value. Therefore accordingly to build the hardware/software approach which consists of the Core Spectrum Symmetry of Distribution such as the respective Data Points (i.e. All Risk, All Performance, All Mean Variance, All Fundamental, All Asset Class, All Sectors, All Historical Evaluation, All Forward Evaluation, All Quantitative, All Qualitative, All Time Series, All Micro, All Macro, All Rotational Asset Class, All Retraceable Asset Allocation, All Efficient Frontier). Subsequently followed by the software support of Core Spectrum, Factor Metrics.

In short, the M/M/SText/FM/CS/BT/TE (T2) specific text is part of the knowledge gap technique of being able to read the feedback and the strength of any value judgment trends to pretty much depend upon the beholder's interpretation market to market pricing thus providing suggestion as to the counterbalancing ways to minimise systematic share/credit market risk. Whether sustained overpriced share markets or low credit spreads is indicative of investors being complacent. Now as to the market price watch the M/M/SText/FM/CS/BT/TE (T2) processed through systematic building blocks managing market prices because through micro/macro capital asset pricing models mechanism creates superior driven skills. Therefore the micro/macro core selection process through/market/sector/relative strength/trends subject to changing times and unpredictable markets means long term assumptions challenges and new methodologies. For example during early GFC period the market experienced a flight to quality assets after momentum-based hedge funds themes interfaced with major downside correction exposure model represents full global/domestic sector price movement out look. Likewise rest assured that the M/M/KGFM/CS/BT/TE(T2) knowledge gap feedback methodologies through its back testing/tracking error sensitivity models will alert when the share market equity prices will turn up well before the economy.

Examples of how the financial planner uses the system 12 to implement M/M/SText/FM/CS/BT/TE (T2) are set out below:
1. Fund Managers
   a. Aust Equities Large Blend—Fund Investment Report shown in FIG. 118;
   b. Aust Equities Large Blend—Fund Portfolio Report shown in FIG. 119; and
   c. Aust Equities Large Blend—Attribution Summary Reports & PDS shown in FIG. 120; and
2. Direct Shares Opportunities
   a. Banking Sector—Company Profile shown in FIG. 121;
   b. Banking Sector—Main View shown in FIG. 122;
   c. Banking Sector—Historical Financials shown in FIG. 123;
   d. Banking Sector—Interim Data shown in FIG. 124;
   e. Banking Sector—Price Chart shown in FIG. 125; and
   f. Banking Sector—ASX Announcements shown in FIG. 126.

### Tier 3:—Tertiary/Horizontal Statistical Verification System (Arithmetic/Geometric Algorithms Hardware/Software System)

### Attribution Pricing Models Selection Analysis Process Systems/Tertiary Capital Asset Pricing Models (APMSPAS/TCAPMS) (T3)

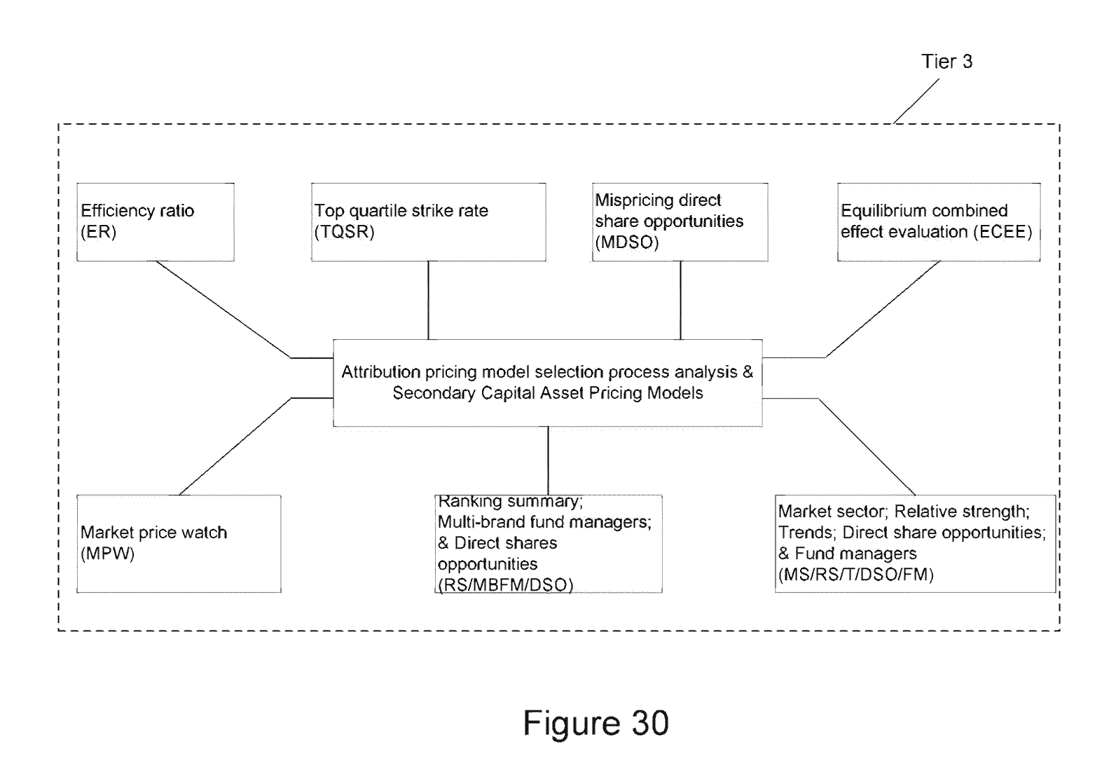

With reference to FIGS. 27 and 30, the main goal of the APMSPAS/TertiaryCAPMs(T3) process system is to instantly provide a high quality of systematic usability that makes it equivalent standard to a universal investment products with a clear superior investment focus and expertise. Realistically it lies in its normalisation pricing since the aim of the selection is its superiority in analysing the universe for skill-driven tradition which uses the importance of systematic building blocks/capital asset pricing models to enhance portfolio structures. This new combined methodology being the APMSPAS/TertiaryCAPMs(T3) realistically adopting factor modeling/superior for active risk management skills, are the true decision makers through the respective capital asset pricing factor mechanisms i.e. ERSPA/SAS/FEM/CS/R/ROA(T3)(Efficiency Ratio), TQSRPA/SAS/FEM/CS/R/ROA (T3) (Top Quartile) and MP/SAS/FEM/CS/R/ROA (T3) (Miss-Pricing) Strongest Aggregate Score being one of the finest practice method for acquiring active risk management skills, captures and displays a robust quantitative/qualitative selection process as to reasonable proxies that test the specific skills and experience.

Rightly so the other part being the front-end of the APMSPAS/TertiaryCAPMs(T3) portfolio selection risk management which may need to be challenged and to explored new methodologies that fund the right mix of investments, that represents the knowledge gap information arbitrage approach for extracting Alpha i.e. ECEESPA/RFR-FM/FCF-SY(T3), MPWSPA(T3), RS/MB/FM/DSO/SPA (T3) and M/S/RS/T/SPA (T3) thus also represents a unique investment skills technique utilising market multiple selection process knows how to select pedigree investments by looking what's behind them. The APMSPAS/TertiaryCAPMs(T3) multi capital asset pricing models tends to make an optimise position because it seeks attribution style represents a reality check coming for dud fund managers/direct shares opportunities in search of absolute port folio selection capability is the proof that remains in the purity of the forecast.
1. Efficiency Ratio Selection Process Analysis (ERSPA) (T3);
2. Top Quartile Strike Rate Selection Process Analysis(TQSRSPA)(T3);
3. Miss-Pricing Direct Share Opportunities Selection Process Analysis (MPDSOSPA) (T3);
4. Equilibrium Combined Effect Evaluation Selection Process Analysis/Reward For Risk-Fund Manager/Free Cash Flow-Shareholders Yield (ECEESPA/RFR-FM/FCF-SY) (T3);
5. Market Price Watch Selection Process Analysis (MPWSPA) (T3);
6. Ranking Summary/Multi-Brand Fund Managers/Direct Shares Opportunities/Selection Process Analysis (RS/MB/FM/DSO/SPA) (T3); and
7. Market/Sector/Relative Strength/Trends/Selection Process Analysis (M/S/RS/T/SPA) (T3)

### 1. Efficiency Ratio Selection Process Analysis (ERSPA)(T3)

How the ERSPA/P/FEM/CS/Q/Q/CA(T3) being a specific combination of efficiency ratio and an unchanged dependant pricing factor metrics which is able to provide a thorough knowledge gap analysis process through the ERSPA/SBBFT(T3) systematic building blocks flexibility technique that has the ability to convert estimates into confident forecasted Alpha standards, thus the ERSPA/S/S/FEM/CS/SODA(T3) being able to score/sort each of the individual risk/return exposures enables a true factor score to be compiled. Because the ERSPA/SAS/FEM/CS/R/ROA(T3) being the strongest aggregate score despite slight overtones of a crude score framework (nonetheless simply by improving the core selection risk/returns concentration through an adjusted framework of factor models) it is no-less diminished as a factor values conditional/restraint mechanism based on best practices simply by the fact that all research and forward looking statements replicate absolute risk adjusted return relative benchmark. In additional to APMSPAS/CAPM's (T1)/(T2)/(T3), thus a three (3) tier discipline capital asset pricing models approach that measure the risk assumed to generate this return like wise the M/M/KGFM/CS/BT/TE (T3) uses three additional qualitative market to market models that provides knowledge gap feedback approach of the micro/macro and text investment skills technique for extracting Alpha. Simply the recognition of the effect of being able to extract triple Alpha tends to make an optimise position because with high conviction there comes the challenge for making it superior by improving risk/return concentration.

Therefore the ERSPA(T3) strategy measured against formal benchmarks to finish up with an efficient Alpha/Beta portfolio selection. One of the major challenges facing diversified investment portfolios is finding enough Alpha. Alpha is the value that most DG/FP/AC/MT/FM/SB aspire to add to the portfolio under management. However clients/members in an Index Funds take whatever return they can get from the market (beta) but a ERSPA(T3) should in theory be able to add additional Alpha. The behavior of some DG/FP/AC/MT/FM/SB and alike delude themselves into thinking that they have good stock selection skills but really, the problem was that their learning outcomes were significantly affected by random events. Whereas the ERSPA(T3) main goal of this process system as it instantly provides a much higher breakeven standard should the “sum of the sample” exceed forty (40) thus bring an equivalent a sample of ten (10). Hence the given name TQSRSPA(T3)(Top Quartile or top 25%) thus exceeds a sample of forty (40) or more, the advantage of the ERSPA(T3) usability selection outcome being systematically infinitely improved, whilst the TQSRSPA (T3) will always be endlessly inferior when it comes to analysing the universe for skill driven traditional FM/DSO.

Examples of how the financial planner uses the system 12 to implement Efficiency Ratio Selection Process Analysis (ERSPA)(T3) are set out below:
1. Fund Managers:
a. Pricing—(ER) Efficiency Ratio:
   i. Historical Evaluation—(ER) Downside Volatility shown in FIG. 127; and
   ii. Forward Evaluation—(ER) Near Term Relative Measures shown in FIG. 128;
b. Scoring—(ER) Efficiency Ratio:
   i. Historical Evaluation—(ER) Risk Measures Summary shown in FIG. 129;
   ii. Forward Evaluation—(ER) Buy/Sell/Hold Summary shown in FIG. 130; and
   iii. Attribution Symmetry—(ER) Combined Summary shown in FIG. 131; and
c. Sorting—(ER) Efficiency Ratio:
   i. Attribution Symmetry—Ranking Summary shown in FIG. 132;

### 2. Direct Shares:

a. Pricing—(ER) Efficiency Ratio:
   i. Historical Evaluation—(ER) Standard Deviation shown in FIG. 133; and
   ii. Forward Evaluation—(ER) Risk Values shown in FIG. 134;
b. Scoring—(ER) Efficiency Ratio:
   i. Historical Evaluation—(ER) Risk Measures Summary shown in FIG. 135;
   ii. Forward Evaluation—Forward Evaluation Summary shown in FIG. 136; and
   iii. Attribution Symmetry—(ER) Combined Summary shown in FIG. 137; and
c. Sorting—(ER) Efficiency Ratio:
   i. Attribution Symmetry—Ranking Summary shown in FIG. 138.

### 2. Top Quartile Strike Rates Election Process Analysis (TQSRSPA) (T3)

The TQSRSPA/AE/FEM/CS/CA(T3) Alpha is a Top Quartile metric task being a statistical measure as a result of dividing the given sample into the top 25% cut-off point. The main goal of the process system is to instantly provide a high standard of systematic usability since the aim of the selection is its superiority in analysing the universe for skill-driven traditional FM/DSO/M/S/RS/T/SPA(T3). In this particular case, its usability task being a “Changed Independent Technique” unlike the ERSPA/AE/FEM/CS/CA (T3) Alpha mention above, whose superior sample of top ten (10) cut-off point, thus also improves risk/return estimates tremendously, through top quartile quantitative/qualitative factor concentration models. Although the TQSRSPA/SAS/FEM/CS/R/ROA(T3) consists of a single score condition response/restraint benchmark set for usability standard for generating Alpha, is still able to generate an combined aggregate score for each of the individual risk/return exposure variables, providing the sample is less than forty (40) thus enables a true factor score to be compiled. However at less than this breakeven benchmark the ERSPA/SAS/FEM/CS/R/ROA(T3) still regards the TQSRSPA/P/FEM/CS/Q/Q/CA(T3) specific single score pricing factor metrics as significant comparison when it comes to converting estimates into confident forecasted Alpha standards, simply by converting it to a “Strike Rate” in the form of a percentile. Furthermore, the TQSRSPA/SAS/FEM/CS/R/ROA (T3) strongest aggregate score Alpha are fairly similar in overall structured characteristics as such being able to score each of the individual risk/return exposure enables a true factor score, notwithstanding the micro/macro as part of the knowledge gap attribution symmetry modeling is able to read the feedback so that the TQSRSPA/SAS/FEM/CS/R/ROA(T3) strongest aggregate score must be consistent with a robust knowledge gap back testing tracking error.

Examples of how the financial planner uses the system 12 to implement Quartile Strike Rates Election Process Analysis (TQSRSPA) (T3) are set out below:
1. Fund Managers:
a. Pricing—Top Quartile:
   i. Attribution Symmetry—(TQ) Performance shown in FIG. 139; and
   ii. Attribution Symmetry—(TQ) Risk Measures shown in FIG. 140;
b. Scoring—(TQ) Top Quartile:
   i. Attribution Symmetry—(TQ) Historical Summary shown in FIG. 141;
   ii. Attribution Symmetry—(TQ) Forward Summary shown in FIG. 142; and
   iii. Attribution Symmetry—(TQ) Combined Summary shown in FIG. 143; and
c. Sorting—(TQ) Top Quartile:
   i. Attribution Symmetry—Ranking Summary shown in FIG. 144.

### 3. Miss-Pricing Direct Share Opportunities Selection Process Analysis (MPDSOSPA)(T3)

The MPDSOSPA/SAS/FEM/CS/R/ROA(T3) mispricing building blocks concentration methods are the crux of selection out-performance because of the importance of forward equity spectrum as framework for miss-pricing and how the MPDSOSPA/M/S/RS/T/SPA(T3) non-systematic risk/return forward estimates and with the aid of the computer-driven investment model on “auto pilot” is far superior than the human brain can be converted into a forecasts that may structurally change a portfolio. Hence the MPDSO SPA/S/S/FEM/CS/SODA(T3) consistently captures the absolute Alpha feedback through scoring/sorting fact or valuation mode because sometimes fundamental analysis are better at casual links than historical experience hence avoids significant estimates of errors.

The MPDSOSPA/S/S/FEM/CS/SODA(T3) mispricing analysis mechanism knows how to select undervalued DSO by applying a robust factor/scoring/sorting system and attribution symmetry process consistent with the Alpha extraction. When using the MPD SOSPA/P/FEM/CS/Q/Q/CA(T3) mispricing valuation framework it should consistently reflect traditional share price levels. However one of the major problems with the active DSO/Managers tends to focus more on the return fundamental rather than risk factor concentration methods which is the very reason why the MPDSOSPA/M/M/KGFM/CS/BT/TE(T3) being the micro/macro Alpha extraction makes it consistent with micro/macro knowledge gap feedback for back testing/tracking error. Therefore the MPDSOSPA/MicroBU/GraphFM/CS/BT/TE(T3) micro mispricing knowledge gap technique is being able to read the feedback for predictability of selection and as a result of the MPDSOSPA/MacroTD/GraphFM/CS/BT/TE(T3) macro mispricing knowledge gap technique is being able to look behind companies for timely resistance to bubble bursts and economic shocks.

Examples of how the financial planner uses the system 12 to implement Miss-Pricing Direct Share Opportunities Selection Process Analysis (MPDSOSPA)(T3) are set out below:
1. Direct Shares:
a. a. Pricing—(MP) Mispricing:
   i. Forward Evaluation—(MP) Income Value shown in FIG. 145; and
   ii. Forward Evaluation—(MP) Risk Value 1 shown in FIG. 146;
b. Scoring—(MP) Mispricing:
   i. Attribution Symmetry—(MP) Mispricing score shown in FIG. 147; and
   ii. Attribution Symmetry—(MP) Mispricing Summary shown in FIG. 148; and
c. Sorting—(MP) Mispricing:
   i. Attribution Symmetry—Ranking Summary shown in FIG. 149;
   ii. Capital Asset Pricing Equilibrium—3 Year Beta V′ Total Return shown in FIG. 150;
   iii. Capital Asset Pricing Equilibrium—3 Year Alpha V′ Total Return shown in FIG. 151;
   iv. Capital Asset Pricing Equilibrium—Reward for Risk shown in FIG. 152; and
   v. Company Details—Chart shown in FIG. 153.

### 4. Equilibrium Combined Effect Evaluation Selection Process Analysis/Reward for Risk-Fund Managers/Free Cash Flow-Shareholders Yield (ECEEPA/RFR-FM/FCF-SY)

The first part of modelling is predicting how much we think that an active ECEEMPA/RFR-FM/FCF-SY(T3) whose imputed statistically verification Alpha, is likely to outperform. However the expectation you can get from active Alpha is a huge question, but unfortunately, the mathematics on its own is not very useful. It basically gets down to if the FM/DSO has talent, they continue to drive the Alpha up just by continuously increasing the level of risk. That is a sore point because ECEESPA/RFR-FM/FCF-SY(T3) believes that the efficient frontier for active FM/DSO are quadratic, that is at some point it actually falls back on itself. Therefore you push FM/DSO out, the more you actually get a decline. However the ECEESPA/RFR-FM/FCF-SY(T3) equilibrium combined effect reward for risk/free cash flow approach avoids this phenomenon by understanding the discrepancies forces between the “market anomalies” (real or a mirage) that respectively drive prices and their returns. As a result, there are two types of risks—systematic risk and non-systematic risk. Systematic risk is related to the market and is affected by the economy, while the non-systematic risk on FM/DSO specific risk is correlated to the market and is instead specific to a particular company. Modern portfolio theory states that since non-systematic risk can be reduced through diversification, aggregate investors should not be compensated for bearing this risk as they can hold the market portfolio, which in theory is perfectly diversified. By doing this, investors remove all stock specific risk from their portfolios and only face market risk. Likewise the ECEEMPA/RFR-FM/FCF-SY(T3) identifies quality securities and investments using a same philosophy because the reasoning behind this rationality therefore is provided by the SAS/FEM/CS/R/ROA(T2) Strongest Aggregate Score has now explored how these key variables of Attribution Symmetry Metrics, i.e. the Efficiency Ratio—Ranking Summary together with Top Quartile Strike Rate Ranking Summary combined with their respective Historical/Forward Summaries, looks behind the FM/DSO as to the way to manage money.

Firstly the ECEESPA/RFR(T3) evaluation model for risk/reward equilibrium is be established through the self adjusting actions by investors which makes it a proxy for premium yet constantly develops equilibrium approach that protects the capital risk by minimising the market risk. Therefore through APMSPAS/CAPMs(T1)(T2)(T3) intrinsic value selection technique enable to create good opportunities for out-performances with low volatility represents a normalised/vertical/horizontal statistical verification system makes it is an exceptional risk adjustment system. In other words because the equilibrium approach, is underpinned according to the FM/DSO risk/reward approach, the only risk that should be rewarded is the market risk. Exposure to market risk is captured by beta, which measures the sensitivity of statistical mean variances returns to market; i.e. Compensation For Bearing Risk. According to economic theory, investors should be compensated for bearing risk. This means the return on risky assets can be broken down into two components—a risk free return and a return as compensation for bearing risk. The latter return, which represents an asset return above the “bond risk free rate” is referred to as an excess return. This should not be confused with industry practise of referring to an asset return above the benchmark or market index as excess returns.

Secondly the ECEESPA/FM/FCF-SY(T3) being the free cash flow analysis for share holders yields are effected entirely by the economic market forces such interest rates, inflation that are constantly punctuated by the equilibrium changes to managing the sum total construct which relies on the absolute concentrated risk adjusted return relative benchmark in a globalisation financial spectrum. This new investment landscape recognises free cash flow analysis as the case for shareholders yield the order of the three drivers of changing equity return i.e. divided yield (DPS), earning per share(EPS), the price earnings yield (PER). Therefore the drivers of shareholder yield changes its importance discovered how necessary it is to establish a sustainable investment strategy in order of important drivers that change shareholder yields also effect changes to price valuation.

Therefore the drivers of equity return change in importance preferred investment valuation are also changing therefore a sustainable investment strategy needs a mechanism that can underpin with superiority/analysis ability/transparency such as Core Spectrum Attribution Symmetry Factor Metrics which means absolute concentrated risk adjusted return relative benchmark such as the following Data Points;
a. all risk,
b. all performance (blend, growth, value);
b. all mean variance;
c. all fundamental;
d. all asset class,
e. all sectors,
f. all historical evaluation;
g. all forward evaluation;
h. all quantitative;
i. all qualitative;
j. all micro;
k. all macro;
l. all ranking increase decrease risk/return;
m. all time series.

Examples of how the financial planner uses the system 12 to implement Equilibrium Combined Effect Evaluation Selection Process Analysis/Reward For Risk-Fund Managers/Free Cash Flow-Shareholders Yield (ECEEPA/RFR-FM/FCF-SY) are set out below:
1. Fund Managers:
a. Sorting Pricing—Attribution Symmetry/Ranking Summary:
   i. Capital Asset Pricing Equilibrium—Reward for Risk shown in FIG. 154; and
   ii. Capital Asset Pricing Equilibrium—3 Year Standard Deviation V's Total Return shown in FIG. 155; and
   iii. Capital Asset Pricing Equilibrium—3 Year Alpha V's Total Return shown in FIG. 156;
2. Direct Shares:
a. Scoring/Sorting—Attribution Symmetry—Ranking Summary:
   i. Share Price Component—Shareholder Yield shown in FIG. 157; and
   ii. Capital Asset Pricing Equilibrium—Reward for Risk shown in FIG. 158;
   iii. Share Price History—Daily Share Price v's All Ordinaries Indices shown in FIG. 159; and
   iv. Companies Details—Company Profile shown in FIG. 160.

### 5. Market Price Watch Process Selection Analysis (MPW SPA)(T3)

The MPWSPA(T3) market price watch processed through systematic building blocks hence market to market pricing provides counter balancing ways to minimise systematic market risk. The MPWSPA(T3) manages market pricing through micro/macro capital asset pricing models mechanisms creates superior driven skills therefore market price watch is part of the knowledge gap technique of being able to read the feedback although its predictability features is its crude Alpha tipping ability to a visual exposure model evidence by the various legacies played out as a result of the GFC looseness, such as priced in adverse debt markets, and further substantial earnings adjustments expected. The MPWPA/SBBFT(T3) likewise specially built as a “visual interfaced/exposure model” that represents the full market prices regarding FM/DSO of Global/Domestic/Sector Earnings Outlook, again evidence by its “the predominance of a sea of red or green ink” based on a metric time series of incremental Price movements ranging from daily to Two (2) Years period. As a result this tends to drive together the variable price changes/earnings upgrades, and as a result investors should reap solid returns from significant forward market valuation. For example with the assistance of MPWSPA/M/M/KGFM/CS/BT/TE (T3) it easy to pick up any early trends and indications, such as the demand from China is still strong.

Therefore as a form of future pricing technique that the major mining companies i.e. Rio Tinto and BHP can look undervalued or overvalued and delivering substantial returns even if base metal prices go sideways. The truth is therefore that it's often only professionals and the MPWPSA/TCAPMs(T3) that with a lot of Research Analysis experience and access to a lot of information who manage to pick these timing points but even then, learn there is short-term pain. So DG/FP/AC/MT/FM/SB groping for profitable investment strategies, golfers experimenting with new putting techniques or pigeons learning to feed themselves, can all face unreliable feedback as they try and distinguish between valid signals and random noise. Furthermore just as ACRARRB discovered how necessary it was to establish a sustainable investment strategy needs to be underpinned with creditable superiority and transparency mechanism in analysing the universe for skill driven traditional FM/DSO, which also contains how efficient investment becomes a self adjusting mechanism or equilibrium approach can becomes. However managing Core Spectrum through MPWSPA(T3) via various capital asset pricing models mechanism such as APMSPASPA/CAPMs (T1)(T2)(T3) creates superior skills driven FM/DSO/M/S/RS/T/SPA(T3). Currently implied default rates are multiple times higher than historical default rates due to the illiquidity premium factored into corporate debt prices. The equities valuations respond to a surge in mining stocks due to commodity prices rise like a cyclical stock and massive high deferred debt that each country has committed itself to for future generation.

Examples of how the financial planner uses the system 12 to implement Market Price Watch Process Selection Analysis (MPW SPA)(T3) are set out below:
1. Fund Managers:
a. Attribution Symmetry—Market Price Watch shown in FIG. 161; and
2. Direct Shares:
a. Attribution Symmetry—Market Price Watch shown in FIG. 162.

### 6. Ranking Summary/Multi-Brand Fund Managers/Direct Shares Opportunities/Selection Process Analysis (RS/MB/FM/DSO/SPA) (T3)

The RS/MB/FM/DSO/SPA likewise is driven by the goals of successful investing is to take positions on securities that exhibit discrepancies between observed prices and funda mental values. When the DG/FP/AC/MT/FM/SB tried to appraise traditionally FM/DSO into some sort of Ranking Summary for “Best of the Breed” and “Brand Recognition” it hasn't been done all that accurately in the past. To overcome this deficiency, the approach by RS/MB/FM/DSO/SPA(T3) takes the view that in order to provide a “best guess” estimate of the future out-performance, hence the RS/MB/FM/DSO/SPA(T3) discovered that it is very much tied to its ground breaking landmark; such as the SAS/FEM/CS/R/ROA(T2) representing the Strongest Aggregate Score has now explored how these key variables of Attribution Symmetry Metrics, i.e. the Efficiency Ratio Ranking Summary together with Top Quartile Strike Rate-Ranking Summary combined with their respective Historical/Forward Summaries, looks behind the FM/DSO as to the way the manage money. For example academic analysis call these discrepancies of the “FM/DSO market anomalies hipe” and ask if they are real or a mirage produced by a lack of understanding of the forces that drive the prices compared to their purity of valuation. Therefore the reasoning behind this new paradigm rationality is about making sound economic financial decision based on rewarded for risk equilibrium thus being able to detect any increased exposure to markets or active management decision will be based on where the excess returns per unit of risk or information ratio/beta are most likely to occur. The higher the excess return per unit of risk, the greater will be the consistency of added value. This underpins as to what the true decision making is all about which also contains this efficient investment becomes a self adjusting mechanism or equilibrium approach. Furthermore just as ACRARRB discovered how necessary it was to establish a sustainable investment strategy needs to be underpinned with creditable superiority and transparent mechanism in analysing the universe for skill driven traditional FM/DSO. Hence being one the most important discovery of this invention, in respect the RS/MB/FM/DSO/SPA(T3) ranking summary that can be described as representative of the single “Best of the Breed” pedigree FM/DSO for the individual sector.

The RS/MB/FM/DSO/SPA(T3) best of a breed and sector specific selection approach processed through systematic building blocks truly lines up on par with good investment opportunities. In other words the RS/MB/FM/DSO/SAS/FEM/CS/R/ROA/SPA(T3) strongest aggregate score for the entire platform system is interdependently linked through the HE/FE/AS(T1) information arbitrage that can function from either the AE/FEM/CS/CA(T2); such as Alpha bottoms-up or top down micro/macro knowledge gap feedback represented by M/M/KGFM/CS/BT/TE(T2). Put simply the separation of Beta from Alpha needs to be done as a reality check coming from dud FM/DSO managers. The RS/MB/FM/DSO/SPA/S/S/FE M/CS/SODA(T3) scoring/sorting approach is more about Alpha/Beta and miss-pricing assessments makes the importance of understanding a myriad of information that can read the feedback builds brand-loyalty. The problem with Research Houses ratings systems for working out the best of a breed can be misleading since although research houses analyse a plethora of multi sector specific products and it's no wonder that their methodology lacks proxy for market acceptance when their strategy is based entirely on qualitative and multi sector specific products reports are often significantly out dated.

Likewise as the name suggests Multi-Brand can be just as much an intrinsic part for determining the “brand recognition” over the total plural/sector/sub-sector. Our aim there fore, when it comes to providing the best practices for arriving at the ‘best of a breed” solutions being the premise behind the RS/MB/FM/DSO/SPA(T3) invention methodology is that the recent historical evaluation/forward evaluation/attribution symmetry are the best estimate of future sector events as a result of the FM/DSO/M/S/RS/T/SPA(T3) price volatility together with correlation data using benchmark based portfolio risk management models produces from best practices. However, with the aid of the RS/MB/FM/DSO/SPA(T3) is to quantify by separating out the full spectrum quantitative/qualitative approach through the triple tier medium of this inventions accurately perceived and represented “on auto pilot” by the APMSPAS/CAPMs(T1)(T2)(T3) Selection Process Analysis System. However the three (3) platform belonging to the all encompassing “Best of the Breed” through Attribution Symmetry” methodology portfolio selection technique is the only way to achieve the purity of a proper full core spectrum Risk/Return investment analysis for this invention which is capable of hacking the universe by constructing an appropriate portfolio selection platforms which to build the appropriate hardware such a myriad of sorting information as the APMSPAS/CAPM's(T1), (T2), (T3) that will ultimately drive the software that manages the scoring/sorting flexibility technique such as the factor pricing and knowledge gap feedback methodologies back-testing technique for each of the three (3) Tiers.

Examples of how the financial planner uses the system 12 to implement Ranking Summary/Multi-Brand Fund Managers/Direct Shares Opportunities/Selection Process Analysis (RS/MB/FM/DSO/SPA) (T3) are set out below:
1. Fund Managers:
a. Scoring/Sorting—(ER) Efficiency Ratio:
   i. Attribution Symmetry—(ER) Combined Summary shown in FIG. 163;
b. Scoring/Sorting—(TQ) Top Quartile:
   i. Attribution Symmetry—(TQ) Combined Summary shown in FIG. 164; and
   ii. Attribution Symmetry—Ranking Summary shown in FIG. 165; and
2. Direct Shares:
a. Scoring/Sorting—(ER) Efficiency Ratio:
   i. Attribution Symmetry—(ER) Combined Summary shown in FIG. 166;
b. Scoring/Sorting—(TQ) Top Quartile:
   i. Attribution Symmetry—(TQ) Combined Summary shown in FIG. 167;
c. Scoring/Sorting—(MP) Mispricing:
   i. Attribution Symmetry—(MP) Misprising Score shown in FIG. 168;
   ii. Attribution Symmetry—Ranking Summary shown in FIG. 169; and
d. Attribution Symmetry—Ranking By Fund Manager/Multi-Brand By Sector Products shown in FIG. 170.

### 7. Market/Sector/Relative Strength/Trend/Direct Shares Opportunities/Fund Manager/Selection Process Analysis (M/S/RS/T/DSO/FM/SPA)

The M/S/RS/T/DSO/FM/SPA(T3) is a portfolio of multiple managers utilising multiple strategies as to market/sector/relative strength/trend processed through systematic building blocks which provides a relative strength guide as to the current optimisation analysis/direction of the Global Investment Classification System (GICS). The M/S/RS/T/DSO/FM/SPA(T3) makes it easier to targets market/sector/relative strength/trends which has the effect in the short to medium term to protects capital by producing an efficient frontier in relation to the market/sector/relative strength/trend. The new paradigm approach that covers core spectrum miss-pricing through M/S/RS/T/DSO/SAS/FEM/CS/R/ROA/SPA (T3) being a Bottoms-Up attribution symmetry and the M/S/RS/T/DSO/FM/M/M/KGFM/CS/BT/TE/SPA(T3) being a Top Down symmetry of distribution technique becomes the efficient frontier problem which can gets really complicated without the required tools for measuring the M/S/RS/T/DSO/FM/ECEESPA/RFR-FM/FCF-SY/SPA(T3) strategic market/sector/relative strength/trend equilibrium optimisation outcomes. Therefore given that the M/S/RS/T/DSO/FM/HE/FE/AS/SPA (T3) with its extensive appetite for information arbitrage usability technique, makes a suitable choice across the board which includes the multiplicity of calculations between the M/S/RS/T/DSO/FM/SBBFT(T1) systematic building blocks hardware, that drives the M/S/RS/T/DSO/FM/HEMV(Q)/FEFR(Q)/AS(FA)SPA(T3) being the arithmetic algorithm normalisation soft ware for extracting M/S/RS/T/DSO/FM/AE/FEM/CS/R/ROA/SPA(T3) in the form of a Alpha; market/sector/relative strength/trend; makes the strategic targeted optimisation i.e. Global Investment Classification System (GICS) that can be liken to a efficient frontier.

The aim of the M/S/RS/T/DSO/FM/SPA(T3) works on the principle that, the process of Top Down/Bottoms Up, which simply means by choosing firstly the strongest sector then secondly choose in that same sector for the strongest DSO/FM, boosts your chances of success. Bear markets expose a lot of weaknesses; such as the witnessed that the majority of DG/FP/AC/MT/FM/SB can't deliver what clients want and that's performance at the desired risk—all can't show they can deliver absolute risk/returns the way they say they can. Hence being able to detect any increased exposure to markets or active management decision will be based on where the excess returns per unit of risk or information ratio/beta are most likely to occur. The higher the excess return per unit of risk, the greater will be the consistency of added value. This underpins as to what the true decision making is all about which also contains this efficient investment becomes a self adjusting mechanism or equilibrium approach, just as ACRARRB discovered how necessary it was to establish a sustainable investment strategy needs to be underpinned with creditable superiority and transparency mechanism in analysing the universe for skill driven traditional DSO/FM.

Furthermore the M/S/RS/T/DSO/FM/SPA(T3) is basically an instrument for managing risk by matching investment opportunities to an individual investment profile based on a correlated technique through the information arbitrage technique of the HE/FE/AS(T1) which has the ability to line up all sector investments that are always on par with good opportunities thus eliminating the possibility of second guessing. Therefore the M/S/RS/T/DSO/FM/SPA (T3) is firstly about choosing the right Alpha i.e. AE/FEM/CS/CA(T2) from the Bottoms Up analysis which involves the Best of a Breed and secondly about choosing the right portfolio selection from Top Down analysis which involves*Micro/Macro/Knowledge Gap Back Testing such as M/M/KGF/M/CS/BT/TE(T2) thus control ing the risk/return in a upside/down side market. For example by demonstrating that the APMSPAS/CAPMs (T1)(T2) (T3) combined approach as being one of the most efficient technique, for managing risk by matching Alpha investment opportunities to relative strength investment strategy based on a correlated M/S/RS/T/DSO/FM/SPA(T3) which has the ability to line up all investments that are always on par with good opportunities thus eliminating the possibility of second guessing. Equally the importance of for acquiring a micro/macro multi back testing/tracking error instrument such as the M/M/KGFM/CS/BT/TE(T2) provide The Best of a Breed over untraditional DSO/FM, that acts as an excellent predictably of this management tool, which can deliver returns, with a much lower overall risk correlation than the untraditional selection. The M/S/RS/T/DSO/FM/SPA(T3) is an instrument therefore for managing investment opportunities risk through matching Alpha factor metrics benchmarks, thus the emergence of a relative strength investment strategy based on a correlated AE/FEM/CS/R/ROA(T2), which has the ability to line up all investments that are always on par with good opportunities thus eliminating the possibility of second guessing. Equally the importance of for acquiring a micro/macro multi back testing/tracking error instrument such as the M/S/RS/T/DSO/FM/PA/M/M/KGFM/CS/BT/TE(T2) provide The Best of a Breed over traditional DSO/FM, that acts as an excellent predictably of this management tool, which can deliver returns, with a much lower overall risk correlation than the traditional FM/DSO/M/S/RS/T/SPA(T3).

Examples of how the financial planner uses the system 12 to Market/Sector/Relative Strength/Trend/Direct Shares Opportunities/Fund Manager/Selection Process Analysis (M/S/RS/T/DSO/FM/SPA) are set out below:
1. Direct Shares:
a. Pricing/Scoring/Sorting—(ER) Efficiency Ratio/(TQ) Top Quartile/(MP) Mispricing:
   i. Historical Fundamental—Earnings Sustainability/EPS Yield % shown in FIG. 171; and
   ii. Historical Fundamental—Earnings Sustainability/Operating Profit Margin % shown in FIG. 172;
   iii. Historical Fundamental—Earnings Sustainability/Return on Equity % shown in FIG. 173;
   iv. Historical Fundamental—Dividends Sustainability/Dividend Yield % shown in FIG. 174;
   v. Historical Fundamental—Financial Strength/Enterprise Multiples shown in FIG. 175;
   vi. Historical Fundamental—Financial Strength/Shareholders Return % shown in FIG. 176;
   vii. Historical Fundamental—Financial Strength/Net Gearing % shown in FIG. 177;
   viii. Historical Fundamental—Financial Strength/Return on Capital % shown in FIG. 178;
   ix. Historical Fundamental—Cash Flow/Price/Cash Flow Ratio % shown in FIG. 179;
   x. Historical Fundamental—Cash Flow/Debt Servicing Capacity Ratio shown in FIG. 180;
   xi. Historical Fundamental—Cash Flow/Receipts Revenue Ratio shown in FIG. 181;
   xii. Historical Fundamental—Total Return shown in FIG. 182;
   xiii. Historical Fundamental—Risk Measures/Standard Deviation shown in FIG. 183;
   xiv. Historical Fundamental—Risk Measures/Kurtosis shown in FIG. 184;
   xv. Historical Fundamental—Risk Measures/Downside Volatility shown in FIG. 185;
   xvi. Historical Fundamental—Risk Measures/Beta shown in FIG. 186;
   xvii. Historical Fundamental—Risk Measures/Batting Average shown in FIG. 187;
   xviii. Forward Evaluation—(ER) Price Value shown in FIG. 188;
   xix. Forward Evaluation—(ER) Forward Evaluation shown in FIG. 189;
   xx. Forward Evaluation—(MP) Growth Value 2 shown in FIG. 190;
   xxi. Forward Evaluation—(MP) Mispricing Summary shown in FIG. 191;
   xxii. Attribution Symmetry—Ranking Summary/(ER) Combined Summary shown in FIG. 192;
   xxiii. Attribution Symmetry—Ranking Summary/(TQ) Historical Summary shown in FIG. 193;
   xxiv. Attribution Symmetry—Ranking Summary/(MP) Mispricing Score shown in FIG. 194; and
   xxv. Attribution Symmetry—Ranking Summary shown in FIG. 195.

### Part B:—Strategic Portfolio Optimisation Process Analysis System/Capital Asset Pricing Models (SPOPAS/CAPMS)(T4)

### Specifically Targeted Correlated Efficient Frontier (SCTEF)

With reference to FIGS. 27 and 31, with the utilisation of the “Modern Portfolio Theory Risk Management (MPTRM)” there are three major drivers of a FM/DSO Investment Portfolio i.e. Selection/Risk Management of the Sector of the Asset Class and the Macro Economics/Risk Management associated with the Asset Class/Asset Allocation. The return opportunities of the first two have been significantly explored above as a factor in the long only world, whereas proactive risk management is really only practiced by SPOPAS/CAPM's (T4), subsequently there came the advent of a broader macro review of investment portfolio to fund the right mix of investments, concluding that asset allocation phenomenon represents over 90% as to the accuracy response of a portfolio volatility return and a 70% response chance regarding the value add return; hence the importance of asset mix cannot be overlooked. The SPOPAS/CAPM's(T4) likewise is driven by the goals of successful investing is to take positions on securities that exhibit discrepancies between observed prices and fundamental values. For example academic analysis call these discrepancies of the FM/DSO/M/S/SRS/T/SPA(T3) market anomalies hype and ask if they are real or a mirage produced by a lack of under standing of the forces that drive the prices compared to their purity of valuation. Therefore because the reasoning behind this New Paradigm is about making sound economic financial decisions based on reward for risk equilibrium i.e. Efficient Market Hypothesis (EMH)(Supply and Demand) rather than making Behavioural Financial(BF)(Emotional Decision), hence this underlying investment strategy rationality provided by the Absolute Concentrated Risk Adjusted Return Relative Benchmark Specifically Targeted Correlated Efficient Frontier(ACRARRBSTCEF) being the mantra of this invention)because it represents not only “The Goal for Successful Investing but also its Broad Investment Risk Management Optimality System Targeted To An Efficient Frontier” thus being able to detect any increased exposure to markets or active management decision will be based on where the excess returns per unit of risk or information ratio/beta are most likely to occur. The higher the excess return per unit of risk, the greater will be the consistency of added value. Subsequently the SPOPAS/CAPM's (T4) spans both Part A/Part B i.e. the APMSPAS/CAPMs (T1)(T2)(T3) and the SPOPAS/FCAPM's (T4) thus it's unique robust hardware/software quantitative/quantitative dedicated usage construct technique i.e. Core Spectrum Symmetry of Distribution Factor Metrics which means absolute concentrated risk adjusted return relative benchmark. What DG/FP/AC/MT/FM/SB should be doing other than creating portfolios by the traditional Mean Variance method but rather think about the Asset/Liability/Optimisation Symmetry of Distribution, Efficient Frontier Problem represented by the following vital Data Points such as (All Risk, All Performance (Blend,Growth,Value) All Mean Variance, All Fundamental, All Asset Class, All Sectors, All Historical Evaluation, All Forward Evaluation, All Quantitative, All Qualitative, All Micro, All Macro, All Economists Consensus, All Rotational Asset Class, All Retraceable Asset Allocation, All Ranking Increase Decrease Risk/Return, All Investor Style Type, All Scenario Outcomes, All Time Series and All Efficient Frontier). Clearly, only a few DG/FP/AC/MT/FM/SB have a clear investment focus and expertise to that of the superiority which realistically lies in its Structure Hardware/Software For Factor Normalisation i.e APMSPAS/CAPMs (T1)(T2)(T3) of the various market multiples components to be able to hack the universe, no matter what multiples Micro/Macro usage procedure or transmit across structural boundaries for portfolio selection/risk management scenarios with the idea of minimising the market movements.

Therefore the SPOPAS/FCAPMs (T4) represented by Part B of the Second Embodiment specifically targets strategic portfolio optimisation by taking a portfolio of multiple managers that utilises multiple strategies and processing them through seven (7) Top-Down back-end systematic building blocks filter tools, for the making of a targeted efficient frontier. Therefore a proper functional Part B “Symmetry of Distribution” represented by the combined APMSPAS/CAPMs (T1)(T2)(T3) and SPOPAS/FCAPMs (T4) becomes the efficient frontier problem which can gets really complicated without the required tools for measuring strategic portfolio optimisation. This new paradigm approach discovery represented by Part A that covers core spectrum for the of miss-pricing of risk right down to the value add through a unique attribution symmetry technique. Portfolio optimisation analysis system represented by both Part A and Part B makes it easier to protect capital by ensuring a suitable choice across the board relies on the systematic building blocks for extracting double Alpha.

### Tier 4:—Final Efficient Frontier Statistical Verification System

(Arithmetic Algorithms Hardware/Software System)

### Strategic Portfolio Optimisation Process Analysis System/Final Capital Asset Pricing Models (SPOPAS/FCAPMS) (T4)

With reference to FIGS. 27 and 31, the significant thing with the SPOPAS/TCAPM's (T4) has been its ability to boost the predictability of the portfolio's outcomes due to a set of new physical variables such as Factor Metrics analysis, that can forecast on a purity of both Quantitative/Qualitative core asset conditional structure together that captures the Micro/Macro Trends, that provides a guide to future ongoing quality sustainability returns for a client's/member's required risk/return. The SPOPAS/FCAPM's(T4) approach may be to utilise the core FM/DSO/M/S/RS/T/SPA(T3) and to surround it with low risk/high performance specialists. This is where the user friendly SPOPAS/FCAPM's(T4) would be controlled by the DG/FP/AC/MT/FM/SB, thus allows acceptable risk return out comes within the clients/members acceptable risk profile. The objective will be to identify the best of a breed of FM/DSO/M/S/RS/T/SPA(T3) and to continue with them in such a way as to satisfy the stated investment objectives. The SPOPAS/FCAPM's(T4) tends to make an optimise position of FM/DSO/M/S/RS/T/SPA(T3) by managing better returns by trading off volatility against the main market according to the clients/members tangible risk tolerance, therefore making it the penultimate back-end of the line process. Therefore given that these Part A and Part B i.e. Front/Back End Factor Pricing Modeling Systems make up the essentials for scenario testing systems combination ability of the core asset class together with these additional condition/response benchmark restraint estimates that span the universe for typical investment products relative to their reliance upon a comprehensive set of Macro Trend Forecasting i.e. MacroTD/GraphFM/CS/BT/TE (T2). These factor model enables the DG/FP/AC/MT/FM/SB to access how the financial products and portfolio will respond to changes to Symmetry of Distribution in Global and Domestic market factors or indices to which financial products are exposed, thus allows acceptable risk return outcomes within the client's/member's acceptable risk profile.

Consequently for the second part of the workings of SPOPAS/FCAPM's(T4), which doesn't believe that there will ever get a pure Strategic Portfolio Optimisation approach to many of these things, because optimisation is incredibly precise thing but the result is that they always buy the biggest error in your forecast. We can't forecast the behaviour of FM/DSO/M/S/RS/T/SPA (T3) on a historical/forward looking basis with sufficient accuracy to take the output of an optimiser with anything more than a grain of salt. At the end of the day, these tools can be useful because they provide insight and understanding of the dynamics of your problem. But you can't really get away from exercising judgment any more than other professionals like a physician or an attorney can avoid exercising judgment. Therefore the TTHBMPA (T4) takes advantages of for Mispricing Opportunity, by using extensive screening process to ensure that FM/DSO it chooses, is consistent with the CPOPA (T4) of selected FM/DSO picks spread according to the “relative strength” of the specific sector and asset classes and the ITFPA (T4), likewise are run through a screening process to conduct a thorough geographic-stock analysis. Therefore from hear the SPOPAS/FCAPM's (T4) constructs the so called clients/members “Optimality or Gap Analysis Procedure” from which the MVPRMPA(T4) being an investment portfolio based on the traditional approach whom the DG/FP/AC/MT/FM/SB generally relies on SPOPAS/FCAPM's (T4), who in turn should be taking on the role of counselors or guides aiming to keep their clients/members investment strategies on the right course in difficult times. Those DG/FP/AC/MT/FM/SB who don't follow this routine of the SPOPAS/FCAPM's(T4) may end up with major implications because they could end up overexposed to highly risky asset classes (and financial products) that fail to deliver in the future.

Subsequently, Part B being the Second Embodiment of the SPOPAS/CAPMs(T4) represent the seven (7) Top-Down back-end filter tools as illustrated below
1. Top Ten Holding Blending Mandate Process Analysis (TTHBMPA)(T4);
2. Classical Portfolio Optimisation Process Analysis (CPOPA) (T4);
3. Intenationalisation Themes/Regions Framework Process Analysis (ITRFPA) (T4);
4. New Global Investment Landscape Process Analysis(NGILPA) (T4);
5. Economists Consensus Macro Rotational Asset Classes/Retracement Asset Allocation Process Analysis(ECMRACRAAPAT4)/Diversified Investor Style Type Utility Function Model (DISTUFM) (T4);
6. Moderate Valuation Portfolio Risk Management Process Analysis (MVPRMPA) (T4); and
7. Quality Assessment Process Analysis (QAPA) (T4).

### 1. Top Ten Holdings Blending Mandate Process Analysis (TTHBMPA) (T4)

The TTHBMPA(T4) is analytical selection blending research process, that manages absolute and relative risk regarding the miss-pricing possibility of the M/M/HCA/FEM/CS/OHR (T2) high conviction for improving the risk/return estimates through forward (qualitative) equity spectrum analysis. The TTHBMPA (T4) uses core spectrum approach for a traditional blending optimisation selection process/asset allocation and risk management. Managing Alpha blended/mandated portfolio depends upon the right strategy tools for how non-systematic risk/return forward estimates can be converted into forecast that may structurally change a portfolio, by taking on the role of counselors or guide that aims to keep investment strategies on the right course in difficult times. Thus, this serves the purpose by turning an estimate into a forecast, hence the purity of the forecast by selecting the TTHBMPA(T4) for Top Ten Holdings Blending Scenario, through a Pricing P/FEM/CS/Q/Q/CA)(T2) drop down Indicators such as Income, Growth 1, Growth 2, Risk and Price. Therefore through the M/M/KGFM/CS/BT/TE(T2) it's good to understand why some FM/DSO are less market related than others. The TTHBMPA(T4) simple strategy buy into companies that deliver dividends because dividend based strategies are so attractive and growth-based strategies are a complement to equity funds.

In essence this is all about using micro/macro knowledge gap technique for FM/DSO mispricing predictability looking at it from associated with in-depth gap analysis data point for achieving desired risk/return performances of a clients/members investment portfolio, for example the DG/FP/AC/MT/FM/SB would use TTHBMPA(T4) to give an improved forward forecasted technique, for mispricing analysis, which may point towards comfortable usage of a High Conviction Approach (HCA) for a better absolute Alpha. At the end of the day, these tools can be useful because they provide insight and under standing of the dynamics of the problem. But you can't really get away from exercising judgment any more than other professionals like a physician or an attorney can avoid exercising judgment. The TTHBMPA(T4) will be responsible for hiring and firing, such as the blending investment styles, deciding which asset classes/sub-class exposure and relative weighting. It is not surprising that some are now conceding to Business Coach Model's statistically link “black box” for their solutions for active selection, monitoring and re-weighting of asset classes of FM/DSO. In other words the TTHBMPA(T4) is very much dependant on the Part A Micro Risk being the first embodiment such as the APMSAPS/CAPM (T1)(T2)(T3) which as you can previously see, is put through a stringent quantitative/qualitative filtering process to ascertain their Scoring/Sorting robustness in the critical focus of Historical Evaluation/Forward Evaluation/Attribution Symmetry being the essential filtering and back testing apparatus of the invention. Therefore to find out where they are coming from the TTHBMPA(T4) is required firstly to under go the robust HEM V(Q)/FEFR(Q)/AS(FA)(T1), factor metric core spectrum test to determine the specific skills and experience by measuring their track record for excess returns over the benchmark in Alpha rather than Beta skills of a traditional manager over the near term risk/return variable of 1, 3 and 6 months to 1 year plus 1 and 2 year forward estimates periods. Thus, this serves the purpose by turning an estimate into a forecast, hence the purity of the forecast by selecting the Top Ten Holdings drop down Indicators such as Income, Growth 1, Growth 2, Risk and Price. It's good to understand why some FM/DSO are less market related than others. Likewise with the TTHBMPA (T4) makes it easy to understand why some FM/DSO/M/S/RS/T/SPA (T3) will either outperform or under perform over a 1 to 2 year forward period (forecasted), since the aim of the filtering process is it's superiority in analysing the universe for skill driven traditional FM/DSO. With TTHMBPA (T4) the innovated techniques of being able to hack various FM/DSO/M/S/RS/T/SPA (T3) and components to make up those adjustments where they are needed. Hence the TTHBMPA (T4) by measuring their track record for excess returns over the benchmark in Alpha (rather than beta skills) over the current and the forward estimated 1 to 2 year period (forecasted) and again system knows how to process two year (2) forward estimates into some meaningful predictable; Income, Growth 1, Growth 2, Risk and Price for FM/DSO. Likewise given the technique of an absolute return/risk strategy measured against relative benchmarks to finish up with an efficient Alpha/Beta portfolio. To find out where they are coming from requires a robust quantitative system to test the specific skills and experience.

Examples of how the financial planner uses the system 12 to Ten Holdings Blending Mandate Process Analysis (TTHBMPA) (T4) are set out below:
1. Fund Managers:
a. Scoring/Sorting—(ER) Efficiency Ratio/(TQ) Top Quartile:
   i. Attribution Symmetry—Ranking Summary shown in FIG. 196;
b. Forward Evaluation—Top Ten Holdings shown in FIG. 197;
c. Portfolio—Correlation Matrix shown in FIG. 198;
d. Portfolio—Top Ten Blending Income shown in FIG. 199;
e. Portfolio—Top Ten Blending—Risk 2 shown in FIG. 200;
f. Portfolio—Top Ten Blending—Pricing shown in FIG. 201;
g. Portfolio—Portfolio Detail/portfolio X—Ray shown in FIG. 202;

### 2. The Classic Portfolio Optimiser Process Analysis (CPOPA) (T4)

The CPOPA(T4) is used as draft constructs investment portfolio or trail run for the purpose of forecasting the purity of the Moderate Valuation Portfolio (MVPRMPA (T4)) hence being based on the traditional approach of relying on asset selected technique i.e. the APM SAPS/CAPMs (T1)(T2)(T3). As a result the FM/DSO needs to be asset allocated across the SPOPAS/CAPMs (T4) that produces the appropriate asset class, according to the clients/members “Efficient Frontier”. Therefore the CPOPA (T4) has the scope to demonstrate the statistical validity of a quantitative/qualitative risk approach due to a comprehensive historical/forward database upon which to perform such an analysis, the opportunity to incorporate risk-based quantitative/qualitative research is appealing simply because it is an area that currently appears to be far less competitively pursued and as such, the rewards for effort should be significant. Clearly, there is a high onus on DG/FP/AC/MT/FM/SB investment management skills, to know their circle of competence and remain within it such as;
i. The CPOPA (T4) is design to leaves some “first and foremost” thoughts evidence by a “High Conviction FM/DSO Portfolio” approach for DG/FP/AC/MT/FM/SB to consider. As a result, an interim sector by sector selection approach list representing the top; The CPOPA(T4) classical portfolio optimisation decides on the feasible exposure on each of the available FM/DSO financial products it chooses approximately three (3) up to eight (8) FM/DSO out of each Asset Class based depending on the sample breakeven hypothesis of forty (40) of both the Efficiency Ratio/Top Quartile Technique. This enables an optimised efficient frontier that is forecasted on a purity of core spectrum risk/return i.e. (fund weighted mean/share weighted mean, sector mean, sector top quartile and market mean) relative to the Top Quartile/Market Mean benchmark that operates across a robust global and domestic FM/DSO asset class respectively, are allocated as a result of an in-depth core spectrum research for an Alpha analysis and evaluation. Subsequently through the initial using of the superior research tools such as ERSPA(T3), TQSRSPA(T3) and MPDSOSPA(T3) thus on the one hand represents the input for the CPOPA (T4), which ultimately provides a superior stock selection output for the final CPOPA(T4) draft, by way further sector by sector concentration selection technique approach (i.e. 1 to 2 funds and 2 to 4 stocks respectively) would be regarded with enough diversification to guard against extreme volatility but not in a manner that substantially dilutes the benefits of disciplined portfolio construction process.
ii. Due to the more variable index characteristics of the CPOPA(T4) such as a benchmark, increased awareness of how concentration and risk/reward characteristics of the index are changing are likely to be an important consideration in the portfolio construction optimisation. Hence the CPOPA(T4) decides on how non-systematic risk/return historical/forward estimates can be converted into a forecast capturing risk consistently using traditional valuation models such as the absolute risk adjusted return relative benchmark results in risk/reward improvements characteristics through systematic building blocks produce via the greater diversification optimisation process. In other words some analyst become over confidence as a measure of how much they believes they have a competitive advantage relative to the market in understanding the risks and return opportunities for a given FM/DSO. This is subjective but recognises that despite all the best intentions, analysts do not always have the same level of understanding or conviction across all FM/DSO within their coverage universally. Therefore unlike ERSPA (T3), TQSRSPA (T3) MPDSOSPA (T3); the CPOPA (T4) risk/return analyses concludes that; by converting the expected risk/return scores into financial forecasts, the quantitative/qualitative risk analysis is just as easy to standardise and quantify into a direct numerical output. For example, the CPOPA (T4) portfolio will take a under weighted good corporate governance and translate it into a “one off′ variability of risk/returns being the Strongest Aggregate Score i.e. SAS/FEM/CS/R/ROA (T2) estimate, so that DG/FP/AC/MT/FM/SB can methodically use this information that they know has significant value but is difficult to measure. In a sense, like the qualitative analysis that results in FM/DSO valuation, there is no getting away from individual analyst judgement and this has to be accepted.
iii. However, it is possible to crudely score each of the risk factors investors are trying to assess with the objective of being approximately right rather than precisely wrong. Using such a crude score would still provide a wide variance of risk estimation between one security that has low transparency, poor corporate governance, low quality earnings, high financial leverage and weak management and a second security that has high transparency, good corporate governance, high quality earnings, low financial leverage and strong management. Therefore we have design such flexible fore casting technique associated with the present CPOPA (T4) that provides such a usefulness ability to differentiate between several competing AE/FEM/CS/CA (T2) Alphas regards their selection population for an “optimised portfolio position”, thus translated it into a “one off′ scoring/sorting variability of risk/returns being the Strongest Aggregate Score i.e. SAS/FEM/CS/R/ROA (T2) estimate, by individual sector embodiment system in-accordance with firstly ranking into the highest score and likewise ranking that process into strongest aggregate score, which thus can be forecasted on a purity of Best of a Bread out—performance; conditionally together with their separate set of physical variables that captures the combined evaluation such as total return, full spectrum of risk and statistical analysis that provides a guide to future ongoing strategic forecasts are useful for selecting the composition of an optimised portfolio and the other such embodiment based on of the present SPOPAS/CAPM's (T4) being a system in-accordance with Macro statistical trends which can be forecasted on a purity of asset classes/asset allocation; conditionally together with their separate set of physical variables that captures the economic conditions that provides a guide to future ongoing strategic forecasts are useful for selecting the composition of an optimised portfolio.
iv. In addition, by directing qualitative research efforts to better understand fundamental risks as well as continuing to look for Alpha opportunities, DG/FP/AC/MT/FM/SB can develop a basis for introducing greater benchmark tracking error into a portfolio that is likely to result in improvements, through greater diversification of the portfolio, in absolute risk adjusted return relative to that of the benchmark. More specifically, regardless of the measurement method used, the CPOPA (T4) evidence by its mandate ACRARRBSTCEF cares about the absolute risk adjusted returns in the performance of their portfolios. Whilst the focus can often be on the return objective or achievement, the risk assumed to generate this return should not be ignored. As a result of the CPOPA(T4) demonstrates the scope and ability for the concentrate technique that refines the quantitative/qualitative risk/reward estimates through Fund Managers—Historical Performance (Trailing Performance), Forward Performance(Equity Statistics), Risk Measures 1 and 2, Relative Risk Measures 1 and 2, Market Capitalisation, GICS, Style Blend, Regions, Buy/Sell. Direct Shares Opportunities—Historical Performance (Trailing Performance), Forward Performance(Buy/Sell/Hold—Income Value, Growth Value 1, Growth Value 2, Risk Value, Price Value) Risk Measures 1 and 2, Relative Risk Measures 1 and 2, Dividend Sustainability, Earnings Sustainability, Financial Strength, Cash Flow. The aim therefore reinforces that CPOPA (T4) complements Comparative Value Analysis (CVA) approach is in line with buying stocks at the bottom of their cycle when the market has priced them at a substantial lower price than they are worth and where FM/DSO are being sold at the top of their cycle before they peak. It also follows that the volatile market place is that perfect place to look for such opportunities. The CPOPA(T4) is basically a CVA which is also known as Intrinsic Value Analysis hence the additional mechanism which searches for FM/DSO that become undervalued whether is Value, Neutral, or Growth Style FM/DSO, and can take a position until such time as they reach their true value. High Conviction FM/DSO/M/S/RS/T/SPA(T3) benefit in the long term. There are always FM/DSO that represent better value than others and between value and the market as a whole. Whilst the focus can often be on the return objective or achievement, the risk assumed to generate this return should not be ignored. As a result of the CPOPA(T4) demonstrates the scope and ability for the concentrate technique that refines the quantitative/qualitative risk/reward estimates.
v. However the question is whether the funds are a suitable choice across the board, firstly in our opinion lies with the establishment of a client/members “Efficient Frontier” processed through the all important systematic building blocks. In that, the behaviour of Structured Portfolio; ie the FM/DSO/M/S/RS/TA/SPA(T3) doesn't need to be looked at solely in terms of mean and variance/fundamentals. The CPOPA(T4) looks at through other characteristics such as Symmetry of Distribution (Absolute Risk/Return/Relative Benchmark) and Optionality. (The Optimum Alignment between the Client's Risk Tolerance and the Selection of Investments known as Gap Analysis). After generating future scenarios from the CPOPA(T4) the uniqueness of the part played by the ECMRACRAAPA(T4). Economics Consensus factor modelling is accomplished by calibration of the returns of individual financial products with exposure of asset classes. In this manner, through interface with the DISTUFMs(T4), the DG/FP/AC/MT/FM/SB learns how each of the available financial products, behaves relative to the asset class employed by the factor model. In doing so, the DG/FP/AC/MT/FM/SB implicitly determines the constraints on feasible exposure to different asset classes faced by to individual clients/members, being DISTUFMs (T4), If the clients/members was risk averse, it would be appropriate to adjust the overall risk of the portfolio according to one of the appropriate Five (5) diversified investor style type utility function embodiment which is scientific/mathematical benchmark of, hence the ease of a drop down investor style down menu i.e. “Conservative, Moderately Conservative, Balanced, Moderately Aggressive, Aggressive. Hence this Economists Consensus technique forecasts the numbers that are usually on an average with all economists' forecasts that creates a top down expectation in general, on how the market views the global and domestic prospects.

Finally the only free lunch if we can find the synergy comes from proper portfolio i.e. the SAS/FEM/CS/R/ROA (T2) strongest aggregate score and stay with it for some time we should have a superior outcome so as to ascertain the efficient portfolio construction a true feeling of discretionary power over achieving clients/members goals and objectives for trading off the clients perceived risk against the portfolios perceived risk. This is done through portfolio scenario testing optimisation that may structurally change a portfolio. In other words this embodiment of the CPOPA(T4) invention has been chosen from “Factor Pricing Metrics condition restraint Benchmarking” such as accordingly the Economics Consensus being the ECMRACRAAPA(T4) which opens up to a range of investments available in main stream FM/DSO/M/S/RS/T/SPA(T4) that enables the individual clients/members to reach the broadest segment of the asset classes/asset allocation selected according to their Risk Tolerance. So it's no wonder that the CPOPA(T4) building blocks may not control omnipotence (all powerful, almighty invincible) but at least may spare the pain of putting all your money in ad hoc diversification that may go wrong. The more you put your investment on auto pilot, the less risk that you will crash them. Therefore in order to understand markets or a FM/DSO/M/S/RS/T/SPA(T3) when managing risk in a Multi Manager Portfolio, you need to focus on the risk structure, exposure to specific FM/DSO but right down to add value, despite having a set of beliefs backed by research and idiosyncratic skills. The thing that is placed on them is that this is diminishing returns for added risk. Therefore, one way in which we can improve performance is to be underweight in that FM/DSO/M/S/RS/T/SPA (T3), thus maintaining an acceptable overall portfolio risk exposure is through tactical asset allocation, i.e. arbitrage by equilibrium offset technique

Examples of how the financial planner uses the system 12 to The Classic Portfolio Optimiser Process Analysis (CPOPA) (T4) are set out below:
1. Fund Managers:
a. Scoring/Sorting—(ER) Efficiency Ratio/(TQ) Top Quartile:
   i. Attribution Symmetry—Ranking Summary shown in FIG. 203;
   ii. Portfolio—Fund Optimiser/Historical Performance shown in FIG. 204;
   iii. Portfolio—Fund Optimiser/Forward Performance shown in FIG. 205;
   iv. Portfolio—Fund Optimiser/Risk Measures 2 shown in FIG. 206;
   v. Portfolio—Fund Optimiser/Relative Risk Measures 2 shown in FIG. 207; and
   vi. Portfolio—Fund Optimiser/Buy/Sell/Hold shown in FIG. 208;
2. Direct Shares Opportunities:
a. Scoring/Sorting—(ER) Efficiency Ratio/(TQ) Top Quartile/(MP) Mispricing:
   i. Attribution Symmetry—Ranking Summary By Sector shown in FIG. 209;
   ii. Portfolio—Asset Allocation/Share Optimiser shown in FIG. 210;
   iii. Portfolio—Share Optimiser/Buy/Sell/Hold—Income Value shown in FIG. 211;
   iv. Portfolio—Share Optimiser/Buy/Sell/Hold—Growth Value 1 shown in FIG. 212;
   v. Portfolio—Share Optimiser/Buy/Sell/Hold—Growth Value 2 shown in FIG. 213;
   vi. Portfolio—Share Optimiser/Buy/Sell/Hold—Risk Value shown in FIG. 214;
   vii. Portfolio—Share Optimiser/Buy/Sell/Hold—Price Value shown in FIG. 215; and
   viii. Portfolio—Share Optimiser/Buy/Sell/Hold—Final DSO Portfolio shown in FIG. 216.
3. Internationalisation Themes/Regions Framework Process Analysis (ITFPA) (T4)

The strategy for ITRFPA(T4) is an artful blend of fundamental insights with philosophical grounding of quantitative/qualitative portfolio management techniques. This is a version of “Hybrid Approaches” concept of development which describes ways in which DG/FP/AC/MT/FM/SB use quantitative/qualitative tools and techniques to build port folios. Fundamental approaches have the advantages in the depth of knowledge and unique insights they provide on individual companies while quantitative approaches have an advantage in their ability to evaluate a large number of stocks through their models and in managing risk through discipline portfolio construction framework. Therefore by design the ITRFPA(T4) searches for Alphas by geographic sectors means and specific study of the FM/DSO/M/S/RS/T/SPA(T3) through the HEM V(Q)/FEFR(Q)/AS(FA)(T1) being a Systematic Factor Pricing Metrics Benchmarking usability process based on the Historical Evaluation/Forward Evaluations/Attribution Symmetry and by this reasoning it has been the effect of shifting to concentrate on High Conviction Approach (HCA) such as “Looking at Themes”, “Global Experience” or the “Next Big Thing”. Given the Emerging Markets and commodities nature of changes opportunity, fundamental insights are preferable in stock selection, given the ability for specialist managers to develop insights in stocks of companies providing emerging solutions to challenges of global funds management. However, the fundamental insights are also a key component in establishing a investable universe that will serve as a benchmark for portfolio construction process, is something that has been identified traditionally by quantitative managers. Traditional approaches of top-down, bottoms-up, indexation and benchmarking fundamental insights can play a key role in identifying the prominent themes within the international framework solutions that will be the key component in establishing the universe of stocks for investment.

The ITRFPA(T3) is basically a combination of factor and non-factor concentration of both the Qualitative/Qualitative risk adjusted return analysis which indirectly, the DG/FP/AC/MT/FM/SB rely on as a “Global Grid Structure” for concentrating on “The Next Big Thing, Themes, or Global Experience” where by altogether the HEMV(Q)/FEFR(Q)/AS(FA)(T1) provides another vector through the Classic Optimiser i.e. the CPOPA (T4) which improves quantitative predictability upon which to create this Micro/Macro statistical verification system once again the intended embodiment of this invention mantra i.e. ACRARRBSTCEF. Indeed the entire APMSAPS/CAPMs (T1) (T2)(T3) and the CPOPA(T4) should better explain the portfolio relative to the benchmark at a particular point in time for both Micro/Macro risk adjusted return models. Furthermore in conjunction with a qualitative approach to risk, the ITR FPA(T4) information contained in this analysis of benchmark diversity or concentration can be useful in helping determine in search of higher Geographic Alpha when as a result of higher tracking error (deviation from the benchmark portfolio) can result in lower absolute portfolio risk that results from a return expectation of an active FM/DSO/M/S/RS/T/SPA(T3) may hold relative to the benchmark.

The ITRFPA(T4) is very much focuses on using research effort to improve returns through the basic usage approach to investments is that every thing reverts to the mean. That's why the ITRFPA(T4) improving the risk/return estimates using traditional HEMV(Q)/FEFR(Q)/AS(FA)(T1) quantitative/qualitative valuation models and given a crude scoring technique still provides a degree of risk estimation that consistently capturing Alpha using high conviction approach. In addition therefore the ITRFPA(T4) makes a great forward looking/thinking statements that's all about the next big thing or the global experience or looking at themes will be in a position to deliver dominant returns whereby a quality of sector is critical in this environment. Therefore as an agreement for change the ITRFPA(T4) concentrates more on the natural thinking aspect based of numbers which projects the rhetorical argument regards identifying the weighting of the next big thing or the global experience or looking at themes thus enables it to focus on absolute comparative value strategy:
a. volatile markets create good opportunities;
b. simple strategy—buy into companies that deliver dividends;
c. overwhelmingly in favour of owning dividend-paying stocks;
d. why dividends are so attractive for investors;
e. growth style v's value style or rotation approach; and
f. how the forecast free cash flow that generates the future cash flow stream.

Examples of how the financial planner uses the system 12 to Internationalisation Themes/Regions Framework Process Analysis (ITFPA) (T4) are set out below:
1. Direct Shares Opportunities:
   i. Portfolio—International/Themes/Regional Framework in FIGS. 217 and 218.
4. New Global Investment Landscape Process Analysis (NGILPA) (T4)

The NGILPA(T4) new investment landscape recognises that several important themes within the present and future investment landscape the two (2) most powerful Global influences that have been impacted are Globalisation and The Post Bubble Economy.

a. Globalisation

Globalisation continues to allocate labour and capital via the Law of Comparative Advantage.

This process has kept inflation down, kept interest rates relatively low, and has resulted in remarkable increases in productivity and profits. As globalisation continues to impact our international economy a free cash flow oriented investment philosophy will be more important than ever. Globalisation has resulted in higher worldwide GDPs and because real interest rates have been shown to track historical GDP growth, it follows that real interest rates should rise as well. Globalisation affects the nominal interest rate and the real interest rate in different ways. However, at the same time, globalisation has also lowered wage expenses via the labour arbitrage phenomenon on inherent in the Law of Comparative Advantage. These low wages have resulted in low prices, which have kept inflation down. Therefore, if we add this decrease in inflation to the increase in real interest rates, we end up with nominal interest rates that will rise, fall, or stay the same by virtue of the magnitude of these two independent variables.

At this point in time, the negative contribution of real growth from falling world GDP's will combine with the positive contribution of low inflation to result in nominal interest rate levels which, are likely to follow a flat-to-growing trajectory, but will be kept lower than they otherwise would be without the presence of labour arbitrage and its impact on inflation measures.

b. Shareholder Yield Philosophy

The NGILPA(T4) belief that while lowering of interest rates will certainly open up new opportunities for the informed DG/FP/AC/MT/FM/SB via the application of the Share holder Yield philosophy, many new dangers and pitfalls will be manufactured as a result of the return to Globalised Federal Reserves Budgeted Deficits as quick fix contraction oriented monetary policy. These pitfalls may include (and in some cases, already have included) Budgeted Deficits Globalisation should cause real interest rates to remain flat or rise and this is indeed the case. But there are also aspects of the globalisation process that may put downward pressure on interest rates and NGILPA(T4)—Managing the New Investment Landscape believes this phenomenon exists alongside the nominal interest rate is equal to the real interest rate plus a measure that reflects inflation.

The NGILPA(T4) has explains how coordinated expansionary monetary policies keep interest rates lower than they would have been otherwise and allowed the forces of globalisation to gather momentum and to aid the creation of a defacto dollar zone. Then NGILPA(T4) has discussed how climbing interest rates lead to falling P/Es which in turn allow the three components of Shareholder Yield—cash dividends, share buybacks and debt pay-downs, to eclipse the P/E ratio as dominant positive explanatory variables in equity market returns. Simply put, Globalisation is producing some dramatically positive results and these results directly support the value of a Shareholder Yield-based approach to investing. Because of the labour arbitrage efficiencies made possible by the Law of Comparative Advantage, global labour costs are lower on aggregate, which has resulted in higher global free cash flow. As the world's factory floor is being rewired through globalisation, more goods and services are being created per unit of resources, which means more resources (i.e. free cash flow) can be deployed in a manner that directly enhances shareholder value through dividends, share buybacks and debt reduction. This process has kept inflation down, kept interest rates relatively low, and has resulted in remarkable increases in productivity and profits. As globalisation continues to impact our international economy a free cash flow oriented investment philosophy will be more important than ever.

c. The Post-Bubble Economy

Hence the effect of the tightening of Interest Rates resulting in the popping of three big economic bubbles:
i. the housing bubble;
ii. the global liquidity bubble; and
iii. the corporate profit bubble.

Because interest rates are also extremely integral to the notion of Shareholder Yield, the popping of these bubbles cannot help but influence how both companies and investors use free cash flow as the dominant investment metric.

Examples of how the financial planner uses the system 12 to New Global Investment Landscape Process Analysis (NGILPA) (T4) are set out below:
1. Globalisation Equity Markets Spectrum:
a. Macro Trend Forecast—Dow Jones Index—Daily shown in FIG. 219;
b. Macro Trend Forecast—S & P 500 Index—Daily shown in FIG. 220;
c. Macro Trend Forecast—NASDAQ 100—Daily shown in FIG. 221;
d. Macro Trend Forecast—Euronext 100 Index—Daily shown in FIG. 222;
e. Macro Trend Forecast—Frankfurt DAX 30 Index—Daily shown in FIG. 223;
f. Macro Trend Forecast—FTSE 100 Index—Daily shown in FIG. 224;
g. Macro Trend Forecast—Nikkei 100 Index—Daily shown in FIG. 225;
h. Macro Trend Forecast—MSCI Emerging Market Free W/Gross Div in A$ (Monthly) shown in FIG. 226; and
i. Macro Trend Forecast—MSCI AS Fer East Free ex Japan Gr Div A$ (Monthly) shown in FIG. 227; and
2. Globalisation Bond Markets Spectrum:
a. Macro Trend Forecast—US 13 Week Treasury Bills—Daily shown in FIG. 228;
b. Macro Trend Forecast—US 5 Year Treasury Notes—Daily shown in FIG. 229;
c. Macro Trend Forecast—US 10 Year Treasury Notes—Daily shown in FIG. 230; and
d. Macro Trend Forecast—US 30 Year Treasury Notes—Daily shown in FIG. 231.

### 5. Economists Consensus Macro Rotational Asset Class/Retracement Asset Allocation Process Analysis (ECMRAARACPA) (T4)/Diversified Investor Style Type Utility Function Models (DISTUFM) (T4)

The only such forecasts associated with all the present Typical Investor Style Type Mixes i.e. Economists Consensus Macro Rotational Asset Class/Retracement Asset Allocation, Risk Tolerance Profile Questionnaire and Life-Cycle Funds which are useful for selecting the composition for a “diversified optimised portfolio” based on such embodiment of the present APMPAS/CAPM's(T1)(T2)(T3) being a system in-accordance with micro statistical trends such as the HEMV(Q)/FEFR (Q)/AS(FA)(T1) which can be forecasted on a purity of Best of a Bread outperformance; conditionally together with their separate set of physical variables that captures the combined evaluation such as total return, full spectrum of risk and statistical analysis that provides a guide to future ongoing strategic forecasts are useful for selecting the composition of an optimised portfolio and the other such embodiment based on of the present SPOPAS/CAPM's(T4) being a system in accordance with Macro statistical trends which can be forecasted on a purity of asset classes/asset allocation; conditionally together with their separate set of physical variables that captures the economic conditions that provides a guide to future ongoing strategic forecasts are useful for selecting the composition of an optimised portfolio. Clearly, only a few DG/FP/AC/MT/FM/SB have a clear investment focus and expertise because the reasoning behind this rationality is provided by Absolute Concentrated Risk Adjusted Return Relative Benchmark Specifically Targeted Correlated Efficient Frontier (ACRRRBSTCEF) (being the mantra of this invention) because it represents not only The Goal For Successful Investing but also its Broad Investment Risk Management Optimality System Targeted To An Efficient Frontier, that signify structural changes to individual's future financial circumstances which can result in behavioural changes that can have some major long-term implications for appropriate investment strategies. As the ECMRAARACPA(T4) is a useful guidance device that provides the DG/FP/AC/MT/FM/SB with an systematic inbuilt on line economists consensus feed back matching as set allocation/asset class trend forecast that takes care of the problem of choosing an appropriate reward for risk technique regarding the five (5) DISTUFM(T4) utility function based on the relative strength of the specific market/sector as set classes. This explains why ECMRAARACPA(T4) are now seeking the SPOPAS/CAPM's (T4) concept of an asset allocation and sector exposure to that aims to produce absolute relative returns irrespective to market trends and rewards it's clients with greater chance for a value added portfolio.

### 1. Economists Consensus Macro Rotational Asset Class/Retracement Asset Allocation

The ECMRACRAAPA(T4) economists consensus macro rotational asset class/retracement asset allocation process being that part of the back-end macro knowledge gap analysis process for the selection mispricing of asset class/asset allocation predictability that makes it conditional on a purity upon a set of variable and forecasted economic conditions, that produces strategic asset class/asset allocation benchmark processed through systematic building blocks thus capturing absolute risk/return for typical investor style type utility function mix i.e. the five (5) DISTUFM(T4) represented by Conservative, Moderately Conservative, Balanced, Moderately Aggressive and Aggressive consistently using traditional economists consensus models. The ECMRACRAAPA(T4) strategic portfolio optimisation makes the efficient frontier, based on forecasted Portfolio Alpha is the value that economists consensus mechanism of top-down/bottoms-up can add is extremely useful for selecting the composition of an optimised portfolio. Therefore the ECMRACRAAPA(T4) as a significant factor modeling forecasting tool provides the need for a scenario testing analysis process system compared to prior art satellite core optimised asset class/asset allocation mix are flaunt with danger.

Thus this Economists Consensus forecasted numbers are usually an average of all economists' forecasts which gives a top down created expectation in general on how the market views the global and domestic prospects. Subsequently, considering it's a proper factor model based upon a appropriate economists consensus conditional response technique, therefore the five (5) DISTUFM(T4) represented by Conservative, Moderately Conservative, Balanced, Moderately Aggressive and Aggressive, that makes it a very useful selection indicator, by recommending that the DG/FP/AC/MT/FM/SB virtually stay between the tramlines. This can be a tremendous confidence booster for relative inexperienced DG/FP/AC/MT/FM/SB, which helps them to diversifying into new asset classes or sectors that have a low correlation with existing asset classes which are typically the traditional asset classes of equities, fixed interest, property and cash, the efficient frontier can be improved to yield better risk reward opportunities.

### 2. Risk Tolerance Profile Questionnaire Style

The ECMRACRAAPA(T4) better risk reward opportunities are possible for across a “Typical Investor Style Type Mix”. In other words the best risk reward opportunities presented by Economists Consensus represent the best “Efficient Frontier”; in this incidence recognised as “a guidance by default benchmark”, thus can be forecasted on a purity of asset classes (core asset) conditional on a set of macro trend forecasting variables that captures the forward global/domestic economic conditions that provides continuous strategic asset allocation/across all the asset classes. Therefore this is accomplished by calibration of the returns of individual financial products with exposure of asset classes. In this manner, through interface with the clients/members, the DG/FP/AC/MT/FM/SB learns how each of the available financial products, behaves relative to the asset class employed by the factor model. In doing so, the DG/FP/AC/MT/FM/SB implicitly deter mines the constraints on feasible exposure to different asset classes faced by to individual clients/members, five (5) Diversified Investor Style Type Utility Model i.e. DISTUFM (T4). If the clients/members was risk averse, it would be appropriate to adjust the over all risk of the portfolio according to one of the appropriate five (5) drop-down typically diversified utility function investor type embodiment which is scientific/mathematical benchmark, thus the clients/members Risk Tolerance Profile determination as a result of a Psycho Metric Questionnaire based on twenty (20) colloquial multi-choice issues. Hence the ease of main stream alignment between five (5) DISTUFM and ECMRACRAAPA (T4)

### Life-Cycle Funds

It is not surprising that most DG/FP/AC/MT/FM/SB who may use Life-Cycle Funds Approach to manage the asset mix in someone's super to fit their changing circumstances during their lifetime, thus adjusting to a lower risk profile as members get near to retirement are now conceding to ACRARRBSTCEF(T4) statistically link “black box” for their solutions for active selection, monitoring and re-weighting of asset classes/sub-sectors of FM/DSO/M/S/RS/T/SPA (T3). But in theory the Life-Cycle Funds Approach of changing assets to fit members' circumstances is not without problems. This often depended on a subtle distinction between whether a fund was investing up to a retirement date or continuing to invest through (and beyond) a retirement date. The Personal Questionnaire already has the detailed member profiling to support such products. Also, the ideal approach might need to involve a different investment approach across a member's entire life. So, while people are working, they have the ability to take more risks and pursue a high growth approach. Life-cycle funds need to recognise that, by the time people near retirement, their at-risk savings are at a peak and that their human capital (their ability to generate future income) is declining. One of our weaknesses of the system is that the post-retirement part of superannuation is much less developed than the accumulation phase. In general, pensions rely on investment performance of a member's account.

Examples of how the financial planner uses the system 12 to Economists Consensus Macro Rotational Asset Class/Retracement Asset Allocation Process Analysis (ECMRAARACPA) (T4)/Diversified Investor Style Type Utility Function Models (DISTUFM) (T4) are set out below:
1. Client Risk Profiling:
a. Risk Tolerance Questionnaire shown in FIG. 232; and
2. Micro/Quantitative:
a. Australian Fund Managers:
   i. Multi-Sector—Conservative shown in FIG. 233;
   ii. Multi-Sector—Moderately Conservative shown in FIG. 234;
   iii. Multi-Sector—Balanced shown in FIG. 235;
   iv. Multi-Sector—Moderately Aggressive shown in FIG. 236; and
   v. Multi-Sector—Aggressive shown in FIG. 237.

### 6. Moderate Valuation Portfolio Risk Management Process Analysis (MVPRMPA) (T4)

The MVPRMPA(T4) is a smart all-in-one system which has the ability to multi task FM/DSO/M/S/RS/T/SPA(T3) strategies to continuously select the pedigree investments that systematically asset allocate in-accordance with the Client Risk Profile, being the penultimate stage of the Strategic Portfolio Construction dynamics, for this reason has taken this theory one step further, than the utilisation of “Markwitz's Modern Portfolio Theory (MPT)” who achieved the “Noble Prize” for his discovery of co-efficient correlation technique approach by using quadratic equations which subsequently there came a broader macro review of Investment Portfolio. However the problem Markwitz's MPT had was that the FM/DSO/M/S/RS/T/SPA(T3) doesn't need to be looked at solely in terms of mean and variance, but also should look at also from the fundamentals point of view (i.e. Profit and Loss/Balance Sheet) and Optimality characteristics such as Symmetry of Distribution (i.e. Absolute Risk Adjusted Return Relative Benchmark The Gap Analysis Alignment between the Client's Risk Tolerance and the Selection of Investments). There fore with the advent the MVPRMPA(T4) came three major drivers of a FM/DSO/M/S/RS/T/SPA (T3) Investment Portfolio i.e. Selection Risk Management over the Asset Class (Micro) and the Asset Allocation Risk Management of matching the Asset Class (Macro) in-accordance with the Client Risk Profile. Therefore to fund the right mix of investments, concluding that co-efficient equation asset allocation phenomenon represented over 90% as to the accuracy response of a portfolio volatility return and a 70% response chance regarding the value add return; hence the importance of asset mix cannot be overlooked.

Hence this gives the MVPRMPA(T4) the purity of an improved predictability expectations to all points towards comfortable forecasted usage a high concentrated approach for a better absolute Alpha. At the end of the day, these tools can be useful because they provide insight and understanding of the dynamics of the problem. But you can't really get away from exercising judgment any more than other professionals like a physician or an attorney can avoid exercising judgment. Since the aim of the MVPRMPA(T4) being based on Core Spectrum Factor Metrics is able to read the “Knowledge Gap Feedback” which consists in part as the hardware; i.e. Core Spectrum Symmetry of Distribution Factor Metrics and as the other part as the software; i.e. Core Spectrum Capital Asset Pricing Models Factor Metrics which you simply can't make it do what you want with out performance in all markets; however when shares get volatile, it can provide constant returns, no matter what's happening around you, albeit managing better returns with the design of the MVPRMPA(T4) by trading off volatility against the main market. The ability to use the basic building blocks is to select the pedigree investments solutions increases the flexibility of DG/FP/AC/MT/FM/SB and increases the possibility of tailoring the portfolio solutions exactly to the needs of the Clients/Members Investor Style Type Utility Function, because the dilemma lies the MVPRMPA(T4) who is perennially faced with the difficulty of accessing and understanding this myriad of information, that comes in the form of statistics, data and other indicators used by professionals to gauge the markets like business sentiments, investment and employment levels and major commodity prices associated with the problem of knowing when to Buy, Sell or Hold are reasons why the DG/FP/AC/MT/FM/SB invest in the MVPRMPA(T4) because it's a reasonable proxies for premiums that DG/FP/AC/MT/FM/SB are willing to pay for investment risk that is superior in analysing the universe for skills driven traditional FM/DSO/NUS/RS/T/SPA(T3) with the innovated techniques to be able to hack the universe and the various components to make up those adjustments where they are needed. Likewise to the technique of an absolute risk adjusted return strategy measured against relative benchmarks to finish up with an efficient Alpha/Beta Portfolio.

Therefore because the reasoning behind this New Paradigm regarding a Alpha/Beta Portfolio is about making sound economic financial decisions based on rewarded for risk equilibrium i.e. Efficient Market Hypothesis (EMH)(Supply and Demand) rather than making Behavioural Financial (BF)(Emotional Decision) hence this underlying investment strategy rationality provided by the Absolute Concentrated Risk Adjusted Return Relative Benchmark Specifically Targeted Correlated Efficient Frontier (ACRARR BSTCEF) (being the mantra of this invention)because it represents not only “The Goal for Successful Investing but also its Broad Investment Risk Management Optimality System Targeted To An Efficient Frontier”. Subsequently as a means to verification of the that brings us to the most important part of which is the basis for the MVPRMPA(T4) modelling apparatus, thus having the scope to illustrate what true investment decision making is all about, because according the MVPRMPA(T4) contains this efficient investment outcomes due to it's self adjusting mechanism or equilibrium approach, meaning the only risk that should be rewarded is the market risk. Exposure to market risk is captured by beta, which measures the sensitivity of returns statistical and all the mean variances/fundamentals on the particular security and the portfolio to market. Therefore this systematic Building Block approach by the MVPR MPA(T4) through its flexible technique of Alpha Metrics forms into a true superior value accordingly based on an in-built technique of efficient self adjusting structural hardware/software mechanism approach combined with utilising multiple strategies processed through systematic building blocks, that builds solutions for their clients/members in much the same way so as to continuously select the pedigree investments that asset allocate across the relative strength asset classes according to the consistency of the changing times and unpredictable markets which can mean long term assumptions about portfolio risk management and portfolio construction may need to be challenged and new methodologies explored by a new breed of DG/FP/AC/MT/FM/SB. Therefore this New Paradigm approach i.e. the MVPRMPA(T4) by strategy definition stands for the purity forecasts of Factor Metric outcomes technique and as a result the MVPRMPA(T4) that consists of multi structured Building Blocks that aims to the construct Investment Portfolio based on the traditional approach on relying on populating the selected FM/DSO/M/S/RS/T/SPA(T3) thus spread across the appropriate asset class according to the perceived client's/member's risk profile. The MVPRMPA(T4) takes on the role of counselor/guide aiming to keep the DG/FP/AC/MT/FM/SB investment strategies selection on the right course not only in difficult times but at all times, otherwise the DG/FP/AC/MT/FM/SB could finish up with major implications if they don't follow this routine, could end up with highly risky asset classes and financial products that fails to deliver in the future. Subsequently the MVPRMPA(T4) spans both; firstly of the Micro Part A is about selection such as the i.e. APMSPAS/CAPMs(T1)(T2)(T3) Historical Evaluation/Forward Evaluation/Attribution Symmetry (mean variance/fundamentals) and the only other characteristics such as secondly of the Macro Part B is about Asset Class/Asset Allocation such as the SPOPAS/CAPMs(T4) being the back-end that captures the sensitivity of the economic conditions to provides Strategic Asset Class/Asset Allocation which again being another part of the embodiment of the present invention evidenced by the MVPRMPA(T4), CPOPA(T4) and the ECMRACRAAPA(T4), that is representative of relative asset class/asset allocation benchmark across a broad global and domestic market diversity of traditionalists FM/DSO that would correlated by the Five (5) Diversified Economists Consensus thus it's unique robust hardware/software quantitative/qualitative dedicated usage construct technique. i.e. Core Spectrum Symmetry of Distribution Factor Metrics which means absolute concentrated risk adjusted return relative benchmark through the various Data Points such as (All Risk, All Performance (Blend, Growth, Value), All Mean Variance, All Fundamental, All Asset Class, All Sectors, All Historical Evaluation, All Forward Evaluation, All Quantitative, All Qualitative, All Micro, All Macro, All Economists Consensus, All Rotational Asset Class, All Retraceable Asset Allocation, All Ranking Increase Decrease Risk/Return, All Investor Style Type, All Time Series, All Scenario Outcomes, All Efficient Frontier). Clearly, only a few DG/FP/AC/MT/FM/SB have a clear investment focus and expertise to that of the superiority which realistically lies in its Structure Hardware/Software For Factor Normalisation i.e. APMSPAS/CAPMs (T1) (T2)(T3) of the various market multiples components to be able to hack the universe, no matter what multiples Micro/Macro usage procedure or transmit across structural boundaries for portfolio selection/risk management scenarios with the idea of minimising the market movements.

Therefore the MVPRMPA(T4) is a moderate valuation portfolio risk management process analysis technique for utilising multiple FM/DSO manager strategies process for efficient frontier through the all important systematic building block such as the SBBFT(T1) that makes an excellent risk management tool, which can deliver superior returns with a much lower over all risk correlation that makes a strategic portfolio optimisation for a the efficient frontier. The MVPRMPA(T4) attribution selection/strategic efficient frontier is a relative process benchmark technique that achieves absolute value strategy thus through the HEMV(Q)/FEFR(Q)/AS(FA)(T1) being a concentrated factor models with the need for a robust of sorting/scoring processing system that add excess Alpha returns over the benchmark, thus carries the importance of the micro/macro core spectrum that's processed with statistical verification assurance thus is all about sustainability of efficient frontier. In addition therefore the focus being on a risk adjusted return makes a enhanced strategy as follows;
a. delivers gains and protect capital sought by members;
b. separating market risk from management risk enables predictability from such trade-off and respective out comes;
c. also acts as compliance protection style portfolio;
d. micro/macro factor variables determined by their relative strategic merit such as rotational asset allocation and retracement asset class/sector;
e. the problem with fund of fund mangers tend to let the portfolio drift; and
f. put your money where the top score ensures how to qualify for out-performance.

Furthermore there is a reality check coming for dud DG/FP/AC/MT/FM/SB most of their multi factor models use for Alpha expectations theoretically are nothing more than a static core satellite asset class/asset allocation estimates by qualitative managers attempting to determine the likely matching outcome between the selection on suitable perceived investments that match the perceived client's risk tolerance which are flaunt with danger.

Examples of how the financial planner uses the system 12 to Moderate Valuation Portfolio Risk Management Process Analysis (MVPRMPA) (T4) are set out below:
1. Fund Managers:
a. Portfolio—Asset Allocation shown in FIG. 238; and
b. Portfolio—Client Profiling shown in FIG. 239; and
2. Direct Shares Opportunities:
a. Portfolio—Final Asset Allocation shown in FIG. 240;
b. Portfolio—Client Profiling shown in FIG. 241;
c. Portfolio—Combined Funds/Shares Final Asset Allocation shown in FIGS. 242 and 243; and
d. Portfolio—Combined Funds/Shares Client Profiling shown in FIGS. 244 and 245.

### 7. Quality Assessment Quarterly Review Process Analysis (QAQRPA(T4))

When it comes to compared to relative benchmark to a periodically assessment (i.e. Income, Growth and Time) of clients/members Managed Portfolio, the aim of the (T4) is that in order to provide a ‘best guess’ estimate of relative Total Performance compared to Relative Benchmark, has become defined by this exposure approach since the last Rebalance Date. Traditionally this has been done by using quantitative/quantitative analysis of recent historical FM/DSO/M/S/RS/T/SPA(T3) regards price volatility and correlation data models. Now the QAQRPA(T4) provides a “dial-up time/graph blocks mechanism” for using indexed based modelling relativity as to a particular time block (i.e. Daily, Weekly Quarterly, Half-Yearly Annually, Bi-Annually) hence being able to improve its periodical challenge of assessing and managing a clients/members Managed Portfolio which achieves a better understanding of how the QAQRPA(T4) is an important part, because the reasoning behind this rationality is provided by Absolute Concentrated Risk Adjusted Return Relative Benchmark Specifically Targeted Correlated Efficient Frontier (ACRARRBSTCEF) (being the mantra of this invention) because it represents not only “The Goal for Successful Investing but also its Broad Investment Risk Management Optimality System Targeted To An Efficient Frontier. Therefore this makes the QAQRPA(T4) an exceptional time saving devise that provides incident feedback for a multi composite asset class adjusted returns Portfolio system, which works on the principle that you are continuously keeping the clients/members portfolio on track by monitoring under-performance FM/DSO/M/S/RS/T/SPA(T3) represented by a typical relative bench mark for all markets; however, when FM/DSO/M/S/RS/T/SPA(T3) get volatile, it can provide constant returns, no matter what's happening around you, albeit managing better returns by trading off volatility against the main market. Thus our approach may be to utilise the core FM/DSO/M/S/RS/T/SPA(T3) and to surround it with low risk/high performance specialists. This is where the user friendly QAQRPA(T4) would be control led by the DG/FP/AC/MT/FM/SB, thus allows acceptable risk/return outcomes within the clients/members acceptable risk profile. The objective will be to identify the best of a breed of FM/DSO and to continue with them in such a way as to satisfy the stated investment objectives. The QAQRPA(T4) believes that profitable strategies require a selection of tools to determine entry and exit positions and anticipate market behaviour. It may also be obvious that different tools may be applicable for different markets for greater or lesser extent. These profitable strategies may involve a long-term, medium-term or a short-term. Technical analysis uses both ‘top-down’ and ‘bottom-up’ approach except they focus on market data, primary price for criteria used to make judgements. One of the most powerful of the possible technical analysis tools is also one of the simplest relative strength is QAQRPA(T4).

Therefore the QAQRPA(T4) quality assessment quarterly review is a FM/DSO buy/sell/hold knowledge gap technique being able to read the feed back through sensitive micro/macro building blocks for sector based investing. Central to the essential parts the QAQRPA(T4) analyses separately for each investment that makes up the portfolio; their respective income and capital growth based over a common time period which is usually represented by the last Purchase Price/Balance Date/Rebalance Date. This therefore establishes a platform so as to compare in isolation their respective individual out performance adjudged against their respective economic benchmark indices. Naturally all changes are surrounded in decision-making rules particularly as to benchmark cut-off point, weather the FM/DSO/M/S/RS/T/SPA (T3), are given a reprieve (euphemistically referred to as “three strikes and your out” in order to right the ship) of an additional one or two quarters comparison against a typical relative benchmark. Some DG/FP/AC/MT/FM/SB generally go back to the revisiting the drawing board the “hiring and firing” analysis/process/system of bottom-up income/growth and top-down macro blending. Therefore the QAQRPA(T4) continuously alert with its on going monitoring program for pedigree FM/DSO back end Alpha constantly searching for sufficiently rewarded for absolute risk/return. Thus the ACRARRBSTCEF traditional optimisation method ensures portfolio protection such as profitable strategies require a selection of tools such as the micro/macro selection process for systematic investment performance v's market risk to determine entry and exit positions and anticipate market behavior, for example the normalisation of shares/credit markets will not mean the end of the downturn but could mean a severe cycle rather than a prolonged stagnation. Therefore the ACRARRBSTCEF efficient frontier processed through systematic building blocks provides so me of the finest practice methods for acquiring the best of a breed that the QAQRPA(T4) decision maker could adopt in order to enhance their skills such as:
a. the best strategic outcomes will emerge from the relative strength of the asset classes;
b. simple strategy—buy into companies that deliver dividends;
c. too many sub-managers on-board that creates a capacity restraint;
d. how does multi-manager outperform a fund of fund manager;
e. be aware of some of the risks that could permanently destroy a portfolio valuation; and
f. acts like an compliance investment plan.

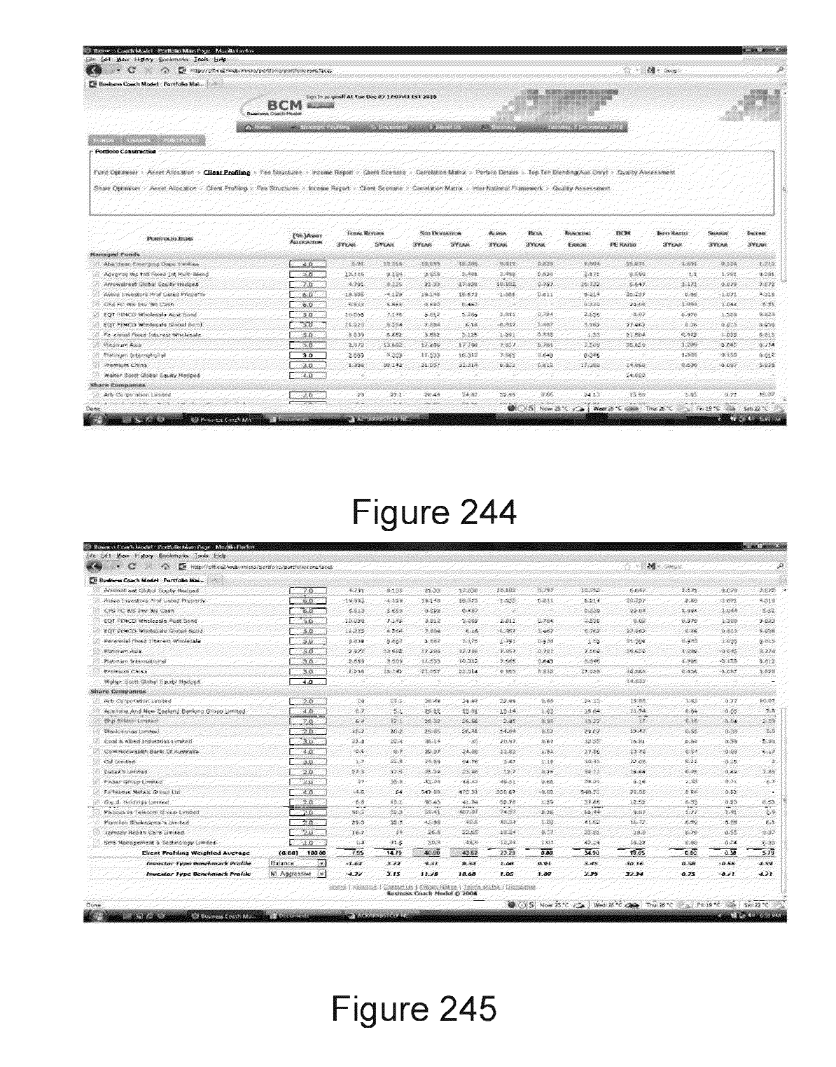

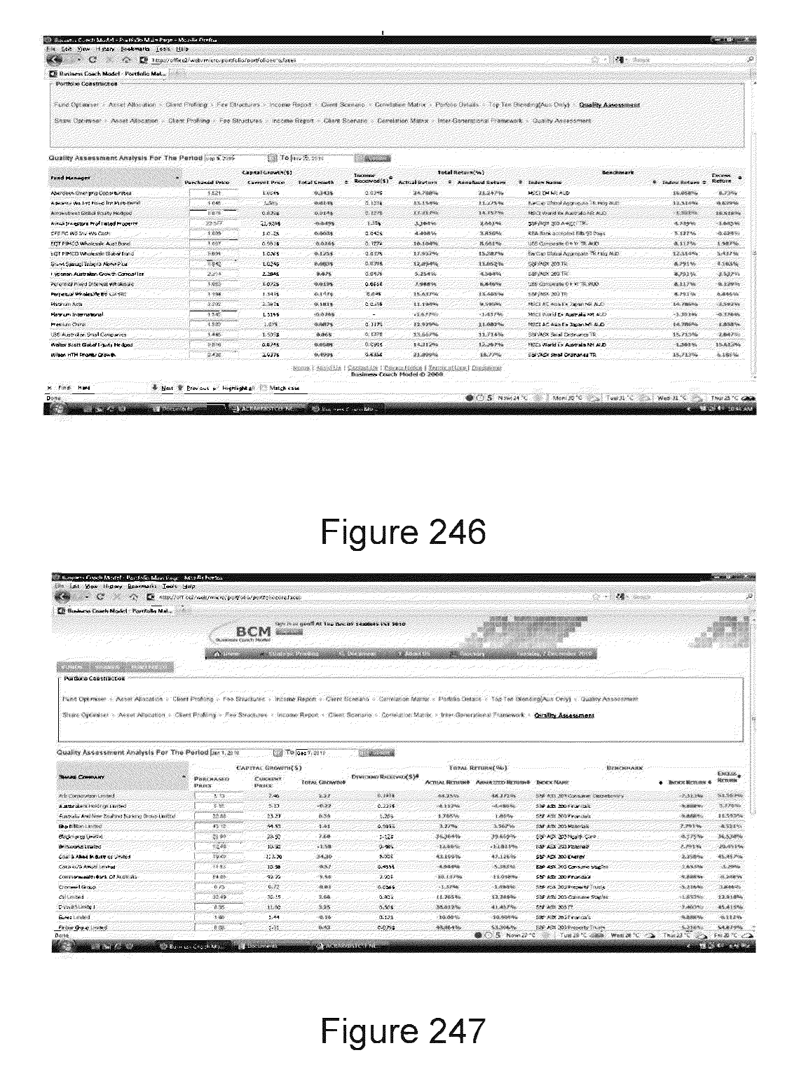

Examples of how the financial planner uses the system 12 to Moderate Valuation Portfolio Risk Management Process Analysis (MVPRMPA) (T4) are set out below:
1. Fund Managers:
a. Portfolio—Quality Assessment/Quarterly Report shown in FIG. 246; and
2. Fund Managers:
a. Portfolio—Quality Assessment/Quarterly Report shown in FIG. 247.

Many modifications will be apparent to those skilled in the art without departing from the scope of the present invention

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

What is claimed is:

1. A database system comprising:
a database storage comprising one or more data items, each data item associated with a selection criteria and a risk tolerance; and
an electronic processing device in data communication with the database storage, the electronic processing device configured to:
receive risk tolerance data representing a risk tolerance level and a selection criteria;
retrieve, from the database storage, a list of data items based on the received selection criteria, wherein the data items included in the list are ranked in accordance with the selection criteria, the list including identifiers for each data item in the list;
receiving an identifier for at least one data item included in the list of data items;
obtaining, from the database storage, the at least one data item based on the received identifier; and
generating, for display on the user interface of the user terminal, a table showing each data item, a distribution of components associated with the data item, a distribution of the components over one or more classes of a benchmark risk category, and a distribution of said components over the one or more classes for the identified at least one data item.
